(19) United States
(12) Patent Application Publication
(10) Pub. No.: US 2025/0390780 A1
(43) Pub. Date: Dec. 25, 2025

(54) QUANTUM OPTIMIZATION WITH RYDBERG ATOM ARRAYS

(71) Applicants: President and Fellows of Harvard College, Cambridge, MA (US); UNIVERSITÄT INNSBRUCK, Innsbruck (AT); ÖSTERREICHISCHE AKADEMIE DER WISSENSCHAFTEN, Vienna (AT); Quera Computing Incorporated, Boston, MA (US)

(72) Inventors: Mikhail D. Lukin, Cambridge, MA (US); Jinguo Liu, Cambridge, MA (US); Minh-Thi Nguyen, Boston, MA (US); Hannes Pichler, Innsbruck (AT); Shengtao Wang, Boston, MA (US); Jonathan Wurtz, Boston, MA (US)

(21) Appl. No.: 18/850,618

(22) PCT Filed: Mar. 24, 2023
(86) PCT No.: PCT/US23/64949

§ 371 Date: Sep. 25, 2024

Related U.S. Application Data
(60) Provisional application No. 63/323,863, filed on Mar. 25, 2022.

(51) Int. Cl. G06N 10/60

(52) U.S. Cl. CPC G06N 10/60

(57) ABSTRACT

Quantum optimization with Rydberg atom arrays is provided. In particular, methods are provided for solving combinatorial graph optimization problems, constraint satisfaction problems, maximum independent set problems, algebraic problems, and factoring.

### CROSS-REFERENCE TO RELATED APPLICATIONS

This application claims the benefit of U.S. Provisional Application No. 63/323,863, filed on Mar. 25, 2022, which is hereby incorporated by reference in its entirety.

### STATEMENT REGARDING FEDERALLY SPONSORED RESEARCH OR DEVELOPMENT

This invention was made with government support under 1734011 awarded by National Science Foundation (NSF) and under W911NF2010021 and W911NF2110367 awarded by U.S. Army Research Office (ARO) and under DE-AC02-05CH11231 awarded by U.S. Department of Energy (DOE). The government has certain rights in this invention.

### BACKGROUND

Neutral atoms can serve as building blocks for large-scale quantum systems, as described in more detail in PCT Application No. PCT/US18/42080, titled “NEUTRAL ATOM QUANTUM INFORMATION PROCESSOR.” They can be well isolated from the environment, enabling long-lived quantum memories. Initialization, control, and read-out of their internal and motional states is accomplished by resonance methods developed over the past four decades. Arrays with a large number of identical atoms can be rapidly assembled while maintaining single-atom optical control. These bottom-up approaches are complementary to the methods involving optical lattices loaded with ultracold atoms prepared via evaporative cooling, and generally result in atom separations of several micrometers. Controllable interactions between the atoms can be introduced to utilize these arrays for quantum simulation and quantum information processing. This can be achieved by coherent coupling to highly excited Rydberg states, which exhibit strong, long-range interactions. This approach provides a powerful platform for many applications, including fast multi-qubit quantum gates, quantum simulations of Ising-type spin models with up to 250 spins, and the study of collective behavior in mesoscopic ensembles. Short coherence times and relatively low gate fidelities associated with such Rydberg excitations are challenging. This imperfect coherence can limit the quality of quantum simulations and can dim the prospects for neutral atom quantum information processing. The limited coherence becomes apparent even at the level of single isolated atomic qubits.

PCT/US18/42080 describes exemplary methods and systems for quantum computing. These systems and methods can involve first trapping individual atoms and arranging them into particular geometric configurations of multiple atoms, for example, using acousto-optic deflectors. This precise placement of individual atoms assists in encoding a quantum computing problem. Next, one or more of the arranged atoms may be excited into a Rydberg state, which can produce interactions between the atoms in the array. After, the system may be evolved under a controlled environment. Finally, the state of the atoms may be read out in order to observe the solution to the encoded problem. Additional examples include providing a high fidelity and coherent control of the assembled array of atoms.

### BRIEF SUMMARY

In various embodiments, methods of and computer program products for compiling a combinatorial graph optimization problem for execution on a quantum computer are provided. A specification of an input graph is read. The input graph comprises a first plurality of vertices, each having a vertex weight, and a first plurality of edges, each having an edge weight and an associated interaction. The input graph corresponds to the combinatorial graph optimization problem. An output graph is generated, the output graph being a unit disk graph and comprising a second plurality of vertices, each having a vertex weight, and a second plurality of edges, such that a maximum weight independent set on the output graph encodes the solution to the combinatorial graph optimization problem. Generating the output graph comprises: generating a chain of vertices corresponding to each of the first plurality of vertices, each vertex in the chain being connected by an edge with its nearest neighbors in the chain; arranging the chains into a crossing lattice such that for any two chains there is one intersection between edges thereof, corresponding to one of the first plurality of edges; for each interaction associated with one of the first plurality of edges, determining a unit disk crossing gadget encoding that interaction; and at each intersection, inserting the unit disk crossing gadget that encodes the interaction associated with the corresponding edge in the input graph.

In various embodiments, methods of and computer program products for compiling a constraint satisfaction problem for execution on a quantum computer are provided. An input constraint satisfaction problem comprising a plurality of variables and constraints is read. A chain of vertices is generated corresponding to each of the plurality of variables, each vertex in the chain being connected by an edge with its nearest neighbors in the chain. The chains are arranged into a lattice such that for each of the plurality of constraints, there is an intersection in the lattice between the chains. A library of constraint satisfaction primitives is read, each constraint satisfaction primitive being associated in the library with a unit disk graph primitive, each unit disk graph comprising weighted vertices and whose maximum weight independent set provides a solution to its associated constraint satisfaction primitive. The input constraint satisfaction problem is decomposed into a plurality of constraint satisfaction primitives selected from the library. An output graph is generated by inserting the corresponding unit disk graph primitive for each constraint at its corresponding intersection in the lattice, the output graph being a unit disk graph and comprising a plurality of vertices and a plurality of edges.

In various embodiments, methods of and computer program products for compiling a maximum independent set problem for execution on a quantum computer are provided. An input graph definition is read comprising a first plurality of vertices and a first plurality of edges, the input graph definition corresponding to a maximum independent set problem. An output graph definition is generated, the output graph definition defining a unit disk graph corresponding to the maximum independent set problem, the output graph definition comprising a second plurality of vertices and a second plurality of edges. Generating the output graph definition comprises: generating a chain of vertices corresponding to each of the first plurality of vertices, each vertex in the chain being connected by an edge with its nearest neighbors in the chain, each chain containing an odd number of vertices; arranging the chains such that for any two chains there is one intersection between edges thereof; at each intersection, connecting a subgraph to the intersecting chains, wherein each subgraph is configured to either connect or bypass the respective chains according to whether the corresponding input vertices are connected by one of the first plurality of edges.

In various embodiments, methods of and computer program products for compiling an algebraic problem for execution on a quantum computer are provided. An input algebraic problem is read. A library of algebraic primitives is read, each algebraic primitive being associated in the library with a unit disk graph whose maximum independent set provides a solution to that algebraic primitive. The input algebraic problem is decomposed into a plurality of the algebraic primitives from the library. An output graph is generated by interconnecting the unit disk graphs corresponding to the plurality of algebraic primitives, the output graph comprising a plurality of vertices and a plurality of edges.

In various embodiments, methods of and computer program products for performing factoring on a quantum computer are provided. A plurality of qubits is arranged according to a unit disk graph. The plurality of qubits is tiled into a plurality of subsets, each subset corresponding to a repeated subgraph of the unit disk graph. The unit disk graph comprises a plurality of vertices and a plurality of edges. Each of the plurality of qubits corresponds to one of the plurality of vertices. Each qubit being excitable into a Rydberg state having a Rydberg blockade radius, the Rydberg blockade radius of each of the plurality of qubits corresponds to a unit disk of the unit disk graph. Each of the subsets comprises qubits corresponding to a carry bit input, a carry bit output, a partial sum input, and a partial sum output. Each subset is configured to receive a carry bit input or provide a carry bit output to another of the subsets on a neighboring tile and to receive a partial sum input or provide a carry bit output to another of the subsets on a neighboring tile. The plurality of qubits comprises a plurality of input qubits, each corresponding to an input bit. The plurality of qubits comprises a plurality of first factor nodes, each corresponding to a first factor bit. The plurality of qubits comprises a plurality of second factor nodes, each corresponding to a second factor bit. The plurality of qubits is evolved into a final state, the final state corresponding to a maximum independent set of the unit disk graph. The plurality of first factor nodes and second factor nodes are measured.

### BRIEF DESCRIPTION OF THE FIGURES

FIGS. 1A-1E illustrate an exemplary scheme for encoding and finding solutions to optimization problems using an array of qubits, according to some embodiments.

FIGS. 2A-2B illustrate and characterize arrangements of vertex and ancillary qubits, according to some embodiments.

FIGS. 3A-3B are graphs illustrating the performance of classical branch and bound algorithms for MIS on random UD graphs, according to some embodiments.

FIGS. 4A-4D are graphs illustrating the performance of quantum algorithms for MIS on random UD graphs, according to some embodiments.

FIG. 5 is an example random unit disk graph, according to some embodiments.

FIG. 6 is a graph showing a method to extract the adiabatic time scale T_{LZ}, according to some embodiments.

FIGS. 7A-7C are graphs showing aspects of the adiabatic time scale T_{LZ}, according to some embodiments.

FIG. 8 is a phase diagram for a quantum algorithm in terms of an approximation ratio r, according to some embodiments.

FIG. 9 is an illustration and graph showing behavior of a Rydberg problem, according to some embodiments.

FIGS. 10A-10B are grid representations of planar graphs of maximum degree 3 and a transformation to a unit disk graph, according to some embodiments.

FIGS. 11A-11C are grid representations of planar graphs of maximum degree 3 taking into account non-nearest-neighbor interactions, according to some embodiments.

FIGS. 12A-12E are grid representations of transformations to an effective spin model, according to some embodiments.

FIGS. 13A-13B are illustrations of local non-maximal independent set configurations and domain walls, according to some embodiments.

FIG. 14A is a schematic of a p-level QAOA algorithm, according to some embodiments.

FIG. 14B is an illustration of an example MaxCut problem, according to some embodiments.

FIGS. 15A-15H are graphs showing QAOA optimal variational parameters, according to some embodiments.

FIGS. 16A-16B are graphs showing comparisons of embodiments of disclosed heuristic strategies to brute force methods, according to some embodiments.

FIGS. 16C-16D are graphs showing the average performance of QAOA, according to some embodiments.

FIGS. 17A-17J are plots showing the performance of QAOA as compared to QA, according to some embodiments.

FIGS. 18A-18F are graphs and illustrations showing nonadiabatic aspects of QAOA, according to some embodiments.

FIG. 19 is a graph showing the results of Monte-Carlo simulations of QAOA, according to some embodiments.

FIGS. 20A-20F are graphs and illustrations showing exemplary vertex renumbering techniques and Rydberg implementations, according to some embodiments.

FIGS. 21A-21F are graphs showing QAOA optimal variational parameters, according to some embodiments.

FIG. 22 is a schematic of two variants of a FOURIER[q, R] heuristic strategy, according to some embodiments.

FIG. 23 is a graph showing a comparison between various heuristic strategies, according to some embodiments.

FIGS. 24A-24C are graphs showing energy spectra and time to solution for QAOA and QA, according to some embodiments.

FIGS. 25A-25B are graphs showing exemplary instantaneous eigenstate populations and couplings, according to some embodiments.

FIG. 26 is a schematic view of a procedure to solve a variety of optimization problems using programmable Rydberg atom arrays according to some embodiments.

FIGS. 27A-G illustrates exemplary UDG-MWIS mappings according to some embodiments.

FIGS. 28A-D show MWIS representation of some example constraints according to some embodiments.

FIGS. 29A-C show gadgets for formulating constraint satisfaction problems as UDG-MWIS according to some embodiments.

FIGS. 30A-B are graphs showing two decoupled effective degrees of freedom according to some embodiments.

FIGS. 31A-B is an example encoding procedure for an MWIS problem into UDG-MWIS according to some embodiments.

FIGS. 32A-C illustrates an example encoding procedure for the QUBO/Ising problem for a 5-bit system according to some embodiments.

FIGS. 33A-C illustrate an encoding procedure for integer factorization according to some embodiments.

FIGS. 34A-C illustrate QAA performance for MWIS on original and mapped graphs according to some embodiments.

FIGS. 35A-E illustrate simplification techniques to reduce the overhead according to some embodiments.

FIGS. 36A-D shows an example 2D restricted-connectivity graph and reduction to UDG-MWIS according to some embodiments.

FIGS. 37A-B shows components of a factoring gadget according to some embodiments.

FIG. 38 shows exemplary graph simplification rules according to some embodiments.

FIG. 39 shows an exemplary length-12 copy gadget according to some embodiments.

FIG. 40 shows an exemplary graph for quadratic unconstrained binary optimization (QUBO) according to some embodiments.

FIG. 41 shows an exemplary graph for quadratic unconstrained binary optimization (QUBO) according to some embodiments.

FIG. 42 shows exemplary local maximum independent sets according to some embodiments.

FIG. 43 shows an exemplary graph rewrite according to some embodiments.

FIG. 44 shows reduction schemes from an MIS problem on a general graph to that on a DUGG according to some embodiments.

FIGS. 45A-B show the Petersen graph and its embedding according to some embodiments.

FIG. 46 shows an exemplary path decomposition of an area-law graph according to some embodiments.

FIG. 47 shows four unit disk crossover gadgets according to some embodiments.

FIG. 48 is an exemplary graph according to some embodiments.

FIG. 49 is an exemplary graph according to some embodiments.

FIG. 50 shows an exemplary mapping between graphs according to some embodiments.

FIG. 51 shows an exemplary mapping between graphs according to some embodiments.

FIG. 52 is an exemplary graph according to some embodiments.

FIG. 53 shows exemplary subgraph rewriting with copy gadgets according to some embodiments.

FIG. 54 illustrates exemplary steps to obtain an MIS of a source graph according to some embodiments.

FIGS. 55-57 show exemplary rewriting rules for MIS gadgets that are suitable for problem reduction according to some embodiments.

FIGS. 58-60 show rules to extract MIS for a source graph according to some embodiments.

FIGS. 61-62 are unit disk graphs illustrating the geometric relationship among vertices according to some embodiments.

FIG. 63 depicts a plurality of unit disk graphs suitable for encoding algebraic primitives according to embodiments of the present disclosure.

FIG. 64 is a schematic view of an apparatus for quantum computation according to embodiments of the present disclosure.

FIG. 65 depicts a computing node according to embodiments of the present disclosure.

### DETAILED DESCRIPTION

A quantum bit (qubit) is the fundamental building block for a quantum computer. By analogy to classical bits which are used to store information in traditional computers (each bit is 0 or 1), qubits can occupy two distinct states labeled |0) and |1), or any quantum superposition of the two states. In various applications, multiple qubits are entangled in order to build multi-qubit quantum gates.

Bits and qubits are each encoded in the state of real physical systems. For example, a classical bit (0 or 1) may be encoded in whether a capacitor is charged or discharged, or whether a switch is ‘on’ or ‘off’.

The term qudit (quantum digit) denotes the unit of quantum information that can be realized in suitable d-level quantum systems. A collection of qubits that can be measured to N states can implement an N-level qudit.

Quantum bits are encoded in quantum systems with two (or more) distinct quantum states. There are many physical realizations that may be employed. One example is based on individual particles such as atoms, ions, or molecules which are isolated in vacuum. These isolated atoms, ions, and molecules have many distinct quantum states that correspond to different orientations of electron spins, nuclear spins, electron orbits, and molecular rotations/vibrations.

In principle, a qubit may be encoded in any pair of quantum states of the atom/ion/molecule. In practice, a key parameter of qubits is described by their quantum coherence properties. Coherence measures the lifetime of the qubit before its information is lost. It has a close analogy with classical bits: if you prepare a classical bit in the 0 state, then after some time it may randomly be flipped to 1 due to environmental noise. Quantum mechanically, the same error may occur: |0 [symbol] may randomly flip to |1 [symbol] after some characteristic timescale. However, qubits may suffer from additional errors: for example, a superposition state (|0 [symbol] +|1 [symbol] )/√2 may randomly flip to (|0 [symbol] −|1 [symbol] )/√2. In real quantum computers, the qubits must be encoded in quantum states which have long coherence properties.

Quantum computers generally can contain many qubits, each encoded in its own atom/molecule/ion/etc. Beyond simply containing the qubits, the quantum computer should be able to (1) initialize the qubits, (2) manipulate the state of the qubits in a controlled way, and (3) read out the final states of the qubits. When it comes to manipulation of the qubits, this is usually broken down into two types: one type of qubit manipulation is a so-called single-qubit gate, which means an operation that is applied individually to a qubit. This may, for example, flip the state of the qubit from |0 [symbol] to |1 [symbol] , or it may take |0 [symbol] to a superposition state (|0 [symbol] +|1 [symbol] )/√2. The second necessary type of qubit manipulation is a multi-qubit gate, which acts collectively on two or more qubits, including those that are entangled. A multi-qubit gate is realized through some form of interaction between the qubits. The various quantum computing platforms (having various physical encodings of qubits) rely on different physical mechanisms both for single-qubit gates as well as multi-qubit gates according to the physical system that is storing the qubit.

In various embodiments of a quantum computer, a qubit is encoded in two near-ground-state energy levels of an atom, ion, or molecule. An example of this is a hyperfine qubit. Such a qubit is encoded in two electronic ground states that differ by the relative orientation of the nuclear spin with respect to the outer electron spin. Pairs of such states can be chosen so that they are particularly robust/insensitive to environmental perturbations, leading to long coherence times. These states are split in energy by the hyperfine interaction energy of the atom/ion/molecule, which is the interaction energy between the nuclear spin and the electron spin. The robustness of the qubit can be understood as the energy splitting between the two states being particularly stable. For this reason, such states are called clock states because the stable energy splitting can form an excellent frequency-reference and as such forms the basis for atomic clocks. Typical hyperfine splitting between these qubit states is in the 1-13 GHz frequency range.

To perform single-qubit gates on such a hyperfine qubit, it is possible to apply coherent microwave radiation at the exact frequency of the energy splitting between states. However, there are two drawbacks to this approach. First, microwaves cannot be applied to just one qubit without affecting adjacent qubits. This is because qubits are encoded in particles that are typically just a few microns apart from one another, and microwaves cannot be focused to such a small scale due to their large wavelength. Second, the microwave intensity is fairly limited and as such the maximum speed of single-qubit gates is correspondingly limited.

An alternative approach is based on stimulated Raman transitions. In this case, a laser field is applied to the atoms/ions/molecules. The laser field is nearly (but not exactly) resonant with an optical transition from one of the ground states to an optically excited state. The laser contains multiple frequency components separated in frequency by exactly the amount equal to the hyperfine splitting of the qubit. The atom/ion/molecule can absorb a photon from one frequency component and coherently emit into a different frequency component, and in doing so it changes its state. This approach benefits from the capability of focusing the laser field onto individual particles or subsets of particles in the quantum computer. The laser field can also be applied with high intensity, allowing much faster gate operations.

Neutral atom quantum computers encode qubits in individual neutral atoms. The neutral atoms are trapped in a vacuum chamber and levitated by trapping lasers. Most commonly, the trapping lasers are individual optical tweezers, which are individual tightly focused laser beams that trap an individual atom at the focus. Alternatively, individual atoms may be trapped in an optical lattice, which is formed from standing waves of laser light which produce a periodic structure of nodes/antinodes.

A typical approach for encoding a qubit in neutral atoms is the hyperfine qubit approach, in which two ground states split by several GHz form the qubit. Multi-qubit gates in neutral atom quantum computers are realized using a third atomic state, which is a highly-excited Rydberg state. When one atom is excited to a Rydberg state, neighboring atoms are prevented from being excited to the Rydberg state. This conditional behavior forms the basis for multi-qubit gates, such as a controlled-NOT gate. The Rydberg state is used temporarily to mediate the multi-qubit gate, and then the atoms are returned back from the Rydberg state to the ground state levels to preserve their coherence.

Trapped ion quantum computers use atomic species that are ionized, meaning they have a net charge. In most cases, many ions are trapped in one large trapping potential formed by electrodes in a vacuum chamber. The ions are pulled to the minimum of the trapping potential, but inter-ion Coulomb repulsion causes them to form a crystal structure centered in the middle of the trapping potential. Most commonly, the ions arrange into a linear chain. Other ways to trap ions are also possible, such as using optical tweezers, or trapping ions individually with local electric fields with a more complex on-chip electrode structure.

Qubits are encoded in trapped ions in multiple ways. One common approach is to use ground-state hyperfine levels, as described for neutral atoms. In trapped ions with hyperfine-qubit encoding, as with neutral atoms, single-qubit gates may use microwave radiation or stimulated Raman transitions.

Unlike in neutral atoms, trapped ion hyperfine qubits rely heavily on stimulated Raman transitions for performing multi-qubit gates. Stimulated Raman transitions may be used to control both the hyperfine state of the ion but also to change the motional state of the ion (i.e., add momentum). This can be understood as absorbing a photon moving in one direction and emitting a photon in a different direction, such that the difference in photon momentum is absorbed by the ion. Since many ions are often trapped in one collective trapping potential and are mutually repelling one another, changing the motional state of one ion affects other ions in the system, and this mechanism forms the basis for multi-qubit gates.

According to various embodiments of a quantum computer, individual particles (atoms/ions/molecules) can first be trapped in an array and arranged into particular configurations. Next, one or more particles are prepared in a desired quantum state. Quantum circuits can then be implemented by a sequence of qubit operations acting on individual qubits (single-qubit gates) or on groups of two or more qubits (multi-qubit gates). Finally, the state of the particles can be read out in order to observe the result of the quantum circuit. The readout can be accomplished using an observation system that typically includes an electron-multiplied CCD (EMCCD) camera image to detect particles' loaded positions, and a second camera image to read out the particles' final states by, for example, detecting fluorescence emitted by the particles in their final states.

Optimization algorithms are used for finding the best solution, given a specified criterion, for a specified problem. Combinatorial optimization involves identifying an optimal solution to a problem given a finite set of solutions. Quantum optimization is a technique for solving combinatorial optimization problems by utilizing controlled dynamics of quantum many-body systems, such as a 2D array of individual atoms, each of which can be referred to as a “qubit” or “spin.” Quantum algorithms can solve combinatorially hard optimization problems by encoding such problems in the classical ground state of a programmable quantum system, such as a spin model. Quantum algorithms are then designed to utilize quantum evolution in order to drive the system into this ground state, such that a subsequent measurement reveals the solution. In other words, a problem can be encoded by placing qubits in a desired arrangement with desired interactions that encode constraints set forth by the optimization problem. When properly encoded, the ground state of the many-body system comprises the solution to the optimization problem. The problem can therefore be solved by driving the many-body system through an evolutionary process into its ground state.

Without being bound by theory, assuming complete control of the interactions between the qubits, it is possible to encode nondeterministic polynomial (“NP”)-complete optimization problems into the ground states of such systems. In most realizations, however, not all interactions are fully programmable. Instead, such interactions are determined by properties of specific physical realizations, such as, but not limited to locality, geometric connectivity, or controllability, which either constrain the class of problems that can be efficiently realized or imply that substantial overhead is required for their realization. Thus, one of the challenges in understanding and assessing quantum optimization algorithms involves designing methods to encode specific and larger classes of combinatorial problems in physical systems in an efficient and natural way.

In some implementations, quantum optimization can involve: (1) encoding a problem by controlling the positions of individual qubits in a quantum system given a particular type and strength of interaction between pairs of qubits and (2) steering the dynamics of the qubits in the quantum system through an evolutionary process such that their evolved final states provide solutions to optimization problems. The steering of the dynamics of the qubits into the ground state solution to the optimization problem can be achieved via multiple different processes, such as, but not limited to the adiabatic principle in quantum annealing algorithms (QAA), or more general variational approaches, such as, but not limited to quantum approximate optimization algorithms (QAOA). Such algorithms may tackle computationally difficult problems beyond the capabilities of classical computers. However, the heuristic nature of these algorithms poses a challenge to predicting their practical performance and calls for experimental tests. In addition, such systems, in their full generality, are inefficient and difficult to implement owing to practical constraints as described above, and can only be used on a subset of optimization problems.

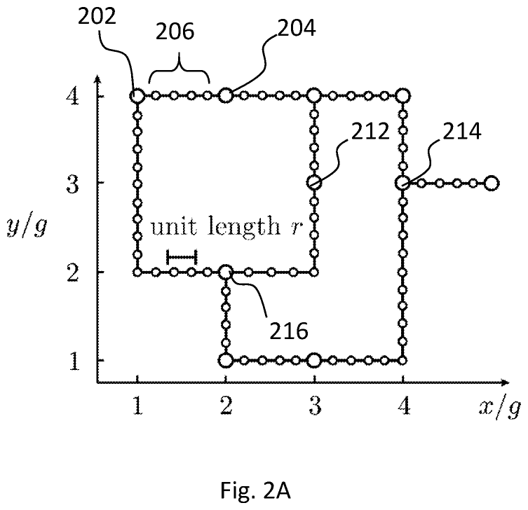

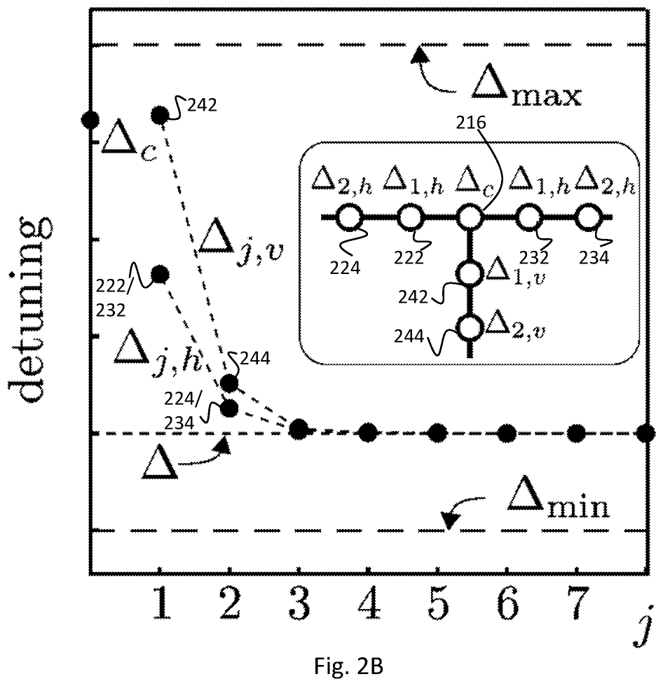

Some aspects of the present disclosure relate to systems and methods for arranging qubits in programmable arrays that can encode or approximately encode in an efficient way a broader set of optimization problems. In some embodiments, chains of even numbers of adjacent “ancillary” qubits are used to encode interactions between distant qubits by connecting such distant qubits with chains of ancillary qubits, for example as described in more detail with reference to FIG. 2A. As described in more detail throughout the present disclosure, these chains of “ancillary” qubits can be used to encode interaction between certain “vertex” qubits, but not other vertex qubits and to reduce the strength of long-range interaction between two vertex qubits that are not intended to be connected via an edge. In some embodiments, the effects of long-range interactions can be further reduced by introducing a detuning parameter to a chosen control technique to selectively control interaction between particular qubits. For example, for corner and junction qubits, detuning patterns described in the present disclosure can reduce the effects of long-range interactions such that the ground state of the system is the optimal solution to the encoded problem. The techniques described herein can permit efficient encoding of a larger set of optimization problems beyond simple unit disk graphs.

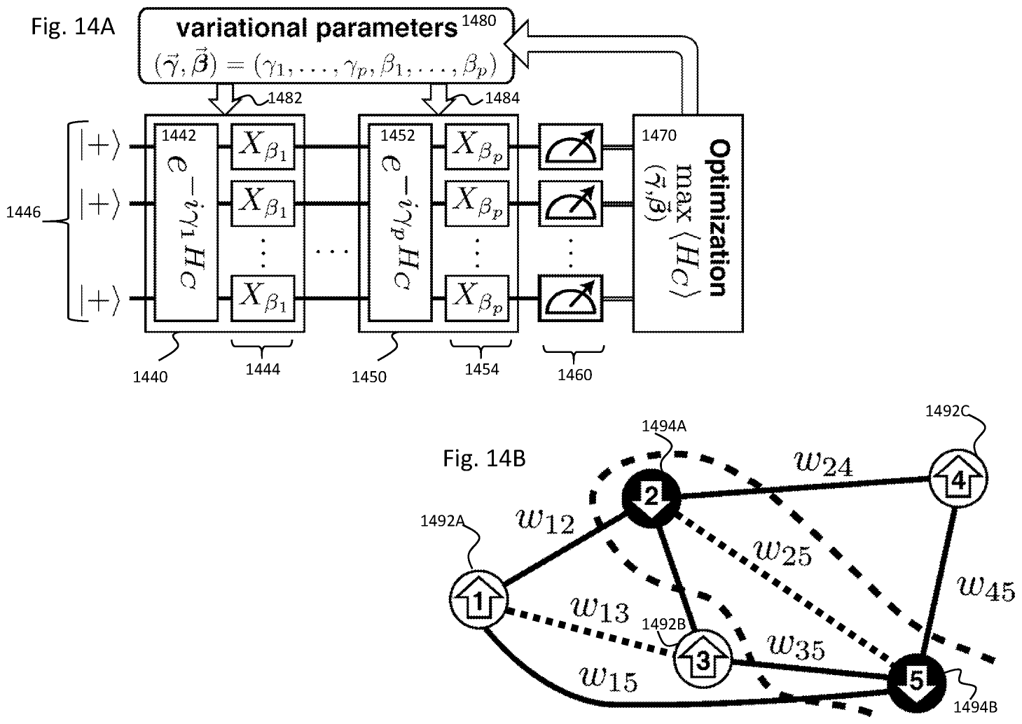

Some additional or alternative aspects of the present disclosure relate to systems and methods for coherently manipulating the internal states of qubits, including excitation. In some embodiments, techniques are disclosed that can be used to evolve an encoded problem to find an optimal (or an approximately optimal) solution. For example, embodiments of the present disclosure relate to optimal variational parameters and strategies for performing the Quantum Approximate Optimization Algorithm (“QAOA”), some embodiments of which are described, for example, with reference to FIG. 14A. For example, embodiments include heuristics for classical feedback loops that can improve the performance of brute-force QAOA implementations. In some embodiments, these strategies perform at least as well if not better than existing algorithms. Some aspects of the present disclosure focus on implementations of using QAOA to solve MaxCut combinatorial problems, but the disclosed techniques are not limited thereto.

### Exemplary Optimization Problems and Encodings

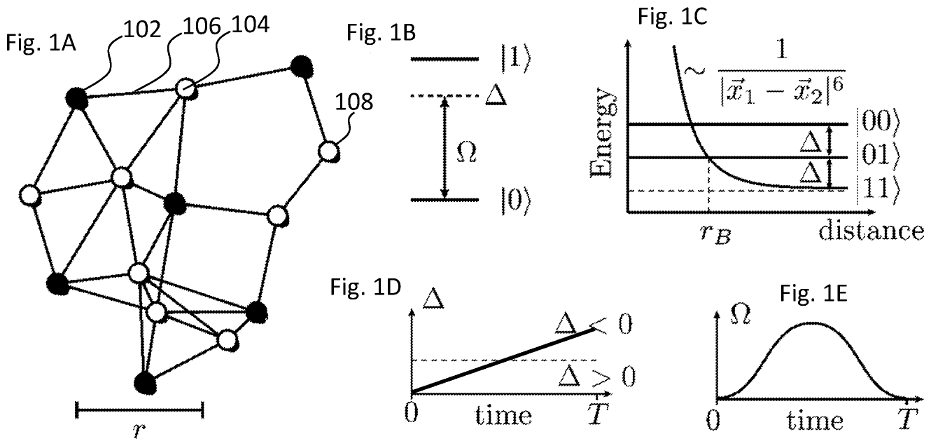

In some embodiments, particular types of optimization problems can be encoded with an arrangement of qubits. For example, FIGS. 1A-1E show an exemplary scheme for encoding and finding solutions to optimization problems using an array of qubits, according to some embodiments. FIG. 1A shows aspects of a Rydberg blockade mechanism and maximum independent set on unit disk graphs, according to some embodiments. One exemplary optimization problem that can be solved using the techniques described in the present disclosure is a maximum independent set (“MIS”) problem. Given a graph G with vertices V and edges E, an independent set can be defined as a subset of vertices where no pair is connected by an edge. FIG. 1A shows an example graph with vertices such as 102, 104. Vertices 102, 104 can be connected via an edge, such as edge 106. The computational task of a MIS problem is to find the largest such set, called the maximum independent set (MIS). As shown in the graph of FIG. 1A, the maximum independent set is denoted via black vertices such as 102, none of which are connected by only one edge. In the example of FIG. 1A, the size of the maximum independent set is 6. Determining whether the size of MIS is larger than a given integer a for an arbitrary graph G is a well-known NP-complete problem. Furthermore, even approximating the size of the MIS is an NP-hard problem. In some embodiments, the MIS problem is also equivalent to the maximum clique problem and the minimum vertex cover problem. Thus, a solution to the MIS problem will constitute a solution to the corresponding maximum clique problem and the minimum vertex cover problem.

Without being bound by theory, the embodiment of FIG. 1A can be referred to as a unit disk (“UD”) graph. UD graphs are geometric graphs in which vertices are placed in a 2D plane and connected if their pairwise distance is less than a unit length, r. In other words, UD graphs are graphs where any two vertices within a distance r from one another are connected with an edge, such as vertices 102, 104 which are connected via edge 106. Vertex 108 is too far from vertices 102, 104 to be connected therewith with an edge. The MIS problem on UD graphs (UD-MIS) is still NP-complete and can be used to find practical situations ranging from, for example, wireless network design to map labelling in various industry sectors.

In some embodiments, a MIS problem can be formulated as an energy minimization problem, by associating a spin-½ with each vertex v∈V. Vertices like those shown in FIG. 1A can be prepared such that after a driving sequence, such as one with a Rabi frequency Ω and detuning Δ that vary over time (as shown in FIGS. 1D and 1E), the state |1 [symbol] of each qubit is energetically favored unless a nearby vertex is also in the state |1 [symbol] , in which case it is energetically favored to have one vertex transition to the state |0 [symbol] . Without being limited by theory, the Hamiltonian (“H_{P}”) of such a system can be represented as follows:

$${H}_{P} = {\sum }_{ν ∈ V} - Δ {n}_{v} + {\sum }_{( v , w ) ∈ E} U {n}_{v} {n}_{w} \qquad Equation 1$$

where a spin-½ system is assigned with states |0 [symbol] and |1 [symbol] to each vertex, nᵥ=|1 [symbol] ᵥ [symbol] 1|, Δ is the detuning on the spin, and U is the energy penalty when two spins (v, w) connected by an edge (E) are both in state |1 [symbol] . Initially, all vertices can be prepared in the |0 [symbol] state. Driving causes at least some of the vertices to transition to the |1 [symbol] state. For Δ>0, H_{P} favors qubits to be in state |1 [symbol] . However, if U>A, it is energetically unfavorable for two qubits, u and v, to be simultaneously in state |1 [symbol] if they are connected by an edge u, v∈E. Thus, each ground state of H_{P} represents a configuration where the qubits that correspond to vertices in the maximum independent set are in state |1 [symbol] , and all other qubits are in state |0 [symbol] .

FIG. 1C is a graph showing interatomic interaction potentials between two adjacent vertices in the limit of weak driving, where Ω<<A and Δ>0, according to some embodiments. Changing the detuning and Rabi frequency over time can produce quantum evolution that changes the system from the initial state to the final state, which can include a solution (or one or more approximate solutions) to the encoded problem. As described above, under such conditions, for qubits closer than r_{B} (the Rydberg blockade radius) it is energetically favorable for one of the qubits to stay in the |0 [symbol] state. For example, when U>Δ>0, the Hamiltonian H_{P} energetically favors each spin to be in the state |1 [symbol] unless a pair of spins are connected by an edge (i.e., within the Rydberg radius). Thus, in the ground state of the Hamiltonian H_{P}, only the vertices in the MIS are in state |1 [symbol] . Such a state can be referred to as a MIS-state, and H_{P} can be referred to as a MIS-Hamiltonian. In some embodiments, the NP-complete decision problem of MIS becomes deciding whether the ground state energy of H_{P} is lower than −aΔ.

In some embodiments, a quantum annealing algorithm (“QAA”) can be used to evolve the quantum state from the initial state to the final state, which encodes the solution of the optimization problem. For example, a simple QAA can be implemented by adding a transverse field

$${H}_{D} = {\sum }_{v} Ω {σ}_{v}^{x}$$

with σ^{x}=|0 [symbol] [symbol] 1|+|1 [symbol] [symbol] 0|, that induces quantum tunneling between different spin configurations. FIG. 1B shows a transition between spin states, according to some embodiments. For example, the arrow labelled as Rabi frequency Ω describes a transition between the spin states |0 [symbol] and |1 [symbol] controlled, for example, by a laser beam with the Hamiltonian

$$Ω {σ}_{v}^{x}$$

for a spin v. when we detuning Δ<0, the ground state of the Hamiltonian H_{P} is the trivial state where all qubits are in the |0 [symbol] state. When the detuning Δ>0, the ground states of H_{P} are the MIS states where qubits in state |1 [symbol] form the MIS. By slowly changing Ω and Δ in a time-dependent fashion, for example as shown in FIGS. 1E and 1D, respectively, the trivial ground state with all qubits in |0 [symbol] (Δ<0, Ω=0) can be adiabatically connected to a final state encoding the MIS (Δ>0, Ω=0), resulting in the qubits being left in a solution to the optimization problem. Note that in general, such a procedure can involve transitions across vanishing energy gaps as discussed in more detail throughout the present disclosure. Exemplary non-limiting embodiments of simulations are described in more detail below in the section titled “Quantum annealing for random UD-MIS.”

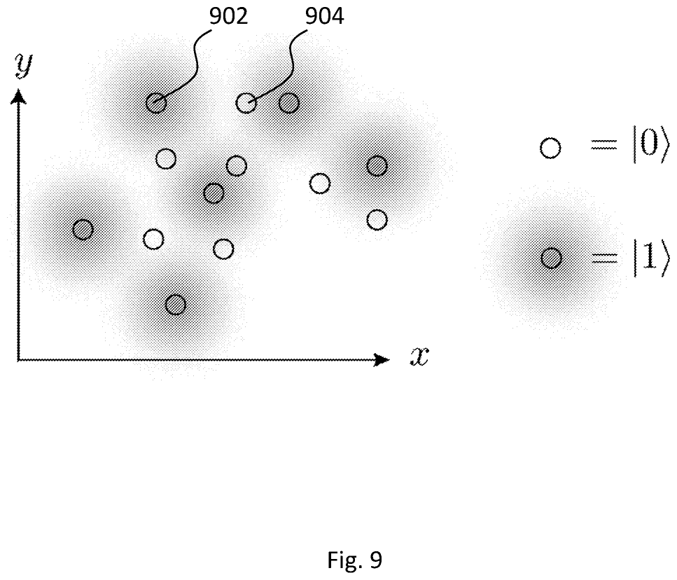

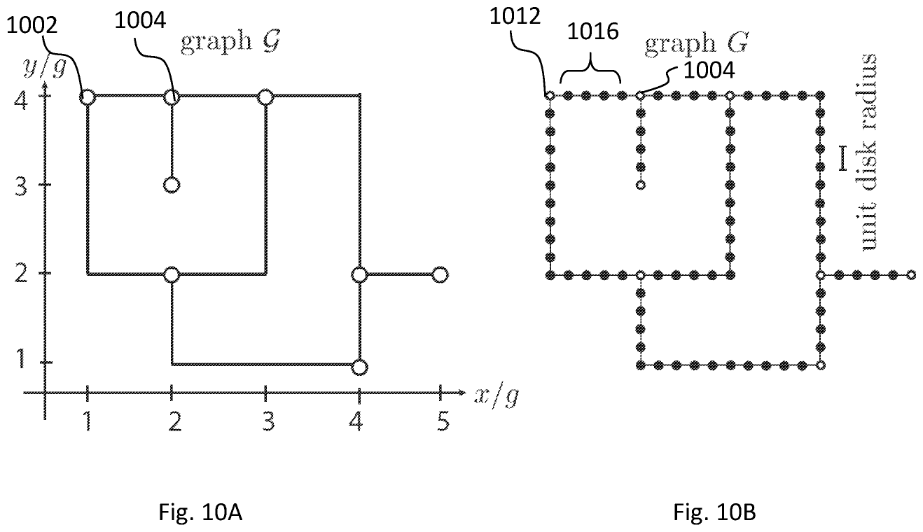

In some embodiments, MIS problems can be implemented using Rydberg interactions between individual atoms. For example, as discussed in more detail in PCT/US18/42080, graphs like that shown in FIG. 1A can be implemented using two-level qubits, the states of which are shown in FIG. 1B, according to some embodiments. Using optical tweezers, atoms (qubits) can be individually and deterministically arranged in fully programmable arrays in one, two and even three dimensions. Such a system can use individually trapped homogeneously excited neutral atoms interacting via the so-called Rydberg blockade mechanism. Each atom realizes a qubit, v, with an internal ground state, |0 [symbol] , and a highly excited, long-lived Rydberg state, |1 [symbol] , which can be coherently manipulated by external laser fields. If two atoms are both in this Rydberg state and within the Rydberg blockade radius, they interact via strong van der Waals interactions, which is energetically unfavorable. This makes it possible to encode a UD-MIS problem using qubits as vertices and the disk size set by the Rydberg radius, as explained in more detail below. FIG. 9 shows an exemplary solution to a UD-MIS problem, where some qubits 904 are found in the internal ground state, |0 [symbol] , and, other qubits 902 in the long-lived Rydberg state, |1 [symbol] , according to some embodiments.

Without being limited by theory, the Hamiltonian governing the evolution of embodiments of such a system can be represented as follows:

$${H}_{Ryd} = {\sum }_{v} ( {Ω}_{v} {σ}_{v}^{x} - {Δ}_{v} {n}_{v} ) + {\sum }_{v < ω} v ( \vert {\vec{x}}_{v} - {x}_{ω} \vert ) {n}_{v} {n}_{w} , \qquad Equation 2$$

where Ω_{υ} and Δ_{υ} are the Rabi frequency and laser detuning at the position \vec{x}_{υ}0 of qubit v. While individual manipulation is feasible, such a system can also be implemented with a homogeneous driving laser, for example, where Ω_{υ}=Ω and Δ_{υ}=Δ. The operator

$${{σ}_{v}^{x} = \vert 0 〉}_{v} {〈 1 \vert + \vert 1 〉}_{v} 〈 0 \vert$$

can give rise to coherent spin flips of qubit v and nᵥ=|1 [symbol] [symbol] 1| counts if the qubit vis in the Rydberg state. In some embodiments, for isotropic Rydberg states, the interatomic interaction strength depends only on the relative atomic distance, x, and is given by VRyd(x)=C/x⁶, where C is a constant. The strong interactions at short distances energetically prevent two qubits from being simultaneously in state |1 [symbol] if they are within the Rydberg blockade radius r_{B}=(C/\sqrt{(2Ω)²+Δ²})^{1/6}, as shown in FIG. 1C, resulting in the so-called blockade mechanism, according to some embodiments. This can provide a connection between the Rydberg Hamiltonian H_{Ryd} and solutions to UD-MIS problems. In other words, the Rydberg blockade causes it to be energetically favorable for adjacent qubits within the Rydberg radius (r_{B}) to not both be in the Rydberg state |1 [symbol] . Like in UD graphs, in some embodiments of this configuration the qubits cannot be found to be both in state |1 [symbol] when separated by a distance smaller than the Rydberg blockade radius.

The MIS-Hamiltonian H_{P} shares some features with the Rydberg Hamiltonian H_{Ryd} in the classical limit, Ωᵥ=0. In some embodiments, the main difference lies in the achievable connectivity of the pairwise interaction, for example, when arbitrary graphs are allowed in H_{P}. A special, restricted class of graphs can be considered that are most closely related to the Rydberg blockade mechanism. These so-called unit disk (UD) graphs, as discussed above, are constructed when vertices can be assigned coordinates in a plane, and only pairs of vertices that are within a unit distance, r, are connected by an edge. Thus, the unit distance r plays an analogous role to the Rydberg blockade radius r_{B} in H_{Ryd}. In other words, spatial proximity of the qubits is used to encode the edges in the UD-MIS problem. MIS is NP-complete even when restricted to such unit disk graphs. While embodiments of the present disclosure discuss 2D problems and 2D arrangement of qubits, a person of skill in the art would understand, based on the present disclosure, that aspects of the problem encoding described herein would be applicable to other spatial structures such as a one-dimensional or three-dimensional structure.

Without being bound by theory, the maximum-weight independent set problem is a MIS problem where each vertex v has a weight Δᵥ that replaces the homogenous weight Δ in equation 1. The maximum-weight independent set problem is to find an independent set with the largest total sum of weights. In some embodiment implementation, these weights Δᵥ can be encoded by applying corresponding light shifts to each qubit. In some embodiments, these light shifts can be AC Stark shifts created by off-resonant laser beams or spatial light modulators.

### Exemplary Qubit Arrangements and Detunings

Although Rydberg interactions decay significantly beyond the Rydberg radius, there are still long-range interaction tails between distant qubits, such as 102 and 108, shown in FIG. 1A. Interaction tails, taken alone or in aggregate, can reduce the likelihood that the system will be found in the solution after driving, such as that shown in FIGS. 1D and 1E. Therefore, implementations such as that shown in FIG. 1A may not always perfectly encode an NP-complete MIS problem. Furthermore, the range of NP-complete problems that can be encoded using the technique described with reference to FIG. 1A is limited to those related to unit disks.

In some embodiments, one or more of these problems can be solved by choosing atom positions in two dimensions and laser parameters such that the low energy sector of the Rydberg Hamiltonian H_{Ryd} reduces to the (NP-complete) MIS-Hamiltonian H_{P} on planar graphs with maximum degree 3. In some aspects of the present disclosure, antiferromagnetic order can be formed in the ground state of (quasi) 1D spin chains of ancillary qubits at positive detuning, due to the Rydberg blockade mechanism. Such a configuration can effectively transport the blockade constraint between distant vertex qubits. In other aspects of the present disclosure, a detuning pattern, {Δᵥ} can be introduced to eliminate the effect of undesired long-range interactions without altering the ground state spin configurations. Some embodiments allow efficient encoding of NP-complete problems in the ground state of arrays of trapped neutral atoms. Without being bound by theory, the ground state energy of Rydberg interacting atoms in 2D array in such embodiments is NP-hard (and NP-complete when Ωᵥ=0).

Exemplary Qubit Arrangements with Ancillary Qubits

As described with reference to FIGS. 2A and 2B, NP-complete problems can be encoded with “ancillary” qubits or vertices that implement edges between “vertex” qubits with vertex qubits having a maximum degree of 3, according to some embodiments. For example, as shown in FIG. 2A, a plurality of vertex qubits 202, 204, 212, 214, and 216 can be arranged in a graph. Edges between pairs of vertex qubits, such as vertex qubits 202 and 204, can be implemented using an even number of ancillary qubits 206, each of which is separated by a unit length r. This technique can be used to embed a planar grid graph with maximum degree 3 into a UD graph. For example, a planar graph with maximum degree 3 can be efficiently embedded on a grid (with grid unit g), [symbol] , and transformed to a UD graph, G, by introducing an even number of ancillary vertices along each edge, as shown in FIG. 2A, according to some embodiments. The UD radius

$$r ≃ \frac{g}{2 k + 1}$$

can be determined by a parameter k, proportional to the linear density of ancillary vertices along each edge. According to some embodiments, it is desirable to implement approximately the same density of ancillary qubits along any given edge to ensure that the interactions that form each vertex are roughly equal in strength.

In the example of vertex qubits 202 and 204, vertex qubit 202 can interact with the leftmost ancillary qubit 206 as if it were vertex qubit 204, and vertex qubit 204 can interact with the rightmost ancillary qubit 206 as if it were vertex qubit 202. In this way, edges can be implemented between vertex qubits outside the Rydberg radius, and in ways that cannot be implemented purely as a unit disk graph. Furthermore, whereas in unit disk graphs like that discussed with reference to FIG. 1A, it would not be possible to have some vertices separated by the same distance connected by an edge (e.g., vertex qubits 202, 204) while other vertices separated by the same distance are not connected by an edge (e.g., vertex qubits 212, 214), such configurations can be realized using the ancillary vertices described in the present disclosure.

### Exemplary Detuning Patterns

In some embodiments, when a MIS graph is implemented as shown in FIG. 2A, the tail of the Rydberg interactions does not affect interactions between qubits except in the vicinity of corners and junctions, where arrays of ancillary qubits meet at an angle. Vertex qubits 202 is an exemplary corner, while vertex qubit 216 is an exemplary junction. As described in more detail with reference to FIG. 2B, the detuning pattern during driving of the qubits can be adjusted around these structures to compensate for the effect of interaction tails.

FIG. 2B shows an example of such a detuning pattern, according to some embodiments. The inset of FIG. 2B shows a vertex qubit 216 with degree of 3, such as the vertex qubit 216 in FIG. 2A, which is adjacent ancillary qubits 222, 224 in a first direction, 232, 234 in a second direction, and 242, 244 in a third direction. FIG. 2B plots detunings Δ_{j,v(h)} of qubits at distances j from the vertex qubit, with detuning Δ_{c}, along the vertical (horizontal) direction. As shown in FIG. 2B, the detunings Δ_{j,v(h)} can individually address each ancillary qubit (for example, using individual addressing techniques described in PCT/US18/42080), and set in a way that eliminates the effects of interaction tails. For example, detunings Δᵥ can be selected in a range Δₘᵢₙ=0.51C/r⁶<Δᵥ<Δₘₐₓ≡C/r⁶, and with sufficiently large k. In some embodiments, detunings can be selected arbitrarily within this range. Such detunings can compensate for undesired effects of long-range interactions. Under such conditions, in the ground state of H_{Ryd} (at Ωᵥ=0), each array of ancillary qubits is in an ordered configuration, alternating between |0 [symbol] and |1 [symbol] (with at most one domain wall). This ensures that the ground state of H_{Ryd} (2) for Ωᵥ=0, coincides with the ground state of the MIS Hamiltonian (1) on G. This perturbation of the detunings for individual ancillary qubits can be performed with multiple different types of global driving patterns (such as QAA and QAOA described in more detail throughout the present disclosure) and without prior knowledge of what the solution is to the MIS. Furthermore, since the size of the MIS on G is identical to that of the MIS on G, up to half of the number of ancillary vertices, it is still NP-hard to find the ground state of the Rydberg Hamiltonian (2) when a MIS problem is implemented using ancillary vertices.

In some embodiments, implementations can be expanded beyond unit disk graphs to more general graphs. Such implementations can be referred to as “stroboscopic” implementations, which can involve an arbitrary graph implemented without ancillary qubits described with reference to FIG. 2A. For example, in some embodiments, various optical techniques can be employed to enlarge the class of problems that can be addressed in these systems. One exemplary approach involves qubits encoded in hyperfine ground states, rather than ground-Rydberg qubit encoding, and selective excitation (for example, with individual addressing of qubits) into various kinds of Rydberg states, such as Rydberg S and P states. In this example, strong and long-range dipolar interactions between Rydberg states with different parities S and P can be used to efficiently realize rotations of a single qubit, controlled by its multiple neighbors. For example, Rydberg S and P states can be used to realize multi-qubit-controlled rotations. Rotations (or qubit flips) can be used to evolve the quantum state from the initial state to the final MIS-state. By controlling these interactions, it is possible to ensure that evolution of a system does not violate the independent set constraint, for example, by ensuring that two qubits do not evolve to both be in the Rydberg state if they are connected by an edge. In some examples, all neighbors of a given (central) qubit can be selectively excited from the state |1 [symbol] to an S-state. Subsequently, a two-step transition between the two hyperfine states of the central qubit, with an intermediary step in the Rydberg P-state, can implement a multi-qubit-controlled rotation. Combined with Trotterized time evolution (e.g., splitting the total Hamiltonian evolution into small discrete steps), these techniques provide means to go beyond UD graphs, and implement various quantum optimization algorithms for MIS problems on arbitrary graphs. In some embodiments, this technique can implement arbitrary graphs, which can include a broader range of graphs than what is depicted in FIG. 2A. In some embodiments, the “stroboscopic implementation” (selective and sequential excitation of qubits into Rydberg states) allows for the implementation of multi-qubit-controlled rotations. This selective excitation can facilitate controlled rotations according to the graph structure, which is not necessarily limited to the unit disk geometry.

### Comparison of Exemplary Classical and Quantum Algorithms

According to some embodiments, it is desirable to identify the types of UD-MIS problems for which finding solutions with quantum computing would show large improvements over standard computing approaches. Numerical simulations of both classical and quantum algorithms can be used to identify regimes and system sizes where quantum algorithms are well suited for UD-MIS. In one embodiment, MIS on random UD graphs constructed by placing N vertices randomly with a density p in a 2D box of size L×L, where L=\sqrt{N/ρ} and UD radius r=1 can be considered. The hardness of this problem can depend on the vertex density: if the density is below the percolation threshold ρ_{c}≈1.436, the graph decomposes into disconnected, finite clusters, allowing for efficient polynomial time algorithms. In the opposite limit, for example if the density is very large, ρ→∞ (and N∝ρ), the problem becomes essentially the closest packing of disks in the (continuous) 2D plane, with the known best packing ratio of π/(2\sqrt{3}).

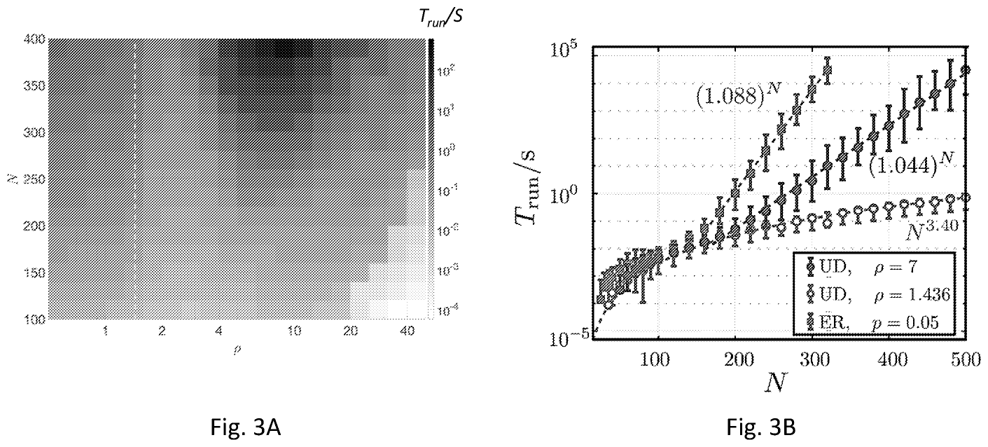

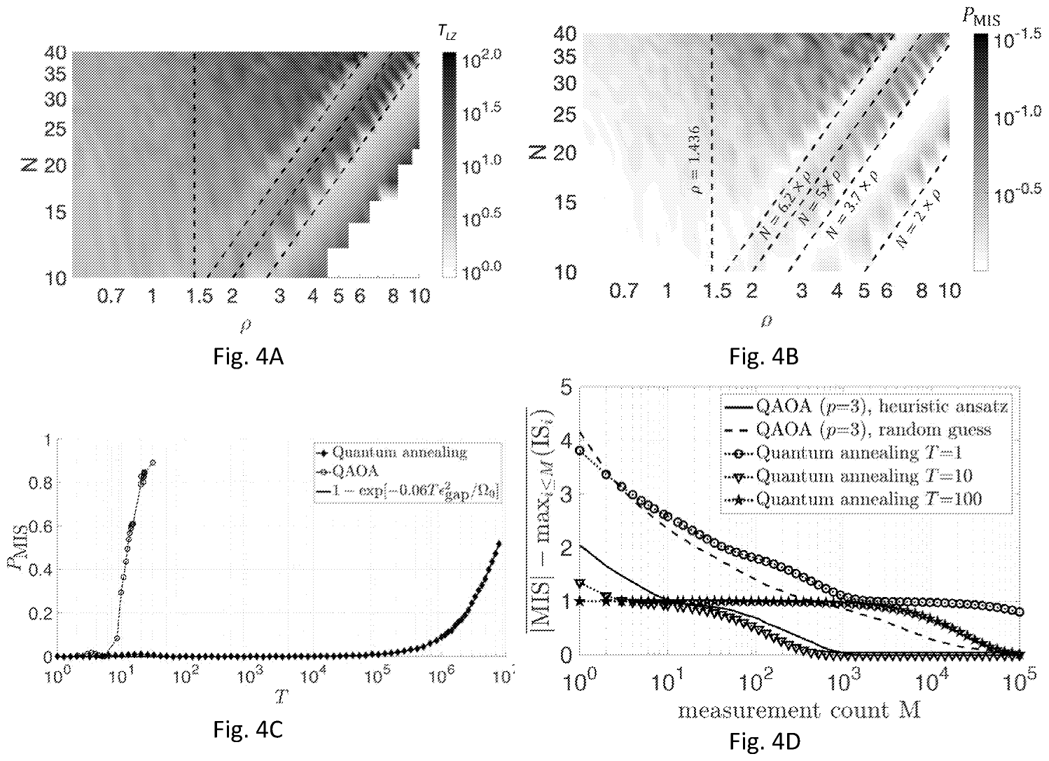

FIGS. 3A-3B show the performance of an exemplary classical optimization algorithm, according to some embodiments. In particular, it shows that in some density regions it is difficult for classical algorithms to solve optimization problems, requiring exponential time to solve exactly. In these regimes, quantum advantage is more beneficial than in other regimes. FIGS. 4A-4D show the corresponding performance of quantum algorithms (both QAA and QAOA), according to some embodiments. Though implemented with small-size simulations, FIGS. 4A-4D indicate that QAOA can solve problems fast and beat QAA. FIGS. 4A-4D show quantum advantage for certain regimes, according to some embodiments. More particularly, FIG. 3A is a graph showing the performance of classical optimization algorithms, focusing on a branch and bound algorithm, according to some embodiments. The median runtime Tᵣᵤₙ to find the MIS in CPU time is shown for bins at given numbers (vertical axis) and densities (horizontal axis). The exemplary statistics shown in FIG. 3A were obtained from 50 graphs per data point. The dashed line indicates the percolation threshold described above, which in this case is shown to be ρ=ρ_{c}≈1.436. As can be seen in FIG. 3A, in certain regimes of the parameter space of N and ρ, problems are difficult for classical optimization algorithms to solve because, for example, the run time is large.

FIG. 3B is a graph showing the run time Tᵣᵤₙ as a function of N, according to some embodiments. While there is a polynomial scaling for ρ<ρ_{c}≈1.436, at an intermediate density ρ˜7, the runtime exhibits an exponential dependence with system sizes exceeding N˜150 vertices. This exponential dependence can be seen in both worst cases and typical instances for any given number N. Note that at p˜7, the classical algorithm often could not find a solution for N≥440 within 24 hours of CPU time on a single node of the Odyssey computing cluster (managed by Harvard University). For more general, non-UD graphs, this limitation of the classical algorithm is observed at N≥320. For comparison, the performance on Erdös-Renyi graphs with edge probability p=0.05 are also shown, demonstrating a similar exponential runtime. Error-bars are 5th and 95th percentile values among 100 graphs. FIG. 3B shows that it can take a long time (for example, 24 hours) for classical algorithm to solve problems of a certain size (for example, ˜N=400). This informs the problem size to test quantum algorithms such that the problem is nontrivial to solve classically.

FIGS. 4A and 4B are graphs showing performance of quantum algorithms for MIS on random UD graphs, according to some embodiments. FIG. 4A is a hardness diagram for a quantum adiabatic algorithm in terms of adiabatic time scale T_{LZ}, according to some embodiments, plotted against N on the vertical axis and density p on the horizontal axis. For example, FIG. 4A shows the results of numerical simulations of the adiabatic QAA, with the MIS annealing Hamiltonian H_{D}+H_{P} described above, while sweeping the parameters as:

$$Δ ( t ) = {Δ}_{0} ( 2 t / T - 1 ) , \qquad Equation 3$$

$$Ω ( t ) = {Ω}_{0} {sin}^{2} ( π t / T ) \qquad Equation 4$$

The limit U/Ω₀→∞ can be observed, where the dynamics are restricted to the independent set subspace, allowing numerical simulation of system sizes up to N˜40 qubits. Sloped dashed lines parallel to the stripe pattern correspond to optimal disk packing. The fully connected region has trivially |MIS|=1. The Landau-Zener time scale, T_{LZ}, required for adiabaticity can be extracted by fitting numerical results to the expected long-time behavior of the ground state probability P_{MIS}=1−e^{a-T/T}^{_{Lz}}. For example, it is possible to fit P_{MIS} for large T to extract T_{LZ}. FIG. 4A shows a clear transition at the percolation threshold ρ=1.436 from the regime in which the problem is easy to solve to that where it is not. At high density the size of the MIS can be determined by L=\sqrt{N/ρ} owing to the relation to the optimum packing problem. This is also reflected in T_{LZ} as visible by the stripe pattern in FIG. 4A. The exponential Hilbert space size limits numerical simulations, making a conclusive comparison with the scaling of the classical algorithm above difficult. In some implementations, finite coherence times can further limit the performance of the adiabatic algorithms with exponential scaling of the minimum energy gap, ϵ_{gap} corresponding to the energy gap between the ground state and first excited state along a quantum adiabatic path.

Several approaches can be implemented to try to overcome these potential limitations. Such approaches include heuristics to open up the gap, the use of diabatic (non-adiabatic) transitions in QAA, and variational quantum algorithms such as QAOA studied below. FIG. 4B is a graph showing the probability to find the MIS, P_{MIS} for simulated non-adiabatic QAA, according to some embodiments. In some embodiments, T_{LZ} and P_{MIS} can convey similar information, and is related by P_{MIS}=1−e^{a-T/T}^{_{Lz}} for large T (in the adiabatic regime). FIG. 4A shows an exemplary adiabatic regime (large T) while FIG. 4B shows an exemplary nonadiabatic regime (short T). For example, FIG. 4B shows a single sweep (rather than sweeping multiple times for total time T, as shown in FIG. 4A) for a single T, which is in an exemplary short-time limit (e.g., nonadiabatic) with profile in Eq. (3) with a short annealing time T=10/Ω₀<<T_{LZ}. FIG. 4B shows that substantial overlap with the MIS state can be obtained with evolution time T<<T_{LZ}, while the success probability resembles qualitatively the adiabatic hardness diagram. These results are consistent with observations that non-adiabatic annealing can be advantageous, especially when the minimum spectral gap ϵ_{gap} is small. In some embodiments, if the gap is small (compared to other energy scales), it can require a long coherence time to run the quantum adiabatic algorithm (for example,

$$T ≫ 1 / {ϵ}_{gap}^{2} ) .$$

As described throughout the present disclosure, it is possible to take advantage of a direct connection between the many-body problem of spins interacting via van der Waals interactions and computational complexity theory. Individual control over the positions of such spins allows for NP-complete optimization problems to be directly encoded into such quantum systems. This result can be obtained from a reduction from MIS on planar graphs with maximum degree of 3. Quantum optimizers based on the techniques described in the present disclosure, in combination with techniques to trap and manipulate neutral atoms, can address NP-hard optimization problems as an improvement over traditional computing techniques.

### Exemplary Quantum Algorithms

As discussed above, after encoding a combinatorial problem using the position of a quantum system, whether using the “ancillary” qubit technique described above or not, the next step is to evolve the system in a way that produces a ground state that is a solution to the combinatorial problem. Some examples include QAA and QAOA.

### QAOA

In some embodiments, QAOA can be applied to quantum optimization problems like those described in the present disclosure. For example, a QAOA (of level p) can consist of applying a sequence of p resonant pulses to all qubits (or with some detuning and energy adjustments for specific qubits as described in more detail in the present disclosure) of varying duration, tₖ, and optical phase, φₖ on an initial prepared state. This can generate a variational wavefunction

$${ψ ( \{ {t}_{k} , {ϕ}_{k} \} ) 〉 = {Π}_{k = 1}^{p} {U}_{k} \vert 0 〉}^{⊗ N} ,$$

where Uₖ=e^{-iH}^{ₖ}^{t}^{ₖ} and Hₖ=Σ_{vϵV}Ω₀e^{iϕ}^{ₖ}|0 [symbol] ᵥ [symbol] 1|+h.c.)+Σ_{(v,w)∈E}Unᵥn_{w}. Without being bound by theory, the present disclosure describes some additional or alternative optimization parameters (γ, β), which can in some embodiments be related to the duration, tₖ, and optical phase, φₖ as described in more detail in the section below titled QAOA for MIS.

The resulting quantum state can be measured in the computational basis and then used for optimization. For example, the variational parameters tₖ and ok can be optimized in a classical feedback loop from measurements of [symbol] Hₚ [symbol] in this quantum state. Examples of this optimization are described in more detail below.

The performance of QAOA depends in part on the chosen classical optimization routine. Before explaining exemplary implementations of such techniques, the performance of QAOA can be shown, which marks an improvement upon classical computation techniques in some embodiments. For example, FIG. 4C compares optimized QAOA with quantum annealing, on an exemplary graph instance, G₀, (with N=32 and independent set space dimension dim_{IS}=17734, ρ=2.4 and |MIS|=8, ϵ_{gap}≈0.0012.2Ω₀) for which the adiabatic timescale can be observed to be approximately ˜10⁶/Ω₀, according to some embodiments. As shown in FIG. 4C, QAOA achieves O(1) success probability at depth p≤40 (i.e., less than 40 resonant pulses) thereby displaying significantly shorter evolution times, T=Σₖtₖ˜10/Ω₀<<T_{LZ} and showing exceptionally good variational states, which can indicate that the algorithm is effective at solving the encoded problem. And discussed in more detail below, this is also reflected in implementations of QAOA on large systems. For exemplary system sizes that can be assessed using common numerical analytics, however, the fluctuations associated with measurement projection noise can imply that the MIS size can be easily found during the classical optimization routine, even at smaller p. In some embodiments, this “measurement projection noise” is not noise in the measurement. For example, each measurement can produce a configuration space. To estimate the expectation value of an observable and perform QAOA optimization, the measurement has to be repeated multiple times. For small system sizes, the measurement result may hit the MIS before much optimization since each measurement has a high probability to produce the MIS.

FIG. 4D shows the simulated performance of various quantum algorithms on the graph G₀, according to some embodiments. For example, FIG. 4D shows the average difference between the true MIS and the largest independent set found after M measurements for simulated QAOA and QAA on G₀. As shown in FIG. 4D, both QAOA with heuristic ansatz as well as random guess methods are shown. To obtain such results, simulations for QAOA were performed with Monte Carlo simulations techniques, including sampling from projective measurements. The size of the largest measured independent set is plotted as a function of the number of measurements (averaged over Monte Carlo trajectories). With a properly chosen heuristic ansatz for tₖ and φₖ, QAOA (at p=3) finds the MIS already after ˜10²-10³ measurements. This is comparable to the number of measurements required for accurately estimating [symbol] H_{P} [symbol] , as part of the classical optimization routine. This performance can be compared to repeated runs of QAA with sweeps described by equation 3 above (and Δ₀/Ω₀=6) for non-adiabatic annealing times T=1/Ω₀, 10/Ω₀, 100/Ω₀. For this small system size, QAOA performs similarly as non-adiabatic QAA at the annealing time T˜10/Ω₀.

As explained above, QAOA is a quantum processor that prepares a quantum state according to a set of variational parameters. Using measurement outputs (such as the measured qubit state (|0 [symbol] or |1 [symbol] ) of each qubit), the parameters can then be optimized, for example via a classical computer and fed back to the quantum machine in a closed loop. In QAOA, the state is prepared by a p-level circuit specified by 2p variational parameters. In other words, each pulse has two parameters (tₖ, ϕₖ), for k from 1 to p. Even at the lowest circuit depth (p=1), QAOA has non-trivial provable performance benefits (for example, better performance than a simple classical algorithm) but cannot be efficiently simulated by classical computers.

However, very little is known about QAOA with p>1. One hurdle lies in the difficulty to efficiently optimize in the non-convex, high-dimensional parameter landscape. Without constructive approaches to perform the parameter optimization, any potential advantages of the hybrid algorithms could be lost. Furthermore, although QAOA can be shown to succeed in the p→∞ limit due to its ability to approximate adiabatic quantum annealing (i.e., the adiabatic algorithm), its performance when 1<p<∞ is largely unexplored.

### Exemplary Parameter Optimization for QAOA

Aspects of the present disclosure detail techniques to efficiently optimize QAOA variational parameters. In some examples, given a set of qubits in a particular arrangement, QAOA proceeds by applying a series of operations to the qubits, each operation having at least two variational parameters. The evolved state of the qubits is measured, which is fed back into an optimization routine (such as a classical algorithm) to adjust the variational parameters. The process then repeats on the qubits until it is determined that the measured state of the qubits is a solution to the encoded problem or an approximation thereof. In some embodiments, techniques for classical optimization routines are disclosed. These techniques are quasi-optimal in the sense that they typically produce known global optima, and generically require 200) brute-force optimization runs to surpass performance. Aspects of the present disclosure also disclose implementations of QAOA with such optimization techniques, such as an example involving a 2D physical array of a few hundred Rydberg-interacting atoms that presents potential advantages over classical algorithms for solving MaxCut problems.

As discussed above, many real-world problems can be framed as combinatorial optimization problems. In some embodiments, these are problems that can be generally defined on N-bit binary strings z=z₁ . . . z_{N}, where the goal is to determine a string that maximizes a given classical objective function C(z): {+1, −1}^{N} [symbol] [symbol] _{≥0}. An approximate optimization algorithm aims to find a string z that achieves a desired approximation ratio

$$\frac{C ( z )}{{C}_{ma x}} \geq {r}^{*} , \qquad Equation 5 A$$

where Cₘₐₓ=max_{z}C(z).

The Quantum Approximate Optimization Algorithm (QAOA) is a quantum algorithm that can tackle these combinatorial optimization problems. To encode the problem, the classical objective function can be converted into a quantum problem Hamiltonian by promoting each binary variable zi into a quantum spin

$${σ}_{i}^{z} :$$

$${H}_{C} = C ( {σ}_{1 ,}^{z} , {σ}_{2}^{z} , ⋯ , {σ}_{N}^{z} ) \qquad Equation 5 B$$

FIG. 14A is a flow diagram of an example QAOA algorithm, according to some embodiments. As shown in FIG. 14A, the quantum circuit takes inputs |+ [symbol] on 1446 and alternately applies sets of p levels (1440, . . . , 1450) of e^{-iγ}^{ᵢ}^{H}^{_{c}} (1442, . . . , 1452) and X_{β}_{ᵢ}=e^{-iβ}^{ᵢ}^{σ}^{^{X}} (1444, . . . , 1454). In some embodiments, e^{-iγ}^{ᵢ}^{H}^{_{c}} and X_{β}_{ᵢ} represent 2 different types of evolution of the system, which can be induced physically by laser pulses. The parameters y and β can quantify for how long each evolution occurs. Each of these levels applies variational parameters 1480, which can differ between each of the set of p levels. The outputs are then measured at 1460 with respect to a function [symbol] H_{C} [symbol] . In some embodiments, the outputs are a superposition of spin states. When measured the system collapses to one of these spin states, so the measurement result can be a single spin configuration. In some embodiments, the expectation value [symbol] H_{C} [symbol] , which is a function of the spin configuration, is the number arrived at when evaluating the Hamiltonian H_{C} in this configuration, and averaged for multiple experimental runs, which is then fed through an optimizer 1470 (which can be a classical optimization function), which calculates the parameters (\vec{γ},\vec{β}) for each level 1440, . . . , 1450 in the set that maximizes [symbol] H_{C} [symbol] . These parameters (\vec{γ}\vec{β}) are then provided as variational parameters 1480 for the next iteration (for example, as a feedback loop). Note that the variational parameters 1480 may be different at each level 1440, . . . , 1450 in the set of p levels. The inputs |+ [symbol] 1446 are then provided again and the process repeats. In some embodiments, after a number of iterations, the measurement 1460 can be considered to be the solution to the encoded problem.

For the p-level QAOA described in FIG. 14A, the quantum processor can be initialized in the state |+ [symbol] (1446). The problem Hamiltonian H_{C} (1442, 1452) and a mixing Hamiltonian

$${H}_{B} = {\sum }_{j = 1}^{N} {σ}_{j}^{x} ( 1444 , 1454 )$$

are applied alternately (p times) with controlled durations to generate a variational wavefunction:

$${\vert {ψ}_{p} ( \vec{γ} , \vec{β} ) 〉 = {e}^{- i {β}_{p} {H}_{B}} {e}^{- i {γ}_{p} {H}_{C}} ⋯ {e}^{- i {β}_{1} {H}_{B}} {e}^{- i {γ}_{1} {H}_{C}} \vert + 〉}^{⊗ N} \qquad Equation 6 A$$

which is parameterized by 2p parameters γᵢ and βᵢ (i=1, 2, . . . p) (one for each level in the set of p level). The expectation value H_{C} in this variational state can be determined as follows:

$$〈 {H}_{C} 〉 = {F}_{p} ( \vec{γ} , \vec{β} ) = 〈 {ψ}_{p} ( \vec{γ} , \vec{β} ) \vert {H}_{C} \vert {ψ}_{p} ( \vec{γ} , \vec{β} ) 〉 , \qquad Equation 6 B$$

which can be identified by repeated measurements 1460 of the quantum system in the computational basis and taking the average (e.g., with two orthogonal spin configurations |0 [symbol] and |1 [symbol] , which can be measured using existing measurement techniques).

Once the measurements 1460 are performed, the results (e.g., the calculated Fₚ determined by taking the average over many H_{C}) can be fed back to an optimizer 1470, such as a classical computer, to search for the optimal parameters (\vec{γ}*\vec{β}*) so as to maximize Fₚ(\vec{γ},\vec{β}),

$$( {\vec{γ}}^{*} , {\vec{β}}^{*} ) = {arg max}_{\vec{γ} , \vec{β}} {F}_{p} ( \vec{γ} , \vec{β} ) . \qquad Equation 7$$

The performance of QAOA can, in some embodiments, be benchmarked based on the approximation ratio:

$$r = \frac{{F}_{p} ( {\vec{γ}}^{*} , {\vec{β}}^{*} )}{{C}_{m ax}} \qquad Equation 8$$

In some embodiments, r characterizes how good the solution provided by QAOA is. The higher the r value, the better the solution.

In some embodiments, without being bound by theory, this QAOA framework can be applied to general combinatorial optimization problems. In one example, an archetypical problem called MaxCut can be considered.

FIG. 14B shows an example of a MaxCut problem, according to some embodiments. A MaxCut problem can be described for an input graph G=(V, E). Here, V={1, 2, . . . , N} denotes the set of vertices (shown as up and down spins 1492A, 1492B, 1492C, 1494A, 1494B) and E={( [symbol] i, j [symbol] , wᵢⱼ)} is the set of edges (shown with solid and dotted lines), where wᵢⱼ∈ [symbol] _{≥0} is the weight of the edge [symbol] i, j [symbol] connecting vertices i and j. For example, the edge connecting the two up spins 1492A, 1492B has a weight of w₁₃. The goal of MaxCut is to maximize the following objective function:

$${H}_{C} = {\sum }_{( i , j )} \frac{{w}_{ij}}{2} ( 1 - {σ}_{i}^{z} {σ}_{j}^{z} ) , \qquad Equation 9$$

where an edge [symbol] i, j [symbol] contributes with weight wᵢⱼ if and only if spins

$${σ}_{i}^{z} and {σ}_{j}^{z}$$

are anti-aligned. For example, the curved dashed line shows a cut through all edges of spins that are anti-aligned, excluding edges w₁₃ and w₂₅, which are aligned.

### Exemplary Combinatorial Problems

While embodiments of the present disclosure discuss MaxCut on d-regular graphs, where every vertex is connected to exactly d other vertices, based on the present disclosure a person of skill in the art would understand that the aspects of QAOA described herein would be applicable to other types of combinatorial problems such as, but not limited to MaxCut problems on other types of graphs, Maximum Independent Set problems, and others. Two types of d-regular MaxCut graphs are considered: (1) unweighted d-regular graphs (udR), where all edges have equal weight wᵢⱼ=1; and (2) weighted d-regular graphs (wdR), where the weights wᵢⱼ are chosen uniformly at random from [0,1] (though other weights other than the interval [0,1] can be selected in other embodiments).

It is NP-hard to design an algorithm that guarantees a minimum approximation ratio of r*≥16/17 for MaxCut on all graphs, or r*≥331/332 when restricted to unweighted 3 regular graphs (“u3R”) discussed above.

According to some embodiments, QAOA presents several benefits. For certain cases, it achieves a guaranteed minimum approximation ratio when p=1. Additionally, under some reasonable complexity-theoretic assumptions, QAOA may not be efficiently simulated by any classical computer even when p=1, making it a candidate algorithm for “quantum supremacy,” or the ability of a quantum computer to perform calculations that a traditional computer cannot. The square-pulse (“bang-bang”) ansatz of dynamical evolution, of which QAOA can be one example, can be optimal given a fixed quantum computation time. In general, the performance of QAOA can improve with increasing p, achieving r→1 as p→∞ since it can approximate adiabatic quantum annealing via Trotterization. This monotonicity makes it more attractive than quantum annealing, whose performance may decrease with increased run time.

While some embodiments of QAOA have a simple description, not much is currently understood beyond p=1. For the example problem of MaxCut on u2R graphs, (such as 1D antiferromagnetic rings,) QAOA may yield r≥(2p+1)/(2p+2) as determined by numerical evidence. In another example, such as Grover's unstructured search problem among n items, QAOA can find the target state with p=Θ(\sqrt{n}), achieving the optimal query complexity within a constant factor. In some embodiments, for more general problems, a simple brute-force approach can be used by discretizing each parameter into O(poly(N)) grid points. However, this technique requires examining N^{O(p)} possibilities at level p, which can become impractical to calculate using typical computers as p grows. Embodiments of the present disclosure therefore address efficient optimization of QAOA parameters and understanding of the algorithm for 1<ρ<∞.

### Exemplary Heuristics for Parameter Optimization

Some embodiments of the present disclosure relate to techniques for optimizing variational parameters. As described in more detail below, patterns in optimal parameters can be exploited to develop a heuristic optimization strategy for more quickly identifying the optimal variational parameters. In some examples described below, parameters identified for level-p QAOA can be used to more quickly optimize parameters for level-(p+1) QAOA, thereby producing a good starting point for optimization. These techniques provide improvements over brute-force techniques. In some embodiments, parameters identified for level-q QAOA, for any q<p, can be used to more quickly optimize parameters for level-p QAOA. Further, while some examples discuss randomly generated instances of u3R and w3R, similar results can be found when applying these techniques to u4R and w4R graphs, as well as complete graphs with random weights (or the Sherington-Kirkpatrick spin glass problem). These other exemplary u3R, w3R, u4R, and w4R graphs are regular graphs, meaning, for example, that each vertex has the same number of neighbors (3 or 4 respectively). The letters u and the w can refer to whether one considers unweighted or weighted graphs, respectively. In some embodiments, these graphs are useful as test samples. The patterns in the optimal parameters identified herein are used to develop example heuristic strategies that can efficiently find quasi-optimal solutions in O(poly(p)) time.

In some embodiments it is possible to eliminate degeneracies in the parameter space due to symmetries. For example, generally, QAOA can have a time-reversal symmetry, Fₚ(\vec{γ},\vec{β})=Fₚ(−\vec{γ},\vec{−β}), since both H_{B} and H_{C} are real-valued. For QAOA applied to MaxCut, there can be an additional Z₂ symmetry, as e^{-i(π/2)H}^{_{B}}≡(σ^{x})^{⊗N} commutes through the circuit. Furthermore, the structure of the MaxCut problem on udR graphs can create redundancy since e^{-iπH}^{_{C}}=1 if dis even, and (σ^{z})^{⊗N} if dis odd. These symmetries make it possible to restrict

$${β}_{i} ∈ [ - \frac{π}{4} , \frac{π}{4} )$$

in general, and

$${γ}_{i} ∈ [ - \frac{π}{2} , \frac{π}{2} )$$

for udR graphs.

In some embodiments, it is possible to numerically investigate the optimal QAOA parameters for MaxCut on random u3R and w3R graphs with vertex number 8≤N≤22, using a brute-force approach. For each graph instance and a given level p, a random starting point (seed) in the parameter space can be chosen and a gradient-based optimization algorithm such as Broyden-Fletcher-Goldfarb-Shanno (“BFGS”) can be used to find a local optimum (\vec{γ}^{L},\vec{β}^{L}) starting with this seed. In some embodiments, a local optimum can refer to a case where for a given choice of parameters β and γ, the result always gets worse if the values of the parameters β and γ are changed slightly. However, for such local optima, the result might get better if the values of these parameters are instead changed drastically. Thus the optimum can be referred to as local optimum, not global optimum. In some embodiments, for each graph, it is possible to optimize the variational parameters to cause the solution to go to a local optimum by a local optimization method, such as one where the optimization only searches parameters close to the initial starting parameters. This local optimization can be repeated with sufficiently many different seeds to find the global optimum (\vec{γ}*, \vec{β}*). In some embodiments, a global optimum may refer to the case where there is not a better choice of parameters. The global optimum can change from graph to graph. The degeneracies of the optimal parameters (\vec{γ}*, \vec{β}*) can be reduced using the symmetries discussed above (e.g., by finding some (distinct) values of γ and β that are equivalent because they lead to exactly the same result and thus do not need to be considered individually). In some illustrative examples, the global optimum can be non-degenerate up to these symmetries.

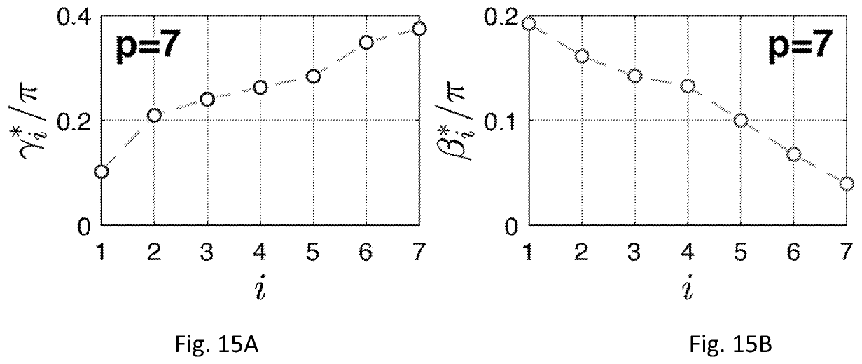

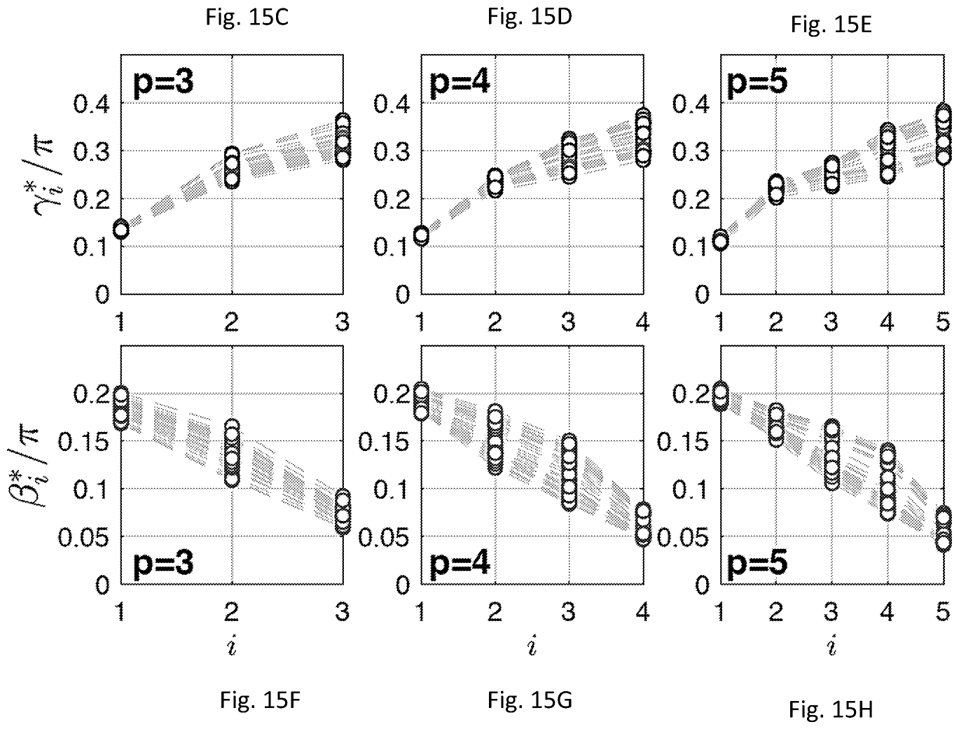

In some embodiments, the process of identifying optimal parameters (\vec{γ}*, \vec{β}*) can be repeated for additional random graphs, such as 100 u3R and w3R graphs with various vertex numbers N, which can draw out one or more patterns in the optimal parameters (\vec{γ}*, \vec{β}*). In one example, the optimal γ*ᵢ can tend to increase smoothly with each iteration i=1, 2, . . . , p, while β*ᵢ can tend to decrease smoothly. For example, FIGS. 15A-15B show an example instance of optimal QAOA parameters (\vec{γ}*, \vec{β}*) obtained for example instances of MaxCut on a 16-vertex unweighted 3-regular (u3R) graph at level p=7, according to some embodiments. As shown in FIGS. 15A-15B, the parameters for level p=7 transition smoothly for each iteration i.

FIGS. 15C-15H shows a parameter pattern visualized by plotting the optimal parameters of 40 instances of 16-vertex u3R graphs (such as the example used to plot FIGS. 15A-15B), for 3≤p≤5 as a function of iteration i, according to some embodiments. Each dashed line connects parameters for one particular graph instance. For each instance and each p, the classical BFGS optimization algorithm was used from 10⁴ random seeds (starting points), with the best parameters being kept. Similar patterns can be found for w3R graphs, which are discussed in more detail below. Furthermore, in some examples, for a given class of graphs, the optimal parameters can be observed to roughly occupy the same range of values as p is varied. This demonstrates a pattern in the optimal QAOA parameters that can be exploited in the optimization, as discussed in more detail below. Similar patterns are found for parameters up to p≤15, if the number of random seeds is increased accordingly.

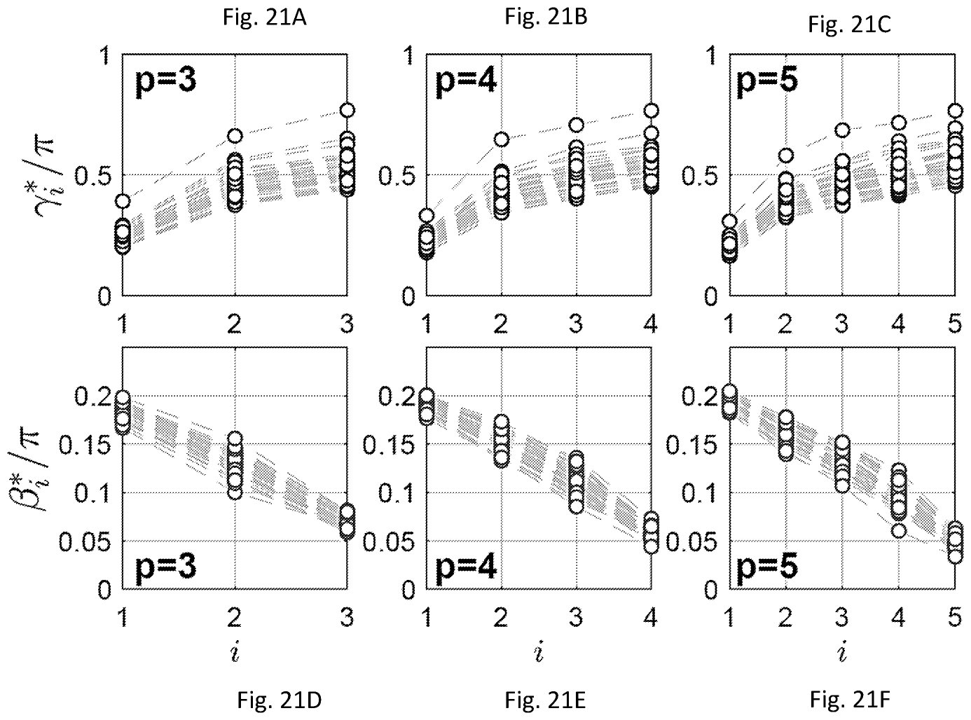

FIGS. 21A-21F show graphs demonstrating optimal QAOA parameters (\vec{γ}*, \vec{β}*) for 40 instances of 16-vertex weighted 3-regular (w3R) graphs, for 3≤p≤5, according to some embodiments. Each dashed line connects parameters for one particular graph instance. For each exemplary instance and each p, the BFGS algorithm is used to optimize from 10⁴ random starting points, and the best parameters are kept as (\vec{γ}*, \vec{β}*). FIGS. 21A-21F are analogous to the results of unweighted graphs in FIGS. 15C-15H. The spread of \vec{γ}* for weighted graphs is wider than that for unweighted graphs shown in FIGS. 15C-15H. In some embodiments, this is because the random weights effectively increase the number of subgraph types. Moreover, the larger value for \vec{γ}* for weighted graphs compared to unweighted graphs can be understood via the effective mean-field strength that each qubit experiences.

Notably, even at small depth, this parameter pattern can be reminiscent of adiabatic quantum annealing where H_{C} is gradually turned on while H_{B} is gradually turned off, in some embodiments. However, the mechanism of QAOA can be shown to go beyond the adiabatic principle, as discussed in more detail below. In addition, in some embodiments, the optimal parameters can have a small spread over many different instances. This can be because the objective function Fₚ(v, B) can be a sum of terms corresponding to subgraphs involving vertices that are a distance ≤p away from every edge. At small p, there are only a few relevant subgraph types that enter into Fₚ and can effectively determine the optimal parameters. As N→∞ and at a fixed finite p, the probability of a relevant subgraph type appearing in a random graph can approach a fixed fraction. This implies that the distribution of optimal parameters (\vec{γ}*, \vec{β}*) can converge to a fixed set of values in this limit.

In some embodiments, the optimal parameter patterns observed above can indicate that generically, there is a slowly varying continuous curve that underlies the parameters γᵢ* and βᵢ*. In some embodiments, this curve changes only slightly from each level p to p+1. Based on these observations, a new parameterization of QAOA can be used, as well as a heuristic optimization strategy that can, without limitation, be referred to as “FOURIER.” In some embodiments, the heuristic strategy uses information from the optimal parameters at level p to help optimization at level p+1 by producing good starting points. While this heuristic does not necessarily find the global optimum of QAOA parameters, it can produce, in O(poly(p)) time, quasi-optima that can only be surpassed with 2^{O(p)} number of brute-force runs. In some beneficial embodiments, this facilitates evaluation of the performance and mechanism of QAOA beyond p=1.

In some embodiments, QAOA can be re-parameterized based on the observation that the optimal QAOA parameters γᵢ* and βᵢ* appear to be smooth functions of their index i. An alternative representation of the QAOA parameters can be implemented using Fourier-related transforms of real numbers, which permits reductions in the number of necessary parameters. Instead of using the 2p parameters (\vec{γ}*, \vec{β}*)∈ [symbol] , FOURIER can instead use 2q parameters (\vec{u}, \vec{v})∈ [symbol] , where the individual elements γᵢ and βᵢ are written as functions of (\vec{u}, \vec{v}) through the following transformation:

$${γ}_{i} = {\sum }_{k = 1}^{q} {u}_{k} sin [ ( k - \frac{1}{2} ) ( i - \frac{1}{2} ) \frac{π}{p} ] , \qquad Equation 10$$

$${β}_{i} = {\sum }_{k = 1}^{q} {v}_{k} cos [ ( k - \frac{1}{2} ) ( i - \frac{1}{2} ) \frac{π}{p} ] . \qquad Equation 11$$

In some embodiments, these transformations can be referred to as Discrete Sine/Cosine Transforms, where uₖ and vₖ can be interpreted as the amplitude of k-th frequency component for \vec{γ} and \vec{β}, respectively. When q≥p, this new parametrization can describe all possible QAOA protocols at level p.

Embodiments of the FOURIER strategy work by starting with level p=1, optimizing using an optimization function such as brute force for level p=1, and then using the optimum at level p to determine a starting point for level p+1. The starting points can be generated by re-using the optimized amplitudes (\vec{u}*, \vec{v}*) of frequency components from level p extrapolated from the optimized parameters (\vec{γ}*, \vec{β}*) to identify the parameters (\vec{γ}*, \vec{β}*) for the level p+1. This can be repeated for increasing p.

Some embodiments include several variants of this strategy, examples of which are referred to as FOURIER[q, R] and INTERP, for optimizing p-level QAOA. Without limitation, embodiments of one of variants can be referred to as FOURIER[q, R], characterized by two integer parameters q and R. The first integer q can refer to the maximum frequency component allowed in the parameters (\vec{u}, \vec{v}′), which can be the maximum value of k. If q=p, the full power of p-level QAOA can be utilized. However, since the smoothness of the optimal parameters (\vec{γ}, \vec{β}) implies that only the low-frequency components are important, it is also possible to consider the case where q is a fixed constant independent of, but smaller than p, so the number of parameters is bounded even as the QAOA circuit depth increases.

In some embodiments, the second integer R can refer to the number of controlled random perturbations added to the parameters to escape a local optimum towards a better one. For example, where the optimization parameters (\vec{γ}, \vec{β}) were identified at a local but not global optimum for the initial value p=1, perturbations can be introduced to avoid focusing only on that local optimum for increased values of p. Exemplary results discussed in the present disclosure implement the FOURIER[q, R] strategy with q=p and R=10 unless otherwise stated, but such as selection is not limiting.

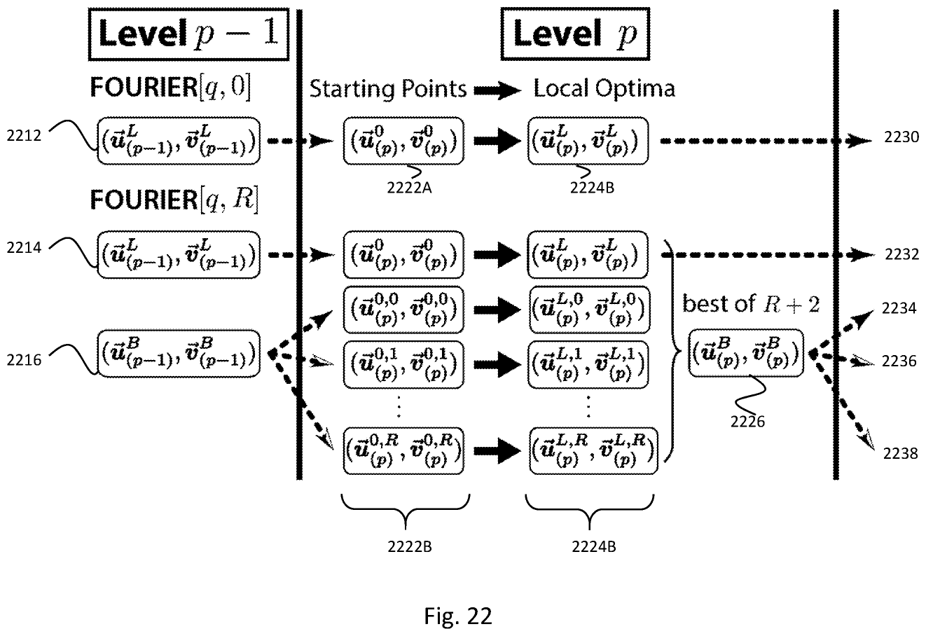

In embodiments where q is chosen such that q=p, the strategy can be denoted as FOURIER[∞, R], since q grows unbounded with p. In embodiments of the FOURIER[∞, 0] variant of this strategy, a starting point is generated for level p+1 by adding a higher frequency component, initialized at zero amplitude, to the optimum at level p. For example, as shown in FIG. 22, according to some embodiments, from the optimized variational parameters

$$2212 ( {\vec{u}}_{( p - 1 )}^{L} , {\vec{v}}_{( p - 1 )}^{L} ) ∈ {ℝ}^{2 p - 2}$$

at a level p−1, the starting point

$$2222 A ( {\vec{u}}_{( p )}^{0} , {\vec{v}}_{( p )}^{0} ) ∈ {ℝ}^{2 ( p )}$$

is generated according to:

$${\vec{u}}_{( p )}^{0} = ( {\vec{u}}_{( p - 1 )}^{L} , 0 ) , {\vec{v}}_{( p )}^{0} = ( {\vec{v}}_{( p - 1 )}^{L} , 0 ) . \qquad Equation 12$$

### Using

$$( {\vec{u}}_{( p )}^{0} , {\vec{v}}_{( p )}^{0} ) 2222 A$$

as a starting point, a BFGS optimization routine can be performed to obtain a local optimum

$$22 \; 24 B ( {\vec{u}}_{( p )}^{L} , {\vec{v}}_{( p )}^{L} )$$

for the level p. This is output to the next level of p, as the process continues.

In some embodiments, improvements over this technique can be gained with the strategy, FOURIER[∞, R>0], which is also shown in FIG. 22. In some embodiments, the strategy FOURIER[∞, 0] can become stuck at a sub-optimal local optimum. Accordingly, perturbing its starting point as is performed in FOURIER[∞, R>0] can greatly improve the performance of QAOA already seen with FOURIER[∞, 0].

As shown in FIG. 22, the technique begins at level p−1, according to some embodiments. In some embodiments of FOURIER[∞, R>0], in addition to optimizing according to the strategy FOURIER[∞, 0], the p-level QAOA can be optimized from R+1 extra starting points, R of which are generated by adding random perturbations to the best of all local optima

$$( {\vec{u}}_{( p - 1 )}^{B} , {\vec{v}}_{( p - 1 )}^{B} )$$

found at level p−1. Specifically, for each instance at p-level QAOA, and for r=0, 1, . . . , R, optimization can start from

$${\vec{u}}_{( p )}^{0 , r} = \{ \begin{matrix}( {\vec{u}}_{( p - 1 )}^{B} , 0 ) , & r = 0 \\ ( {\vec{u}}_{( p - 1 )}^{B} + {\vec{α u}}_{( p - 1 )}^{P , r} , 0 ) , & 1 \leq r \leq R\end{matrix} \qquad Equation 13$$

$${\vec{v}}_{( p )}^{0 , r} = \{ \begin{matrix}( {\vec{v}}_{( p - 1 )}^{B} , 0 ) , & r = 0 \\ ( {\vec{v}}_{( p - 1 )}^{B} + {\vec{α v}}_{( p - 1 )}^{P , r} , 0 ) , & 1 \leq r \leq R\end{matrix} \qquad Equation 14$$

where

$${\vec{u}}_{( p - 1 )}^{P , r} and {\vec{v}}_{( p - 1 )}^{P , r}$$

contain random numbers drawn from normal distributions with mean 0 and variance given by

$${\vec{u}}_{( p - 1 )}^{B} and {\vec{v}}_{( p - 1 )}^{B} :$$

$${[ {\vec{u}}_{( p - 1 )}^{P , r} ]}_{k} \sim Normal ( 0 , {[ {\vec{u}}_{( p - 1 )}^{B} ]}_{k}^{2} ) , \qquad Equation 15$$

$${[ {\vec{v}}_{( p - 1 )}^{P , r} ]}_{k} \sim Normal ( 0 , {[ {\vec{v}}_{( p - 1 )}^{B} ]}_{k}^{2} ) , \qquad Equation 16$$

In such embodiments, there is a free parameter a corresponding to the strength of the perturbation. In some non-limiting examples derived from trial and error, setting α=0.6 can yield good results. This choice of a is assumed in the present disclosure unless otherwise stated. However, a person of skill in the art would understand that other values of α can be used, including dynamic values of α as needed depending on particular implementations.

In some embodiments, additional strategies can be used to take advantages of the parameter pattern indicated above. One exemplary strategy can use linear interpolation of optimal parameters at lower level QAOA to generate starting points for higher levels, which can be referred to without limitation as “INTERP.” Both INTERP and FOURIER strategies are effective for the instances discussed throughout the present disclosure and are applicable to others as well. While FOURIER has demonstrated a slight edge in its performance in finding better optima when random perturbations are introduced, a person of skill in the art would understand from the present disclosure that INTERP is also an efficient way of improving QAOA and can present additional benefits. Embodiments of FOURIER[q, R] and INTERP are described below in more detail. However, additional techniques are contemplated by the present disclosure, such as the use of machine learning. Furthermore, although in aspects of the present disclosure, the heuristic strategies makes use of optimal variational parameters found at level-(p−1) QAOA to find initial variational parameters at level-p QAOA, a person of skill in the art would understand that optimal variational parameters found at level-m, for any m<p, can be used to design initial variational parameters at level-p QAOA.

In some variants of the FOURIER strategy, the number of frequency components q is fixed. These variants can be treated similarly to the strategies where q=p discussed above, except all \vec{u} and \vec{v} parameters can be truncated at the first q components. For example, when optimizing QAOA at level p≥q with the FOURIER[q,0] strategy, no further higher frequency components are added, and the starting point begins at

$${\vec{u}}_{( p )}^{0} = {\vec{u}}_{( p - 1 )}^{L} ∈ {ℝ}^{q} .$$

In some embodiments of the optimization strategy referred to as INTERP, linear interpolation can be used to produce a starting point for optimizing QAOA and an optimization routine can iteratively increase the level p. However, for purposes of the present discussion, p should be considered the same as p−1 in the discussion for the FOURIER strategy, as this is simply a matter of semantics for where to begin the algorithm. In some embodiments, this is based on the observation that the shape of parameters (\vec{γ}*₍ₚ₊₁₎, \vec{β}*₍ₚ₊₁₎) closely resembles that of (\vec{γ}*₍ₚ₎, \vec{β}*₍ₚ₎). For a given instance, QAOA is iteratively optimized by starting from ρ=1, obtaining local optimum parameters

$$( {\vec{γ}}_{( p )}^{L} , {\vec{β}}_{( p )}^{L} ) ,$$

and incrementing p to p+1. To optimize parameters for level p+1, optimized parameters from level p are used to produce starting points

$$( {\vec{γ}}_{( p + 1 )}^{0} , {\vec{β}}_{( p + 1 )}^{0} )$$

according to:

$${[ {\vec{γ}}_{( p + 1 )}^{0} ]}_{i} = {\frac{i - 1}{p} [ {\vec{γ}}_{( p )}^{L} ]}_{i - 1} + {\frac{p - i + 1}{p} [ {\vec{γ}}_{( p )}^{L} ]}_{i} \qquad Equation 17$$

for i=1, 2, . . . , p+1, where i denotes the i-th element of the vector. Here, [\vec{γ}]ᵢ≡γᵢ denotes the i-th element of the parameter vector \vec{γ}, and

$${[ {\vec{γ}}_{( p )}^{L} ]}_{0} ≡ {[ {\vec{γ}}_{( p )}^{L} ]}_{p + 1} ≡ 0 .$$

The expression for

$${\vec{β}}_{( p + 1 )}^{0}$$

can be the same as above atter swapping γ↔β. Starting from

$$( {\vec{γ}}_{( p + 1 )}^{0} , {\vec{β}}_{( p + 1 )}^{0} ) ,$$

the BFGS optimization routine (or any other optimization routine) can be performed to obtain a local optimum

$$( {\vec{γ}}_{( p + 1 )}^{L} , {\vec{β}}_{( p + 1 )}^{L} )$$

for the (p+1)-ever QAOA. Finally, p can be incremented by one and the same process can be repeated until a target level is reached.

The INTERP strategy can also get stuck in a local optimum in some embodiments. Adding perturbations to INTERP can help but may not be as effective in some embodiments as with FOURIER. This may occur because the optimal parameters are smooth, and adding perturbations in the (\vec{u}, \vec{v})-space modify (\vec{γ}, \vec{β}) in a correlated way, which can enable the optimization to escape local optima more easily. However, a similar perturbation routine is contemplated.

As discussed above, the heuristic approaches described in the present disclosure constitute a significant improvement over brute force QAOA techniques. Non-limiting comparisons of example implementations are discussed below in the sections below.

Based on the present disclosure, a person of skill in the art would understand that the disclosed heuristic strategies could be implemented on a number of technical platforms. In the section below titled “Example QAOA Implementations” the MaxCut problem is considered as an example, although it can also be applied to solve other interesting problems.

### Example Implementations with Quantum Systems

In some embodiments, large-size problems are suitable for implementation on quantum systems. Two aspects of such implementations (reducing the interaction range and examples with Rydberg atoms) are discussed in more detail below.

First, with regard to reducing the interaction range, in some quantum implementations, as discussed above, each vertex can be represented by a qubit. For a large problem size, a major challenge to encode general graphs is the necessary range and versatility of the interaction patterns (between qubits). The embedding of a random graph into a physical implementation with a 1D or 2D geometry may require very long-range interactions. By re-labelling the graph vertices, it is possible reduce the required range of interactions. Without being bound by theory, this can be formulated as the graph bandwidth problem: Given a graph G=(V, E) with N vertices, a vertex numbering is a bijective map from vertices to distinct integers, f: V→{1, 2, . . . , N}. The bandwidth of a vertex numbering f is, B_{f}(G)=max{|f(u)−f(v)|: (u, v)∈E(G)} which can be understood as the length of the longest edge (in 1D). The graph bandwidth problem is then to find the minimum bandwidth among all vertex numberings, i.e., B(G)=min_{f}B_{f}(G); namely, it is to minimize the length of the longest edge by vertex renumbering.

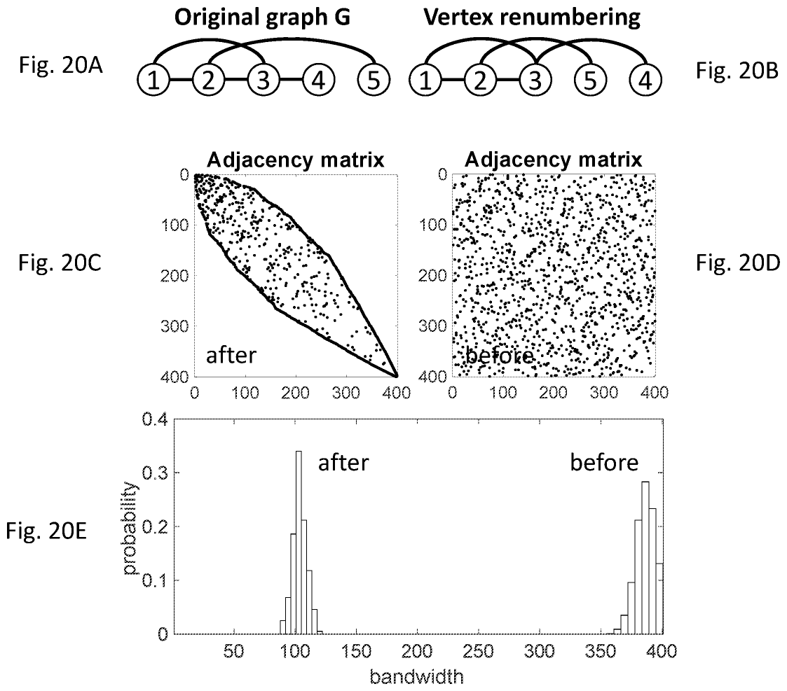

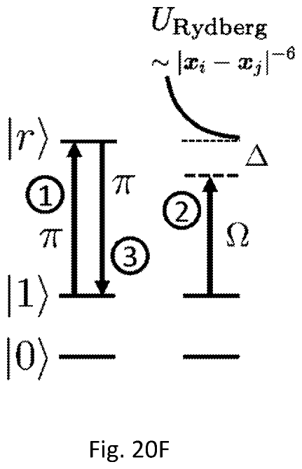

In general, finding the minimum graph bandwidth is NP-hard, but good heuristic algorithms have been developed to reduce the graph bandwidth. FIGS. 20A-20E show a simple example of bandwidth reduction, according to some embodiments. FIGS. 20A, 20B illustrate the vertex renumbering with a 5-vertex graph. FIG. 20E shows the histogram of graph band-widths for 1000 random 3-regular graphs of N=400 each. Using the Cuthill-McKee algorithm, the graph bandwidth can be reduced to around B≈100. While this still may require quite a long interaction range in 1D, the bandwidth problem can also be generalized to higher dimensions. In 2D arrangements, the radius of interaction can be considered to be B_{2D}˜\sqrt{100} for N=400 3-regular graphs, which is possible for quantum devices. FIGS. 20C and 20D show sparsity patterns of the adjacency matrix before and after vertex renumbering for one exemplary graph. While, in this illustrative example, the vertex renumbering technique is applied to the MaxCut problem, a person of skill in the art would understand based on the present disclosure that the same technique can be used for other combinatorial optimization problems such as maximum independent set problems.

In some embodiments, a general construction can be used to encode any long-range interactions to local fields by including additional physical qubits and gauge constraints. It is also possible to restrict to special graphs that exhibit some geometric structures. For example, unit disk graphs are geometric graphs in the 2D plane, where vertices are connected by an edge only if they are within a unit distance. These graphs can be encoded into 2D physical implementations, and the MaxCut problem is still NP-hard on unit disk graphs.

In some embodiments, the above discussion of QAOA has been platform independent, and is applicable to any state-of-the-art platforms. Exemplary platforms include neutral Rydberg atoms, trapped ions, and superconducting qubits. Although the following discussion focuses on an implementation of QAOA with neutral atoms interacting via Rydberg excitations, where high-fidelity entanglement has been recently demonstrated, other implementations are contemplated.

In some embodiments, it is possible to implement control over the interaction between individual atoms according to a given graph. In some embodiments, in this way it is possible to control which types of problems are to be solved. Since the interactions can specify the problem, controlling the interactions is one way to control the problem. As discussed in more detail above, in an exemplary Rydberg implementation, the hyperfine ground states in each atom can be used to encode the qubit states |0 [symbol] and |1 [symbol] , and the |1 [symbol] state can be excited to the Rydberg level |r [symbol] to induce interactions. The qubit rotating term, exp

$$( - i β {\sum }_{j = 1}^{N} {σ}_{j}^{x} )$$

can be implemented by a global driving beam with tunable durations. The interaction terms

$${\sum }_{〈 i , j 〉} {σ}_{i}^{Z} {σ}_{j}^{Z}$$

can be implemented stroboscopically for general graphs; this can be realized by a Rydberg-blockade controlled gate, as illustrated in FIG. 20F. For example, FIG. 20F shows a protocol to use Rydberg-blockade controlled gate to implement the interaction term exp

$$( - i γ {σ}_{i}^{Z} {σ}_{j}^{Z} ) .$$

For example, FIG. 20F shows how to realize a specific component of the interaction term by first applying a pi-pulse to a control qubit, second applying a pulse with coupling strength Ω and detuning Δ to a target qubit, and following this pulse with another pi-pulse on the control qubit. By choosing a proper gate time for the second step, such as (t=2π/\sqrt{Ω²+Δ²}), the population on the Rydberg level |r [symbol] may not be accumulated. With tunable coupling strength Ω and detuning Δ, it is possible to control the interaction time γ.

By controlling the coupling strength Ω, detuning Δ, and the gate time, together with single-qubit rotations, it is possible to implement exp

$$( - i γ {σ}_{i}^{Z} {σ}_{j}^{Z} ) ,$$

which can then be repeated for each interacting pair. In this way, it is possible to choose which pairs should interact, and thus control which problem to solve. In some embodiments, an additional advantage of the Rydberg-blockade mechanism is its ability to perform multi-qubit collective gates in parallel. This can reduce the number of two-qubit operation steps from the number of edges to the number of vertices, N, which means a factor of N reduction for dense graphs with ˜N² edges. While the falloff of Rydberg interactions may limit the distance two qubits can interact, MaxCut problems of interesting sizes can still be implemented by vertex renumbering or focusing on unit disk graphs, as discussed above. Furthermore, implementing ancillary vertices discussed in the present disclosure can be used to increase the length of interactions.

Without being bound by theory, in some embodiments, for generic problems of 400-vertex regular graphs, the interaction range can be on the order of 5 atoms in 2D. This can be determined by assuming a minimum inter-atom separation of 2 μm, which means an interaction radius of 10 μm, which is realizable with high Rydberg levels. Given examples of coupling strength Ω˜2π×10-100 MHz and single-qubit coherence time τ˜200 μs (limited by Rydberg level lifetime), with high-fidelity control, the error per two-qubit gate can be made roughly (Ωτ)⁻¹˜10⁻³-10⁻⁴. For 400-vertex 3-regular graphs, QAOA of level p≅Ωτ/N˜25 can be implemented with a 2D array of neutral atoms. Advanced control techniques such as pulse-shaping would increase the capabilities of QAOA in such systems. Furthermore, QAOA may not be sensitive to some of the imperfections present in existing implementations with Rydberg atoms.

The following sections explore additional examples and embodiments of the present disclosure. The present disclosure is not limited by the theory described herein, which is merely meant for illustration of some aspects of operational principles that underly some embodiments of the present disclosure.

### Quantum Annealing for Random UD-MIS

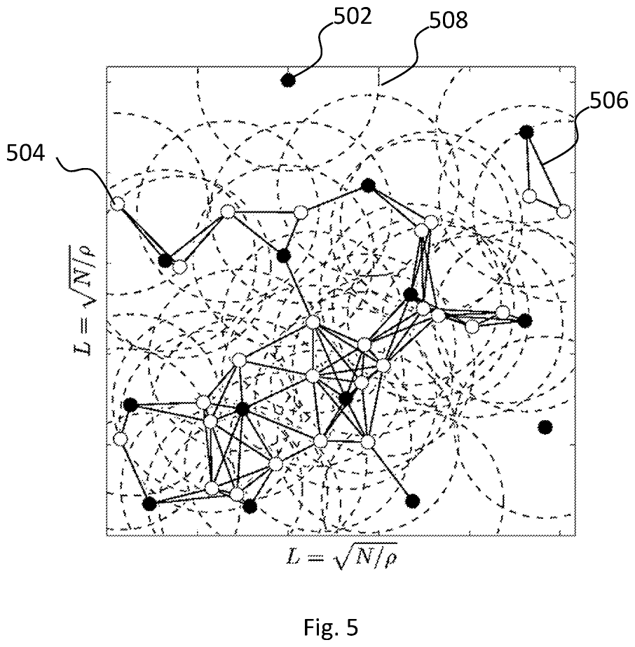

In some embodiments, quantum optimization algorithms such as quantum annealing algorithm (QAA) can be used for random UD-MIS problems. As discussed above, the maximum independent set problem on random unit disk (UD) graphs is only one type of problem that is contemplated by the present disclosure. For QAA with UD graphs, a random UD graphs can be parameterized by two parameters: the number of vertices N and the 2D vertex density p. As shown in FIG. 5, the unit distance can be taken to be r=1, and the vertices are put into a box of L×L, where L=\sqrt{N/ρ}, in some embodiments. In particular, FIG. 5 shows an example of a random unit disk graph with N=40, ρ=1.5, MIS|=14, and 93 edges. Without being bound by theory, for a random UD graph with density p, the average vertex degree is approximately πρ. To minimize the finite-size boundary effect, periodic boundary conditions are used for UD graphs in numerical simulations discussed in the present disclosure. However, such conditions are not necessary.

As discussed above, a QAA for MIS can be performed using the following Hamiltonian:

$${H}_{Q A} ( t ) = {\sum }_{v ϵ V} ( - Δ ( t ) {n}_{v} + Ω ( t ) {σ}_{v}^{x} ) + {\sum }_{( u , w ) ∈ E} U {n}_{u} {n}_{w} \qquad Equation 18$$

The QAA can be designed by first initializing all qubits in |0 [symbol] at time t=0, which is the ground state of H_{QA}(t=0) when Δ(t=0)<0 and Ω(t=0)=0 (with U>0). The parameters can then be changed, for example by first turning on Ω(t) to a non-zero value, sweeping Δ(t) to a positive value, and finally turning off Ω(t) again. Without being bound by theory, the exemplary annealing protocol discussed throughout the present disclosure can be specified by

$$Δ ( t ) = ( 2 s - 1 ) {Δ}_{0} , Ω ( t ) = {Ω}_{0} {sin}^{2} ( π s ) with s = t / T . \qquad Equation 19$$

If the time evolution is sufficiently slow, then by the adiabatic theorem, the system can follow the instantaneous ground state, ending up in the solution to the MIS problem. Ω₀=1 can be considered the unit of energy, and it is possible to fix Δ₀/Ω₀=6, which in non-limiting examples has been identified as a good ratio to minimize nonadiabatic transitions.

In some embodiments, quantum annealing can be explored on random unit disk graphs, with N vertices and density p. In some embodiments, in the limit of Δ₀, Ω₀<<U, the non-independent sets are pushed away by large energy penalties and can be neglected. In some implementations, this can correspond to the limit where the Rydberg interaction energy is much stronger than other energy scales. Without being bound by theory, in some examples in this limit, the wavefunction can be restricted to the subspace of all independent sets, such as:

$${ℋ}_{IS} = \{ \vert ψ 〉 : {n}_{v} {n}_{w} \vert ψ 〉 = 0 for any ( v , w ) ∈ E \} \qquad Equation 20$$

in the exemplary numerical simulation discussed herein, which allows for access to a much bigger system size up to N˜50 since dim (H_{IS})<<2^{N}. First, in an example, the subspace of all independent sets can be found by a classical algorithm, the Bron-Kerbosch algorithm, and the Hamiltonian in equation 18 can then be projected into the subspace of all independent sets. The dynamics with the time-dependent Hamiltonian can be simulated by dividing the total simulation time t into sufficiently small discrete time steps t and at each small-time step, a scaling and squaring method with a truncated Taylor series approximation can be used to perform the time evolution without forming the full evolution operators.

In some embodiments, exemplary time scales for adiabatic quantum annealing to perform well can be explored. In some examples, this time scale can be governed by the minimum spectral gap, ϵ_{gap}, where the runtime required can be

$$T = O ( 1 / {ϵ}_{gap}^{2} ) .$$

However, the minimum spectral gap can be considered to be ambiguous when the final ground state is highly degenerate, since it is possible for the state to couple to an instantaneous excited state as long as it comes down to the ground state in the end. For an example generic graph, there can be many distinct maximum independent sets (the ground state of H_{P} can be highly degenerate). So instead of finding the minimum gap, a different approach can be taken to extract the adiabatic time scale.

In some embodiments, in the adiabatic limit, the final ground state population (including degeneracy) can take the form of the Landau-Zener formula P_{MIS}≈1−e^{a-T/T}^{_{LZ}}, where a is a constant and T_{LZ} is the adiabatic time scale. In embodiments of the nondegenerate case, it is typical to have

$${T}_{LZ} = O ( 1 / {ϵ}_{gap}^{2} ) .$$

In the more general case, the time scale T_{LZ} can be extracted by fitting to this expression. However, in some examples, the simple exponential form holds only in the adiabatic limit, where T≥T_{LZ}. Hence, for each graph instance, it is possible to search for the minimum T such that the equation holds. For example, T can be adaptively doubled iteratively (from Tₘᵢₙ=5) until the minimum T* is found such that P_{MIS}>0.9, at which it is possible to assume, in some embodiments, that the time evolution lies in the Landau-Zener regime. The dynamics can then be simulated for another three time points 1.5T*, 2T*, and 2.5T*, before finally fitting to the equation from T* to 2.5T* to extract the time scale T_{LZ}.

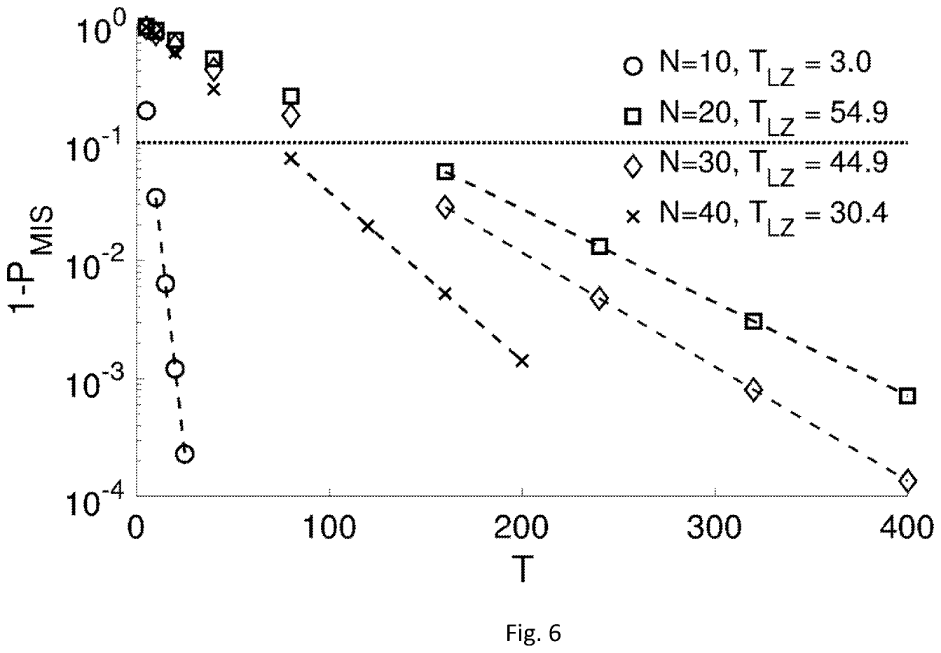

The fitting has been shown in some examples to be effective for most instances. For example, FIG. 6 shows the Landau-Zener fitting to 1−P_{MIS}=e^{a-T/T}^{_{Lz}} to extract the adiabatic time scale T_{LZ}. Here, four random unit disk graphs with N=10, 20, 30, 40 are plotted. For each exemplary instance, the first T is found iteratively such that P_{MIS}(T)>0.9, denoted as T*. The fitting is then performed on four points T*, 1.5T, 2T*, 2.5T* to extract the time scale T_{LZ}. It is possible to drop the few graphs where the goodness-of-fit R²<0.99. In some embodiments, this procedure can be performed to extract T_{LZ} for up to 30 graph instances at each N and ρ. From these, the median can be taken, which can be used to produce the full phase diagram in terms of T_{LZ} as plotted in FIG. 4A described above.

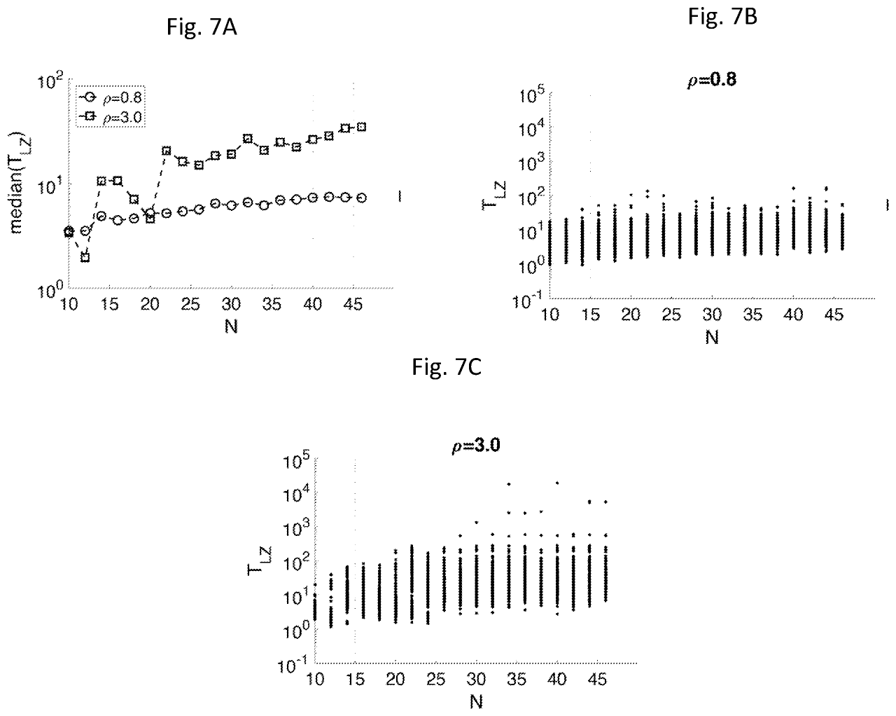

FIGS. 7A-7C show the adiabatic time scale T_{LZ} at some fixed densities. More particularly, FIGS. 7A-7C show 200 random unit disk graphs that are simulated for QAA for system sizes up to N=46. FIG. 7A plots the median T_{LZ}, while FIGS. 7B and 7C plot T_{LZ} for individual instances for ρ=0.8 and ρ=3. FIGS. 7A-7C show the scaling of T_{LZ} with N at some fixed densities ρ=0.8 (below the percolation threshold) and ρ=3 (above the percolation threshold). FIG. 7A shows a clear separation between ρ=0.8 and ρ=3, according to some embodiments. However, the scaling of Nis unclear, which can be due to a finite-size effect: N≥100 may be a better condition to show scaling. FIGS. 7B and 7C also show the spread of T_{LZ} for each instance. It can be seen that some exemplary hard instances require significantly longer T_{LZ} than the typical instance, though even on average T_{LZ}>10 for ρ=3, N≥20.

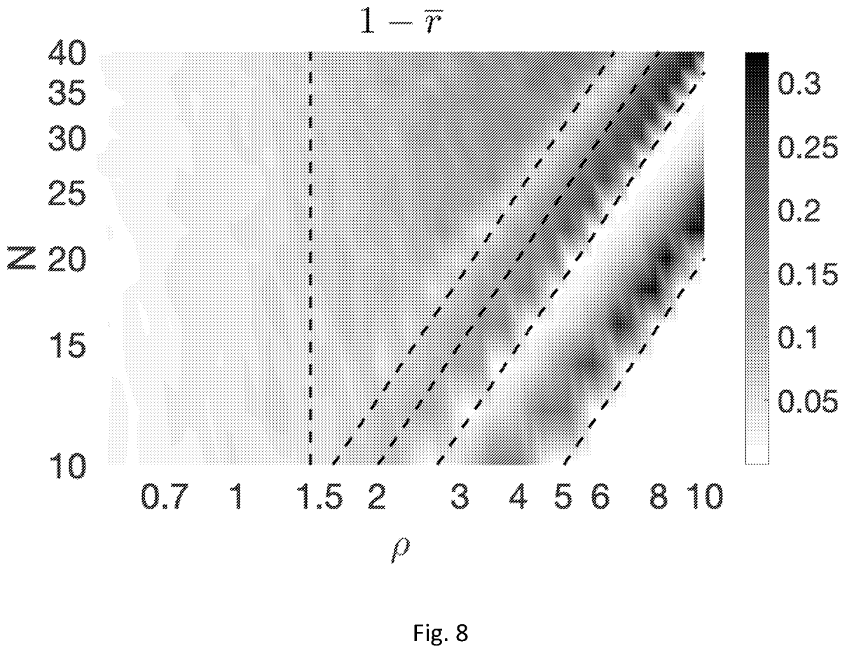

While some embodiments discussed above focused mainly on the capacity of exemplary algorithms to solve MIS exactly, it is also possible to identify whether the algorithms can solve MIS approximately, for example in the sense of finding an independent set as large as possible. For some exemplary quantum algorithms, without being bound by theory, the approximation ratio r can be used to gauge performance for approximations. For example, for a quantum algorithm (such as a quantum annealer) that outputs a state |ψ_{f} [symbol] , it is possible to write r=Σᵢ [symbol] ψ_{f}|nᵢ|ψ_{f} [symbol] /MIS|, where |MIS| is the size of the MIS. In other words, r can quantify the ratio of the average independent-set size found by measuring the output quantum state to the maximum independent-set size. FIG. 8 shows an exemplary analogous phase diagram in terms of the approximation ratio r by simulating quantum annealing at a fixed time T=10/Ω₀, averaged over 30 graph instances per N and ρ (the same instances as in FIG. 4B discussed above), according to some embodiments. The vertical dashed line corresponds to the percolation ratio at ρ=ρ_{c}≈1.436, while the sloped dashed lines correspond to optimal disk packing. FIG. 8 shows qualitatively the same features as the ground state population discussed above with reference to FIG. 4B, but the finite-size effect is stronger due to the small discrete |MIS| values at large densities.

### Generalizations to Arbitrary Graph Structure Beyond UD Graphs

### Stroboscopic Evolution

As discussed above, it is possible to generalize the exemplary implementation discussed above to address MIS problems on graphs, G=(V, E) that are beyond the UD paradigm.

In some embodiments, the quantum algorithms discussed above with reference to the UD paradigm involve evolution with a Hamiltonian

$$H ( t ) = {\sum }_{v} {Ω}_{v} ( t ) {σ}_{v}^{x} - Δ ( t ) {n}_{v} + {\sum }_{( u , v ) ∈ E} {Un}_{u} {n}_{v} .$$

In exemplary embodiments where U>>|Ω|, |Δ|, the dynamics can be effectively restricted to the independent set space H_{IS}. Without being bound by theory, in some embodiments to generate such evolution with a Hamiltonian corresponding to a general graph structure, a Trotterized version of the time evolution operator can be considered:

$$𝒯exp ( - i {\int }_{0}^{T} dtH ( t ) ) ≃ {\prod }_{j} 𝒰 ( {t}_{j} ) ≡ {\prod }_{j} exp ( - i ( {t}_{j + 1} - {t}_{j} ) H ( {t}_{j} ) ) \qquad Equation 21$$

where the time interval [0,T] is sliced defining times tⱼ such that Σⱼtⱼ=T and tⱼ₊₁−tⱼ<<\sqrt{Dₘₐₓ}Ω(tⱼ), |Δ(tⱼ)|. Here Dₘₐₓ can denote the maximum degree of the graph. Each U(tⱼ) can be further Trotterized as follows

$$𝒰 ( {t}_{j} ) ≃ {\prod }_{v = 1}^{N} {𝒰}_{v} ( {t}_{j} ) = {\prod }_{v = 1}^{N} exp ( - i ( {t}_{j + 1} - {t}_{j} ) ( {Ω}_{v} ( {t}_{j} ) {σ}_{v}^{x} - {Δ}_{v} ( {t}_{j} ) {n}_{v} + \frac{1}{2} {\sum }_{u ∈ 𝒩 ( v )} {Un}_{u} {n}_{v} ) ) \qquad Equation 22$$

In other words, it can be split into a product of terms [symbol] ᵥ that each are associated with the evolution of one spin, v. Here [symbol] (v) can denote the neighbors of v on the graph. Note that in the U→∞ limit this can be written as

$${{𝒰}_{v} ( {c}_{j} ) = exp ( - i ( {t}_{j + 1} - {t}_{j} ) ( {Ω}_{v} ( {t}_{j} ) {σ}_{v}^{x} - {Δ}_{v} ( {t}_{j} ) {n}_{v} ) ) {\prod }_{u ∈ {N}_{( v )}} \vert 0 〉}_{u} 〈 0 \vert \qquad Equation 23$$

This is a simple single qubit rotation of atom v, conditioned in some embodiments on the state of the atoms corresponding to neighbors of v being |0 [symbol] . If at least one of the neighbors is in state |1 [symbol] , atom v may not evolve.

### Implementation Using Qubit Hyperfine Encoding

In some embodiments it is desirable to add further control of a quantum system in order to specify interactions between particular pairs or subsets of qubits. One exemplary approach to implement the corresponding dynamics with individually controlled neutral atoms can take advantage of qubit states |0 [symbol] and |1 [symbol] encoded in two (non-interacting) hyperfine states, in the internal atomic ground state manifold. In other words, when implementing other forms of graphs, it is possible to iterate through desired interactions between individual pairs (or sets) of qubits.

In some embodiments, the atoms can be positioned on the points of a 2D square lattice with distance g. To realize a single step, Uᵥ(tⱼ), the atoms, u, can be excited that correspond to neighbors of v on the graph (u∈ [symbol] (v)), selectively from the state |1 [symbol] to a Rydberg S-state |1′ [symbol] . In some embodiments, a grid length g<<r_{B} can be chosen such that none of the atoms u∈ [symbol] (v) interact during this process. Atom v can then be driven to realize the single qubit rotation in the hyperfine manifold, for example with a unitary, such as, but not limited to, a physical operation that can be performed deterministically such as driving the atom with a laser to cause a quantum state evolution corresponding to an evolution with

$${Ω}_{v} ( {t}_{j} ) {σ}_{v}^{x} - {Δ}_{v} ( {t}_{j} ) {n}_{v} ,$$

where

$${σ}_{v}^{x}$$

couples the two hyperfine qubit states of atom v, and nᵥ counts if atom v is in hyperfine state |1 [symbol] . In some embodiments, to realize this rotation, an individually addressed two-step excitation can be used that can couple the two hyperfine states |0 [symbol] and |1 [symbol] of atom v via a transition through a Rydberg P-state (for example, by first exciting the atom from the state |0 [symbol] to a Rydberg P state with a first laser pulse, and then changing its state from the Rydberg P state to the state |1 [symbol] with a second laser pulse). In some embodiments, if all atoms u are in the state |0 [symbol] , then this process may not be disturbed, but if at least one of the neighbors is the Rydberg S state, the strong S-P interaction can give rise to a blockade mechanism that prevents the rotation of the qubit v, thus realizing exactly equation 23. Note that in some embodiments this may require a different scale of interaction length of the blockade radius for two atoms in the Rydberg S-states on one hand, and the S-P blockade radius on the other hand because these two interactions scale differently with separation of the atoms: the S−P interactions decay as 1/x³ (much slower than the S-S interactions that scale like 1/x⁶), which makes it possible to implement collective gate with high fidelity. Accordingly, it is possible to apply quantum optimization to MIS problems on graphs that are more general than the unit disk graphs.

### Maximum Independent Sets for Unit Disk Graphs

Without being bound by theory, this section addresses some aspects of MIS problems on unit disk graphs that can be solved according to the techniques described in the present disclosure. FIG. 5 shows a unit disk graph with vertices 502, 504, some of which are connected by edges 506 when they fall within a radius r of one another, as represented by disks 508, according to some embodiments. The problem can be formulated as minimizing the energy of:

$${H}_{UD} = {\sum }_{v ∈ V} - Δ {n}_{v} + {\sum }_{w > v} {V}_{UD} ( \vert {\vec{x}}_{v} - {\vec{x}}_{w} \vert ) {n}_{v} {n}_{w} , \\ \text{where:} \\ {V}_{UD} ( x ) = \{ \begin{matrix}U , & x \leq r \\ 0 , & x > r\end{matrix} \qquad Equation 24$$

which is a subclass of H_{P}(2). This problem can be proved to be NP-complete by reducing it from MIS on planar graphs of maximum degree 3. Since, in some embodiments, analysis of the computational complexity associated with the Rydberg Hamiltonian (Equation 2) discussed herein is based on a similar reduction, it can be instructive to review the following theorem and its proof: MIS on unit disk graphs is NP-complete.

Without being bound by theory, this theorem can be proven as follows: (1) MIS on planar graphs with maximum degree 3 is NP-complete. (2) A planar graph [symbol] =(V, ε), with vertices V and edges ε, with maximum degree 3 can be embedded in the plane using [symbol] (|V|) area in such a way that its vertices are at integer coordinates, and its edges are drawn by joining line segments on the grid lines x=i×g or y=j×g, for integers i and j, and grid spacing g. (3) One can replace each edge {u, v} of [symbol] by a path having an even number, 2k_{u,v}, of ancillary vertices, in such a way that a UD graph, G=(V, E) with vertices V and edges E, can be constructed. It is straightforward to verify that [symbol] has an independent set S⊂V such that |S|≤a if and only if G has an independent set S⊂V such that |S|≤a′=a+Σ_{{u,v}∈ε}k_{u,v}.

In some embodiments, this theorem shows that it is NP-complete to decide whether the ground state energy of HUD is lower than −a′Δ. In some embodiments, the transformation in the proof of this theorem does not fully determine the actual positions of the ancillary vertices in the 2D plane. In some embodiments, a particular arrangement can be specified consistent with the requirements of this transformation. Once Rydberg interactions are considered, the interaction strength between each pair of qubits can be fixed in a way that takes into account the distance of the atoms.

Given an edge {u, v} of the graph [symbol] embedded on a grid, the length of this edge can be denoted by g× [symbol] _{u,v} with [symbol] _{u,v} an integer, and g the grid unit length, in some embodiments. First, an ancillary vertex can be placed on the [symbol] _{u,v}−1 grid point along the edge, separating the edge in [symbol] _{u,v} segments of length g. An integer k≥3 can be selected and equally spaced 2k ancillary vertices can be placed along each segment, dividing it into 2k+1 pieces of equal length d=g/(2k+1). In some embodiments, irregular vertices can be used to ensure that the number of ancillary spins on each edge is even. In some embodiments, however, the total number of spins on each edge might be different. If [symbol] _{u,v} is even, one segment can be chosen and the 4ϕ+2 ancillary vertices close to the center of this segment can be replaced with 4ϕ+1 ancillary vertices, that are equally spaced by a distance

$$D = d + \frac{d}{4 ϕ} ,$$

for some integer ϕ to be determined. Such segments can be referred to as “irregular segments”, and to the vertex at the center of the irregular segment can be referred to as an irregular vertex. In some embodiments, these exceptions are made to ensure that the total number of ancillary vertices along each edge {u, v}ϵε, 2k_{u,v}, is even in order to ensure that the ancillary vertices transfer the independent set constraint without changing the nature of the problem to be solved. Following this arrangement, the nearest-neighbor distance of the ancillary vertices can be either d or D. Setting the unit disk radius to r=D+0⁺ can produce the unit disk graph G. The positions of the vertices can be labelled by \vec{x}ᵥ. In some embodiments, arrangement depends on the freely chosen parameters k and ϕ. Accordingly, as described throughout the present disclosure, a hard problem can be transformed into an MIS problem on an arrangement of vertices that form a unit disk graph.

Without being bound by theory, a few properties of the maximum independent set on the types of unit disk graphs constructed in this way can be noted, according to some embodiments. First, in some embodiments, the maximum independent set on G is in general degenerate, even if the maximum independent set on [symbol] is unique. The properties of a particular set of MIS-states on G can be considered, such as MIS-states on G, |ψ_{G} [symbol] , that coincide with MIS-states on [symbol] , | [symbol] [symbol] , on the vertices V. Without being bound by theory, to see that such states can always exist, |ψ_{G} [symbol] can be constructed from [symbol] [symbol] as follows: given the state of two qubits corresponding to two vertices, u, vϵV, if u is in the state |0 [symbol] and vis in state |1 [symbol] (or vice versa) then the 2k_{u,v} ancillary vertices can be placed on the edge connecting u and v in an (antiferromagnetically) ordered state, where the qubits are alternating in states |1 [symbol] and |0 [symbol] . In the other case, if u and v are both in states |0 [symbol] , the ancillary vertices can be placed in an analogously ordered state. In embodiments of this latter case, a domain wall, such as an instance where two neighboring qubits are both in the state |0 [symbol] can be introduced. The position of this domain wall along the edge is irrelevant. In both cases half of the 2k_{u,v} ancillary vertices along the edge are in state |1 [symbol] . Therefore, by the above theorem, the state constructed from | [symbol] [symbol] by applying this process on all edges of [symbol] , is a MIS-state on G.

Without being bound by theory, the structure of these MIS-states around points where edges meet under a 90° angle can be further specified, according to some embodiments. Such points can be either junctions, where 3 edges meet at a vertex, such as point 216 in FIG. 2A, or corners, such as 202 in FIG. 2A. There is a MIS-state, |ψ_{G} [symbol] , such that the qubits close to each corner or junction are ordered (for example, in a state where every other vertex is in state |1 [symbol] and the others are in state |0 [symbol] ). For example, there exists a maximum independent set, such that for every corner and junction, all vertices within a distance 8<g/4 are in one of the two possible ordered configurations with no domain wall. Without being bound by theory, this follows from the above discussion by noting that the position of any domain wall along an edge ε is irrelevant, in some embodiments. For example, any domain wall can be moved along an edge ε such that its distance to any vertex on a grid point is larger than g/4. The possibility to move domain walls is also exploited in the discussion of the full Rydberg problem discussed, for example below in the section titled NP-Completeness of the Rydberg Problem.

### Model Detunings for Corners and Junctions

Without being bound by theory, to illustrate applications of the above reduction to implementations that employ Rydberg interactions, a simple model can be implemented to explain aspects of some implementations. This model can be used to show some aspects and benefits of embodiments of the present disclosure, including, but not limited to treatment of special vertices. For example, a Hamiltonian similar to HUD, the MIS-Hamiltonian for UD graphs, can be considered with the introduction of interactions beyond the unit disk radius. Similar to the situation in the Rydberg system, these additional interactions can cause energy shifts that can result in a change of the ground state, thus invalidating the encoding of the MIS. In other words, such additional interaction can cause the ground state of an encoded MIS problem to be mismatched with the solution to the MIS problem. To resolve this issue, local detunings can be used to compensate for the additional interactions.

Without being bound by theory, embodiments of the model can be expressed as:

$${H}_{model} = {\sum }_{v ∈ V} - {Δ}_{v} {n}_{v} + {\sum }_{w > v} {V}_{model} ( \vert {\vec{x}}_{w} - {\vec{x}}_{v} \vert ) {n}_{v} {n}_{w} \qquad Equation 26$$

with interactions given by:

$${V}_{model} ( x ) = \{ \begin{matrix}U , x \leq r , \\ W , r < x \leq R \\ 0 , x > R ,\end{matrix} \qquad Equation 27$$

where W<U. For W=0 and Δᵥ=Δ, H_{model} can reduce to the Hamiltonian H_{UD} described in Equation 25. For W>0 it includes interactions beyond the unit disk radius, r, and can thus be considered as a first approximation to the Rydberg Hamiltonian.

In some embodiments, in the case of a qubit arrangement described in the section titled “Maximum Independent Sets for Unit Disk Graphs” corresponding to a unit disk graph, G, and the case \sqrt{2}r<R<2r, most qubits interact only with their neighbors on G, with an exception being qubits that are close to corners (such as qubit 202 in FIG. 2A) or junctions (such as qubit 216 in FIG. 2A). In such geometric arrangements, some qubits that are not neighboring on G interact with strength W>0. These interactions can, in some embodiment, change the ground state, as compared to the MIS-Hamiltonian, H_{P}.

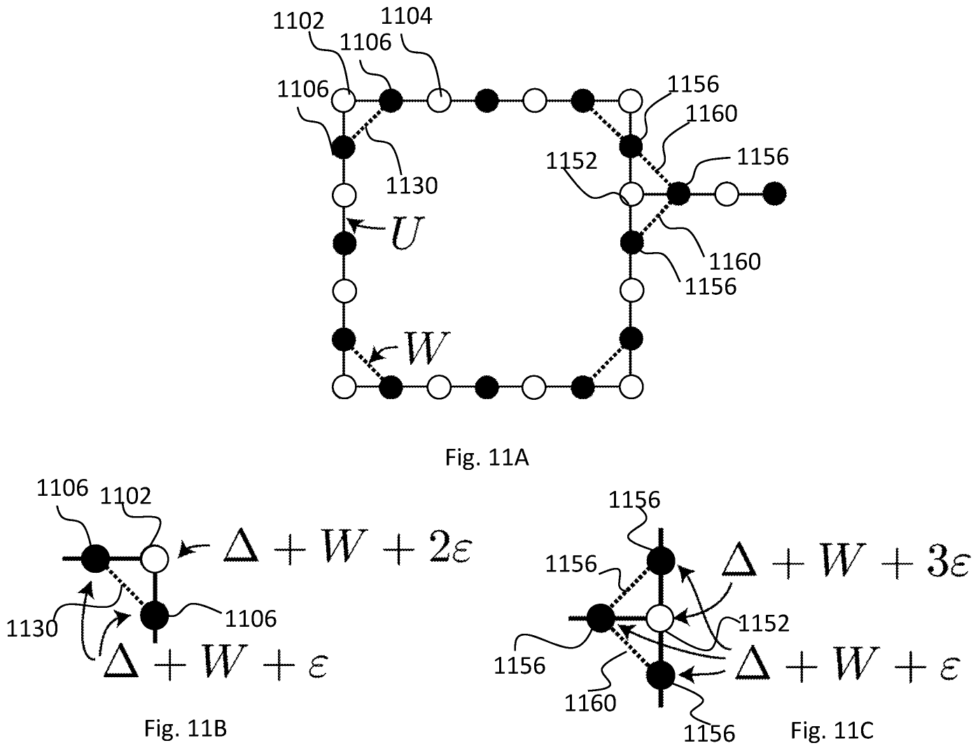

FIGS. 11A-11C show examples of vertex arrangements corresponding to a unit disk graph, where the ground state of the model H_{model} (Equation 26) does not correspond to the maximum independent set, according to some embodiments. The maximum independent set on this graph in FIG. 11A is indicated by the black vertices, such as vertices 1106 and 1156. The white vertices, such as vertices 1102, 1104, 1152 indicate another independent set whose size is smaller than the size of the maximum independent set by one vertex. If W is too large, the additional interactions on the diagonals 1130, 1160 close to corners 1102 and junctions 1152 disfavor the MIS-state; instead, the state where the black qubits are in state |1 [symbol] , becomes the ground state. As described throughout the present disclosure, this problem can be resolved by changing the detuning locally at the problematic structures as indicated FIGS. 11B and 11C for corners and junctions, respectively.

In some embodiments, it is desirable to find a detuning pattern, Δᵥ, such that the MIS-state of Hup remains the ground state of H_{model}, even at finite W. In other words, it is desirable to find a detuning pattern that renders the MIS solution of the graph more energetically favorable (i.e., coupling it to the ground state of the system) than other solution of the graph. For the relevant qubit arrangements, the interactions of the H_{UD} and H_{model} differ only around corners and junctions, in some embodiments. Thus, Δᵥ can be set to Δᵥ=A everywhere (e.g., for all qubits) except at these structures, which can be considered individually and separately.

In some embodiments, with reference to corners as shown in FIG. 11B, as discussed above in the section titled “Maximum Independent Sets for Unit Disk Graphs,” there exists at least one MIS-state, |ψ_{G} [symbol] , such that the corner qubit 1102 and its two neighbors 1106 are in one of the two ordered configurations: either the corner qubit 1102 is in state |0 [symbol] and its two neighbors 1106 are in state |1 [symbol] (|011)), or the corner qubit 1102 is in state |1 [symbol] and its two neighbors 1106 are in state |0 [symbol] (|100)), where |100) is a state of three vertices where the first vertex is in the state |1 [symbol] , and the other two vertices are in the state |0 [symbol] . Detunings can be chosen for these three qubits in such a way that only these two configurations are relevant for the ground state of H_{model}. That is, detunings can be specified such that the energy of all possible qubit configurations can always be lowered by arranging the qubits on the corners in one of the two ordered states, such as, but not limited to 01010 or 10101. In some embodiments, this can be achieved if the detuning of the corner qubit 1102 is selected to be Δ_{C}=Δ+W+2ϵ, and the detuning of its two neighbors 1106 is selected to be Δ_{N}=Δ+W+ϵ. Here ϵ>0 can be chosen freely (up to the trivial constraint Δᵥ<U, where U is the strength of interaction for two vertices that are very close). In some embodiments, there might be some advantages for choosing different E, and the values described herein are discussed as examples. In some embodiments, this choice of the detuning restores the energy difference between the two ordered configurations on the three qubits to A, corresponding to the additional vertex qubit in state |1 [symbol] . Without being bound by theory, up to a trivial constant (and contributions from junctions discussed below), H_{model} and H_{UD} are identical on all states where each corner is in one of the above ordered configurations. This includes in particular one ground state of H_{UD}, which corresponds to a MIS-state. All states that are not of this type have higher energy with respect to H_{model} by construction, according to some embodiments.

In some embodiments, with reference to FIG. 11C, junctions can be treated with a similar detuning technique. Without being bound by theory, there exists at least one MIS such that the central qubit 1152 is in the state |0 [symbol] and its three neighbors 1156 are in the state |1 [symbol] , or the central qubit 1152 is in the state |1 [symbol] and its three neighbors 1156 are in the state |0 [symbol] . A detuning of the degree-3 junction qubit 1152 (denoted Δ_{J}) can be chosen as Δ_{J}=Δ+W+3ϵ, and the detuning of its three neighbors 1156 (denoted by Δ_{N′}) can be chosen as Δ_{N′}=Δ+W+ϵ. In some embodiments, this choice renders one of the two ordered states on the junction energetically more favorable than any other state and restores their energy difference to exactly 2Δ. It should be appreciated, based on the present disclosure, that other values of can be selected.

In some embodiments, by using the detuning patterns described above, the actions of H_{UD} and H_{model} are, for non-limiting theoretical purposes, identical for at least one MIS-state. In addition, some embodiments ensure that the chosen detunings do not lower the energy of any other configurations. Therefore, a ground state of H_{model} is a ground state of H_{UD}, encoding an MIS problem on the corresponding unit disk graph such that the ground state is a solution to the MIS problem.

### NP-Completeness of the Rydberg Problem

Without being bound by theory, in some embodiments the detuning model described above can be applied to the case of the Rydberg Hamiltonian, thereby showing that it is NP-complete to decide whether the ground state energy of H_{Ryd} is below a given threshold, when Ωᵥ=0, where the atoms can be positioned arbitrarily in at least two dimensions. While the main idea is similar, the infinite ranged Rydberg interactions warrant more explanation.

As described above, it is possible to apply a detuning pattern that separates length and interaction scales, in some embodiments. This is possible in part because the Rydberg interactions decay fast, such that interactions between qubits that are close can be separated from the interactions between qubits that are far apart on the graph G. For example, the interactions between distant qubits can be neglected, if k is chosen large enough. In such embodiments, individual substructures of the system can be treated separately for purposes of theory.

In some embodiments, the low energy sector of the Rydberg Hamiltonian can be mapped to a much simpler effective spin model. For example, clusters of qubits can be addressed with specific detuning patterns such that only two configurations are relevant for each cluster. In some embodiments, the resulting, effective pseudo-spins are described by a MIS Hamiltonian. This makes it possible to encode MIS problems on planar graphs with maximum degree 3 such that the ground state of the Rydberg Hamiltonian is the MIS solution. The discussion in this section proves the details of the mapping to the effective model.

First, with regard to separation of length scales, the Rydberg interactions can decay as a power law with distance, and thus do not define a length scale where the interactions cease to exist. Nevertheless, in some embodiments, an exemplary qubit arrangement introduces two length scales: (1) the closest distance between two qubits, d, and (2) the grid length, g. These length scales are separated by a factor, g=d (2k+1), that can be chosen arbitrarily in the transformation of the planar graph, [symbol] , to the unit disk graph, G. In some embodiments, with such implementations, interactions between qubits that are “close” can be separated from interactions between qubits that are “distant”, for example when k is selected to be sufficiently large, as described in the present disclosure.

The closest qubits in the system are separated by a distance d and thus interact with a strength of [symbol] =C/d⁶. This defines a convenient unit of energy, [symbol] , which depends on the choice of the parameter k specifying the transformation from [symbol] to G.

Without being bound by theory, two qubits can be described as “distant” if their x or y coordinate differs by at least g (the grid length). The interaction energy of a single qubit with all distant qubits can be upper bounded by:

$${E}_{dist} = C ( {\sum }_{j = 1}^{∞} {\sum }_{i = 1}^{∞} \frac{8}{{( {d}^{2} {i}^{2} + {g}^{2} {j}^{2} )}^{3}} + {\sum }_{i = 0}^{∞} \frac{4}{{( id + g )}^{6}} ) \qquad Equation 28$$

In some embodiments, this bound can be derived by considering a system where a qubit can be placed in state |1 [symbol] on each possible qubit position in the 2D plane (i.e. along all grid lines). E_{dist} is the interaction energy of a single qubit in such a system with all other qubits that are distant in the above sense. This is an upper bound to the maximum interaction energy of a single qubit with all distant qubits on arbitrary graphs, that itself can be upper bounded by

$${E}_{dist} = \leq 𝒰 ( \frac{3 π ζ ( 5 )}{2} + \frac{4}{5} + 4 ( \frac{d}{g} ) ) {( \frac{d}{g} )}^{5} , \qquad Equation 29$$

where ζ(x) is the Riemann zeta function. Since in some embodiments, d/g=1/(2k+1), the interaction energy of a spin with all distant spins can scale as E_{dist}= [symbol] ( [symbol] /k⁵). The total number of spins can scale as |V|˜ [symbol] (k|V|), as the grid representation of the original planar graph [symbol] in the plane can be done with [symbol] (|V|) area. Thus, in some embodiments, the contribution of interactions between all pairs of spins that are distant with respect to each other can be bounded by E_{dist}|V|˜ [symbol] ( [symbol] |V|/k⁴). In some embodiments, k can be chosen large enough such that these contributions can be neglected. In such embodiments, the ground state does not change due to the long range interactions. Note that the required k can scale polynomially with the problem size |V|.

### Effective Spin Model

As described in more detail below, without being bound by theory, an effective spin model can be developed in order to show that for each planar graph [symbol] =(V, ε) of maximum degree 3, an arrangement of [symbol] (k|V|)= [symbol] (|V|^{5/4}) atoms can be identified, and detuning patterns applied such that the ground state of the corresponding Rydberg Hamiltonian directly reveals a maximum independent set of [symbol] . Furthermore, without being bound by theory, it can be seen that it is NP-complete to decide whether the ground state energy of H_{Ryd} (Ωᵥ=0) is lower than some threshold. In addition, without being bound by theory, it is possible to treat certain arrangements as pseudo-spins to simplify nonlimiting discussion of aspects of some embodiments.

In some embodiments, similar to the model discussed above, interactions beyond the unit disk radius (e.g., interaction tails) can be problematic. For example, longer range interactions can cause the ground state of systems with encoded MIS problems described above to differ from MIS solutions. These interactions can be more prominent close to vertices of degree 3, such as at vertex qubit 216 in FIG. 2A or corners, such as vertex qubit 202 in FIG. 2A.

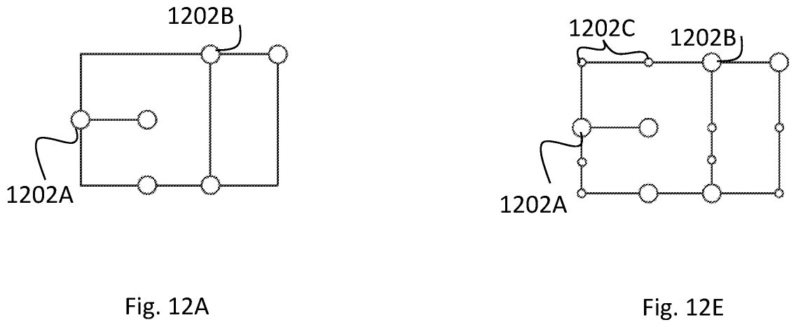

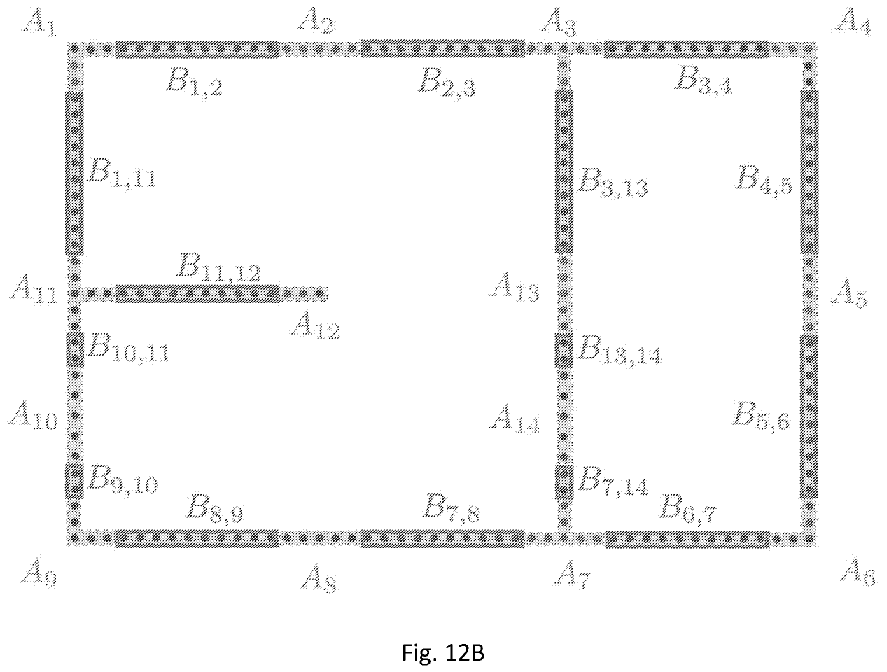

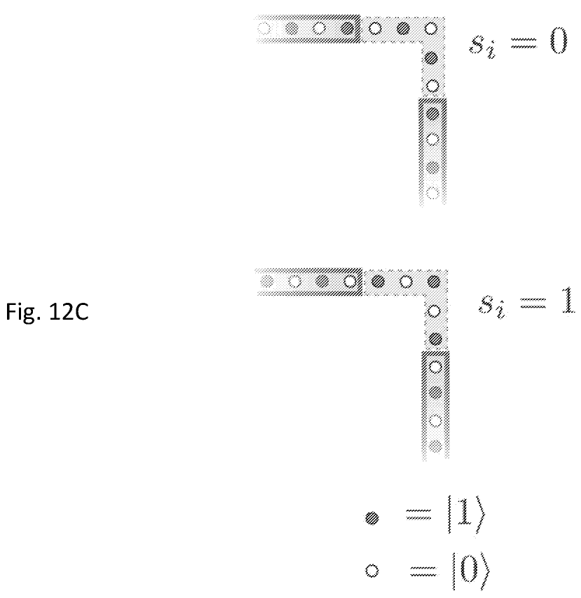

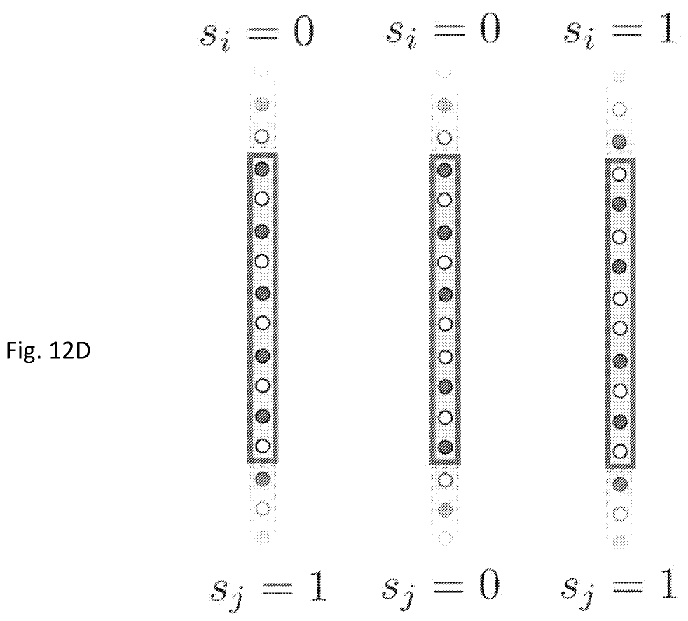

In some embodiments, as discussed throughout the present disclosure, to address these complications length and interaction scales can be separated to isolate these structures and control them individually. For example, for some graphs discussed in the present disclosure, various “special” vertices can be defined. These are special vertices can correspond to those that that either have integer grid coordinates or are irregular vertices. Special vertices thus include all vertices V of [symbol] , but also a subset of vertices introduced to transform [symbol] to the UD graph G. FIG. 12A shows an example of a planar graph with maximum degree 3, [symbol] embedded on a grid, according to some embodiments. The planar graph of FIG. 12A includes vertex qubits 1202A, 1202B that can be connected with edge qubits as discussed above.

FIG. 12B shows a spin arrangement implementing the graph of FIG. 12A with k=7 and ϕ=1, according to some embodiments. For each special vertex, denoted as i, a set of vertices, Aᵢ, can be defined that includes i and its 2q neighbors on each leg. The value of q can be chosen such that 2φ<2q≤k/4.

FIG. 12B shows the regions Aᵢ, corresponding to special vertices and their 2q neighbors on each leg with a value of q=1. The regions A₁, A₄, A₆ and A₉ can be referred to as corners, and regions A₃, A₇, and A₁₁ can be referred to as junctions. The region A₁₂ can be referred to as an open leg, while regions A₂, A₅, As, A₁₀, A₁₃ and A₁₄ can be referred to as special vertices on straight segments. Regions A₁₀ and A₁₄ can be referred to as irregular regions (e.g., those in which the spacing between vertices is different than in the other regions). In a spin model, each region Aᵢ can be represented by a pseudo-spin si that interacts with neighboring pseudo-spins. In other words, the spins in a certain region can be aggregated as a pseudo-spin, which, as explained in more detail below, is limited to a specified number of states in the ground state. The two pseudo-spin states correspond to the two ordered configurations in Aᵢ. These two configurations, denoted by sᵢ=0 and sᵢ=1, correspond to states where the special spin, i, is in state |sᵢ [symbol] and all other spins in Aᵢ are in the corresponding perfectly ordered state. For each region Aᵢ a pseudo-spin sᵢ can be defined and E_{A}_{ᵢ} can be calculated for both pseudo-spin states

$$( denoted {E}_{{A}_{i}}^{{s}_{i}} ) .$$

Note that the number of spins in Aᵢ that are in state |1 [symbol] can be directly determined by the pseudo-spin state sᵢ, as it is given by sᵢ+mᵢq (where m denotes the degree of the special vertex i). As shown in FIG. 12B, sets B_{i,j} can be defined as the vertices along the path connecting Aᵢ and Aⱼ. In such embodiments, by construction B_{i,j} contains an even number of vertices. The ground states of different types of pseudo-spins A and B are described in more detail with reference to the section titled “Behavior at Low Energy.” For example, FIG. 12D shows the 3 possible configurations of vertices along a straight segment of ancillary spins that can appear in a ground state configuration. FIG. 12E shows the effective spin model corresponding to the graph [symbol] , according to some embodiments.

Without being bound by theory, due to the separation of length and interaction scales described throughout the present disclosure, interactions between two spins, u and v, are only relevant if they belong to the same set, u, vϵAᵢ (or u,v∈B_{i,j}), or if they belong to adjacent sets, uϵAᵢ and v∈B_{i,j}. All other interaction terms will give contributions that vanish like [symbol] ( [symbol] | [symbol] |/k⁴). Without being bound by theory, the total energy can be written as

$$E = {\sum }_{i} {E}_{{A}_{i}} + {\sum }_{〈 〈 i , j 〉 〉} ( {E}_{{A}_{i} , {B}_{i , j}} + \frac{1}{2} {E}_{{B}_{i , j}} ) + 𝒪 ( 𝒰 \vert 𝒱 \vert / {k}^{4} ) . \qquad Equation 30$$

Where, E_{X}=Σ_{v∈X}−Δᵥnᵥ+Σ_{w>v∈X}V_{Ryd}(|\vec{x}_{w}−\vec{x}ᵥ|)n_{w}nᵥ gives the energy of the system when only spins in X are taken into account, and Σ_{X,Y}=Σ_{u∈X}Σ_{v∈Y}V_{Ryd}(|\vec{x}ᵤ−\vec{x}ᵥ|)nᵤnᵥ quantifies the interaction energy between spins in two regions X and Y. The sum [symbol] [symbol] =Σᵢ [symbol] runs over i and j, such that Aᵢ is connected to Aⱼ, by a non-empty set B_{i,j}, and the factor ½ compensates for double counting.

It is possible to apply an appropriate choice of the detunings, Δᵥ, such that only a few configurations of spins in regions Aᵢ and B_{i,j} are relevant to construct the ground state of the entire system, in some embodiments. In some such configurations it is possible to consider only a few configurations as candidates for the ground state, rather than exponentially many. For example, as discussed in more detail below, in such embodiments only two configurations of spins in the regions Aᵢ shown in FIG. 12C are relevant. Furthermore, in such embodiments, only four configurations of spins in each region B_{i,j} are relevant, as shown in FIG. 12D, according to some embodiments. Moreover, these configurations can be completely determined by the pseudo-spin state sᵢ and sⱼ. If sᵢ=1 and sⱼ=0 (or vice versa) the total energy is minimized if B_{i,j} is in the perfectly ordered state. If sᵢ=sⱼ=0 or sᵢ=sⱼ=1, the lowest energy state is also ordered but with a single domain wall in the center of the region B_{i,j}. Without being bound by theory, the energy E_{B}_{_{i,j}} for these configurations can be denoted by by

$${\sum }_{{B}_{i , j}}^{{s}_{i} , {s}_{j}} ,$$

which yields:

$${E}_{{B}_{i , j}} = ( {s}_{i} ( 1 - {s}_{j} ) + ( 1 - {s}_{i} ) {s}_{j} ) {E}_{{B}_{i , j}}^{1 , 0} + ( 1 - {s}_{i} ) ( 1 - {s}_{j} ) {E}_{{B}_{i , j}}^{0 , 0} + {s}_{i} {s}_{j} {E}_{{B}_{i , {j}^{}}}^{1 , 1} , \qquad Equation 31$$

where note

$${E}_{{B}_{i , j}}^{1 , 0} = {E}_{{B}_{i , j}}^{0 , 1} .$$

The number of spins in state |1 [symbol] in B_{i,j} can be written as b_{i,j}−sᵢsⱼ (where 2b_{i,j} gives the number of spins in B_{i,j}). The interaction energy E_{A}_{ᵢ}_{B}_{_{i,j}} can be constant for all of the above combinations of relevant states [up to [symbol] ( [symbol] /k⁵)].

In some embodiments, the total energy in the relevant configuration sector containing the ground state of H_{Ryd} can be given by an effective spin model for the pseudo-spins:

$$E = {\sum }_{i} - {Δ}_{i}^{eff} {s}_{i} + {\sum }_{〈 〈 i , j 〉 〉} {s}_{i} {s}_{j} {U}_{i , j}^{eff} + ξ + O ( 𝒰 \vert 𝒱 \vert / {k}^{4} ) , \qquad Equation 32$$

where the sum [symbol] _{i,j} [symbol] runs over neighboring pairs of pseudospins (without double-counting). Effective detunings

$${Δ}_{i}^{eff}$$

(e.g., detunings that have a similar effect on pseudospins as detunings for normal spins) can be introduced and pseudo-spin interactions

$${U}_{i , j}^{eff}$$

can be given by:

$${Δ}_{i}^{eff} = {E}_{{A}_{i}}^{0} - {E}_{{A}_{i}}^{1} - {\sum }_{j ∈ 𝒩 ( i )} ( {E}_{{B}_{i , j}}^{1 , 0} - {E}_{{B}_{i , j}}^{0 , 0} ) , \qquad Equation 33$$

$${U}_{i , j}^{eff} = {E}_{{B}_{i , j}}^{1 , 1} + {E}_{{B}_{i , j}}^{0 , 0} - 2 {E}_{{B}_{i , j}}^{1 , 0} , \qquad Equation 34$$

$$ξ = {\sum }_{i} {E}_{{A}_{i}}^{0} + {\sum }_{〈 〈 i , j 〉 〉} ( {E}_{{A}_{i} , {B}_{i , j}} + \frac{1}{2} {E}_{{B}_{i , j}}^{0 , 0} ) . \qquad Equation 35$$

In some embodiments, detuning patterns, Δᵥ, can be chosen such that the effective pseudo-spin detunings and interactions are homogeneous,

$${Δ}_{i}^{eff} = {Δ}^{eff} and {U}_{i , j}^{eff} = {U}^{eff} ,$$

and satisfy 0<Δ^{eff} U^{eff}. In some embodiments, when these parameters are chosen such that the above equations are satisfied the problem of the Rydberg Hamiltonian can be treated as equivalent to the MIS problem. To ensure that the long-range correction is bounded by some small constant n<<Δ^{eff}, k can be selected such that k≥ [symbol] (( [symbol] | [symbol] |/η)^{1/4)}). ξ can be computed based on the chosen detuning pattern.

This effective spin model in equation 32 can be related back to the original MIS problem on [symbol] . Without being bound by theory, embodiments of this effective spin model corresponds exactly to a MIS problem on a graph [symbol] obtained from [symbol] =(V, ε) by replacing each edge {u,v}ϵε by a string of an even number 2K_{u,v} of vertices as discussed in more detail with reference to FIGS. 12A-12E. These additional vertices transport the independent set constraint giving an exact correspondence between the maximum independent sets of [symbol] and [symbol] , in complete analogy to the discussion above in the section titled “Maximum Independent Sets for Unit Disk Graphs.”

Therefore, for each planar graph G=(V, E) of maximum degree 3, an arrangement of [symbol] (k|V|)= [symbol] (|V|^{5/4}) atoms can be identified, and detuning patterns applied such that the ground state of the corresponding Rydberg Hamiltonian directly reveals a maximum independent set of [symbol] . Thus, without being bound by theory, it can be seen that it is NP-complete to decide whether the ground state energy of H_{Ryd}(Ωᵥ=0) is lower than some threshold. First, this question is in NP since the ground state of H_{Ryd}(Ωᵥ=0) has a classical description. In addition, for reduction from the NP-complete problem of deciding whether the size of MIS on [symbol] , a planar graph of maximum degree 3, is ≥a. Let a′=a+Σ_{{u,v}∈ε}K_{u,v}. If the size of MIS of [symbol] is ≥a, then the ground state energy of H_{Ryd} is ≤−a′Δ^{eff}+ξ+η. If the size of MIS of [symbol] is ≤a−1, then the ground state energy of H_{Ryd} is ≥−(a′−1)Δ^{eff}+ξ−η. In some embodiments, by choosing n<Δ^{eff}/2, the MIS of [symbol] has size ≥a if and only if the ground state energy of H_{Ryd} is ≤−(a′−½)Δ^{eff}+ξ.

### Behavior at Low Energy

Without being bound by theory, embodiments of aspects of the ground state of the Rydberg Hamiltonian are described below. Example aspects of the Rydberg Hamiltonian show that at lower energy, the ground state corresponds to an MIS solution to an encoded problem. Thus, in example implementations, if a problem is properly encoded, transitioning the corresponding qubits into lower energy states can result in the system in the ground state which corresponds to the solution to the encoded problem. Without being bound by theory, discussion of such transitions can be aided by referencing the “pseudo-spins” discussed in the previous section.

In some embodiments, the ground state of H_{Ryd} corresponds to a maximal independent set on the associated UD graph if the detuning of each spin is selected according to the techniques described herein. Maximal independent sets refer to independent sets where no vertex can be added without violating the independence property (e.g., that no two neighboring vertices can both be in the state |1 [symbol] ). The largest maximal independent set is the maximum independent set. For configurations corresponding to such sets, no two neighboring spins can be in state |1 [symbol] (independence), and no spin can be in state |0 [symbol] if all its neighbors are in state |0 [symbol] (maximality).

In some embodiments of the Rydberg Hamiltonian, no two neighboring vertices on G can be simultaneously in state |1 [symbol] if the system is in the ground state of H_{Ryd} as long as the detuning Δᵥ on all vertices obeys:

$${Δ}_{v} < {Δ}_{max} ≡ C / {D}^{6} {\to }^{ϕ ≫ 1} 𝒰 , \qquad Equation 36$$

where D is the maximal Euclidean distance between two vertices that are neighboring on G.

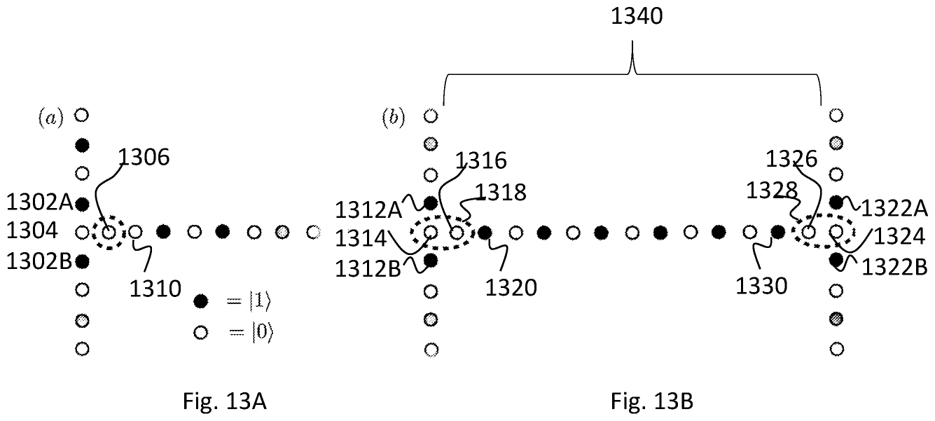

FIG. 13A shows a portion of a graph of qubits at a vertex of degree-3, according to some embodiments. The graph includes qubits 1302A, 1302B, 1304, 1306, and 1310. FIG. 13B shows a similar graph with two vertices of degree-3, according to some embodiments. FIG. 13B shows vertices of degree three 1314, 1324, as well as qubits 1312A, 1312B, 1316, 1318, 1320, 1322A, 1322B, 1326, 1328, 1330. While for the MIS Hamiltonian Δ>0 is sufficient to energetically favor spins to be in the state |1 [symbol] and thus maximality of the ground state, this is not necessarily the case for the Rydberg Hamiltonian. This is in part due to long range interactions discussed throughout the present disclosure. In this case, the energy gain Δᵥ has to exceed the energy cost associated with the interaction energy of a spin v, with all other spins that are in state |1 [symbol] . In order to determine the required detuning that guarantees maximality, the interaction energy of a spin, v (such as qubit 1306 in FIG. 13A or qubits 1316 and 1326 in FIG. 13B) whose neighbors (on G) are all in state |0 [symbol] can be bounded with the rest of the system. In order to obtain a bound, the energy to a contribution can be split from distant spins (bounded by E_{dist}= [symbol] ( [symbol] /k⁵), see equation 29) and a contribution from the remaining “close” spins, B₁. The latter contribution from close spins is maximal if the spin v (1306, 1316, 1326) is directly neighboring to a vertex 1304 of degree 3. Since no two neighboring spins can be simultaneously in the state |1 [symbol] as long as Δᵥ<Δₘₐₓ, it can be upper bounded by

$${B}_{1} \leq 𝒰 {\sum }_{i = 1}^{∞} \frac{1}{{( 2 i )}^{6}} + 2 𝒰 {\sum }_{i = 1}^{∞} \frac{1}{{( {( 2 i - 1 )}^{2} + 1 )}^{3}} = 0.268031 \times 𝒰 .$$

The first term corresponds to the maximum interaction of spin v with spins on the same grid line (such as qubits 1304, 1310 in FIG. 13A, and qubits 1314, 1320 or 1324, 1330 in FIG. 13B), while the second term bounds the interaction with spins on the two perpendicular gridlines (such as 1302A, 1302B in FIG. 13A, or 1312A, 1312B, 1322A, 1322B in FIG. 13B).

The configuration shown in FIG. 13A corresponds to a non-maximal independent set configuration where three qubits (1304, 1306) are in the same state |0 [symbol] , according to some embodiments. It is energetically favorable to flip the spin 1306 if the detuning is Δᵥ>0.268031× [symbol] . [symbol] embedded on a grid. The configuration shown in FIG. 13B is another non-maximal independent set configuration with two domain walls 1318, 1328 along a straight segment. As discussed in more detail below, by merging the two domain walls (i.e., by flipping the spins along the straight segment such that only one domain wall exists), it is possible to obtain a defect-free configuration with one more spin in state |1 [symbol] . The increase in interaction energy between these two configurations can be bounded by 0.504748× [symbol] , where the state with one domain wall is the lowest energy configuration. Thus, for any given segment connecting two special vertices, such as vertices 1314, 1324, it is energetically favorable to include at most one domain wall.

Therefore, in some embodiments, the configuration of spins in the ground state of the Rydberg Hamiltonian corresponds to a maximal independent set on the associated UD graph (edge between nearest neighbor) if, C/D⁶≥Δᵥ≥0.268031×C/d⁶.

### Straight Segments

FIG. 13B shows an exemplary straight segment pseudo-spin, according to some embodiments. As explained below, such segments can be found in at most three states, shown in FIG. 12D.

The spins on each edge ε of the graph [symbol] are in an ordered configuration, such as a configuration where spins are alternating in state |0 [symbol] and |1 [symbol] , up to so called domain walls, where two (but not more) neighboring spins are in state |0 [symbol] . A MIS configuration on G has at most one such domain wall on any array of spins connecting two special vertices i and j such as 1314, 1324 in FIG. 13B, according to some embodiments. In order to ensure that the ground state of the Rydberg system respects this property, the detuning can be chosen to be large enough. For example, assuming such a straight segment is in an ordered state with n domain walls, when two such domain walls (1318, 1328) are combined an additional spin, v, can be flipped from state |0 [symbol] to state |1 [symbol] , lowering the single-particle contribution to the total energy by Δᵥ. The corresponding difference in interaction energy grows with the distance of the domain walls, for example, it is maximal if the two domain walls are initially on opposite ends of a segment connecting two junctions as shown in FIG. 13B. It can be bounded by E₂+E_{dist}, where

$$Equation 37$$

$$\frac{{E}_{2}}{𝒰} \leq {\sum }_{i , j = 1}^{∞} [ \frac{4}{{( {( 2 i - 1 )}^{2} + {( 2 j - 1 )}^{2} )}^{3}} - \frac{4}{{( {( 2 i - 1 )}^{2} + {( 2 j )}^{2} )}^{3}} ] + {\sum }_{i = 1}^{∞} \frac{1}{{( 2 i )}^{6}} \leq 0.490084 .$$

This bound can be understood with reference to FIG. 13B, where the zero-domain-wall configuration can be obtained from one with two domain walls by shifting the ordered spins on the middle bar 1340 (i.e., between the domain walls) one atom to the left in, and then flipping a spin next to the right junction to the state |1 [symbol] , according to some embodiments. Thus, the first sum corresponds to the interactions between the middle bar of the H-shape with the sides, and the last sum is the extra interaction from a new flipped spin. Thus (for large enough k where E_{dist} is negligible) it is favorable to merge two neighboring domain walls along a straight segment if

$${Δ}_{v} \geq {Δ}_{min} ≡ 0.490084 \times 𝒰 . \qquad Equation 38$$

Therefore, for Δₘᵢₙ<Δᵥ<Δₘₐₓ, the ground state of the Rydberg Hamiltonian is ordered on all segments connecting two special vertices, with at most one domain wall per segment. This justifies the assumption made with reference to FIG. 12D, that it is possible to restrict the analysis of the low energy sector to only 3 configurations of the structures B_{i,j}. In the first configuration, all spins alternate with different states on either end of the structure B_{i,j}. In the second configuration, the spin states on either end of the structure B_{i,j} are equal to 0, with one domain wall in between. In the third configuration, the spin states on either end of the structure B_{i,j} are equal to 1, with one domain wall in between. The detuning for all those spins can be set to be equal and in the above range, which can be denoted by AB.

Below, embodiments of special structures Aᵢ consisting of a vertex i and its 2q neighbors on each leg are described in more detail. The discussion can be restricted to states that are ordered in Aᵢ with at most one domain wall per leg. Detuning patterns can be selected for the spins in Aᵢ such that any such domain wall is energetically pushed away from spin, i, out of the structure Aᵢ. Without being bound by theory, with such a detuning only the two ordered states on Aᵢ have to be considered for the ground state.

### Corners

A corner vertex and the spins on the two legs, which can be collectively treated as a pseudo-spin, are considered first, such as those shown in embodiments of FIG. 12C. A detuning pattern consistent with Δₘₐₓ≥Δᵥ≥ Δₘᵢₙ can be applied such that only two configurations are relevant in the low energy sector (e.g., for the ground state). These are the two ordered states across the corner which correspond to the state of the corner spin, |0 [symbol] or |1 [symbol] , which can be denoted by s=0 and s=1 respectively.

In some embodiments, if the corner spin is in state |0 [symbol] , a domain wall can be formed where on one of the legs the two spins at distance 2p−2 and 2p−1 from the corner are in state |0 [symbol] . The domain wall can be moved by one unit (i.e. p→p+1) by flipping the state of the spins 2p−1 and 2p. The interaction energy increases in this process. Its amount can be bounded by [symbol] F₀(p)+ [symbol] ( [symbol] /k⁵) with

$${F}_{0} ( p ) = {\sum }_{i = 0}^{∞} [ \frac{1}{{( {( 2 i + 1 )}^{2} + {( 2 p - 1 )}^{2} )}^{3}} - \frac{1}{{( {( 2 i - 1 )}^{2} + {( 2 p )}^{2} )}^{3}} ] . \qquad Equation 39$$

Without being bound by theory, this bound can be understood as follows. Effectively, the one spin excitation is moved by one site towards the corner. While the interaction energy of this excitation with all spins on the same leg is reduced (such as where 2p<k), and thus is upper bounded by zero, the interaction energy with all spins on the other leg increases. Since any defect on this leg would decrease this interaction energy, the energy can be maximized if all spins on the other leg are in the perfectly ordered state, which gives the bound in equation 39.

While the interaction energy can increase in this process, the contribution from the single particle term to the total energy changes by Δ₂ₚ₋₁−Δ₂ₚ. Depending on the choice of the detuning, this can lead to an energy gain such that it is energetically favorable to move the domain wall by one unit away from the corner spin. Thus, the energy is minimized if the first 2q spins on each of the legs are in the perfectly ordered state if the corner spin is in state |0 [symbol] and the detuning for spins satisfy for p=1, 2 . . . , q:

$${Δ}_{2 p - 1} - {Δ}_{2 p} \geq 𝒰 {F}_{0} ( p ) , \qquad Equation 40$$

Similarly, if the corner spin is in state |1 [symbol] , the energy is minimized if the first 2q+1 spins on each of the leg are in the perfectly ordered state if detunings satisfy:

$${Δ}_{2 p} - {Δ}_{2 p + 1} \geq 𝒰 {F}_{1} ( p ) , with \qquad Equation 41$$

$${F}_{1} ( p ) = {\sum }_{i = 0}^{∞} [ \frac{1}{{( {( 2 i )}^{2} + {( 2 p )}^{2} )}^{3}} - \frac{1}{{( {( 2 i )}^{2} + {( 2 p + 1 )}^{2} )}^{3}} ] . \qquad Equation 42$$

The conditions in equations 40, 41 can be satisfied by the choice (for p=1, . . . , q):

$${Δ}_{2 p} = {Δ}_{∞} + 𝒰 {\sum }_{i = p}^{∞} [ {F}_{1} ( i ) + {F}_{0} ( i + 1 ) ] , \qquad Equation 43$$

$${Δ}_{2 p - 1} = {Δ}_{∞} + 𝒰 {\sum }_{i = p}^{∞} [ {F}_{0} ( i ) + {F}_{1} ( i ) ] . \qquad Equation 44$$

In some embodiments, these sums are convergent and can be efficiently evaluated numerically. Δₓ is monotonically decreasing with x and for large x approaches Δ_{∞}+ [symbol] ( [symbol] /x⁵). Moreover, the maximum value of Δₓ in this sequence can be evaluated to Δ₁=Δ_{∞}+0.134682× [symbol] . It is therefore possible to choose Δ_{∞} such that the detuning along the legs of the corner are within the required range.

With the above detuning pattern and the choice Δ∞≥AB, the ground state configuration is necessarily such that the 4q+1 spins forming a corner structure are in one of the two ordered states. These states can be labeled as s=0 and s=1 according to the corresponding state of the corner spin (|0 [symbol] and |1 [symbol] ).

Note that the choice in equations43, 44 fixes the detuning on all spins except the detuning of the corner spin, denoted Δ_{C}. This makes it possible to tune the relative energy between the two relevant configurations,

$${E}_{{A}_{i}}^{1} - {E}_{{A}_{i}}^{0}$$

for the ground state. Without being bound by theory, to calculate this difference, the quantity I_{C} can be defined as the difference in interaction energies between the two spin configurations,

$$\begin{matrix}\frac{{I}_{C}}{𝒰} = {\sum }_{i = 1}^{q} {\sum }_{j = 1}^{q} [ \frac{1}{{( {( 2 i + 1 )}^{2} + {( 2 j - 1 )}^{2} )}^{3}} - \frac{1}{{( {( 2 i )}^{2} + {( 2 j )}^{2} )}^{3}} ] - \\ 2 {\sum }_{i = 1}^{q} \frac{1}{{( 2 i )}^{6}} \\ = 0.0932973 + O ( 𝒰 / {q}^{5} ) .\end{matrix} \qquad Equation 45$$

Similarly, without being bound by theory, the difference in energy ( [symbol] ) of the two configurations due to the single particle term can be calculated as:

$$\begin{matrix}{𝒟}_{C} = {Δ}_{C} + 2 {\sum }_{p = 1}^{q} ( - {Δ}_{2 p - 1} + {Δ}_{2 p} ) \\ = {Δ}_{C} - 𝒰 \times 0.237094 + O ( 𝒰 / {q}^{5} )\end{matrix} \qquad Equation 46$$

For the corner structures,

$${E}_{{A}_{i}}^{1} - {E}_{{A}_{i}}^{0} = - {D}_{C} - {I}_{C} ,$$

this can be evaluated to

$${E}_{{A}_{i}}^{1} - {E}_{{A}_{i}}^{0} = - {Δ}_{C} + 0.143 \; 797 \times 𝒰 + O ( 𝒰 / {q}^{5} ) \qquad Equation 47$$

which can be fully tuned by the detuning of the corner spin. Thus, in some embodiments, corner structures can be treated as having only two configurations.

### Junctions

In some embodiments, junctions, such as that shown in FIG. 13A can be treated in a similar way as corners. For example, the spin at the junction and adjacent spins can be treated as a pseudo-spin. A detuning pattern on the legs of a junction can be chosen such that it is energetically favorable to push domain walls away from the junction, such that in the ground state, a junction can only be in one of the two ordered configurations, according to some embodiments. In this way, junctions also can be described by at most two states defined by the state of the 3-way junction vertex.

First, with reference to central spin, such as the degree-3 vertex 1304 in FIG. 13A, which can be in state |0 [symbol] , the three legs can be referred to by X, Y and Z, where for concreteness X and Z are on the same gridline (e.g., corresponding to spins continuing from vertices 1302A, 1302B) with Y being perpendicular thereto (e.g., corresponding to spins continuing from vertex 1306), according to some embodiments. In a situation where two vertices on leg X at a distance 2p−2 and 2p−1 from the central vertex are in state |0 [symbol] and thus form a domain wall, in order to push this domain wall one unit away from the vertex, the state of vertices 2p−1 and 2p has to be flipped. The interaction energy required to do so is bounded, in some embodiments, by [symbol] F₀(p). Note that this bound can hold true regardless of whether (or where) on legs Y and Z a domain wall is present. Similarly, the interaction energy required to push a domain wall on leg Y by one unit from the corner can be bounded by 2 [symbol] F₀(p).

In the other case, i.e. if the central vertex is in state |1 [symbol] , similar bounds can be found. If the two vertices on leg X at a distance 2p−1 and 2p from the central vertex are in state |0 [symbol] , the interaction energy will be increased when the states of vertices 2p and 2p+1 are flipped, i.e. when the domain wall is pushed away from the center by one unit. The interaction energy required to push the domain wall on leg X by one unit can therefore be bounded by [symbol] F₁(p). This bound can be valid independently of the configuration of the spins on legs Y and Z. The interaction energy required to push a domain wall on leg Y by one unit from the corner can be bounded by 2 [symbol] F₁(p).

Therefore, in some embodiments, the state that minimizes the energy may not contain any domain wall on the first 2q+1 spins on each leg if the detuning pattern satisfies

$${Δ}_{2 p - 1}^{( X )} - {Δ}_{2 p}^{( X )} \geq 𝒰 {F}_{0} ( p ) , \qquad Equation 48$$

$${Δ}_{2 p - 1}^{( Y )} - {Δ}_{2 p}^{( Y )} \geq 2 𝒰 {F}_{0} ( p ) , \qquad Equation 49$$

$${Δ}_{2 p}^{( X )} - {Δ}_{2 p + 1}^{( X )} \geq 𝒰 {F}_{1} ( p ) , \qquad Equation 50$$

$${Δ}_{2 p}^{( Y )} - {Δ}_{2 p + 1}^{Y} \geq 2 𝒰 {F}_{1} ( p ) , \qquad Equation 51$$

for p=1, 2, . . . q, and

$${Δ}_{v}^{( Z )} = {Δ}_{v}^{( X )} .$$

### Here

$${Δ}_{v}^{( σ )}$$

denotes the detuning or the v-th spin on leg σ. Without being bound by theory, this can be achieved by the following:

$${Δ}_{2 p}^{( X )} = {Δ}_{∞} + 𝒰 {\sum }_{i = p}^{∞} ( {F}_{1} ( i ) + {F}_{0} ( i + 1 ) ) , \qquad Equation 52$$

$${Δ}_{2 p - 1}^{( X )} = {Δ}_{∞} + 𝒰 {\sum }_{i = p}^{∞} ( {F}_{0} ( i ) + {F}_{1} ( i ) ) , \qquad Equation 53$$

$${Δ}_{2 p}^{( Y )} = {Δ}_{∞} + 2 𝒰 {\sum }_{i = p}^{∞} ( {F}_{1} ( i ) + {F}_{0} ( i + 1 ) ) , \qquad Equation 54$$

$${Δ}_{2 p - 1}^{( Y )} = {Δ}_{∞} + 2 𝒰 {\sum }_{i = p}^{∞} ( {F}_{0} ( i ) + {F}_{1} ( i ) ) , \qquad Equation 55$$

### Where

$${Δ}_{v}^{( Z )} = {Δ}_{v}^{( X )} .$$

For the Choice above, the maximum value of

$${Δ}_{v}^{( σ )}$$

in this sequence can evaluate to

$${Δ}_{1}^{( Y )} = {Δ}_{∞} + 0.26 \; 9364 \times 𝒰 .$$

Thus, all the detunings on the legs of a junction Aᵢ are within the range [Δ_{∞}, Δ_{∞}+0.269364× [symbol] ]. It is therefore possible to choose Δ_{∞} such that all of them are in the allowed range, Δₘᵢₙ<Δᵥ<Δₘₐₓ. With the additional choice Δ_{∞}>Δ_{B}, it can be seen that, in some embodiments, only the two ordered configurations are relevant for the ground state.

Analogous to the situation of corner structures, the detuning of the junction spin, denoted Δ_{J} can be used to tune the relative energy between the two relevant configurations of the junction. Without being bound by theory, the difference in interaction energies of the two spin configurations in this structure can be given by

$$\frac{{I}_{J}}{𝒰} = {\sum }_{i = 1}^{q} {\sum }_{j = 1}^{q} ( \frac{1}{{( 2 i - 2 + 2 j )}^{6}} - \frac{1}{{( 2 i + 2 j )}^{6}} ) - 3 {\sum }_{i = 1}^{q} \frac{1}{{( 2 i )}^{6}} + 2 {\sum }_{i = 1}^{q} {\sum }_{j = 1}^{q} ( \frac{1}{{( {( 2 i - 1 )}^{2} + {( 2 j - 1 )}^{2} )}^{3}} - \frac{1}{{( {( 2 i )}^{2} + {( 2 j )}^{2} )}^{3}} ) , \qquad Equation 56$$

which can be evaluated to I_{J}=0.218387× [symbol] + [symbol] ( [symbol] /q⁵). Similarly, the difference in energy of the two configurations due to the single particle terms can be calculated as

$${𝒟}_{J} = {Δ}_{J} + 4 𝒰 {\sum }_{p = 1}^{q} {\sum }_{i = p}^{∞} ( - {F}_{0} ( i ) + {F}_{0} ( i + 1 ) ) \qquad Equation 57$$

which can be evaluated to [symbol] _{J}=Δ_{J}−0.474188× [symbol] + [symbol] ( [symbol] /q⁵). Without being bound by theory, the quantity

$${E}_{{A}_{i}}^{1} - {E}_{{A}_{i}}^{0} = - {𝒟}_{J} - {I}_{J}$$

can therefore be written as

$${E}_{{A}_{i}}^{1} - {E}_{{A}_{i}}^{0} = - {Δ}_{J} + 0.22 \; 5881 \times 𝒰 + O ( 𝒰 / {q}^{5} ) . \qquad Equation 58$$

### Other Special Vertices

Without being bound by theory, some embodiments include other special vertices described above in addition to vertices at corners and junctions. These are vertices of degree 1 (open ends, such as A₁₂ in FIG. 12B), vertices on a grid point with two legs on the same grid line (straight structures, such as A₁₃ in FIG. 12B), and irregular vertices (such as A₁₄ in FIG. 12B). These special vertices can be treated as pseudo-spins, as described in more detail below. The analysis in the previous two sections can be repeated for all such vertices, thereby showing that these two can be described as being in one of two states.

### Open Ends.

In some embodiments, energy can be lowered if a domain wall is moved away from a spin at the end of an open leg if the detuning is constant for the spins on that leg. Therefore, the pseudo-spin states can be restricted to the two ordered configurations on the 2q spins adjacent to the spin at the end of an open leg. Without being bound by theory, the energy difference between the two states of such an open leg can be denoted by:

$${E}_{{A}_{i}}^{1} - {E}_{{A}_{i}}^{0} = - {Δ}_{O} + 𝒰 {\sum }_{i = 1}^{q} \frac{1}{{( 2 i )}^{6}} = - {Δ}_{O} + 0.015896 \times 𝒰 + 𝒪 ( 𝒰 / {q}^{5} ) \qquad Equation 59$$

where Δ_{O} is the detuning for the spin corresponding to the vertex of degree 1. The homogenous detuning on the 2q spins adjacent to the latter can be chosen to be equal to Δ_{∞}.

### Straight Structures.

In some embodiments, for a regular special vertex, the relevant configurations for the ground state can be restricted to two ordered states by choosing a detuning for all 4q spins on the leg as Δ_{∞}>Δ_{B}. With this choice it would be energetically favorable to move a potential domain wall into the adjacent neighboring regions. Without being bound by theory, the energy difference can be denoted by:

$${E}_{{A}_{i}}^{1} - {E}_{{A}_{i}}^{0} = - {Δ}_{S} + 𝒰 {\sum }_{i = 1}^{2 q} \frac{1}{{( 2 i )}^{6}} = - {Δ}_{S} + 0.015896 \times 𝒰 + 𝒪 ( 𝒰 / {q}^{5} ) \qquad Equation 60$$

where Δ_{S} denotes the detuning of the special vertex.

### Irregular Structures.

In some embodiments, irregular vertices can be treated identically to straight structures. Since the spacing of the spins close to the irregular vertex is slightly larger than elsewhere (e.g., because irregular structures can be defined as structures where the spacing between vertices is larger than in ordinary structures to ensure that the number of ancillary vertices on each edge is even), any domain wall will be pushed away from the irregular structure naturally, if the detuning in the irregular structure is larger than AB. Thus, only the two ordered configurations are relevant for the ground state. The corresponding energy difference can be numerically evaluated for every choice of ϕ (which can indicate how ancillary vertices are positioned). In the large ϕ (and q) limit, it is possible to obtain the same analytic expression as in equation 60.

### Effective Energy

In some embodiments, it is possible to determine the effective detuning Δ_{eff} of the pseudo-spins (such as the straight segments, corners, junctions, and other special vertices described above that can be described as having a limited set of states in the ground state) and their effective interaction energies

$${U}_{i , j}^{eff} .$$

In some embodiments, knowing the effective detunings and effective interactions of pseudospins allows for encoding of the problem to be effectively solved.

### Effective Interactions

In some embodiments and without being bound by theory, the discussion above with reference to straight segments, corners, junctions, and other special vertices can rely on the concept that only four spin configurations are relevant in each region B_{i,j} to describe the ground state. These correspond to the four possible configurations of the spins in the adjacent regions Aᵢ and Aⱼ. For example, if the detuning in B_{i,j} is set to be homogeneous, AB, if sᵢ=1 and sⱼ=0 (or vice versa), the lowest energy configuration should correspond to the perfectly ordered state on B_{i,j} (with b_{i,j} spins in state |1 [symbol] , with b vertices in the set B), if Δₘₐₓ>Δ_{B}>Δₘᵢₙ. Any other configuration would require at least two domain walls. Second, if sᵢ=sⱼ=0 then energy can be lowered by arranging the spins in B_{i,j} in an ordered configuration with b_{i,j} spins in state |1 [symbol] , and one domain wall. The position of this domain wall does not change the energy up to [symbol] ( [symbol] /k⁵), such that there is no need to distinguish between the different domain wall configurations. Finally, if sᵢ=sⱼ=1 the lowest energy configuration is similarly achieved by an ordered configuration with one domain wall, if Δₘₐₓ≥Δ_{B}>Δₘᵢₙ. While the position of the domain wall can be irrelevant, only b_{i,j}−1 spins are in state |1 [symbol] in this state.

Without being bound by theory, in some embodiments, the relevant energy differences between these different relevant configurations can be readily calculated, as

$${E}_{{B}_{i , j}}^{1 , 0} - {E}_{{B}_{i , j}}^{0 , 0} = 𝒰 {{\sum }_{r = 1}}^{⌈ \frac{{b}_{i , j}}{2} ⌉} {{\sum }_{s = 1}}^{⌊ \frac{{b}_{i , j}}{2} ⌋} ( \frac{1}{{( 2 r + 2 s - 2 )}^{6}} - \frac{1}{{( 2 r + 2 s - 1 )}^{6}} ) \qquad Equation 61$$

If Aᵢ and Aⱼ are not connected, this can be zero. Else, this term becomes independent of i and j in the large q and k limit, since b_{i,j}= [symbol] (k), and evaluates to

$${E}_{B}^{1 , 0} - {E}_{B}^{0 , 0} = 0.01466 \; 37 \times 𝒰 + 𝒪 ( 𝒰 / {k}^{5} ) \qquad Equation 62$$

Similarly,

$${E}_{B}^{1 , 1} - {E}_{B}^{1 , 0}$$

can be calculated as

$$\begin{matrix}{E}_{B}^{0 , 0} - {E}_{B}^{1 , 0} = {E}_{B}^{1 , 1} - {E}_{B}^{1 , 0} - {Δ}_{B} + 𝒰 {{\sum }_{r = 1}}^{⌈ \frac{{b}_{i , j}}{2} ⌉ - 1} \frac{1}{{( 2 r )}^{6}} + 𝒰 {{\sum }_{r = 1}}^{⌊ \frac{{b}_{i , j}}{2} ⌋} \frac{1}{{( {b}_{i , j} + 2 r )}^{6}} \\ = {E}_{B}^{1 , 1} - {E}_{B}^{1 , 0} + {Δ}_{B} + 0.015896 \times 𝒰 + 𝒪 ( 𝒰 / {k}^{5} )\end{matrix} \qquad Equation 63$$

Thus, in some embodiments the effective interaction between pseudo-spins

$${U}_{i , j}^{eff} = {U}_{eff} = {E}_{B}^{1 , 1} + {E}_{B}^{0 , 0}$$

can be written as

$${U}^{eff} = {Δ}_{B} - 0.01343 \; 13 \times 𝒰 + 𝒪 ( 𝒰 / {k}^{5} ) . \qquad Equation 64$$

In such embodiments, the effective interaction depends only on the choice of the detuning in the connecting structures, Δ_{B}, thereby allowing for control of the effective interactions for specifying problems.

### Effective Detuning

In some embodiments, the effective detuning for a pseudo spin can be given by

$${Δ}_{i}^{eff} = {E}_{{A}_{i}}^{0} - {E}_{{A}_{i}}^{1} - {m}_{i} ( {E}_{B}^{1 , 0} - {E}_{B}^{0 , 0} ) ,$$

where mᵢ is he degree of the special vertex, i (i.e. mᵢ=2 for corner vertices and straight structures, mᵢ=3 for junctions, and mᵢ=1 for open legs). The value of

$${E}_{{A}_{i}}^{0} - {E}_{{A}_{i}}^{1}$$

can be fully tuned by the choice of the detuning of spin i. This can be chosen such that a homogeneous effective detuning,

$${Δ}_{i}^{eff} = {Δ}^{eff} ,$$

can be used for all four types of pseudo-spins. This can be achieved by

$${Δ}_{C} = {Δ}^{eff} + 0.173124 \times 𝒰 , \qquad Equation 65$$

$${Δ}_{J} = {Δ}^{eff} + 0.2997 \; 92 \times 𝒰 , \qquad Equation 66$$

$${Δ}_{O} = {Δ}^{eff} + 0.03055 \; 97 \times 𝒰 , \qquad Equation 67$$

$${Δ}_{S} = {Δ}^{eff} + 0.04522 \; 34 \times 𝒰 . \qquad Equation 68$$

This is compatible with Δₘₐₓ≥Δᵥ≥Δₘᵢₙ and the realization of an effective spin model with 0<Δ^{eff}<U^{eff}. In some embodiments, where this inequality is satisfied, the solution of the effective model can coincide with the solution of the hard problem to be solved.

### Example QAOA Implementations

In some embodiments, additional considerations are relevant to implementing the QAOA techniques described in the present disclosure. The framework of QAOA is general, however, and can be applied to various technical platforms to solve combinatorial optimization problems.

### Finite Measurement Samples

In some embodiments, quantum fluctuations (such as projection noise) can result in finite precision since the precision can be obtained via averaging over finitely many measurement outcomes that can only take on discrete values. Hence, there can be a trade-off between measurement cost and optimization quality: finding a good optimum can require good precision at the cost of a large number of measurements. Additionally, large variance in the objective function value can demand more measurements but may help improve the chances of finding near-optimal MaxCut configurations.

Without being bound by theory, as an example, the effect of measurement projection noise can be demonstrated with a full Monte-Carlo simulation of QAOA on some example graphs, where an objective function is evaluated by repeated projective measurements until its error is below a threshold. Exemplary implementation details of this numerical simulation are discussed in the section titled “Exemplary simulation with measurement projection noise.”

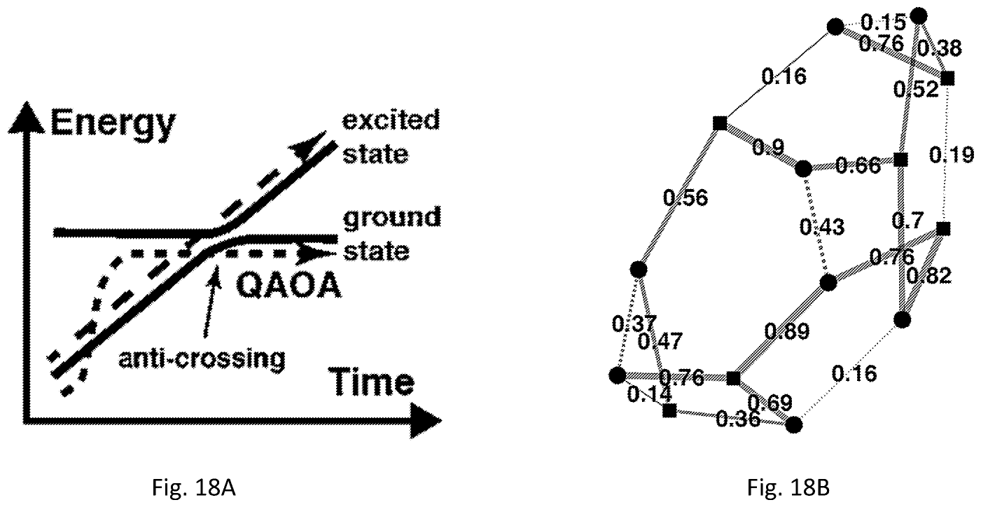

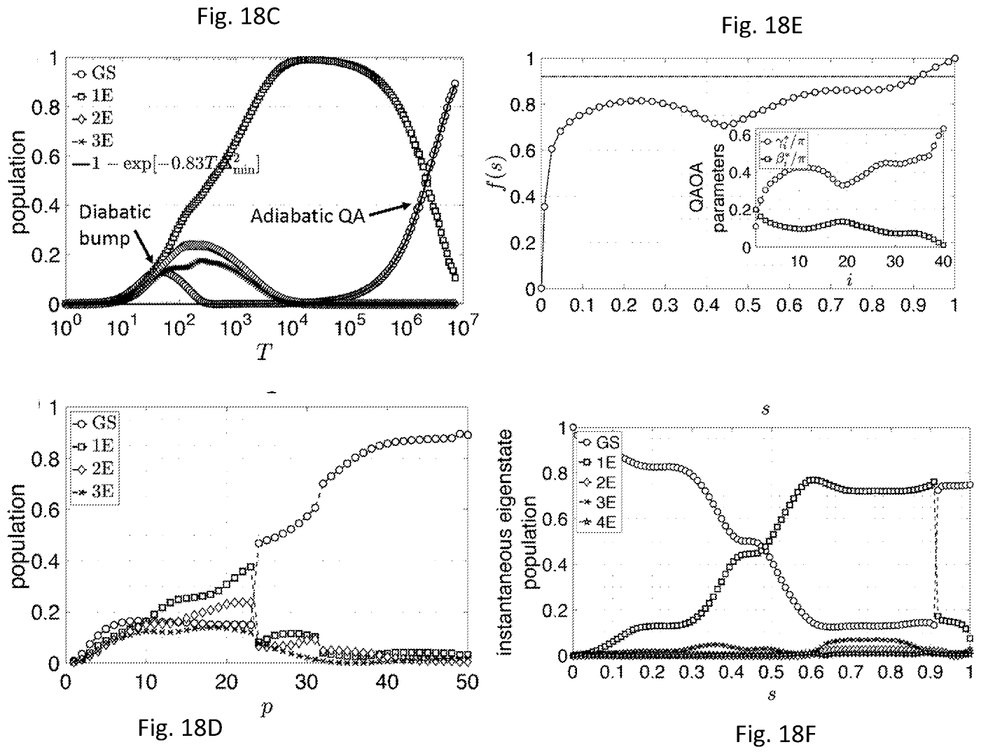

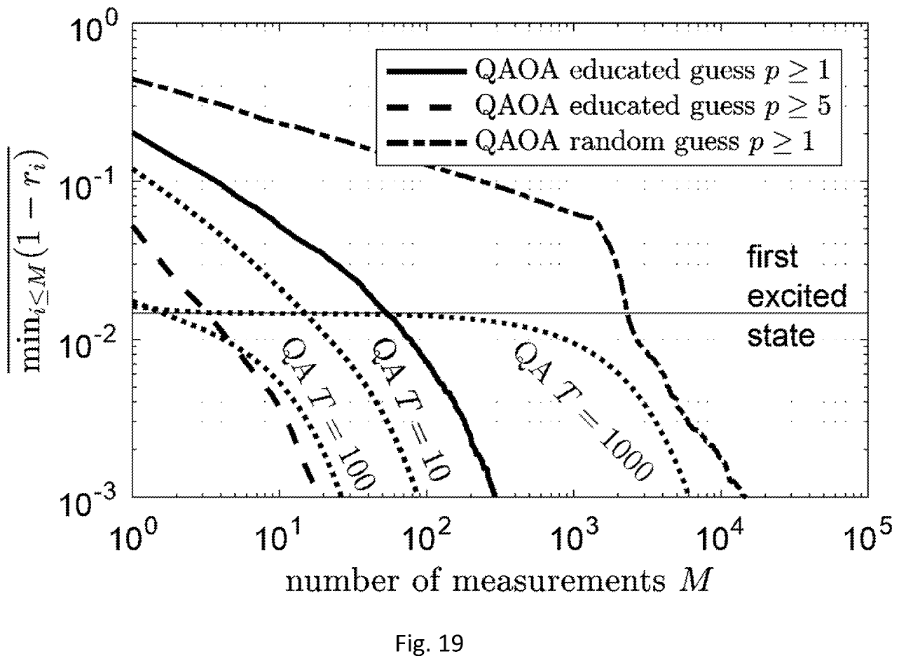

FIG. 19 shows Monte-Carlo simulation of QAOA accounting for measurement projection noise, on the example instance studied in FIG. 18B, according to some embodiments. Simulated QAOA is optimized with embodiments of the disclosed FOURIER heuristic starting at level either p=1 or p=5 μsing an educated choice of initial parameters based on known optima found for small size instances. The approximation ratio rᵢ=|Cutᵢ|/|MaxCut| is tracked from the i-th measurement, and the minimum fractional error 1−rᵢ found after M measurements is plotted, averaged over many Monte-Carlo realizations. The solid and dashed lines correspond to QAOA optimized with the FOURIER strategy starting with an educated guess of (\vec{γ}, \vec{β}) at p=1 and p=5, respectively, and increasing p by 1 after a local optimum is found. A local optimum can be presumed to be found if the new candidate parameter vector norm changes by less than 0.01, or when the average Cutᵢ changes by less than 0.1. The dash-dot line corresponds to QAOA optimized starting with randomly guessed (\vec{γ}, \vec{β}) at p=1, and increasing p by 1 after a local optimum is found. The three labelled dotted lines are results from repeatedly running QA with total time T=10, 10², 10³, and performing measurements on the output state.

As shown in FIG. 19, QAOA can find the MaxCut solution in ˜10-10² measurements, and starting embodiments of the disclosed optimization at intermediate level (p=5) is better than starting at the lowest level (p=1). In comparison, some embodiments with random choices of initial parameters starting at p=1 perform worse, which fail to find the MaxCut solution until 10³-10⁴ measurements have been made. Moreover, if QAOA is compared to QA with various annealing time, it appears that the choice of annealing time T=100 can perform just as well as QAOA on this instance. Nevertheless, running QAOA at level p=5 is still more advantageous than QA at T=100, in some embodiments, when coherence time is limited.

While this exemplary simulation is limited to small-size instances, the good performance of QAOA and QA can be complicated by the small but significant ground state population from generic annealing schedules. Since it can take 10² measurements to obtain a sufficiently precise estimate of the objective function, a ground state probability of ≥10⁻² would mean that one can find the ground state without much parameter optimization. In some embodiments, for larger problem sizes with 10²˜10³ qubits, the ground state probability from generic QAOA/QA protocol without optimization can decrease exponentially with system size, whereas the measurement cost of optimization grows merely polynomially with the problem size. The results here indicate that the parameter pattern and the disclosed heuristic strategies are practically useful guidelines in realistic implementation of QAOA that leverages optimization to significantly increase the probability of finding the ground state.

### Implementation for Large Problem Sizes

Implementing a solution to the MaxCut problems with quantum machines can be limited by quantum coherence time and graph connectivity. In some embodiments, in terms of coherence time, QAOA is highly advantageous: the hybrid nature of QAOA as well as its short- and intermediate-depth circuit parametrization makes it useful for quantum devices. In addition, QAOA is not generally limited by the small spectral gaps, which demonstrates that interesting problems can be solved (or at least approximated) within the coherence time.

### Performance of Heuristically Optimized QAOA

### Comparison Between Heuristics Embodiments and Brute-Force

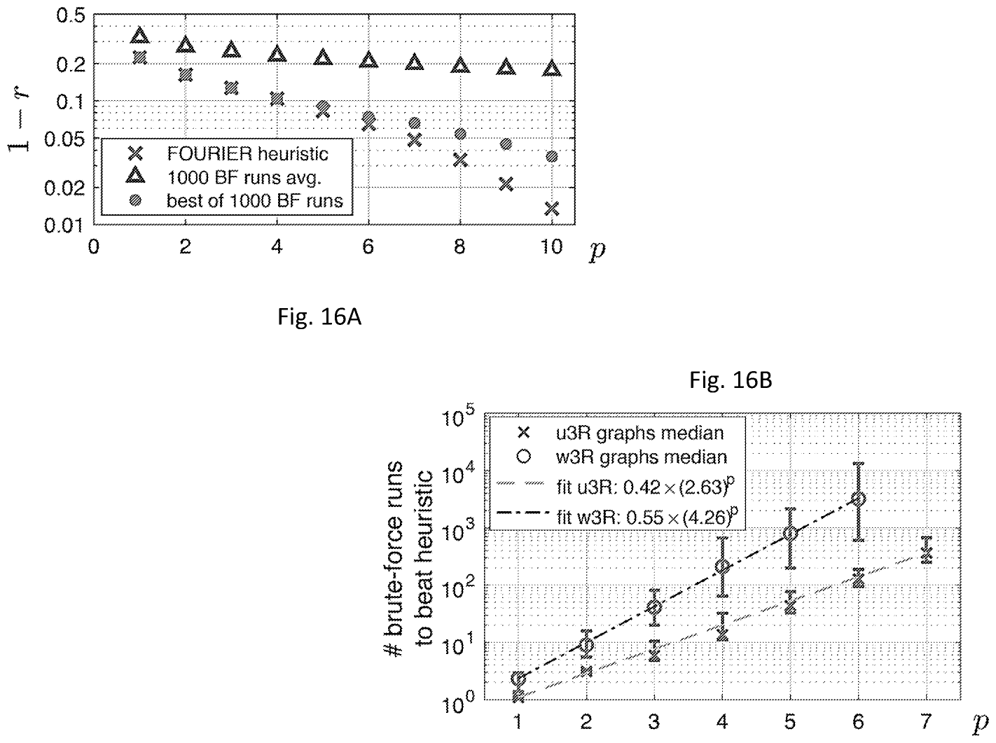

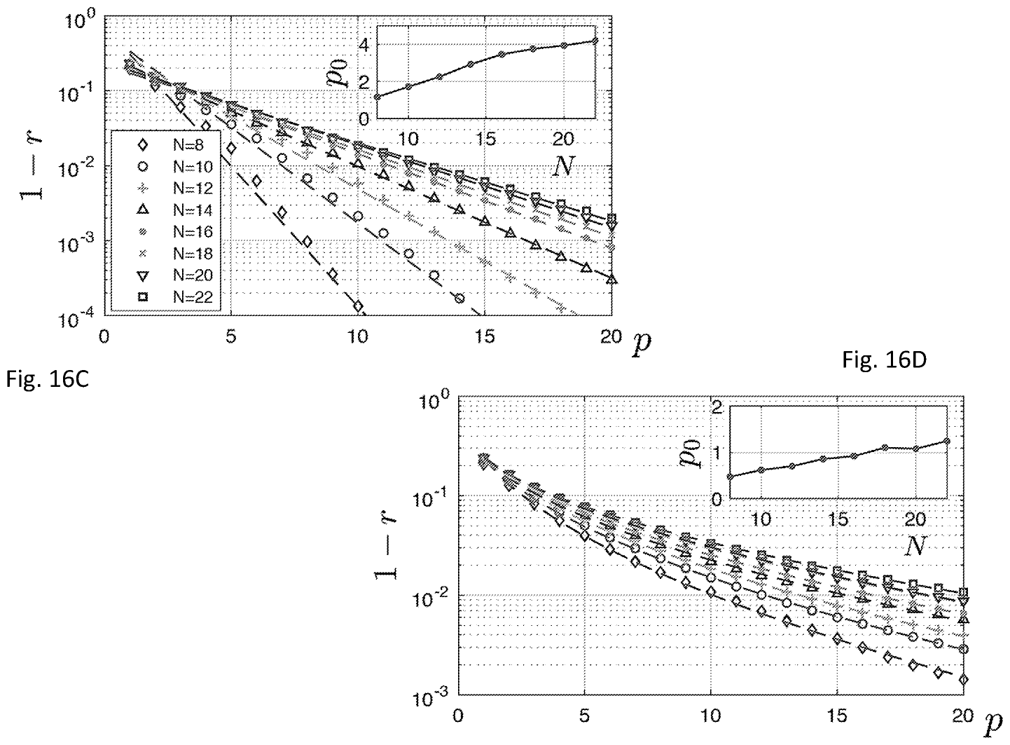

According to some embodiments, non-limiting comparisons of exemplary heuristic strategies to exemplary brute-force approaches can be evaluated. For example, FIG. 16A shows a comparison between an exemplary FOURIER heuristic and the brute-force (BF) approach for optimizing QAOA, on an example instance of 16-vertex w4R graph, according to some embodiments. The value of 1−r, where r is the approximation ratio, is plotted as a function of QAOA level p on a log-linear scale. The brute-force points are obtained by optimizing from 1000 randomly generated starting points, averaged over 10 such realizations. At low p, the exemplary FOURIER heuristic strategies perform just as well as the best out of 1000 brute-force runs—both are able to find the global optimum. The average performance of the brute-force strategy, on the other hand, is much worse than the disclosed heuristics. This indicates that the QAOA parameter landscape can be highly non-convex and filled with low-quality, non-degenerate local optima. When p≥5, the exemplary FOURIER heuristic outperforms the best brute-force run.

To estimate the number of brute-force runs needed to find an optimum with the same or better approximation ratio as the exemplary FOURIER heuristics, brute-force optimization was performed on 40 instances of 16-vertex u3R and w3R graphs with up to 40000 runs, as shown in FIG. 16B, according to some embodiments. In particular, FIG. 16B shows the median number of brute-force runs needed to obtain an approximation ratio as good as an exemplary FOURIER heuristic, for 40 instances of 16-vertex u3R and w3R graphs. A log-linear scale is used, and exponential curves are fitted to the results. Error bars are 5th and 95th percentiles. In FIG. 16B, the median number of brute-force runs needed to beat the exemplary FOURIER heuristic is shown to scale exponentially with p. Hence, the embodiments of the disclosed heuristics offer a dramatic improvement in the resource required to find good parameters for QAOA. As verified with an excessive number of brute-force runs, the heuristics often find the global optima.

Although most examples discussed in the present disclosure use gradient-based methods (BFGS) in numerical simulations, non-gradient based approaches, such as the Nelder-Mead method, can be used with the disclosed heuristic strategies. The choice to use gradient-based optimization can be motivated by the simulation speed, which in some implementations is faster with gradient-based optimization. In other embodiments, other procedures can be used.

### Performance of QAOA on Typical Instances

Using embodiments of the disclosed heuristic optimization strategies in hand, the performance of intermediate p-level QAOA on many graph instances can be examined. For example, it is possible to consider many randomly generated instances u3R and w3R graphs with vertex number 8≤N≤22 and use embodiments of the disclosed FOURIER strategy to find optimal QAOA parameters for level p≤20. In the following discussion, the fractional error 1−r is used to assess the performance of QAOA.

In one example, the case of unweighted graphs, specifically u3R graphs can be considered. For example, FIGS. 16C and 16D plot the fractional error 1−r as a function of QAOA's level p. The exemplary results shown in FIGS. 16C and 16D were obtained by applying embodiments of the disclosed heuristic FOURIER optimization strategies to up to 100 random instances of u3R graphs (FIG. 16C) and w3R graphs (FIG. 16D). Lines with different shapes correspond to fitted lines to the average for different system size N, where the model function is 1−r∝e^{-p/p}^{₀} for unweighted graphs and

$$1 - r ∝ {e}^{- \sqrt{p / {p}_{0}}}$$

for weighted graphs. Insets show the dependence of the fit parameters p₀ on the system size N.

As shown in FIG. 16C, on average, 1−r∝e^{-p/p}^{₀} appears to decay exponentially with p in some embodiments. Note that since the instances studied were u3R graphs with system size N≤22, where Cₘₐₓ≤|E|≤33, such embodiments prepared the MaxCut state in virtually all scenarios where the fractional error goes below ˜10⁻². Without being bound by theory, this good performance can be understood by interpreting QAOA as Trotterized quantum annealing, especially when the optimized parameters are of the pattern seen in FIGS. 15C-15H, where initialization is in the ground state of −H_{B} and the system then evolves with H_{B} (and H_{C}) with smoothly decreasing (and increasing) durations. The equivalent total annealing time T can be approximately proportional to the level p, since the individual parameters γᵢ, βᵢ=O(1) and can correspond to the evolution times under H_{C} and H_{B}. If T is much longer than

$$1 / {Δ}_{min}^{2} ,$$

where Δₘᵢₙ is the minimum spectral gap (which can govern the application of quantum annealing algorithm (QAA), for example, by requiring a long time T to run where the spectral gap is small), quantum annealing can find the exact solution to MaxCut (ground state of −H_{C}) by the adiabatic theorem, and achieve exponentially small fractional error as predicted by the Landau-Zener formula. Numerically, the minimum gaps of these u3R instances when running quantum annealing can be determined to be on the order of Δₘᵢₙ≥0.2 in some embodiments. It is thus not surprising that QAOA can achieve exponentially small fractional error on average of exemplary embodiments, since it can prepare the ground state of −H_{C} through the adiabatic mechanism for these large-gap instances. Nevertheless, this exponential behavior can break down for some hard instances, where the gap is small.

As shown in FIG. 16D, in the case of w3R graphs, the fractional error appears to scale as

$$1 - r ∝ {e}^{- \sqrt{p / {p}_{0}}} ,$$

according to some embodiments. In some embodiments, the stretched-exponential scaling is true in the average sense, while individual instances have very different behavior. For easy instances whose corresponding minimum gaps Δₘᵢₙ are large, exponential scaling of the fractional error can be found. For more difficult instances whose minimum gaps are small, fractional errors reach plateaus at intermediate p, before decreasing further when p is increased. These hard instances are discussed in more detail in the section below titled “Adiabatic Mechanisms, Quantum Annealing, and QAOA.” Notably, when averaged over randomly generated instances, the fractional error is fitted remarkably well by a stretched-exponential function.

These results of average performance of embodiments of QAOA are notable despite considerations of finite-size effect. While the decay constant p₀ does appear to depend on the system size N as shown in the insets of FIG. 16C, 16D, the exemplary finite-size simulations shown in the present disclosure may not conclusively determine the exact scaling. In some embodiments, if the trend continues to system size of N=100˜1000, then QAOA will be practically useful in solving interesting MaxCut instances, better or on par with other known algorithms, in a regime where finding the exact solution will be infeasible (i.e., it will be an effective quantum approximator). Even if QAOA fails for some worst-case graphs, it can still be practically useful, if it performs well on a randomly chosen graph of large system size.

### Comparison Between Heuristics

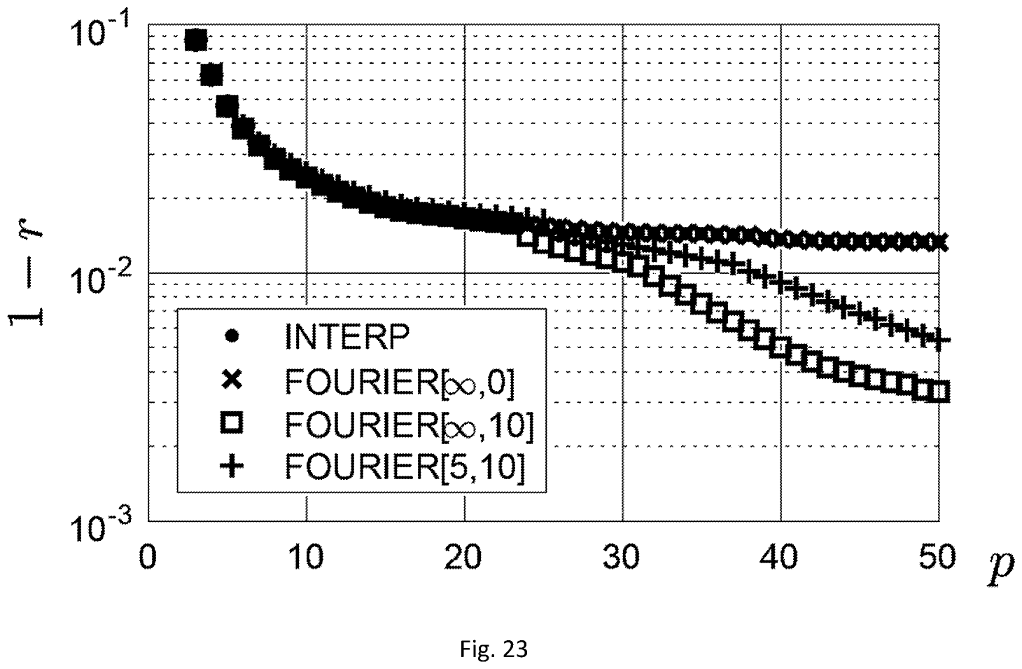

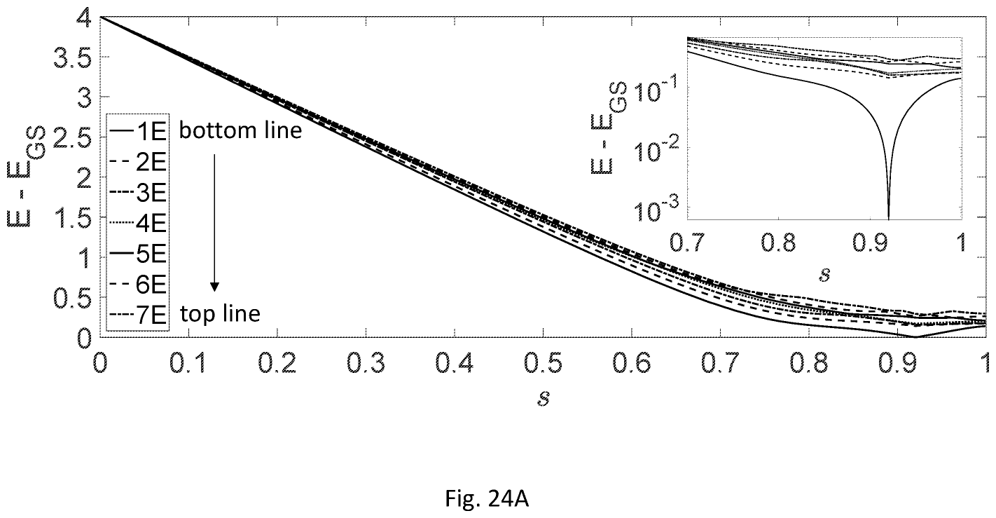

The difference in the performance among embodiments of the various heuristic strategies proposed in the present disclosure can be examined on an example instance of 14-vertex w3R graph. As shown in FIG. 23, exemplary embodiments of INTERP and FOURIER[∞, 0] strategies disclosed herein have essentially identical performance (except for small variations barely visible at large p), according to some embodiments. This can be explained by considering that both strategies generate starting points for optimizing level p+1 based on smooth deformation of the optimum at level p, in some embodiments. Furthermore, the FOURIER[∞, 10] strategy outperforms INTERP and FOURIER[∞, 0] beginning at level p≥20. Notably, even when restricting the number of QAOA parameters to 2q=10, the FOURIER[q=5,R=10] strategy closely matches the performance of other heuristics at low p and beats the R=0 heuristic at large p. This suggests that the optimal QAOA parameters may in fact exist in a small-dimensional manifold. Therefore, optimization for intermediate p-level QAOA can be dramatically simplified by using the disclosed parameterization (\vec{u}, \vec{v}).

### Adiabatic Mechanism, Quantum Annealing, and QAOA

The previous section discussed the performance of embodiments of QAOA for MaxCut on random graph instances in terms of the approximation ratio r. Although useful for approximate optimization, QAOA is often able to find the MaxCut configuration—the global optimum of the problem—with a high probability as level p increases. In this section, the efficiencies of example embodiments of the disclosed algorithms are shown to find the MaxCut configuration and compare it with quantum annealing. In some embodiments, QAOA is not necessarily limited by the minimum gap in the quantum annealing and explain a mechanism at work that allows it to overcome the adiabatic limitations.

Comparing QAOA with Quantum Annealing

A predecessor of QAOA, quantum annealing (QA) can be used for solving combinatorial optimization problems. Without being bound by theory, to find the MaxCut configuration that maximizes (H_{C}), the following simple QA protocol can be considered:

$$\begin{matrix}{H}_{Q A} ( s ) = - [ s {H}_{C} + ( 1 - s ) {H}_{B} ] , & s = t / T ,\end{matrix} \qquad Equation 69$$

where t∈[0, T] and T is the total annealing time. The initial state can be prepared to be the ground state of H_{QA}(s=0), i.e., |ψ(0) [symbol] =|+ [symbol] . The ground state of the final Hamiltonian, H_{QA}(s=1), can correspond to the solution of the MaxCut problem encoded in H_{C}. In adiabatic QA, the algorithm can rely on the adiabatic theorem to remain in the instantaneous ground state along the annealing path and solves the computational problem by finding the ground state at the end. To ensure a high probability of success, the run time of the algorithm typically scales as

$$T = O ( 1 / {Δ}_{min}^{2} ) ,$$

where Δₘᵢₙ is the minimum spectral gap. Consequently, adiabatic QA becomes inefficient for instances where Δₘᵢₙ is extremely small. These graph instances can be referred to as hard instances for adiabatic QA.

In some embodiments beyond the completely adiabatic regime, there is often a tradeoff between the success probability (ground state population p_{GS}(T)) and the run time (annealing time T): either algorithm can be run with a long annealing time to obtain a high success probability, or it can be run multiple times at a shorter time to find the solution at least once. One metric that can be used to determine the best balance can be referred to as the time-to-solution (TTS):

$$T T {S}_{Q A} ( T ) = T \frac{ln ( 1 - {p}_{d} )}{ln [ 1 - {p}_{G S} ( T ) ]} \qquad Equation 70$$

$$TT {S}_{Q A}^{o p t} = {min}_{T > 0} {TTS}_{Q A} ( T ) . \qquad Equation 71$$

TTS_{QA}(T) can measure the time required to find the ground state at least once with the target probability p_{d} (taken to be 99% in the present disclosure), neglecting non-algorithmic overheads such as state-preparation and measurement time. The adiabatic regime where ln

$$[ 1 - {p}_{G S} ( T ) ] ∝ T {Δ}_{min}^{2}$$

per Landau-Zener formula can yield

$$T T {S}_{Q A} ∝ 1 / {Δ}_{min}^{2}$$

which is independent of T. In some cases, it can be better to run QA non-adiabatically to obtain a shorter TTS. By choosing the best annealing time T, regardless of adiabaticity,

$${TTS}_{QA}^{opt}$$

can be determined as the minimum algorithmic run time of QA. Without being bound by theory, a similar non-limiting metric can be defined for QAOA for purposes of benchmarking. The variational parameters γ*ᵢ and β*ᵢ can be regarded as the time evolved under the Hamiltonians H_{C} and H_{B}, respectively. The sum of the variational parameters can be interpreted to be the total “annealing” time such that

$${T}_{p} = {\sum }_{i = 1}^{p} ( \vert {γ}_{i}^{*} \vert + \vert {β}_{i}^{*} \vert ) , and {TTS}_{QAOA} ( p ) and {TTS}_{QAOA}^{opt}$$

can be defined as:

$${TTS}_{AQOA} ( p ) = {T}_{p} \frac{ln ( 1 - {p}_{d} )}{ln [ 1 - {p}_{GS} ( p ) ]} \qquad Equation 72$$

$${TTS}_{QAOA}^{opt} = {min}_{p > 0} {TTS}_{QAOA} ( p ) . \qquad Equation 73$$

where p_{GS}(p) is the ground state population after the optimal p-level QAOA protocol, in some embodiments. This quantity need not take into account the overhead in finding the optimal parameters. TTS_{QAOA}(p) can be used to benchmark the algorithm but should not be taken directly to be the actual experimental run time.

To compare examples of the algorithms,

$${TTS}_{QA}^{opt} and {TTS}_{QAOA}^{opt}$$

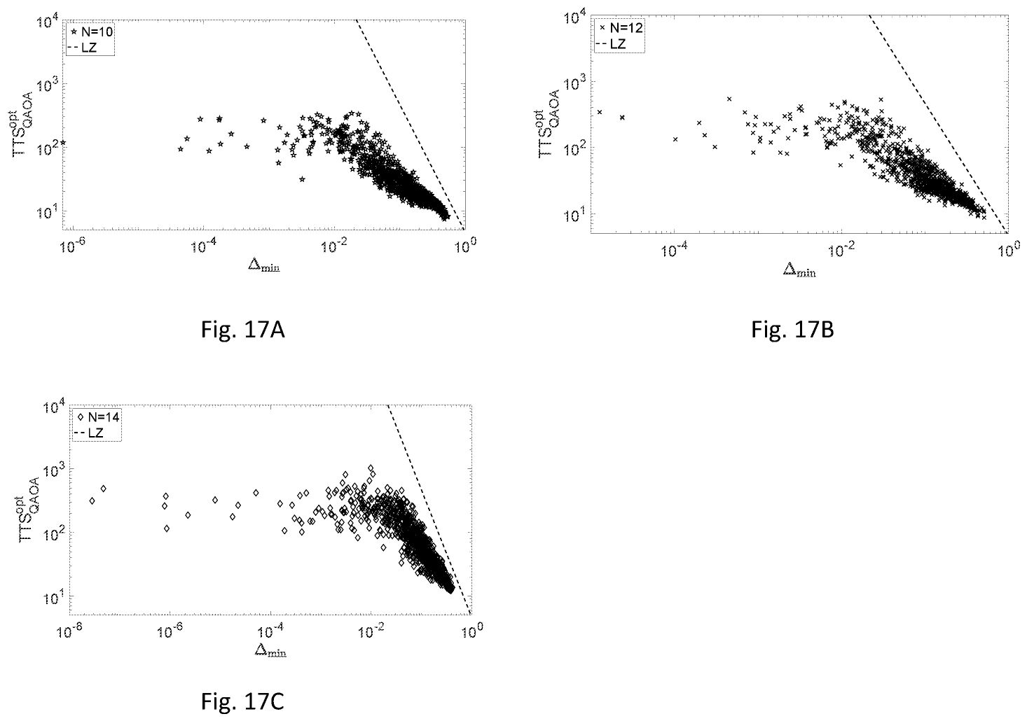

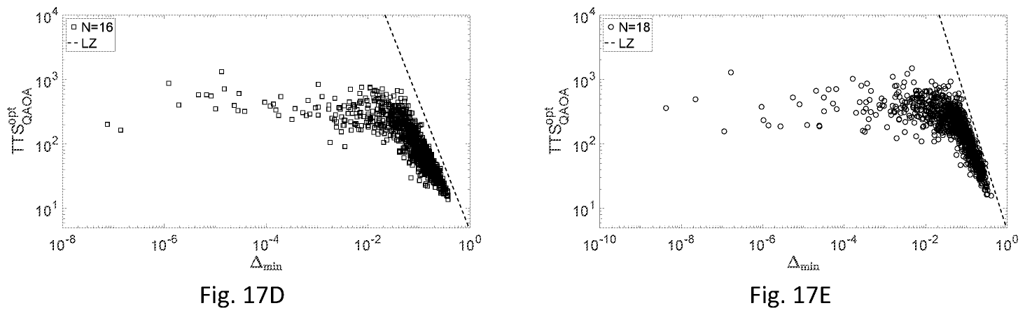

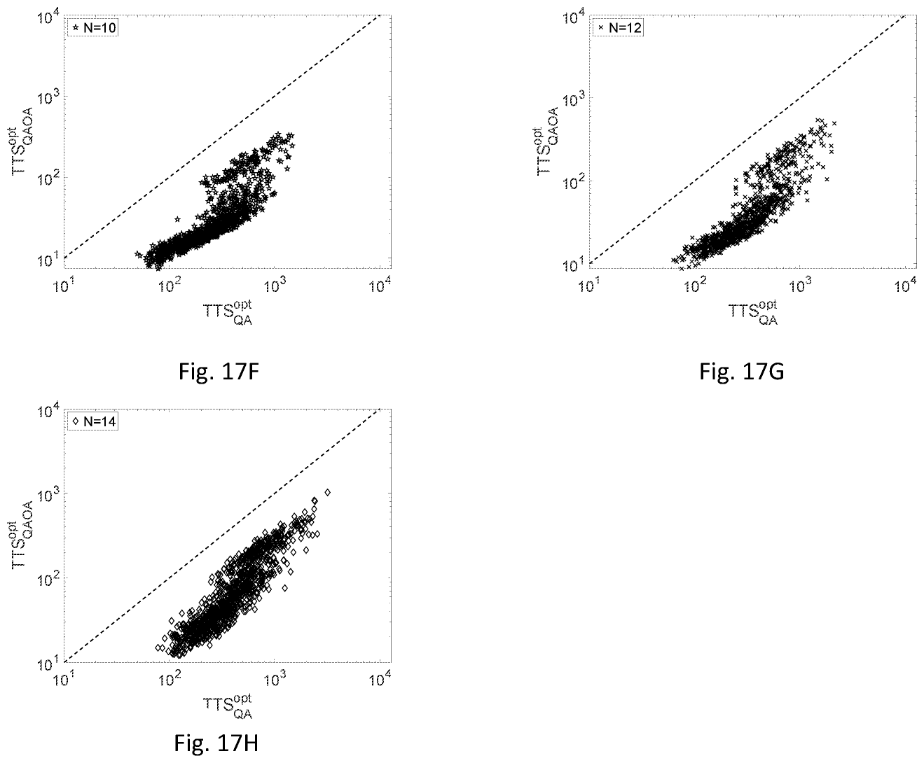

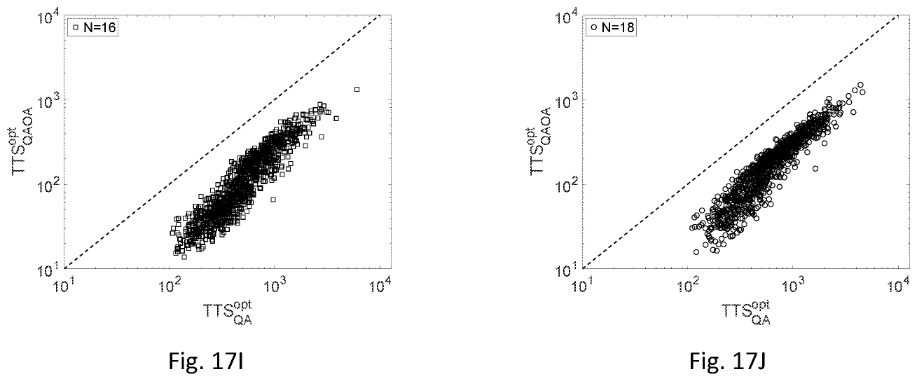

can be computed for many random graph instances. For each even vertex number from N=10 to N=18, 1000 instances of w3R graphs are generated. FIGS. 17A-17E are plots of the relationship between

$${TTS}_{QAOA}^{opt}$$

and the minimum gap Δₘᵢₙ and vertex size N in quantum annealing for each exemplary instance, according to some embodiments. The maximum cutoff p is taken to be pₘₐₓ=50, 50, 40, 35, 30 for N=10, 12, 14, 16, 18, respectively, for FIGS. 17A-17E. The dashed line corresponds to adiabatic QA run time of

$$1 / {Δ}_{min}^{2}$$

predicted by Landau-Zener. Most of the exemplary random graphs have large gaps (Δₘᵢₙ≥10⁻²). The optimal TTS can be observed to follow the Landau-Zener prediction of

$$1 / {Δ}_{min}^{2}$$

min for these graphs. This indicates that a quasi-adiabatic parametrization of QAOA can be the best when Δₘᵢₙ is reasonably large, in some embodiments. Many exemplary graphs, however, exhibit very small gaps (Δₘᵢₙ≤10⁻³), and thus require exceedingly long run time for adiabatic evolution. For some graphs, Δₘᵢₙ is as small as 10⁻⁸, which can imply that an adiabatic evolution requires a run time T≥10¹⁶. Nevertheless, QAOA can find the solution for these hard instances faster than adiabatic QA. Notably,

$${TTS}_{QAOA}^{opt}$$

appears to be independent of the gap for many graphs that have extremely small gaps and beats the adiabatic TTS (Landau-Zener line) by many orders of magnitude, in some embodiments. Thus, an exponential improvement of TTS is possible with non-adiabatic mechanisms when adiabatic QA is limited by exponentially small gaps.

Similarly, for QA, the optimal annealing time T need not be in the adiabatic limit for small-gap graphs. FIGS. 17F-17J show

$${TTS}_{QAOA}^{opt}$$

versus

$${TTS}_{QA}^{opt}$$

for each random graph instance, according to some embodiments. Embodiments of QAOA outperform QA for instances below the dashed line. The (Pearson's) correlation coefficient between QAOA TTS and QA TTS is

$$ρ ( ln ( {TTS}_{QAOA}^{opt} ) , ln ( {TTS}_{QA}^{opt} ) ) \approx 0.91 .$$

As shown in FIGS. 17F-17J, there can be a strong correlation between

$${TTS}_{QAOA}^{opt} and {TTS}_{QA}^{opt}$$

for each graph instance. Without being bound by theory, this suggests that QAOA is making use of the optimal annealing schedule, regardless of whether a slow adiabatic evolution or a fast diabatic evolution is better. Without being bound by theory, the following section titled “Beyond the adiabatic mechanism: a case study” explores a non-limiting example to explain aspects of the results observed in FIGS. 17A-17H and a mechanism of QAOA that go beyond the adiabatic paradigm.

### Beyond the Adiabatic Mechanism: A Case Study

To understand the behavior of QAOA, graph instances that are hard for adiabatic QA can be addressed in more detail. For example, a representative instance is used to explain how embodiments of QAOA as well as diabatic QA can overcome the adiabatic limitations. As illustrated in 18A, QAOA can learn to utilize diabatic transitions at anti-crossings to circumvent difficulties caused by very small gaps in QA. FIG. 18A shows a schematic of how QAOA and the interpolated annealing path can overcome the small minimum gap limitations via diabatic transitions (small dashed line). Naive adiabatic quantum annealing path leads to excited states passing through the anti-crossing point (large dashed line).

FIG. 18B shows a representative instance of weighted 3-regular graph with N=14, which has a small minimum spectral gap Δₘᵢₙ<10⁻³, according to some embodiments. For example, FIG. 18B shows an instance of weighted 3-regular graph that has a small minimum spectral gap along the quantum annealing path given by equation 69. As an example, the optimal MaxCut configuration is shown with two vertex types (circles and squares), and the solid (dashed) lines are the cut (uncut) edges. For this example, hard instance, the quantum annealing process can be simulated. Without being bound by theory, FIG. 18C shows populations in the ground state and low excited states at the end of the process for different annealing time T, according to some embodiments. The solid line follows the Landau-Zener formula for the ground state population,

$${p}_{GS} = 1 - exp ( - cT {Δ}_{min}^{2} ) ,$$

where c is a fitting parameter. Since the minimum gap can be very small, the adiabatic condition requires

$$T \geq 1 / {Δ}_{min}^{2} \approx {10}^{6} .$$

The Landau-Zener formula for the ground state population

$${p}_{GS} = 1 - exp ( - cT {Δ}_{min}^{2} )$$

fits well with the exact numerical simulation discussed herein, where c is a fitting parameter. However, there is a “bump” in the ground state population at annealing time T≈40. At such a time scale, the dynamics can be considered non-adiabatic; which can be referred to as a “diabatic bump.” This phenomenon has been observed in quantum annealing of other optimization problems as well.

In some embodiments, it is also possible to simulate QAOA on this hard instance. As mentioned above, although QAOA can optimizes energy instead of ground state overlap, substantial ground state population can still be obtained even for many hard graphs. Using an exemplary embodiment of the disclosed FOURIER heuristic strategy, various low-energy state populations of the output state are shown for different levels p shown in FIG. 18D, according to some embodiments. More particularly, FIG. 18D shows populations in low excited states using QAOA at different level p. The exemplary FOURIER heuristic strategy is used in the optimization shown in FIG. 18D. In such embodiments, QAOA can achieve similar ground state population as the diabatic bump at small p, with substantial enhancements occurring after p≥24.

Without being bound by theory, to better understand the mechanism of embodiments of QAOA and make a comparison with QA, the QAOA parameters can be interpreted as a smooth annealing path. The sum of the variational parameters can be interpreted to be the total annealing time, i.e.,

$${T}_{p} = {\sum }_{i = 1}^{p} ( \vert {γ}_{i} \vert + \vert {β}_{i} \vert ) ,$$

as discussed above. A smooth annealing path can be constructed from QAOA optimal parameters as

$${H}_{QAOA} ( t ) = - [ f ( t ) {H}_{C} + ( 1 - f ( t ) ) {H}_{B} ] , \qquad Equation 74$$

$$f ( {t}_{i} = {\sum }_{j = 1}^{i} ( ( \vert {γ}_{j}^{*} \vert + \vert {β}_{j}^{*} \vert ) - \frac{1}{2} ( \vert {γ}_{i}^{*} \vert + \vert {β}_{i}^{*} \vert ) ) ) = \frac{{γ}_{i}^{*}}{( \vert {γ}_{i}^{*} \vert + \vert {β}_{i}^{*} \vert} , \qquad Equation 75$$

where tᵢ can be chosen to be at the mid-point of each time interval (γᵢ*+βᵢ*). With the boundary conditions f(t=0)=0, f(t=Tₚ)=1 and linear interpolation at other intermediate time t, QAOA parameters can be converted to a well-defined annealing path. This conversion can be applied to the QAOA optimal parameters at p=40, as shown in FIG. 18E, according to some embodiments. The annealing time parameter can be written as s=t/Tₚ, where

$${T}_{p} = {\sum }_{i = 1}^{p} ( \vert {γ}_{i}^{*} \vert + \vert {β}_{i}^{*} \vert ) .$$

The flat upper dotted line labels the location of anti-crossing where the gap is at its minimum, at which point f(s)≈0.92. The inset shows the original QAOA optimal parameters γᵢ* and βᵢ* for p=40. With this annealing path, it is possible to follow the instantaneous eigenstate population throughout the quantum annealing process, as shown in FIG. 18F, according to some embodiments. In particular, FIG. 18F shows instantaneous eigenstate populations under the annealing path given in FIG. 18E. Note that the instantaneous ground state and first excited state swap at the anti-crossing point. In contrast to adiabatic QA, the state population leaks out of the ground state and accumulates in the first excited state before the anticrossing point, where the gap is at its minimum. Using a diabatic transition at the anti-crossing, the two states can swap populations, and a large ground state population is obtained in the end. The final state population from the constructed annealing path can differ slightly from those of QAOA, due to, for example, Trotterization and interpolation, but without being bound by theory, the underlying mechanism can be interpreted as the same, which can also be considered responsible for the diabatic bump seen in FIG. 18C. In addition to the conversion used in the equation above, other prescriptions can be used to construct an annealing path from QAOA parameters, and qualitative features do not seem to change.

Without being bound by theory, these results indicate that QAOA is closely related to a cleverly optimized diabatic QA path that can overcome limitations set by the adiabatic theorem. Through optimization, QAOA can find a good annealing path and exploit diabatic transitions to enhance ground state population. This explains the observation in FIGS. 17A-17E that

$$TT {S}_{Q A O A}^{opt}$$

can be significantly shorter than the time required by the adiabatic algorithm. On the other hand, as seen in FIGS. 17H-17J,

$$T T {S}_{Q A O A}^{opt}$$

can be strongly correlated with

$$TT {S}_{Q A}^{opt} :$$

QAUA can find a good annealing path, which could be adiabatic or not, depending on what is the best route for the specific problem instance.

The effective dynamics of QAOA for these exemplary specific instances, as shown in FIG. 18F, can be understood, without limitation, by an effective two-level system discussed in more detail in the following section. In general, the energy spectrum can be more complex, and the dynamics may involve many excited states, which may not be explainable by the simple schematic in FIG. 18A. Nonetheless, QAOA can find a suitable path via the disclosed heuristic optimization strategies even in more complicated cases.

### Effective Few-Level Understanding of the Diabatic Bump

Without being bound by theory, this section elucidates the mechanism of the diabatic bump discussed above with reference to FIG. 18C via effective few-level dynamics. The intermediate dynamics during quantum annealing can be understood using the basis of instantaneous eigenstates |∈ₗ(t) [symbol] , where

$${H}_{Q A} ( t ) \vert {∈}_{l} ( t ) 〉 = {∈}_{l} ( t ) \vert {∈}_{l} ( t ) 〉 , \qquad Equation 76$$

Expanding the time-evolved state in this basis as |ψ(t))=Σₗaₗ(t)|∈ₗ(t)), the Schrodinger equation can be written as

$$i {\sum }_{l} ( {\dot{a}}_{l} \vert {∈}_{l} 〉 + {a}_{l} \vert {\dot{∈}}_{l} 〉 ) = {\sum }_{l} {∈}_{l} {a}_{l} \vert {∈}_{l} 〉 , \qquad Equation 77$$

where ℏ=1 and the time dependence in the notations is dropped for convenience. Multiplying the equation by [symbol] ∈ₖ|, the Schrodinger equation becomes

$$i {\dot{a}}_{k} = {∈}_{k} {a}_{k} - i {\sum }_{l \neq k} {a}_{l} 〈 {∈}_{k} \vert {( \dot{∈} )}_{l} 〉 , \qquad Equation 78$$

where [symbol] ∈ₖ|∉ₖ [symbol] =0 is taken by absorbing the phase into the eigenvector |∈ₖ [symbol] . Written in a matrix form, it can be seen that

$$i ( \begin{matrix}\begin{matrix}\begin{matrix}\dot{{a}_{0}} \\ \dot{{a}_{1}}\end{matrix} \\ \dot{{a}_{2}}\end{matrix} \\ ⋮\end{matrix} ) = 0 ( \begin{matrix}0 & - i 〈 {∈}_{0} \vert {\dot{∈}}_{1} 〉 & - i 〈 {∈}_{0} \vert {\dot{∈}}_{2} 〉 & … \\ i 〈 {∈}_{1} \vert {\dot{∈}}_{0} 〉 & {Δ}_{10} & - i 〈 {∈}_{1} \vert {\dot{∈}}_{2} 〉 & … \\ i 〈 {∈}_{2} \vert {\dot{∈}}_{0} 〉 & - i 〈 {∈}_{2} \vert {\dot{∈}}_{1} 〉 & {Δ}_{20} & … \\ ⋮ & ⋮ & ⋮ & ⋱\end{matrix} ) ( \begin{matrix}\begin{matrix}\begin{matrix}{a}_{0} \\ {a}_{1}\end{matrix} \\ {a}_{2}\end{matrix} \\ ⋮\end{matrix} ) , \qquad Equation 79$$

where the ground state energy is ∈₀=0 (by absorbing it into the phase of the coefficients) and Δᵢ₀=∈ᵢ−∈₀, is the instantaneous energy gap from the ith excited state to the ground state. The time evolution starts from the initial ground state with a₀=1 and aᵢ=0 for i≠0, and the adiabatic condition to prevent coupling to excited states is

$$\frac{\vert 〈 {∈}_{0} \vert {( \dot{∈} )}_{1} 〉 \vert}{{Δ}_{i 0}} = \frac{\vert 〈 {∈}_{0} \vert \frac{d {H}_{Q A}}{d t} \vert {∈}_{i} 〉 \vert}{{Δ}_{i 0}^{2}} = \frac{\vert 〈 {∈}_{0} \vert \frac{d {H}_{Q A}}{d s} \vert {∈}_{i} 〉 \vert}{{Δ}_{i 0}^{2} T} ≪ 1 \qquad Equation 80$$

The first equality can be derived from equation 76. This can produce the standard adiabatic condition

$$T = O ( 1 / {Δ}_{min}^{2} ) .$$

As discussed above, the minimum gap for some graphs can be exceedingly small, so the adiabatic limit may not be practical. However, is possible to choose an appropriate run time T, which breaks adiabaticity, but is long enough such that only few excited states are effectively involved in the dynamics. This is the regime where the diabatic bump operates and one can understand the dynamics by truncating equation 79 to the first few basis states.

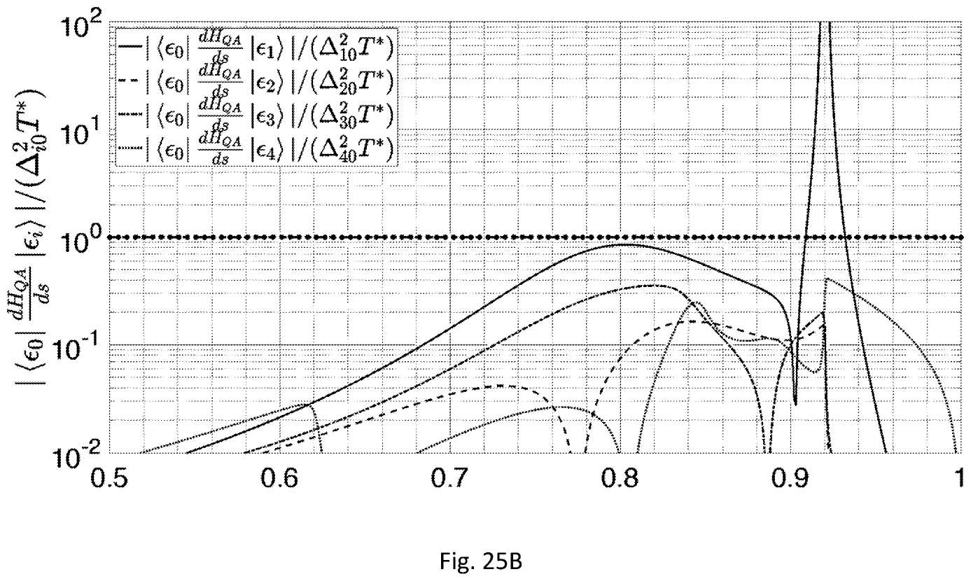

As an example, FIG. 25A plots the instantaneous eigenstate populations of the first few states, according to some embodiments. In particular, FIG. 25A plots instantaneous eigenstate populations along the linear-ramp quantum annealing path given by equation 69 for the example graph in FIG. 18B. The annealing time can be chosen to be T=T*=40, which can correspond to the time where the diabatic bump occurs in FIG. 18C. FIG. 25A is simulated with the full Hilbert space, but effectively the same dynamics will be generated if the simulation is restricted to the first few basis states in equation 79.

FIG. 25B shows the strength of the couplings between the instantaneous ground state and the low excited states, according to some embodiments. The plotted quantities measure the degree of adiabaticity (as explained in equation 80). By comparing FIGS. 25A and 25B it is possible to see that T=T*=40 allows the time evolution to break the adiabatic condition before the anticrossing: population leaks to the first excited state, which becomes the ground state after the anticrossing. Thus, the time scale of T* for the diabatic bump represents a delicate balance between allowing population to leak out of the ground state and suppressing excessive population leakage, which without being bound by theory explains why it happens at a certain range of time scale.

### Example Graph Instance and Time-to-Solution

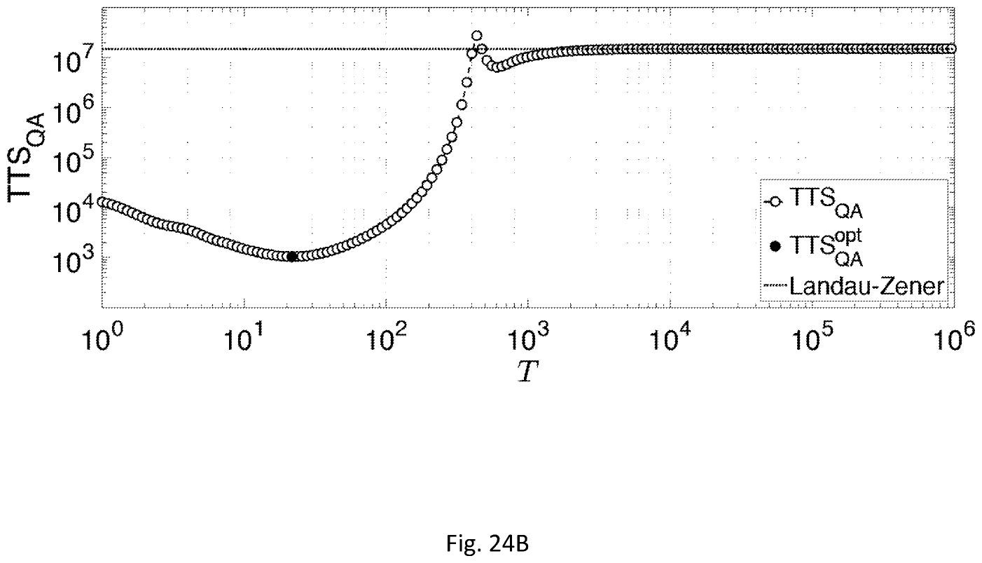

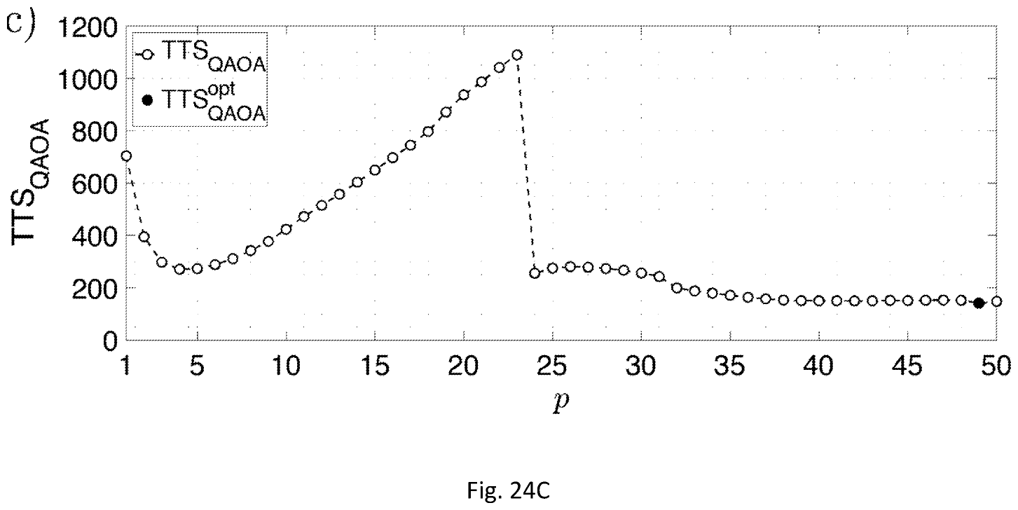

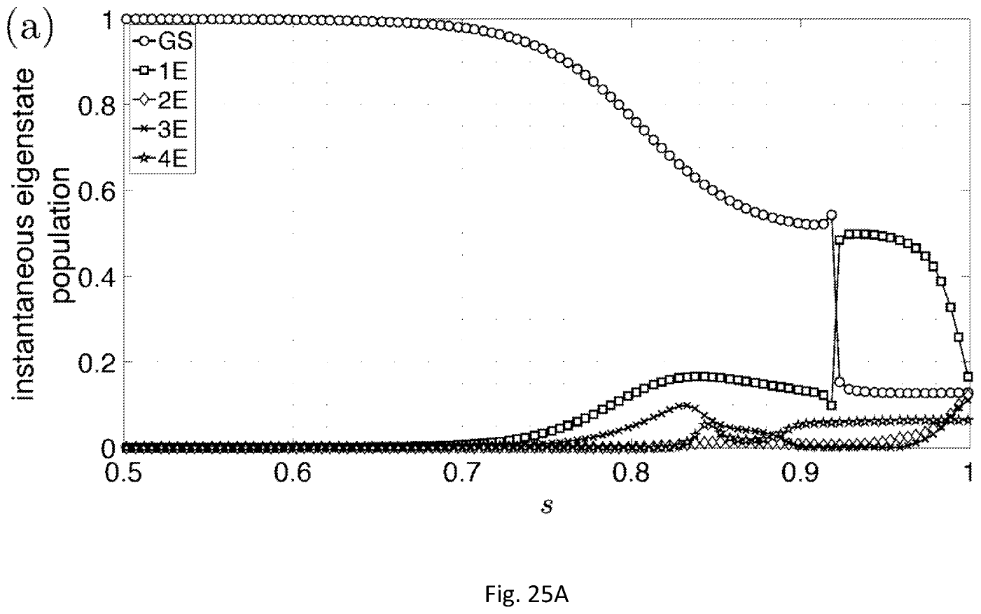

In the previous sections, an example representative graph instance where the adiabatic minimum gap is small was considered with reference to FIG. 18B. The low energy spectrum for the graph along the QA path can be seen in FIG. 24A, according to some embodiments. More particularly, FIG. 24A shows an exemplary energy spectrum of low excited states (measured from the ground state energy E_{GS}) along the annealing path for the graph instance given in FIG. 18B. Only states that can, in this example, couple to the ground state are shown, such as states that are invariant under the parity operator

$$P = {\prod }_{i = 1}^{N} {σ}_{i}^{x} .$$

The inset shows the energy gap from the ground state in logarithmic scale. As shown in the embodiment of FIG. 24A, only eigenstates that are invariant under the party operator

$$P = {\prod }_{i = 1}^{N} {σ}_{i}^{x}$$

are shown, since the Hamiltonian H_{QA}(s) commutes with P and the initial state is P-invariant: P|ψ(0) [symbol] =|ψ(0) [symbol] .

FIGS. 24B and 24C illustrate TTS_{QA} and TTS_{QAOA} for the same graph. In particular, FIG. 24B shows the time-to-solution for the linear-ramp quantum annealing protocol, TTS_{QA}, for the same graph instance. In this embodiment, TTS in the long-time limit follows a line predicted by the Landau-Zener formula, which is independent of the annealing time T. FIG. 24C shows TTS for QAOA at each iteration depth p. For QA, it can be seen that non-adiabatic evolution with T≈20 yields orders of magnitude shorter TTS than the adiabatic evolution. In addition, TTS in the adiabatic limit is independent of the annealing time T, following the Landau-Zener formula

$${p}_{G S} = 1 - exp ( - cT {Δ}_{min}^{2} ) .$$

For QAOA, an exemplary embodiment of the FOURIER[∞, 10] heuristic strategy is used to perform the numerical simulation up to pₘₐₓ=50, and compute TTS_{QAOA}(p) and

$$T T {S}_{Q A O A}^{opt} ( up to p \leq {p}_{max} ) .$$

For this particular figure, although

$$TT {S}_{Q A O A}^{opt} occurs at p = 49 ,$$

in some embodiments it may be better to run QAOA at p=4 or p=5 due to optimization overhead and error accumulation at deeper circuit depths. The apparent discontinuous jump in TTS_{QAOA} shown in FIG. 24C is due to the corresponding jump in pos (p), which can be explained by two reasons: first, embodiments of the disclosed heuristic strategy is not guaranteed to find the global optimum, and random perturbations may help the algorithm escape a local optimum, resulting in a jump in ground state population; second, even when the global optimum is found for all level p, there can still be discontinuities in pos, since the objective function of QAOA is energy instead of ground state population.

### Simulation Techniques

Details of Simulation with Measurement Projection Noise

When running QAOA on actual quantum devices, the objective function can be evaluated by averaging over many measurement outcomes, and consequently its precision can be limited by the so-called measurement projection noise from quantum fluctuations, in some embodiments. This effect can be accounted for by performing full Monte-Carlo simulations of actual measurements, where the simulated quantum processor only outputs approximate values of the objective function obtained by averaging M measurements:

$${\overline{F}}_{p , M} = \frac{1}{M} {\sum }_{i = 1}^{m} C ( {z}_{p , i} ) \qquad Equation 81$$

where z_{p,i} is a random variable corresponding to the ith measurement outcome obtained by measuring |ψₚ(\vec{γ}, \vec{β}) [symbol] in the computational basis, and C(z) is the classical objective function. Note when M→∞, F̅_{p,M}→Fₚ=Fₚ= [symbol] ψₚ(\vec{γ}, \vec{β})|H_{C}|ψₚ(\vec{γ}, \vec{β}) [symbol] . In the exemplary simulation, finite precision |F_{p,M}−Fₚ|≤ξ can be achieved by sampling measurements until the cumulative standard error of the mean falls below the target precision level ξ. In other words, for each evaluation of Fₚ requested by the classical optimizer, the number of measurements M performed is set by the following criterion:

$$\sqrt{\frac{1}{M ( M - 1 )} {\sum }_{i = 1}^{M} {[ C ( {z}_{p , i} ) - {\overline{F}}_{p , M} ]}^{2} \leq ξ} \qquad Equation 82$$

In some embodiments, it can be expected that M≈Var(Fₚ)/ξ². To address issues that can appear with finite sample sizes, at least 10 measurements are performed (M≥10) for each objective function evaluation.

Regarding the classical optimization algorithm used to optimize QAOA parameters, generally, classical optimization algorithms iteratively use information from some given parameter point (\vec{γ}, \vec{β}) to find a new parameter point (\vec{γ}′, \vec{β}′) that produces a larger value of the objective function Fₚ(\vec{γ}′, \vec{β}′)≥Fₚ(\vec{γ}, \vec{β}). In order for the algorithm to terminate, some stopping criteria can be set. In some embodiments, up to two can be used: First, an objective function tolerance ∈ can be set, such that if the change in objective function |F̅_{p,M′}(\vec{γ}′, \vec{β}′)−F̅_{p,M}(\vec{γ}′, \vec{β}′)|≤∈, the algorithm terminates. Second, a step-tolerance δ can also be set so that the algorithm terminates if the new parameter point is very close to the previous one |\vec{γ}′−\vec{γ}|²+|\vec{β}′−\vec{β}|²≤δ². For gradient-based optimization algorithms such as BFGS, δ can also be used as the increment size for estimating gradients via the finite-difference method: ∂Fₚ/∂γᵢ≅[F̅_{p,M′}(γᵢ+δ)−F̅_{p,M}(γᵢ)]/δ. In the simulations discussed herein, the BFGS algorithm is implemented as fminunc in the standard library of MATLAB R2017b.

Using the approach described above, it is possible to simulate experiments of optimizing QAOA with measurement projection noise for a few example instances, with various choices of precision parameters (∈, ξ, δ) and starting points. For the example representative instance studied in FIGS. 19, ∈=0.1, ξ=0.05, and δ=0.01. Each run of the simulated experiment begins with QAOA of level either p=1 or p=5 and continues with optimizing increasing levels of QAOA using embodiments of the disclosed FOURIER[∞, 0] heuristic strategy. The starting point of QAOA optimization can either be randomly selected (when starting at p=1) or chosen based on an educated guess using optimal parameters from small-sized instances (at p=1 and p=5). Specifically, the starting points obtained from educated guesses for the example studied in FIG. 19 are (\vec{u}⁰, \vec{v}⁰)=(1.4849,0.5409) at level p=1, and

$${\vec{u}}^{0} = ( 1.9212 , 0.2891 , 0.1601 , 0.05 \; 64 , 0.0292 ) \qquad Equation 83$$

$${\vec{v}}^{0} = ( 0.60 \; 55 , - 0.0178 , 0.04 \; 31 , - 0.0061 , 0.0141 ) \qquad Equation 84$$

at level p=5. For each such run, the history of all the measurements can be tracked so that the largest cut Cutᵢ found after the i-th measurement can be calculated. Each experiment is repeated 500 times with different pseudo-random number generation seeds, and an average over their histories is taken.

### Techniques to Speed Up Numerical Simulation

In some embodiments, a number of techniques can be exploited to speed up the numerical simulation for both QAOA and QA.

For example, first, the symmetries present in the Hamiltonian can be used. For MaxCut on general graphs, the only symmetry operator that commutes with both H_{C} and H_{B} is the parity operator

$$P = {\prod }_{i = 1}^{N} {σ}_{i}^{x} : [ {H}_{C} , P ] = [ {H}_{B} , P ] = 0 ,$$

and so does [H_{QA}(s), P]=0, where H_{QA}(s) is the quantum annealing Hamiltonian equation 69. The parity operator can have two eigenvalues, +1 and −1, each with half of the entire Hilbert space. The initial state for both QAOA and QA are in the positive sector, i.e., P|+ [symbol] =|+ [symbol] . Thus, any dynamics must remain in the positive parity sector. H_{C} and H_{B} can be rewritten in the basis of the eigenvectors of P, and the Hilbert space reduced from 2^{N} to 2^{N}−1 by working in the positive parity sector.

For QA, dynamics involving the time-dependent Hamiltonian can be simulated by dividing the total simulation time Tinto sufficiently small discrete time T and implementing each time step sequentially. At each small step, it is possible to evolve the state without forming the full evolution operator, either using the Krylov subspace projection method or a truncated Taylor series approximation. In the simulations discussed herein, a scaling and squaring method is used with a truncated Taylor series approximation as it appears to run slightly faster than the Krylov subspace method for small time steps.

For QAOA, the dynamics can be implemented in a more efficient way due to the special form of the operators H_{C} and H_{B}, in some embodiments. Work can be performed in the standard σ_{z} basis. Thus,

$${H}_{C} = {\sum }_{( i , j 〉} \frac{{w}_{ij}}{2} ( 1 - {σ}_{i}^{z} {σ}_{j}^{z} )$$

can be written as a diagonal matrix and the action of e⁻ⁱ^{_{γ}}^{H}^{_{C}} can be implemented as vector operations. For H_{B}, the time evolution operator can be simplified as

$${e}^{- i β {H}_{B} =} {\prod }_{j = 1}^{N} {e}^{- i {βσ}_{j}^{x}} = {\prod }_{j = 1}^{N} ( 1 cos β - i {σ}_{j}^{x} sin β ) \qquad Equation 85$$

Therefore, the action of e^{-iβH}^{_{B}} can also be implemented as N sequential vector operations without explicitly forming the sparse matrix H_{B}, which both improves simulation speed and saves memory. In addition, in the optimization of variational parameters, the gradient can be calculated analytically, instead of using finite-difference methods. Techniques similar to the gradient ascent pulse engineering (GRAPE) method are also used, which reduces the cost of computing the gradient from O(p²) to O(p), for a p-level QAOA. Lastly, in example simulations of embodiments of the disclosed FOURIER strategy, the gradient of the objective function can be calculated with respect to the new parameters (\vec{u},\vec{v}). Since \vec{γ}=A_{S}\vec{u} and \vec{β}=A_{C}\vec{v} and for some matrices A_{S} and A_{C}, their gradients can also be related via ∇_{\vec{u}}=A_{S}∇_{\vec{γ}} and ∇_{\vec{v}}=A_{S}∇_{\vec{β}}.

### QAOA for MIS

This section discusses exemplary techniques to simulate the Quantum Approximate Optimization Algorithm to solve Maximum Independent Set Problems, according to some embodiments.

### Quantum Approximate Optimization Algorithm

Without being bound by theory, in some embodiments, given a problem to find MIS on a given a graph G=(V, E), the p-level QAOA for MIS can be a variational algorithm consisting of the following steps:
(i) Initialization of the quantum state in |ψ₀ [symbol] =|0 [symbol] .
(ii) Preparation of variational wavefunction:

$$\vert {ψ}_{p} ( \vec{γ} , \vec{β} ) 〉 = exp ( - i {β}_{p} {H}_{Q} ) {\prod }_{k = 1}^{p - 1} exp ( - i {γ}_{k} {H}_{p} ) exp ( - i {β}_{k} {H}_{Q} ) \vert {ψ}_{0} 〉 , \qquad Equation 86$$

where H_{P}Σ_{vϵV}−Δnᵥ+Σ_{(v,w)ϵE}Unᵥn_{w}, and

$${H}_{Q} = {\sum }_{v ∈ V} {Ωσ}_{v}^{x} + {\sum }_{( v , w ) ∈ E} {Un}_{v} {n}_{w} .$$

The parameters \vec{γ}∈ [symbol] and \vec{β}∈ [symbol] , specify the variational state.
(iii) Measurement of H_{P}.

The three steps (i)-(iii) can be iterated and combined with a classical optimization of the variational parameters in order to minimize [symbol] ψₚ(\vec{γ}, \vec{β})|H_{P}|ψₚ(\vec{γ}, \vec{β}) [symbol] .

### Alternative Formulation

In some embodiments, where U>>|Ω|, |Δ|, the variational search can be restricted to the subspace [symbol] is spanned by independent sets, such that the algorithm does not need to explore states that can be directly excluded as MIS candidates. In this limit, it is possible to write:

$${H}_{Q} = {\sum }_{v} {P}_{IS} Ω {σ}_{x} {P}_{IS} , \qquad Equation 87$$

$${H}_{P} = {\sum }_{v ∈ V} - Δ {n}_{v} , \qquad Equation 88$$

where P_{IS} is a projector onto the independent set subspace [symbol] _{IS}. Evolution with H_{P} can reduce to simple rotation of individual spins around the z axis. Since

$${exp ( i γ {H}_{P} ) exp ( - i β {H}_{Q} ) = exp ( - i Ωσ {\sum }_{v} {P}_{IS} ( \vert 0 〉}_{v} 〈 1 \vert {e}^{- i γ Δ} + h . c . ) {P}_{IS} ) exp ( - i γ {H}_{P} ) , \qquad Equation 89$$

it is possible to commute all the unitaries generated by H_{P} in Equation 86 to the rightmost side until they act (trivially) on the initial state. Thus, it is possible to rewrite the state |ψₚ(\vec{γ}, \vec{β}) [symbol] as

$$Equation 90$$

$${\vert {ψ}_{p} ( \vec{γ} , \vec{β} ) 〉 = {\prod }_{k = 1}^{p} exp ( - {it}_{k} Ω {\sum }_{v} {P}_{IS} ( \vert 0 〉}_{v} 〈 1 \vert {e}^{- i {ϕ}_{k}} + h . c . ) {P}_{IS} ) \vert {ψ}_{0} 〉 ,$$

where the following can be identified

$${ϕ}_{k} = {\sum }_{j \geq k} {γ}_{j} Δ , \qquad Equation 91$$

$${t}_{k} = {β}_{k} \qquad Equation 92$$

Thus, some embodiments of the formulation of QAOA given above can be equivalent to equation 90 for U>>Ω.

Quantum Optimization with Arbitrary Connectivity Using Rydberg Atom Arrays

Programmable quantum systems based on Rydberg atom arrays have recently been used for hardware-efficient tests of quantum optimization algorithms with hundreds of qubits. In particular, the maximum independent set problem on so-called unit-disk graphs was shown to be efficiently encodable in such a quantum system. Here, the classes of problems that can be efficiently encoded in Rydberg arrays are extended by constructing explicit mappings from a wide class of problems to maximum weight independent set problems on unit-disk graphs, with at most a quadratic overhead in the number of qubits. Several examples are analyzed, including: maximum weight independent set on graphs with arbitrary connectivity, quadratic unconstrained binary optimization problems with arbitrary or restricted connectivity, and integer factorization. Numerical simulations on small system sizes indicate that the adiabatic time scale for solving the mapped problems is strongly correlated with that of the original problems.

In some embodiments, this disclosure provides a blueprint for using Rydberg atom arrays to solve a wide range of combinatorial optimization problems with arbitrary connectivity, beyond the restrictions imposed by the hardware geometry.

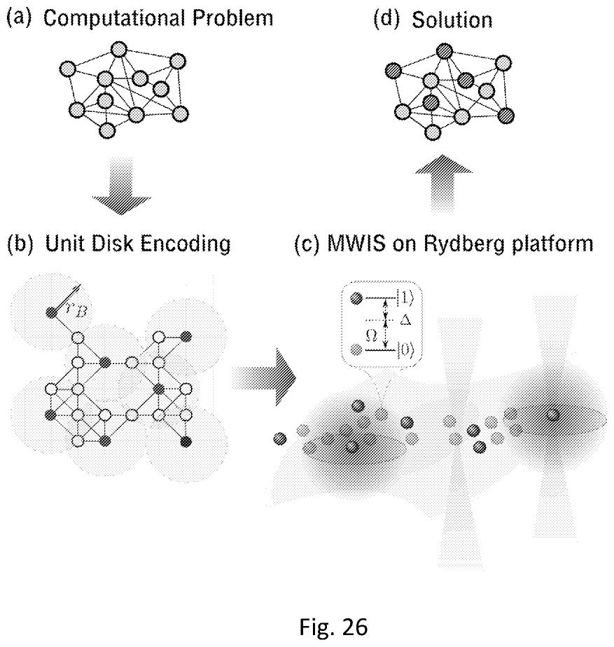

Referring to FIG. 26, a procedure to solve a variety of optimization problems using programmable Rydberg atom arrays is illustrated. The original computational problem (a) can be mapped onto a maximum-weight independent set (MWIS) problem on a unit-disk graph (UDG) in (b). The physical platform is shown in (c), where each vertex in (b) represents an atom trapped by optical tweezers. Each two-level atom can be coherently driven with Rabi frequency Ω and detuning Δ, and the Rydberg blockade mechanism prevents two atoms from being simultaneously excited to state |1 [symbol] if they are within a unit distance r_{B}. The solution to the UDG-MWIS problem in (d) encodes the solution to the original problem.

Quantum optimization algorithms aim to solve combinatorial optimization problems by utilizing controlled dynamics of quantum many-body systems. The key idea underlying this paradigm is to steer the dynamics of quantum systems such that their final states provide solutions to the optimization problem of interest. Such dynamics are often achieved either via the adiabatic principle in quantum annealing algorithms (QAA), or by employing more general, variational approaches, as exemplified by quantum approximate optimization algorithms (QAOA). A popular approach to design such quantum algorithms is to formulate the optimization problem in terms of a classical spin model that can be implemented on special-purpose quantum hardware.

An exciting possibility in this context is offered by Rydberg atom arrays. Owing to the Rydberg blockade mechanism, these systems realize spin models that naturally encode a paradigmatic combinatorial optimization problem, namely the maximum independent set (MIS) problem on a special class of geometric graphs, called unit-disk graphs (UDG). This allows a direct implementation of a variety of quantum optimization algorithms on this platform. Remarkably, first experiments exploring this approach observed a superlinear quantum speedup over optimized classical simulated annealing for finding exact solutions for some of the hardest accessible graphs. However, the restriction to unit disk graphs limits the applicability of this approach. Overcoming this limitation is one of the major challenges for exploring quantum optimization on a much wider range of optimization problems, including several problems of industrial relevance.

Approaches to extend the applicability of Rydberg atom arrays beyond UDGs have been recently explored, but they are either limited to a specific class of graphs, or require three-dimensional arrays, and both approaches require bespoke encoding for each problem graph with unclear overhead for general graphs. Alternatively, other schemes that can map arbitrary non-local interactions into local ones have been proposed, but their implementations are experimentally even more demanding, requiring either 4-body interactions or the use of tunable Ising interactions.

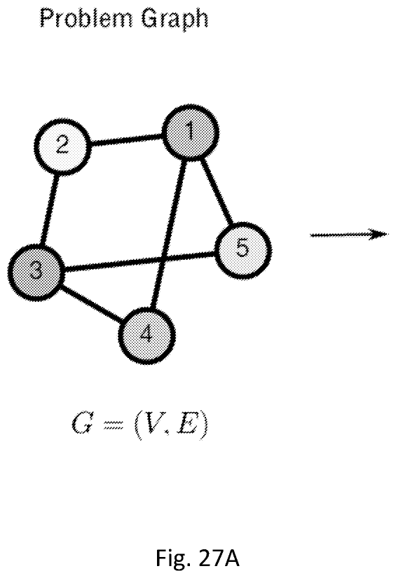

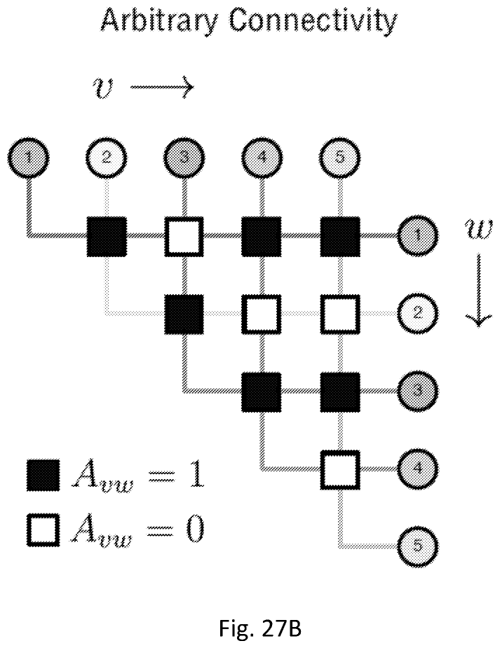

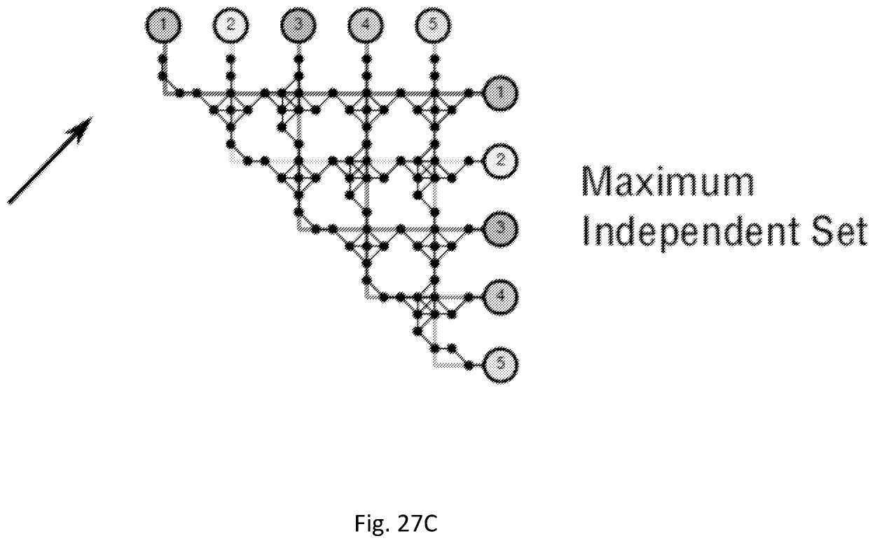

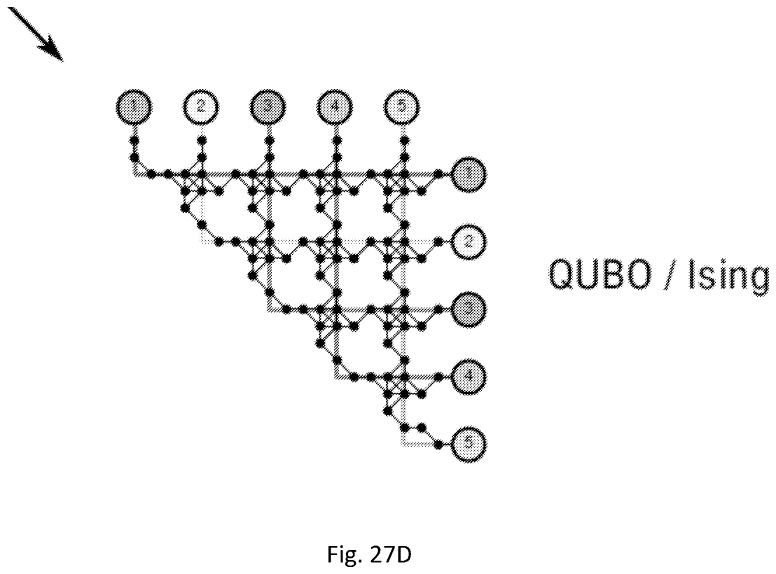

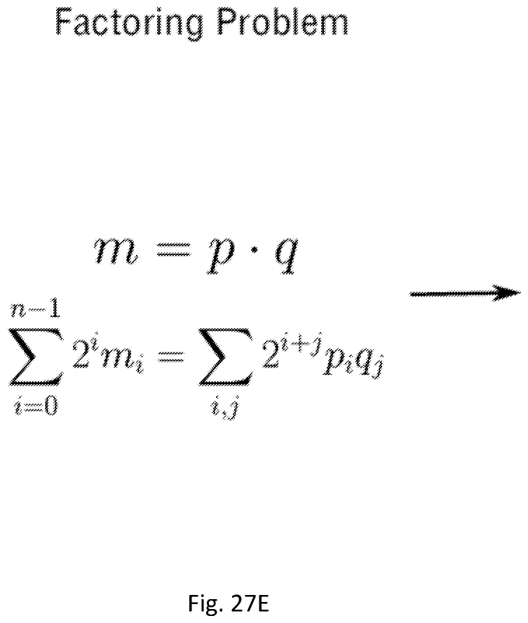

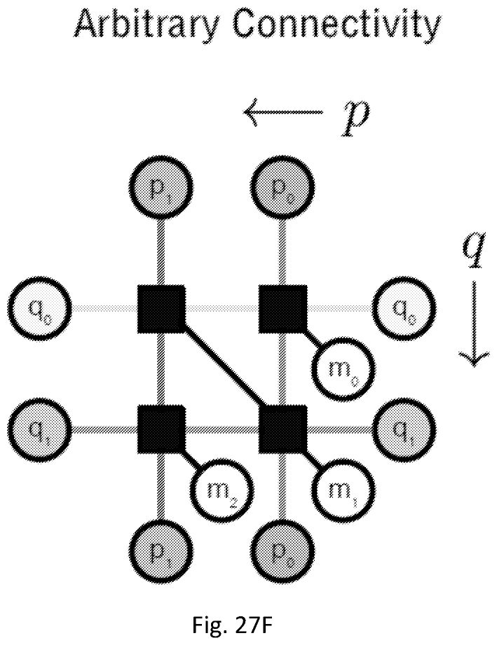

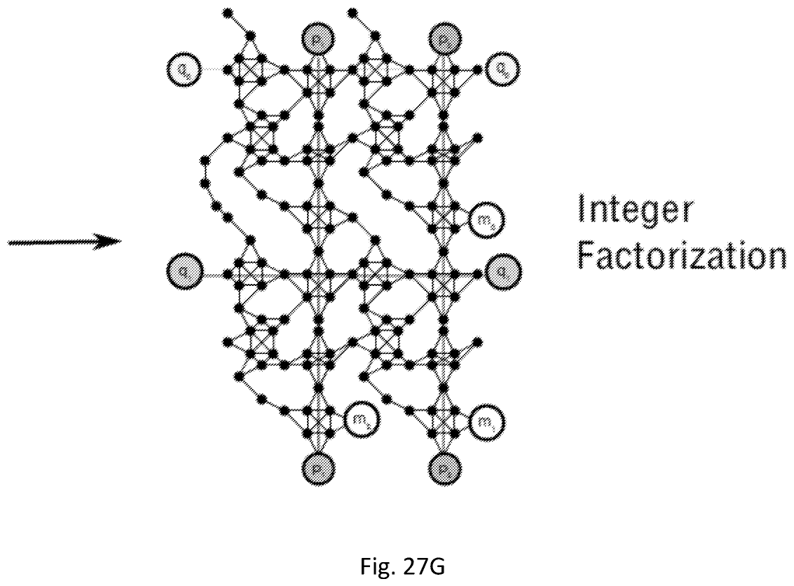

Referring to FIGS. 27A-27G, an architecture of UDG-MWIS mapping for three example problems is illustrated. FIG. 27A gives an example non-UDG represented by G=(V, E) for the MWIS and quadratic unconstrained binary optimization (QUBO) problems. FIG. 27B shows a crossing lattice used to construct UDG-MWIS mappings. Vertices in FIG. 27A are binary variables that can be represented effectively by lines to construct the lattice. Intersections in the lattice allow arbitrary connectivity between the variables, abstractly represented by squares. The lattice mimics an upper triangular adjacency matrix A, where for two vertices {v, w}∈V, A_{vw}=1 if (v, w)∈E and A_{vw}=0 otherwise, represented abstractly by a filled and empty square here, respectively. FIG. 27C shows a final UDG-MWIS representation of the original MWIS problem on general graphs. FIG. 27D shows final UDG-MWIS representation of the original QUBO/Ising problem. FIG. 27E-G show a similar encoding procedure for the integer factorization problem for the example 6=2×3, with the corresponding UDG-MWIS representation shown in FIG. 27G.

The present disclosure provides a new, systematic approach to encode optimization problems with arbitrary connectivity into Rydberg atom arrays. The scheme requires only 2D atom trapping and the Rydberg blockade mechanism as main ingredients, both of which have been demonstrated already on current Rydberg atom array platforms with high fidelity (see FIG. 26). Importantly, the encoding is constructive and efficient as it incurs only a minimal, quadratic overhead in the number of qubits. A discussion is provided of this approach on the paradigmatic optimization problems including maximum-weight independent set (MWIS) problems on arbitrary graphs, arbitrary quadratic unconstrained binary optimization (QUBO) or Ising problems. In addition, the method is applied to generic constraint satisfaction problems and shows how integer factorization can be mapped to Rydberg atom arrangements. Numerical simulations are performed on small system sizes, comparing the adiabatic time scale for original MWIS on non-UDG graphs to that of the mapped problem, and observing strong correlations that suggest the encoding does not negatively impact the performance of quantum algorithms.

MIS on UDGs is known to be NP-complete, so in principle any NP problem can be reduced to MIS on UDGs with a polynomial overhead. Specifically, formal reduction sequences have been considered, but direct application of the prescribed reduction method requires at least O(N⁶) overhead. It is important for near-term implementation on quantum machines to find a low-overhead, explicit mapping, which is provided herein.

In the following discussion, an overview is provided of results of this work. The main ideas are summarized in FIGS. 26 and 27A-27G. Given a computation problem, it is mapped to a UDG-MWIS problem (i.e., a MWIS problem on a UDG) using a novel encoding scheme. The resulting UDG-MWIS is the native problem for Rydberg atom array platforms allowing a direct implementation of QAA or QAOA for its solution. The solution for the UDG-MWIS obtained on the quantum device can then be mapped back to a solution for the original computation problem. The key result of this work is to provide a general framework for the low-overhead, efficient, and explicit mapping.

The main idea underlying the encoding is summarized in FIGS. 27A-27G for three examples discussed in detail in this work: MWIS on general (non-unit-disk) graphs, QUBO/Ising problems with arbitrary connectivity, and integer factorization. It is also shown that circuit satisfiability problems can be mapped into UDG-MWIS and so all other NP problems can be mapped through circuit satisfiability if no better low-overhead mapping is found. The general framework for mapping combinatorial optimization problems defined on graphs can be seen in FIGS. 27A-D. First, the variables corresponding to vertices in the original graph can be encoded in one-dimensional chains of atoms using the “copy gadget”. These chains (represented by lines) are then arranged in the form of a crossing lattice shown in FIG. 27B, exhibiting exactly one crossing between each pair of lines. For each such crossing, additional gadgets are used—the “crossing gadget” and the “crossing-with-edge gadget”—to encode the presence (and strength) or absence of an interaction for each pair of lines. All these gadgets are carefully designed such that the resulting graph is a UDG (embedded on a square lattice), and the solution of the original problem is encoded in its MWIS. The mapping for the factoring problem follows a similar strategy (FIGS. 27E-G): the problem of finding the prime factors of a N-bit integer is first encoded into an optimization problem; with the help of a crossing lattice and a properly designed factoring gadget, this optimization problem is then transformed to a UDG-MWIS problem. In all cases, the overhead in the number of qubits is at most O(N²), which is optimal for arbitrary connectivity.

### Rydberg Atom Arrays

This work is motivated by recent advances in experiments with Rydberg atom arrays using neutral atoms in optical tweezers. In these systems, atoms can be deterministically placed at programmable positions in two dimensions. Each atom realizes a qubit with an internal ground state representing |0 [symbol] and a highly excited, long-lived Rydberg state representing |1 [symbol] . The atoms can be coherently manipulated with laser fields and interact pairwise via induced dipole-dipole interactions when two atoms are in the Rydberg state. Specifically, the laser induced quantum dynamics of this system can be described by the Hamiltonian

$${H}_{RYD} = {\sum }_{v} \frac{{Ω}_{v}}{2} {σ}_{v}^{x} - {\sum }_{v} {Δ}_{v} {n}_{v} + {\sum }_{v < w} {V}_{Ryd} ( \vert \vec{{r}_{v}} - \vec{{r}_{w}} \vert ) {n}_{v} {n}_{w} \qquad Equation 93$$

Here, \vec{rᵥ} denotes the position of the atom labeled by v,

$${{{σ}_{v}^{x} = \vert 1 〉}_{v} 〈 0 \vert + \vert 0 〉}_{v} 〈 1 \vert$$

coherently flips its internal state, and nᵥ=|1 [symbol] ᵥ [symbol] 1| counts if the atom is in the Rydberg state. The parameters Ωᵥ and Δᵥ are the Rabi frequency and laser detuning for the vth atom, respectively. In experiments, the laser detuning can be controlled in a site-dependent way, for example, using local AC-Stark shifts. The interaction potential V_{Ryd}(|\vec{rᵥ}−\vec{r_{w}})=C₆/|\vec{rᵥ}−\vec{r_{w}}|⁶ leads to a strong (distance-dependent) energy penalty for configurations where two nearby atoms are simultaneously in the Rydberg state, giving rise to the so-called Rydberg blockade mechanism. As a result, the low-energy states of the Hamiltonian do not contain states with pairs of atoms that are both in the Rydberg state if they are within some characteristic distance, defined as the blockade radius r_{B}. This effect naturally imposes the independent set constraint on the ground state(s) of the Hamiltonian at Ωᵥ=0, which, as discussed below, allows one to encode the MWIS of a corresponding UDG. In this classical limit (Ωᵥ=0), it is convenient to define the blockade radius r_{B} via V_{Ryd}(TB)=maxᵥ(Δᵥ), which is the convention adopted throughout this disclosure.

### Unit Disk Graphs

A unit disk graph is a graph G=(V, E) with vertices V and edges E that can be embedded in the two-dimensional (2D) Euclidean plane such that two vertices are connected by an edge if and only if they are separated by a distance smaller than a unit radius. Unit disk graphs are notable since they are in one-to-one correspondence with atom arrangements in 2D. Specifically, each atom represents a vertex, and the blockade radius is identified with the unit disk radius of the graph. In this way, the low-energy configurations of the atom array at Ωᵥ=0 correspond to large independent sets of the unit disk graph.

### Maximum Weight Independent Sets

An independent set of a graph G is the subset of vertices S⊆V, such that none of the vertices in S are connected by an edge in G. The largest such independent set is called a maximum independent set. Note that in general the MIS may not be unique. The problem of finding a MIS is called the maximum independent set problem. The MIS problem can be generalized to the maximum weight independent set problem, where each vertex is assigned a weight δᵥ>0, and accordingly, a weight W_{S} is assigned to each subset of vertices S⊆V via W_{S}=Σ_{v∈S}δᵥ. The MWIS problem is to find an independent set with the largest weight. It can be formulated as an energy minimization problem. For this, one can associate a binary variable nᵥ∈{0, 1} with each vertex v∈V. This allows us to identify a subset of vertices S by a bitstring n=(n₁, n₂, . . . ), via S={v∈V|nᵥ=1}. Using this representation, the following cost function is obtained

$${H}_{MWIS} = {\sum }_{v ∈ V} {δ}_{v} {n}_{v} + {\sum }_{( u , v ) ∈ E} {U}_{uv} {n}_{u} {n}_{v} , \qquad Equation 94$$

If Uᵤᵥ>δ_{w}>0 for all u, v, w, the ground state configuration of H_{MWIS} indeed corresponds to the MWIS. As in the unweighted case, the ground state can be degenerate, corresponding to multiple independent sets achieving the same maximum weight. Note that the particular scale of Uᵤᵥ does not change the low-energy properties (i.e., the energy of the states corresponding to independent sets) as long as Uᵤᵥ>max_{w}δ_{w}.

If the graph G is a UDG, the corresponding MWIS problem may be referred to as the UDG-MWIS problem. Importantly, for such UDG-MWIS problems, the Hamiltonian Equation 94 coincides with the Rydberg atom array Hamiltonian Equation 93 at Ω=0, where each atom is placed at the respective location of the corresponding vertex, the blockade radius is identified with the unit disk radius (and the interaction tails beyond the blockade radius are neglected), and the weight of each vertex is identified with the local detuning Δᵥ=δᵥ. Hence, it is a goal of the following to encode a variety of problems of interests in UDG-MWIS.

### Encoding Gadgets

In the discussion below, a number of encoding gadgets are constructed, which are the basic tools used in this disclosure to reformulate a variety of optimization problems as UDG-MWIS. To this end, solutions of a set of elementary constraint satisfaction problems are encoded as the solutions of a MWIS problem on properly constructed unit disk graphs.

### Constraint Satisfaction Problems as MWIS

Consider a set of binary variables n=(n₁, n₂, . . . ) with nᵢ∈{0,1} and a set of constraints between them, denoted by C, that can be simultaneously satisfied by one or more assignments. This constraint satisfaction problem is represented as a MWIS problem by constructing a weighted graph G_{C}, such that the constraint-satisfying assignments are in correspondence with the maximum weight independent sets of G_{C}. More specifically, the MWIS problem on G_{C} represents the constraint satisfaction problem C if every MWIS of G_{C} coincides with a satisfying assignment of C, and if every satisfying assignment of C corresponds to at least one MWIS of G_{C}. Note that the number of vertices in G_{C} can be larger than the number of variables in C, in which case the correspondence between the MWISs and the satisfying assignments is required only on the subset of vertices that correspond to the variables in C. Below, this concept is illustrated on several examples.

### Single Constraints

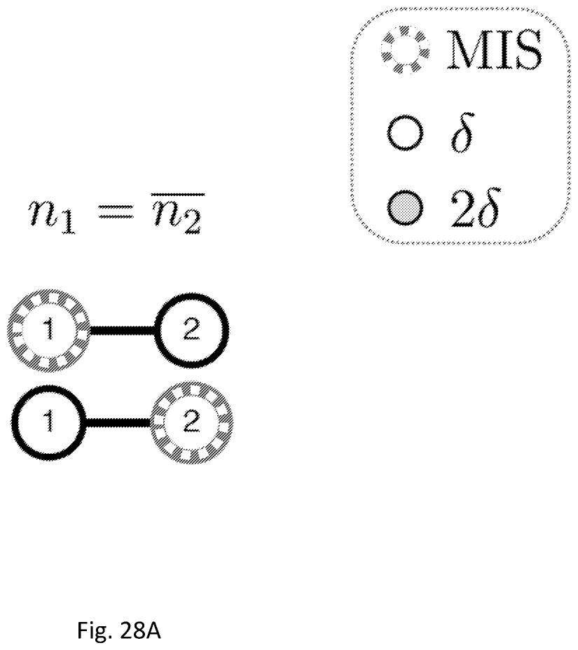

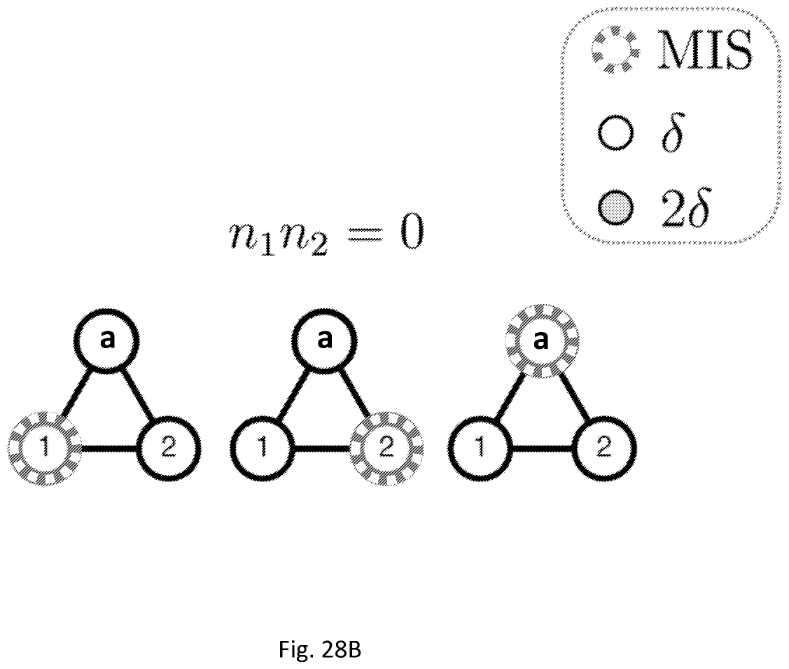

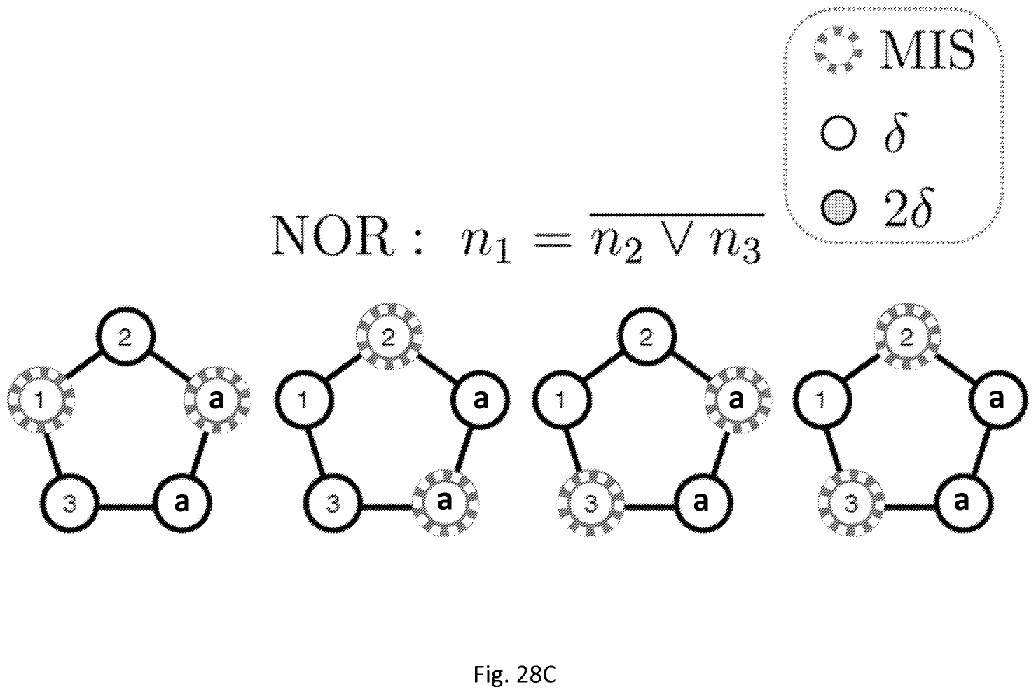

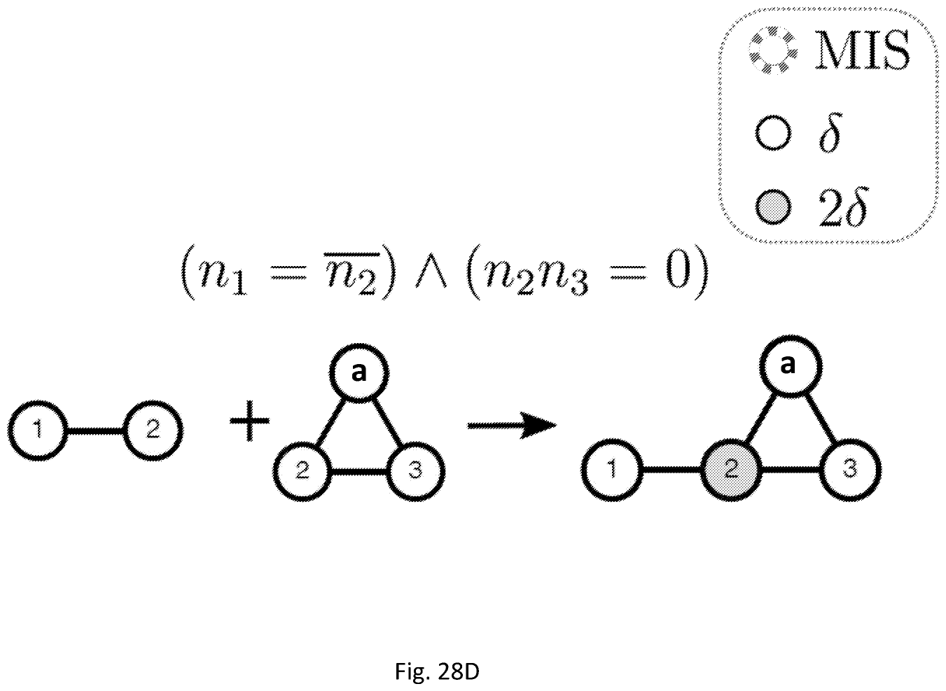

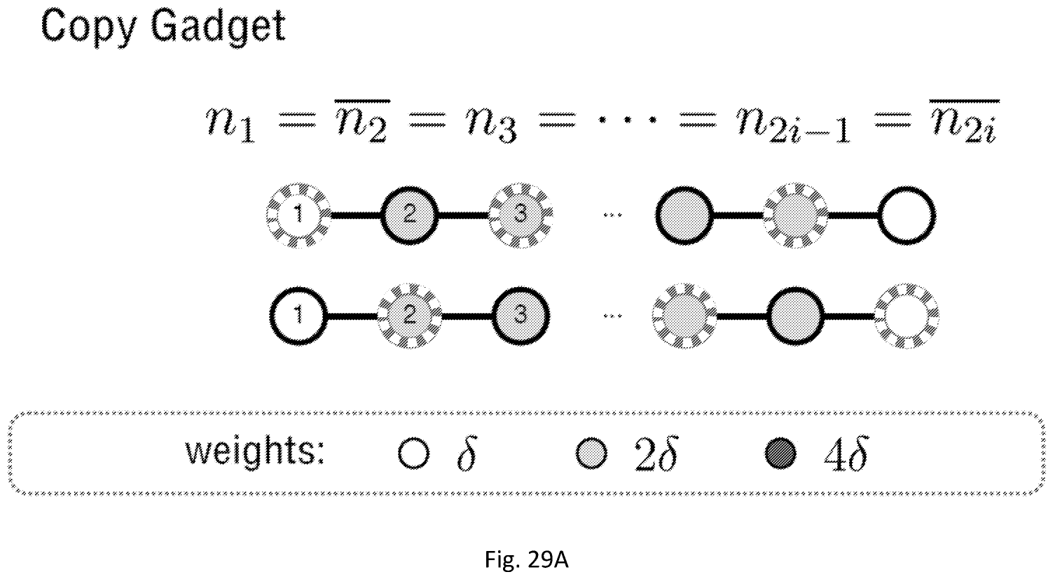

Referring to FIGS. 28A-28D, an MWIS representation of some example constraints is provided. Each bit is represented by a corresponding vertex in the MWIS problem graph. The weight of the vertices is indicated by its interior color on a gray scale. For each example, the degenerate MWIS configurations are shown by identifying vertices in a MWIS with a dashed boundary. The MWISs correspond to the satisfying assignments to the corresponding constraint satisfaction problem. FIG. 28A shows a MWIS representation of n₁=n̅₂̅. FIG. 28B shows a MWIS representation of n₁n₂=0, with the third, unlabeled vertex being an ancillary vertex. For each of the three MWIS states, the configuration on the relevant vertices 1 and 2 matches the corresponding satisfying assignment. FIG. 28C shows a MWIS representation of the NOR constraint using 2 ancilla vertices. Note that only 4 of the 5 MWIS states are shown. Nevertheless, all 5 MWIS states correspond to the four satisfying assignments on the relevant vertices 1, 2 and 3. FIG. 28D shows a set of constraints C={n₁=n̅₂̅, n₂n₃=0}, where each is of the form given in FIGS. 28A and 28B. The corresponding MWIS problem is obtained by combining the two graphs corresponding to both constraints in C, resulting in the weighted graph on the right. Observe that vertex 2, which appears in both constraints, has twice the weight of the other vertices.

First consider the simple example of two bits n=(n₁, n₂) with a single constraint

$${n}_{1} = \overline{{n}_{2}} \qquad Equation 95$$

where n̅ₗ̅≡1−nᵢ denotes the negation of nᵢ. This simple NOT constraint has two satisfying assignments, n=(1, 0) and n=(0, 1).

This constraint satisfaction problem is represented as a MWIS problem on a graph with two equally weighted vertices connected by an edge (FIG. 28A), whose cost function is simply H_{MWIS}=−δ(n₁+n₂)+Un₁n₂, with U>δ>0. This graph has two degenerate MWISs, n=(1,0) and n=(0,1), which are indeed in one-to-one correspondence to the two satisfying assignments of the constraint.

Note that for these two assignments, the cost function evaluates to H_{MWIS}=−δ, while a violation of the constraint incurs a cost δ>0 (for n=(0, 0)) or a cost of U−2δ>0 (for n=(1, 1)), rendering them energetically unfavorable. For the remainder of this discussion, the quantity δ_{gap}=min(U−δ,δ)>0 is used as the minimum energy penalty for violation of a constraint.

Next, consider another simple two-variable constraint:

$${n}_{1} {n}_{2} = 0 \qquad Equation 96$$

This constraint has three satisfying assignments n∈{(0,0), (1,0), (0, 1)} and may be represented as a MWIS problem on a complete graph with three vertices with equal weights (FIG. 28B). The first two vertices, labelled 1 and 2, correspond to the two bits of interest, while the third vertex, labelled a, corresponds to an ancillary variable.

The cost function associated with this MWIS problem is H_{MWIS}=−δ(n₁+n₂+n₃ₐ)+U(n₁n₂+n₂n₃ₐ+n₃ₐn₁), with the three degenerate solutions corresponding to the three satisfying assignments, with nₐ being an ancilla qubit. Importantly, each of the three MWIS states coincides with one of the three satisfying assignments on the two vertices of interest (see FIG. 28B). Again, a violation of the constraint incurs an energy cost of at least δ_{gap}.

In this manner, one can construct the MWIS representation of all the basic operations in Boolean logic, by providing a gadget that is the MWIS representation of the NOR constraint in FIG. 28C.

### Conjunction of Constraints

Consider now a situation where C consists of a set of multiple constraints that have to be satisfied simultaneously. For example, consider a conjunction of constraints involving three bits:

$$( {n}_{1} = \overline{{n}_{2}} ) ⋀ ( {n}_{2} {n}_{3} = 0 ) \qquad Equation 97$$

which has three satisfying assignments, (n₁, n₂, n₃)∈{(1,0,0), (1,0,1), (0,1,0)}. To construct a corresponding MWIS representation, first consider the two MWIS representations for the two involved constraints individually, which are given in FIGS. 28A and B, and then simply combine them by constructing the union of the individual graphs and add their weights (FIG. 28D). Equivalently, the two cost functions of the two individual constraints are added to obtain the MWIS cost function encoding of Equation 97:

$${H}_{MWIS} = - δ ( {n}_{1} + 2 {n}_{2} + {n}_{3} + {n}_{4 a} ) + U ( {n}_{1} {n}_{2} + {n}_{2} {n}_{3} + {n}_{3} {n}_{4 a} + {n}_{4 a} {n}_{2} ) \qquad Equation 98$$

The ground states of this cost function correspond to the satisfying assignments in Equation 97 on the vertices of interest, i.e. vertices 1, 2 and 3.

This example generalizes to the following important observation: Consider a set of constraints, C={C₁, C₂, . . . }, allowing for at least one satisfying assignment. Given the MWIS representations of each individual constraint Cᵢ, a MWIS representation of C can be constructed by simply adding all the MWIS cost functions for all individual constraints in C.

The resulting cost function for C indeed corresponds to a MWIS problem: its graph is simply the union of the individual graphs corresponding to the Cᵢs, with the corresponding weights added on the respective vertices. Note that, in general, this strategy could result in edges appearing in multiple constraints, producing inhomogeneous edge weights. However, because the satisfying assignments are independent sets, the edge constraint can be homogenized by considering an equivalent problem of homogeneous edge weights by choosing a large enough U>>δ.

This is a powerful method that allows building MWIS representations of complicated constraints out of simpler ones. The utility of this tool can already be illustrated by noting that the combination of the NOT and the NOR constraints (FIGS. 28A and 28C) is universal. This immediately implies that any circuit satisfiability problem can be encoded into a MWIS problem with a constant overhead using this construction.

### Gadgets for Unit Disk Transformation

While the representations introduced in the previous subsection allow the encoding of arbitrary constraint satisfaction problems into MWIS, additional gadgets are required for the specific task of transforming general graph problems into UDG-MWIS problems, which can then be natively implemented using Rydberg atom arrays.

### Copy Gadget and Effective Bits

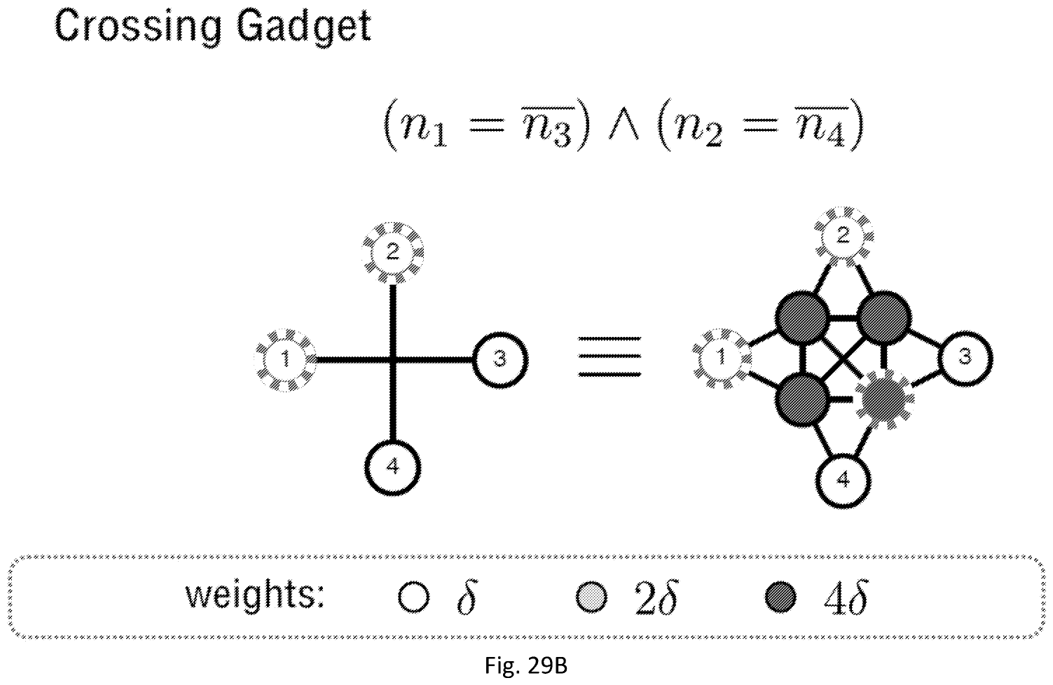

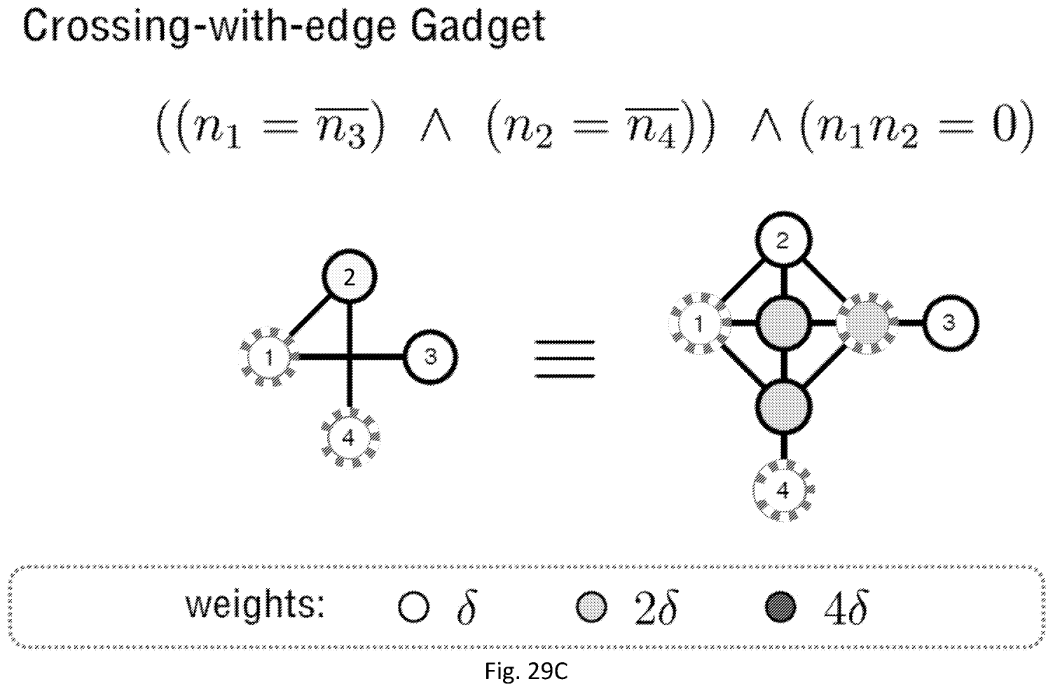

Referring to FIGS. 29A-29C, gadgets for formulating constraint satisfaction problems as UDG-MWIS are illustrated. FIG. 29A shows a copy gadget. A 1D line graph encodes an effective bit. The two degenerate MWIS solutions are shown: the subset of odd-numbered vertices (top) and even-numbered vertices (bottom) represent the effective bit values 1 and 0, respectively. In this way, one can copy a single bit to any odd-numbered vertex. FIG. 29B shows a crossing gadget. The four degenerate MWIS solutions of the left graph coincide with the four MWIS solutions on the right graph on vertices 1,2,3,4. One of these solutions is shown. Given a graph that contains a crossing, it can be replaced with the right UDG, without changing the structure of the MWIS solution. FIG. 29C shows a crossing-with-edge gadget. Similar to FIG. 29B, any subgraph of the type depicted on the left can be replaced with the UDG on the right. One can check the MWIS solutions have one-to-one correspondence. The weights in FIG. 29A-29C are encoded in grayscale according to the legend at the bottom of the figure.

By combining N constraints of the form nₘ=n̅ₘ̅₊̅₁̅, a gadget is obtained, called the copy gadget:

$${n}_{1} = \overline{{n}_{2}} = {n}_{3} = \overline{{n}_{4}} = … \qquad Equation 99$$

Here, the information of the bit n₁ is copied to all odd-index bits n₃, n₅, . . . . As the name suggests, this copy gadget is useful in situations where the value of the bit n₁ is needed in several distant locations or in a location in conflict with the unit-disk requirement. Conceptually, copy gadgets “stretch” the representation of a bit from a vertex (a point-like structure) to a one-dimensional line, while staying in the paradigm of unit-disk graphs. This technique is similar to other encoding approaches of using wires or chains of virtual vertices.

The MWIS representation of the copy gadget in Equation 99 can be constructed. It consists of a one-dimensional graph with N vertices and edges between neighboring vertices. All vertices have a weight 2δ, except for the two boundary vertices of the line, which have weights δ (see FIG. 29A). Indeed, this weighted graph has two degenerate MWIS solutions: n=(1, 0, 1, 0, . . . ) and n=(0, 1, 0, 1, . . . ), corresponding to the two satisfying assignments of Equation 99. Thus, these two states can be used to represent the effective binary variable with values 1 and 0 respectively (corresponding to the value of n₁). Note that the 1D line representation does not necessarily need to be drawn as a straight line when embedded in a 2D plane; it can bend and have kinks, as long as the resulting embedding satisfies the unit-disk criterion.

This effective bit can be equipped with an effective weight w by simply favoring one of the two staggered configurations with respect to the other. For instance, this can be achieved by adding an additional weight w to any one of the equivalent vertices with an odd index in this gadget, e.g., the boundary vertex n₁. More generally, an effective weight w can be induced by any vertex weight configuration as long as it satisfies

$${\sum }_{m = 0}^{i} {δ}_{2 m = 1} = W + {\sum }_{m = 1}^{i} {δ}_{2 m}$$

and 0<δ_{m,w}<U. The latter inequalities ensure that the two staggered configurations remain the two lowest energy states, i.e., states with defects have a lower weight.

### Crossing Gadget

The copy gadget allows the effective representation of a binary variable as a 1D line on a UDG. When there are multiple such variables in a geometric representation, it can be extremely useful to allow two such lines to cross, without introducing any coupling between their corresponding effective degrees of freedom. However, such a crossing manifestly violates the unit-disk constraint. This problem is solved with the crossing gadget.

For this, consider the following set of constraints between four binary variables

$$( {n}_{1} = \overline{{n}_{3}} ) ⋀ ( {n}_{2} = \overline{{n}_{4}} ) \qquad Equation 100$$

One way to represented this as a MWIS problem is to identify each variable as an equally weighted vertex in a graph with edges E={(1, 3), (2, 4)}. Depending on the relative location of the vertices in the 2D plane (which might be fixed, e.g., due to additional constraints), these two edges might need to cross each other, violating the unit disk requirement. The crossing gadget is an alternative MWIS representation of the same pair of constraints in Equation 100 that avoids this issue. This gadget is depicted in FIG. 29B and contains 4 ancillary binary variables (vertices). Note that the vertices representing the original variables are weighted equally with a weight δ, while the four ancillary vertices have a weight 4δ. Any weight larger than 2δ for the ancillary vertices would work. The choice 4δ is convenient, since it homogenized defect energies when crossing gadgets are combined with copy gadgets. This graph is manifestly a UDG and realizes the desired relative geometrical distribution of the vertices 1, 2, 3 and 4. One can easily check that it has four-fold degenerate MWISs, which correspond to the four satisfying assignments on the four original vertices.

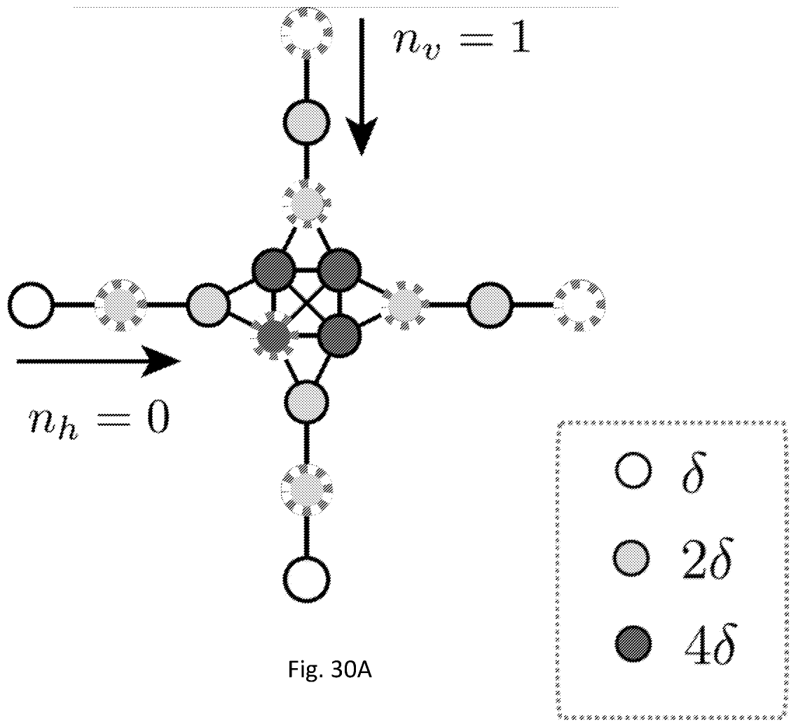

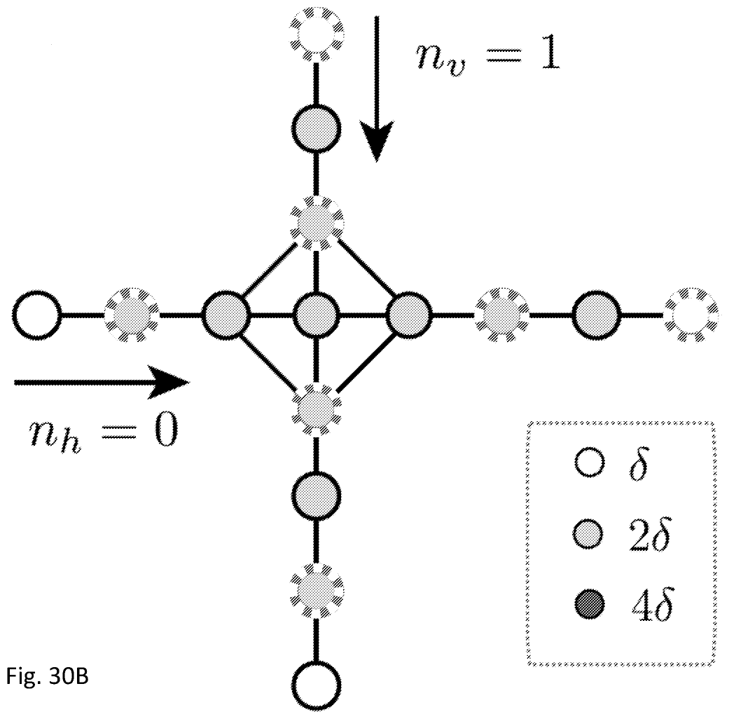

Referring to FIG. 30A, two decoupled effective degrees of freedom are shown. By combining the copy gadget and the crossing gadget, two 1D lines are formed, here drawn horizontally and vertically. Both lines represent a binary variable, nₕ∈{0,1} and nᵥ∈{0,1}, respectively. The crossing gadget effectively decouples these degrees of freedom. Accordingly, this weighted graph has a 4-fold degenerate MWIS, corresponding to the 4 possible states of two binary variables. One of the MWISs is shown in dashed line corresponding to nₕ=0 and nᵥ=1. Note that each of the four MWISs contains exactly one of the 4 internal vertices of the crossing gadget, so these internal vertices encode the states of both effective degrees of freedom.

Referring to FIG. 30B, two effective degrees of freedom, defined on a horizontal and a vertical line respectively, that satisfy an independence constraint nₕnᵥ=0, (introduced by the crossing-with-edge gadget of FIG. 29C) are shown. Note that this graph has exactly 3 degenerate MWIS (out of which, one is shown in dashed line), corresponding to the configurations (nₕ, nᵥ)∈{(0,0), (0,1), (1,0)}.

FIG. 30A illustrates how to combine a crossing gadget and the copy gadget to define two decoupled effective binary degrees of freedom realized on two lines, a horizontal one and a vertical one. Specifically, in FIG. 30A, the two effective degrees of freedom are realized by the two staggered configurations of the horizontal and vertical line, and the crossing gadget decouples them; this structure is realized by extending each boundary vertex of the crossing gadget using the copy gadget. Following the recipe given herein, one defines a vertex weight pattern with weights 4δ on the interior vertices of the crossing gadget, weight 2δ on the exterior vertices of the crossing gadget and on all vertices of the lines, except for the boundary vertices of each line, which have a weight δ.

By generalizing this example, it can be seen that the copy gadget allows one to represent binary variables as lines and the crossing gadget allows these lines to cross without introducing any interactions or constraints between their effective degrees of freedom, so these effective 1D lines can be arranged arbitrarily in 2D without crossings between them.

### Crossing-with-Edge Gadget

The crossing gadget is useful to decouple effective degrees of freedom defined on lines, even if the lines cross. In contrast, an additional gadget is introduced that allows one to introduce a specific type of interaction between the effective degrees of freedom. Specifically, the target gadget is one that introduces the independence constraint nᵤnᵥ=0 between two effective variables, nᵤ and nᵥ, when their corresponding lines cross. For this, consider the situation where four binary variables must satisfy the constraints

$$( ( {n}_{1} = \overline{{n}_{3}} ) ⋀ ( {n}_{2} = \overline{{n}_{4}} ) ) ⋀ ( {n}_{1} {n}_{2} = 0 ) \qquad Equation 101$$

where in this case, nᵤ≡n₁, nᵥ≡n₂. This corresponds to the MWIS problem on the graph on the left of FIG. 29C. In particular, consider the situation where the vertices are geometrically positioned relative to each other in a way that requires a crossing; this case indeed occurs when n₁, n₃ and n₂, n₄ each belong to a line (created by a copy gadget) that corresponds to the effective binary variable associated with n₁ and n₂. This graph is, however, not a unit-disk graph, so the crossing-with-edge gadget shown on the right of FIG. 29C is introduced. The resulting graph is manifestly a unit-disk graph with a three-fold degenerate MWIS solutions, corresponding to the three satisfying assignments of the crossing-with-edge constraint required in Equation 101.

Analogous to the discussion of the crossing gadget, the crossing-with-edge gadget can also be combined with copy gadgets to obtain two crossing lines (drawn horizontally and vertically in FIG. 30B) that host two effective binary degrees of freedom, respectively, with an independence constraint between them. The resulting weight pattern is shown in FIG. 30B.

### Arbitrary Connectivity

Using the suite of encoding gadgets introduced in the previous section, a variety of computational problems can be encoded into UDG-MWIS, which can then be readily implemented on Rydberg atom arrays. In this discussion, three example applications are provided in detail: MWIS on graphs with arbitrary connectivity, QUBO problem, and the integer factorization problem. As shown below, the resulting UDGs can be embedded on a square lattice with at most a quadratic overhead. The recipe involves two main steps: the first is to construct the so-called crossing lattice using the copy gadget, and the second is to apply crossing replacements to encode arbitrary connectivity.

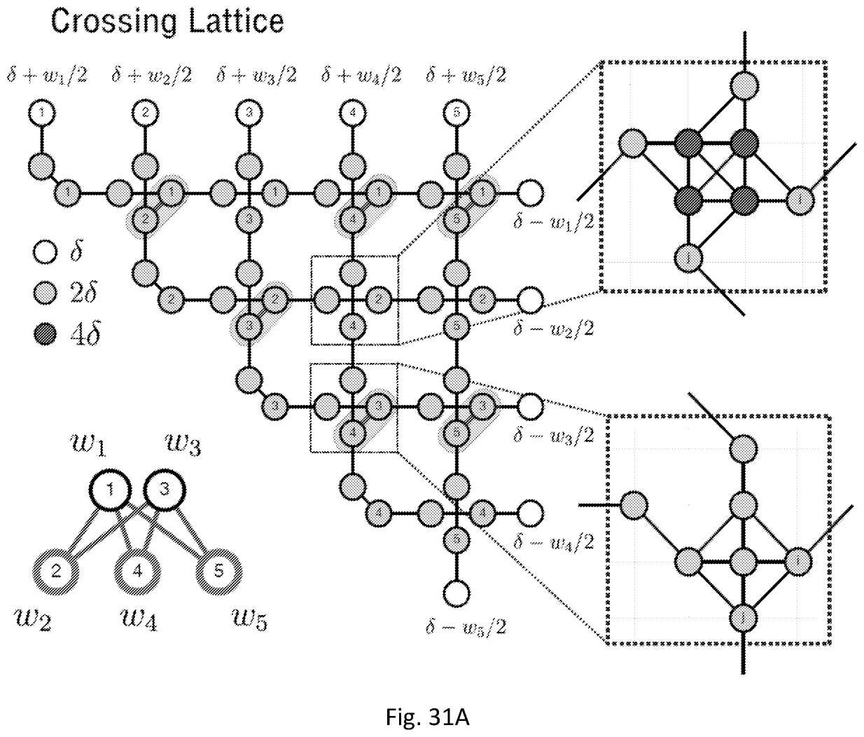

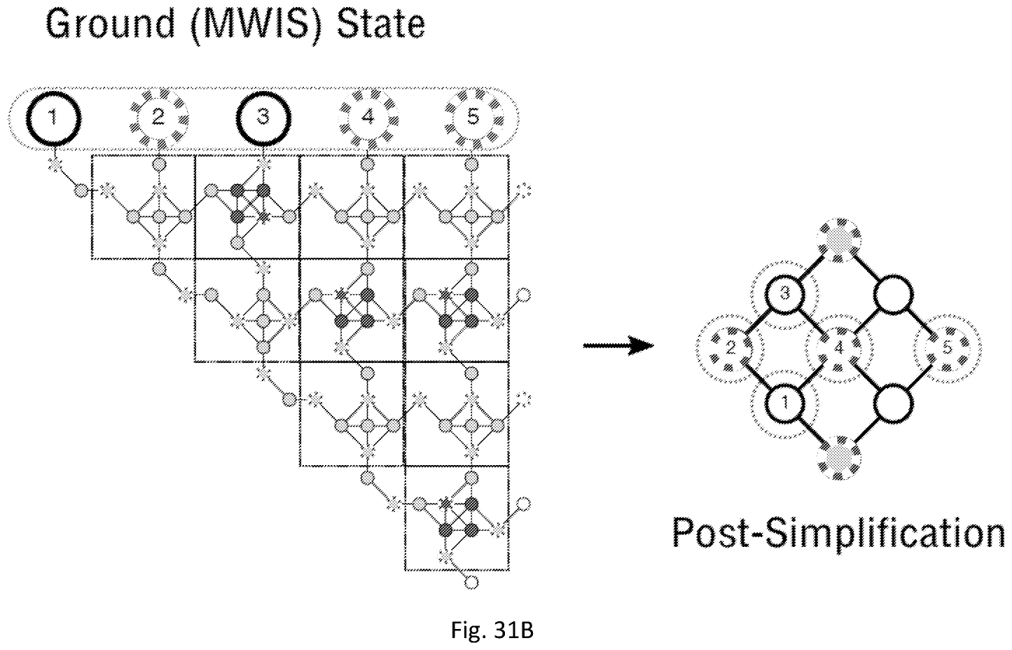

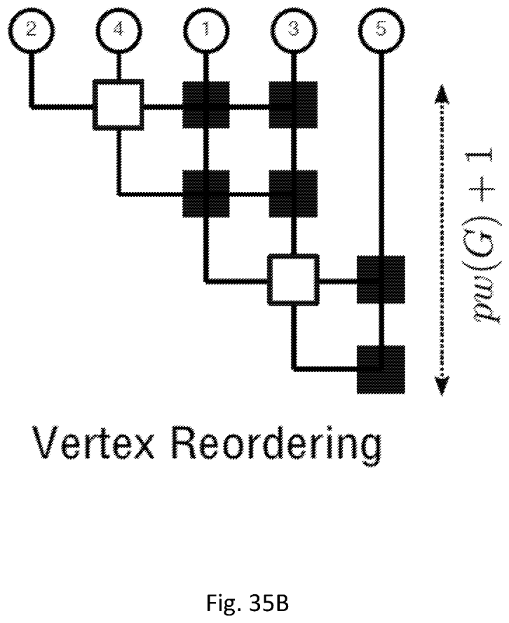

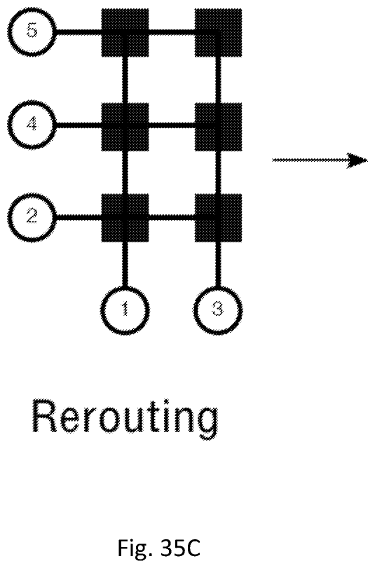

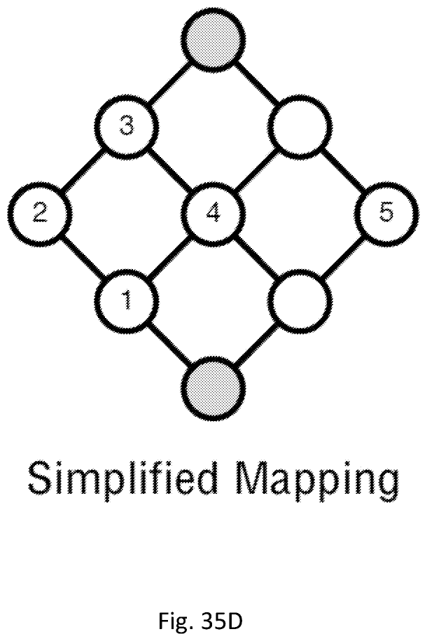

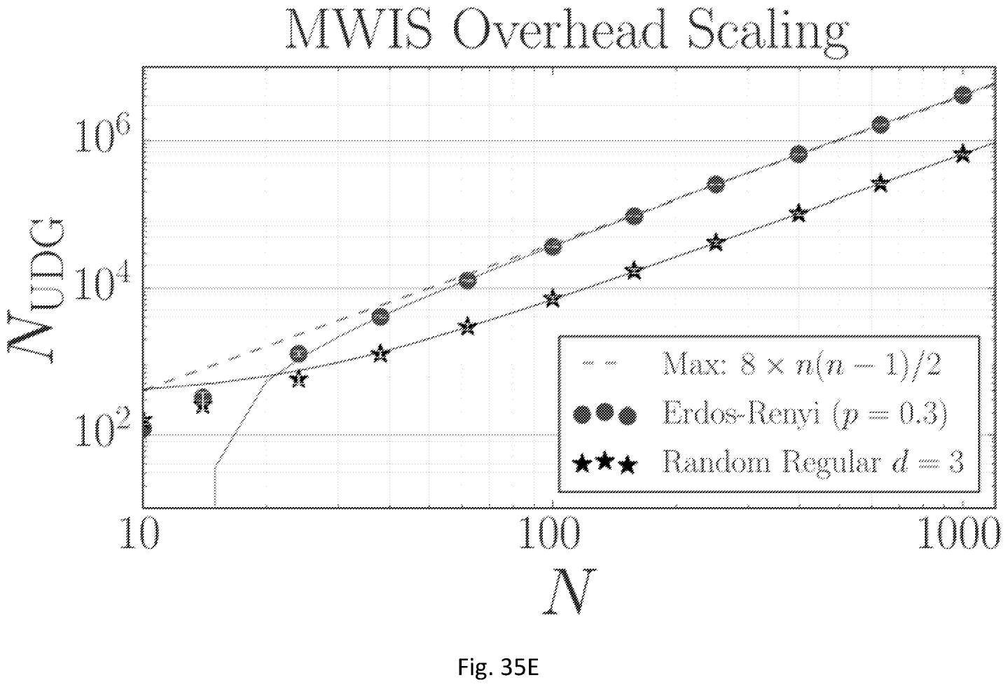

Referring to FIGS. 31A-31B, an example encoding procedure is given for the MWIS problem on the K_{2,3} (non-unit-disk) graph into UDG-MWIS. FIG. 31A illustrates a crossing lattice. Each vertex v is represented by a line using the copy gadget, with odd-numbered vertices labeled. Each line is bent to form a triangular lattice, giving a crossing point between any two variables. If the two variables share an edge in the original graph, an edge can be drawn between their representative vertices on the lattice. A UDG is then obtained by replacing each crossing with a crossing or crossing-with-edge gadget. FIG. 31B shows a UDG representation and the corresponding ground state solution. Each crossing in FIG. 31A is replaced with a unit cell containing at most 8 vertices, thus resulting in a final mapping with 92 vertices. The MWIS of the original graph ({2, 4, 5}) can be read out from the boundary vertices of the ground state of the mapped graph. This mapping can further be simplified (see FIG. 35D) to a mapping of only 9 vertices, where the vertices corresponding to the original degrees of freedom still encode the desired MWIS solution.

### The Crossing Lattice

Consider an optimization problem for N binary variables, such as the MWIS problem defined on an arbitrary graph G=(V, E), where each vertex represents a binary degree of freedom.

To realize arbitrary connectivity, the copy gadget is first used to represent each vertex v∈V by a 1D vertex line. The state of the binary variable associated with a vertex v (0 or 1) can then be accessed at any odd-index vertex of the corresponding line (FIG. 29A). As detailed below, interactions between the effective degrees of freedom represented by these lines can be introduce at points where the lines cross. To achieve arbitrary connectivity, each line must thus cross every other line at least once. A simple layout achieving this is shown abstractly in FIG. 27B, where each line is drawn with a vertical and a horizontal segment, forming an upper triangular crossing lattice. In this way, a line (representing vertex v) crosses any other line (representing vertex w) exactly once. At these crossing points, the various crossing gadgets introduced in the previous section can be used to induce interactions between v and w or to keep them decoupled. In addition to introducing interactions, these gadgets also turn the resulting graph explicitly into a UDG. Note that the resulting graph can be constructed by N(N−1)/2 “tiles”, each containing 8 vertices for a tile formed by a crossing gadget, or 7 vertices for a tile formed by a crossing-with-edge gadget. Taking into account the boundary vertices, this construction leads to a UDG with at most 4N² vertices, corresponding to the optimal quadratic overhead for arbitrary connectivity.

This particular choice of “weaving” lines together may be sub-optimal, especially if the connectivity is sparse. In such a case, the total size of the lattice and thus the encoding overhead can be reduced by forming more sophisticated crossing lattices.

### Maximum Weight Independent Set

Building on the above recipe, this discussion provides how to map the MWIS problem on an arbitrary weighted graph G=(V, E) with vertex weights wᵥ (v∈V) to a UDG-MWIS problem. As shown in FIG. 31A, a crossing lattice is created using the copy gadget. At each crossing point between two lines (corresponding to vertices u, v∈V), the effective degrees of freedom are decoupled using a crossing gadget if (u, v)∉E, or induce an independence constraint for the effective degrees of freedom via a crossing-with-edge gadget if (u, v)∈E, as shown in FIG. 31B. This results in a UDG that can be embedded on a square lattice (whose diagonal sets the unit disk radius). The weights on the vertices of this UDG are 2δ on all vertices except the 4 interior vertices of the crossing gadget (which have weight 4δ) and the 2 boundary vertices of each line, whose weights are chosen to introduce the correct effective weights wᵥ for the effective variable represented by each line. A convention is chosen in which the first vertex along the line v has a weight δ+wᵥ/2, and the last vertex along this line has a weight δ−wᵥ/2. Note that to guarantee that the MWIS of the resulting UDG is indeed formed by the proper low energy configurations of each line, the weights have to satisfy 2wᵥ≤δ. This can always be achieved by a proper normalization of the weights, or a suitable choice of δ.

The MWIS of the mapped problem can be straightforwardly transformed back to a valid solution in the original problem. Indeed, since the state of the effective degrees of freedom associated with each line can be accessed at the first vertex of the line, the MWIS of the original problem is directly given by the configuration of the boundary vertices of the MWIS of the mapped problem. This solution readout is shown in the circled portions of FIG. 31B.

### Quadratic Unconstrained Binary Optimization

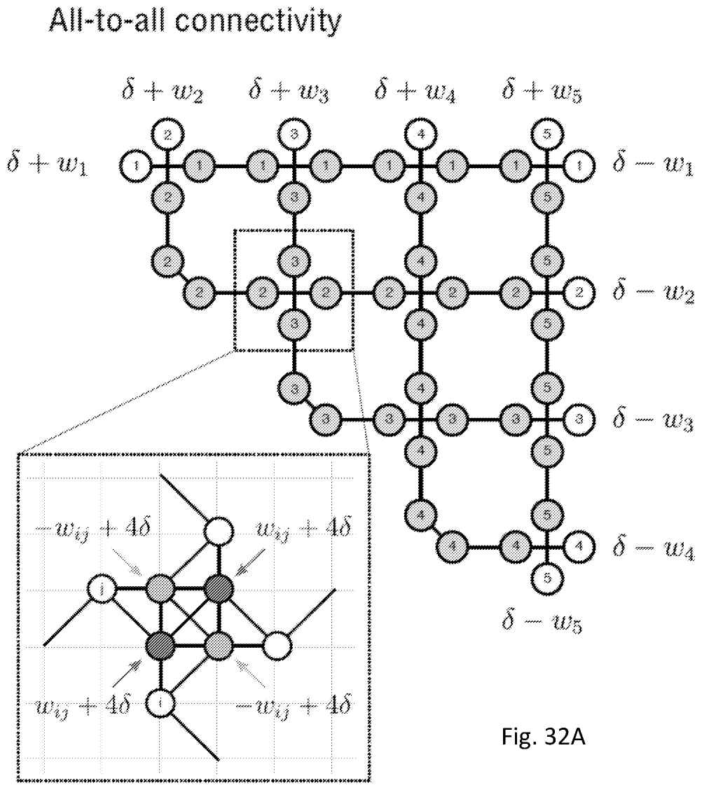

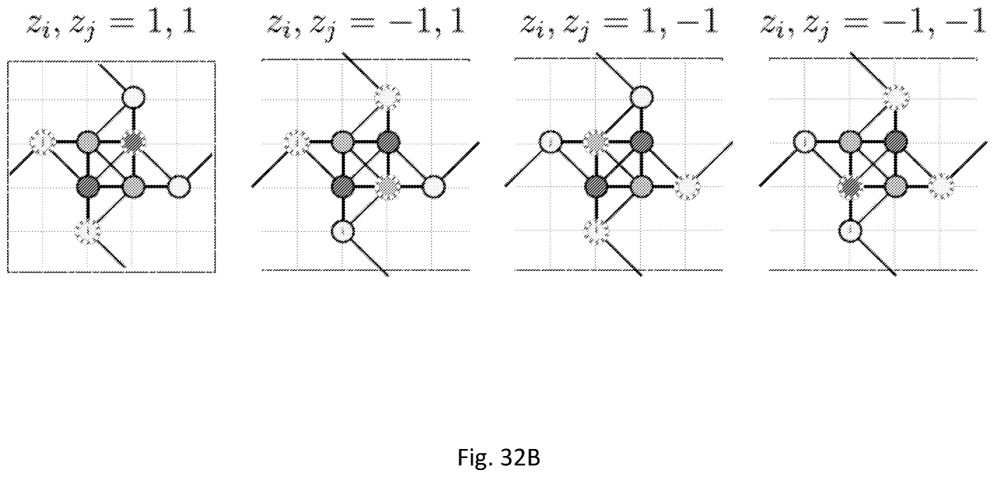

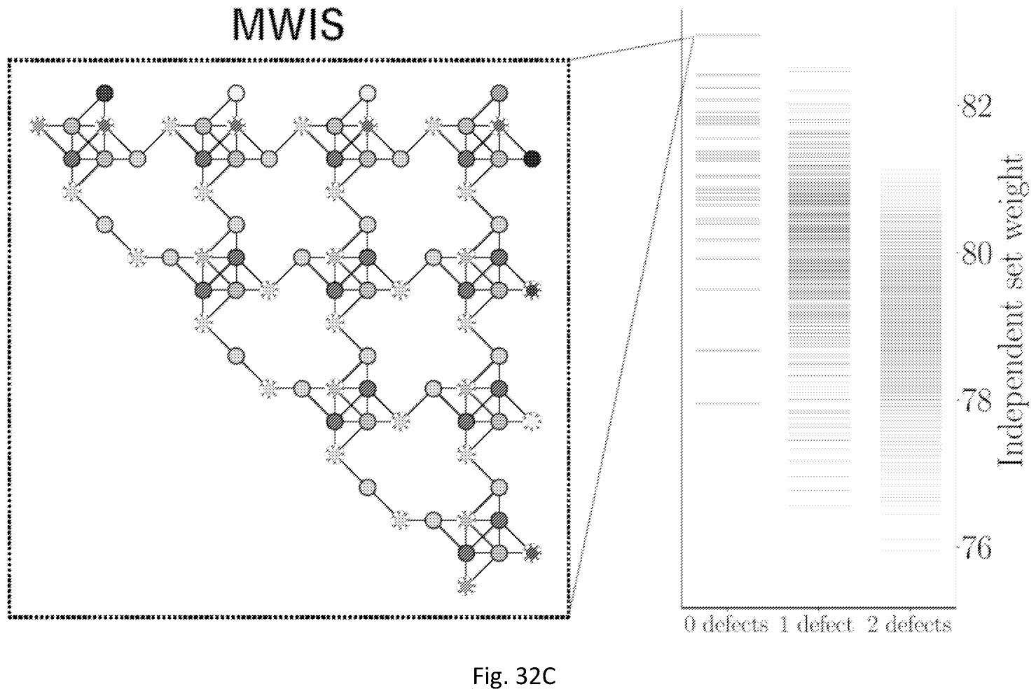

Referring to FIGS. 32A-32C, an example encoding procedure for the QUBO/Ising problem for a 5-bit system is given. FIG. 32A shows a crossing lattice. Similar to the MWIS mapping, the UDG-MWIS representation of a generic QUBO problem can be constructed by inserting a gadget at each crossing. The gadget has a similar structure as the crossing gadget used in the MWIS encoding, but the weights on the ancillary vertices are biased to induce quadratic interaction terms wᵢⱼ between the effective degrees of freedom; see FIG. 32B. FIG. 32C shows an example of an encoded N=5 QUBO problem, and the high-weight spectrum of the encoded cost function, illustrating that the MWIS is indeed in the 0-defect sector and thus encodes the solution of the QUBO problem. The QUBO solution {−1, +1, +1, +1, +1} is encoded in the boundary of the graph.

QUBO is a paradigmatic NP-hard combinatorial optimization problem that has a wide range of applications. Generally, it seeks to find an input configuration that minimizes a quadratic polynomial function

$$f ( z ) = {\sum }_{i < j} {J}_{ij} {z}_{i} {z}_{j} + {\sum }_{i} {h}_{i} {z}_{i} \qquad Equation 102$$

where the domain of f is binary bitstrings z∈{±1}^{N}. QUBO is also called the Ising problem, where each bit can be represented by a spin ½ degree of freedom, and the QUBO solutions correspond to the ground states of the Ising model.

To encode the QUBO problem in a UDG-MWIS, one again starts with constructing the crossing lattice, with each line encoding one of the binary variables zi (FIG. 32A). For simplicity, the number of vertices along each line is chosen to be even. The crossing gadget is then used at each of the crossing points of the lattice, which decouples all the N effective binary degrees of freedom. Recall that at this point in the construction all vertices in the resulting graph have a weight 2δ, except for the boundary vertices on each line, which have a weight δ and the 4 interior vertices of each crossing gadgets, which have a weight 4δ. The QUBO cost function is then imposed on the effective degrees of freedom by adjusting these weights as follows: Firstly, the weight of the two boundary vertices of line i is adjusted to δ+wᵢ for the first vertex and δ−wᵢ for the last one (see FIG. 32A). For lines of even length this induces the linear term hᵢzᵢ for the effective degree of freedom zᵢ, with wᵢ=hᵢ up to normalization. Secondly, the weights of the internal four vertices of the crossover gadget between the lines representing the bits i and j are adjusted to 4δ+wᵢⱼ as depicted in the inset of FIG. 32A, where wᵢⱼ=Jᵢⱼ up to normalization. To see that this induces the quadratic interaction term Jᵢⱼzᵢzⱼ between the two effective bits, recall that exactly one of the four ancillary vertices of the crossing gadget is part of the MWIS, and that this vertex is determined by the configuration of the effective degrees of freedom zᵢ and zⱼ (see FIGS. 30A and 32B). Similar to the MWIS encoding, the additional weights have to be appropriately normalized, such that the ground state of the cost Hamiltonian consists of configurations that correspond to valid (i.e., defect-free) configurations of the effective degrees of freedom. This is guaranteed by a normalization such that maxᵢ(Σⱼ|wᵢⱼ|, |wᵢ|)<δ.

Similar to the MWIS problem, the ground state of the QUBO problem can be directly inferred from the ground state of the resulting UDG-MWIS problem. An example is shown in FIG. 32C highlighting the MWIS for a random choice of Jᵢⱼ and hᵢ, and N=5. In the inset, it is confirmed that the MWIS state is indeed the one corresponding to the solution of the QUBO problem. The weights of other independent sets are also shown, including those that do not correspond to valid configurations of the effective degrees of freedom, i.e., configurations that include defects. The weights of the configurations in the zero-defect sector have a one-to-one correspondence with the spectra of the original QUBO problem. One can see that some states with defects have a higher total weight than some states that represent valid configurations of the effective variables (i.e., without defects), but, importantly, the MWIS is guaranteed to be in the zero-defect sector given proper normalization.

In summary, any QUBO problem on N variables can be encoded in a UDG-MWIS problem with at most 4N²+ [symbol] (N) vertices. For restricted connectivity, one may construct a lower-overhead crossing lattice.

### Integer Factorization

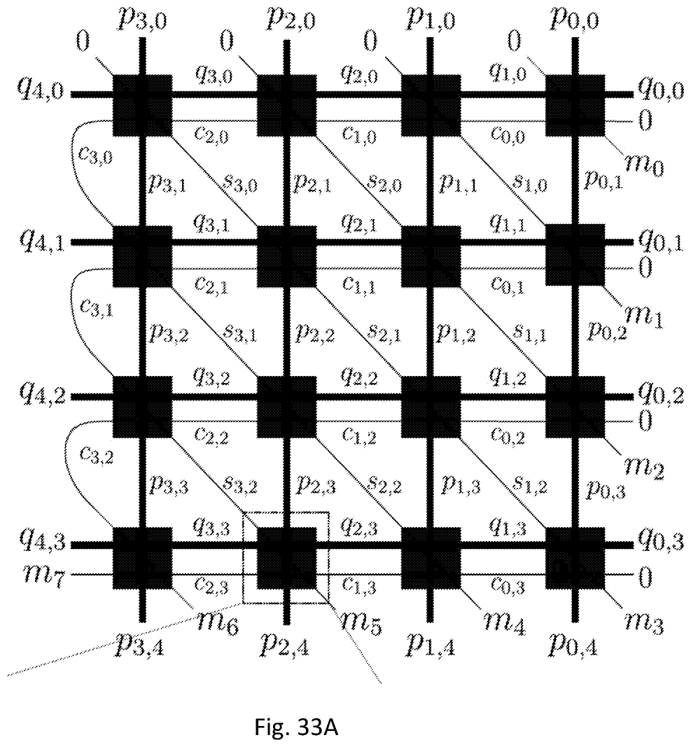

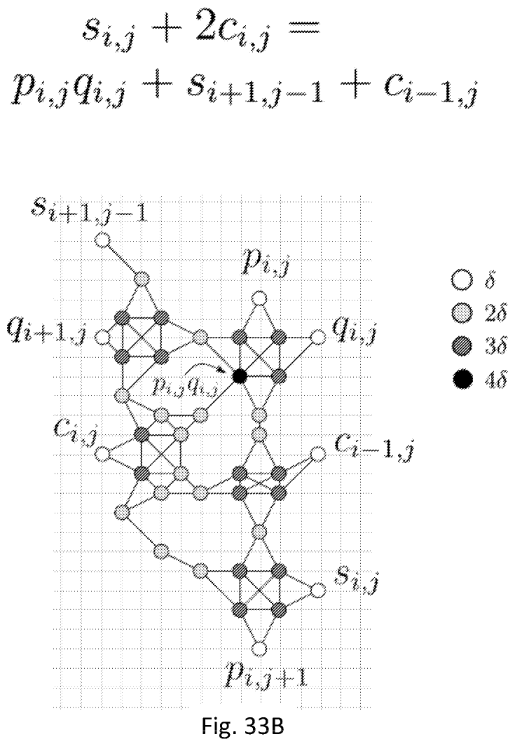

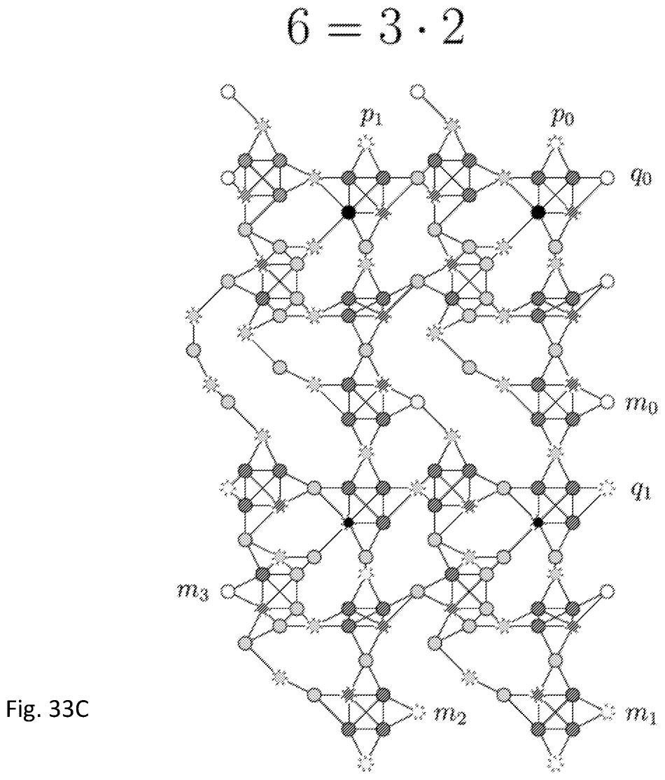

Referring to FIGS. 33A-33C, an encoding procedure for integer factorization is illustrated. FIG. 33A is a graphical representation of the set of equations to be satisfied for integer factorization (m=p·q). The factor bits pᵢ, qᵢ and binary variables s_{i,j}, c_{i,j} are represented by copy lines to construct an effective square crossing lattice for the problem, with a filled square at crossings and the integer bits mᵢ specifying some of the boundary conditions of the problem. In FIG. 33B, each filled square represents a set of equality constraints between the binary variables associated with the adjacent legs. The final UDG-MWIS can be obtained by replacing each square with the factoring gadget that enforces the mathematical constraints relevant for the factoring problem. The unit-disk radius should be slightly larger than 2\sqrt{2} times the lattice constant. FIG. 33C shows an example of the UDG-MWIS representation of the factoring problem 6=3·2.

As a final example, the problem of decomposing an n-bit composite integer m=pq into its prime factors p and q is formulated as UDG-MWIS problem. To this end, the binary representation is used for the integer

$$m = {\sum }_{i = 0}^{n - 1} {2}^{i} {m}_{i} ,$$

with mᵢ∈{0, 1},

$$p = {\sum }_{i = 0}^{k - 1} {2}^{i} {p}_{i}$$

for the k-bit integer, and

$$q = {\sum }_{i = 0}^{n - k - 1} {2}^{i} {q}_{i}$$

for the (n−k)-bit integer. The factoring problem thus amounts to finding the unknown bits pᵢ and qᵢ such that

$${\sum }_{i = 0}^{n - 1} {2}^{i} {m}^{i} = {\sum }_{i = 0}^{k - 1} {\sum }_{j = 0}^{n - k - 1} {2}^{i + j} {p}_{i} {q}_{j} \qquad Equation 103$$

Note that k is a priori unknown. However, this is not an issue, as one can consider the problem (Equation 103) for each possible value k=1, 2, . . . , n/2, or, alternatively, consider n-bit representations of both p and q.

Ancillary binary variables s_{i,j} and c_{i,j} are introduced, which may be interpreted as partial sum bits and carry bits, respectively. Using elementary algebra, the factoring problem (Equation 103) may be expressed as a system of k(n−k) coupled equations

$${s}_{i , j} + 2 {c}_{i , j} = {p}_{i} {q}_{j} + {s}_{i + 1 , j - 1} + {c}_{i - 1 , j} \qquad Equation 104$$

for i=0, . . . , k−1 and j=0, . . . , n−k−1, where the values c_{-1,j}=c_{i,0}=s_{i,-1}=0 are fixed and s_{0,j}=mⱼ. Factoring m thus reduces to finding binary values for s_{i,j}, C_{i,j}, pᵢ and qⱼ such that the k(n−k) equations (Equation 104) are all satisfied.

To embed this system of equations in a 2D plane, the copy gadget is used to copy the values of pᵢ and qⱼ to new ancillary variables p_{i,j} and q_{i,j} with the copy-constraints

$${p}_{i , j} = {p}_{i + 1 , j} \qquad Equation 105$$

$${q}_{i , j} = {q}_{i , j + 1} \qquad Equation 106$$

and identify pᵢ≡p_{i,0} and qⱼ≡q_{0,j}. Equation 103 can then be written as

$${s}_{i , j} + 2 {c}_{i , j} = {p}_{i , j} {q}_{i , j} + {s}_{i + 1 , j - 1} + {c}_{i - 1 , j} \qquad Equation 107$$

The three equations Equation 105-Equation 107 (for a given i, j) are referred to as the factoring constraints F_{i,j}. The constraints F_{i,j} are manifestly local in two dimensions, in the sense that the variables s_{i,j}, c_{i,j}, p_{i,j} and q_{i,j} can be arranged on a square lattice such that all factoring constraints F_{i,j} involve only neighboring or diagonally neighboring variables. A graphical representation of this is given in FIG. 33A, with the box at lattice point (i, j) representing the constraints F_{i,j}. Specifically, each line represents a binary variable, and each box represents the factoring constraints that have to be satisfied by the variables connected to it. Each variable enters in exactly two factoring constraints, except at the boundary.

This formulation of the factoring problem allows for a mapping to a UDG-MWIS problem. Specifically, a new factoring gadget is provided consisting of a weighted 32-vertex unit-disk graph depicted in FIG. 33B, where 8 of the vertices are identified with the 8 variables involved in the factoring constraints F_{i,j}. In particular, the design principle given above is followed: the factoring gadget is designed such that (i) the MWIS space is degenerate, (ii) every MWIS coincides with a valid solution of F_{i,j} on the vertices that represent the involved variables, and (iii) every valid solution of F_{i,j} is represented by at least one MWIS. All these requirements can be checked by exhaustive search for the factoring gadget depicted in FIG. 33B. Since each variable has to satisfy two factoring constraints (see FIG. 33A), the factoring gadget is designed such that this geometrical requirement can be easily met. Indeed, the full set of constraints {F_{i,j}|i=0, . . . , k−1; j=0, . . . , n−k−1} can be represented as a unit-disk graph (of unit radius r=2\sqrt{2} on a square lattice), by repeating the factoring gadget on a k(n−k) square lattice, as depicted in FIG. 33C. This construction therefore results in a lattice with some of the boundary conditions fixed by the values of mᵢ, such that the MWIS of the rest of the graph reveals the values of pᵢ and qⱼ, satisfying Equation 103, thus providing the solution for the factoring problem.

### Numerical Simulations

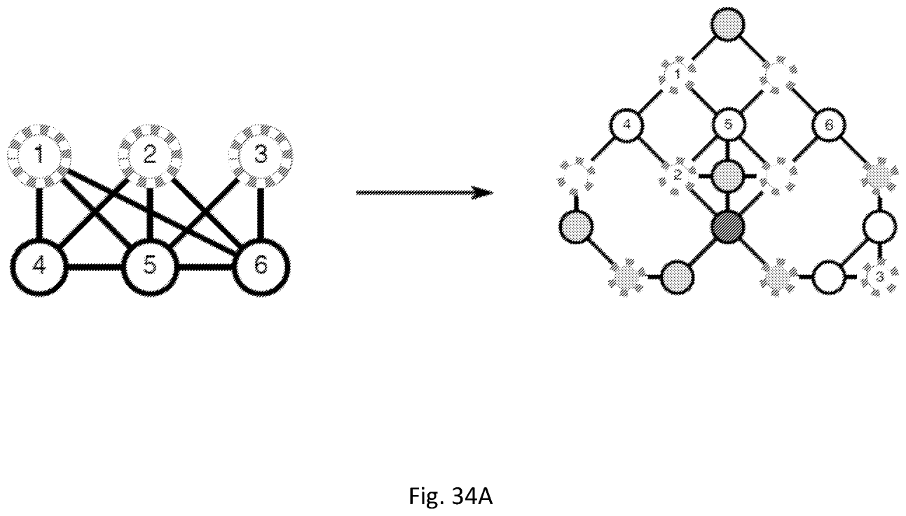

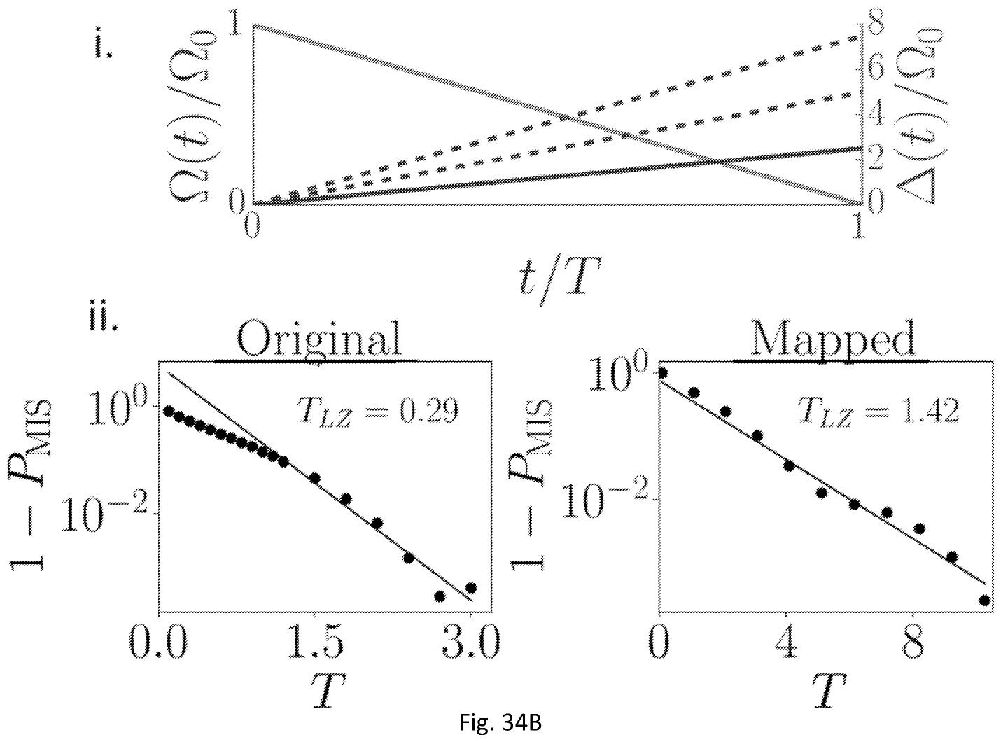

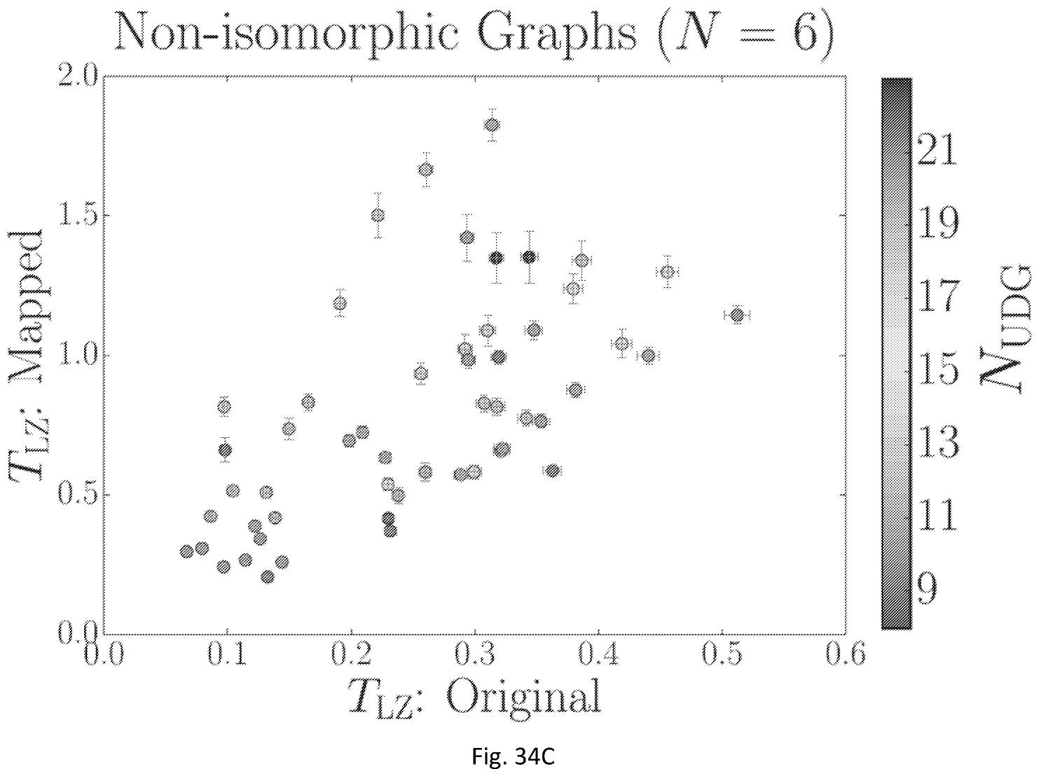

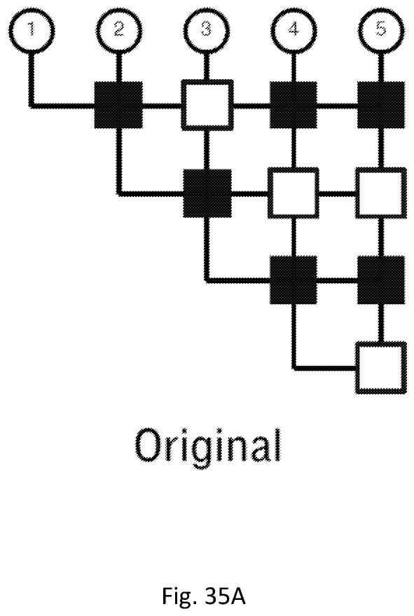

Referring to FIGS. 34A-34C, QAA performance for MWIS on original and mapped graphs is illustrated. FIG. 34A shows an example unit-disk mapping and MIS configuration of a 6-vertex graph. The original graph (left) is unweighted, and the mapped graph is a weighted UDG (right). The corresponding vertices are labeled with numbers. FIG. 34B contains three graphs. Graph i: Rabi frequency Ω(t) and detuning Δ (t) sweep used in the QAA protocol. The global detuning Δ(t) is shown in solid line, while 2Δ(t) and 3Δ(t) are shown in dashed lines. Graph ii: Computed P_{MIS} for the original and mapped graphs as a function of total sweep time T. The adiabatic timescale T_{LZ}, which is related to the minimum energy gap, is extracted from the long-time Landau-Zener fitting. FIG. 34C illustrates the scaling of T_{LZ} for mapped graphs for the ensemble of unweighted non-isomorphic graphs with size N=6.

In previous sections, an encoding strategy is provided to map a computation problem with arbitrary connectivity onto a maximum weighted independent set problem on a unit-disk graph, showing that the ground state of the mapped problem encodes the solution of the original problem. Numerical simulations of quantum algorithms are provided to demonstrate the impact of the proposed mapping procedure on quantum performance. Specifically, the quantum adiabatic algorithm is used, and the MWIS problem on an ensemble of non-isomorphic, simply connected six-node graphs is considered, which includes three non-unit-disk graphs. For simplicity, uniform weights are chosen for each graph Δᵥ=Δ. Using the procedure introduced above and further simplification steps described below, each of the original MIS problems is mapped to a UDG-MWIS problem and performance metrics of QAA for both problems are compared. There are a total of 112 non-isomorphic graphs with 6 vertices. 54 such graphs are sampled: due to limits of classical simulation, only instances whose mapped graphs contain no more than 25 vertices are considered; the 40 graphs that can be directly embedded as UDGs on the square lattice without any overhead are not considered.

FIG. 34B presents the performance results for the ensemble of graphs. The QAA for the MWIS problems may be performed for a particular graph by varying Δᵥ(t) and Ωᵥ(t) in the Rydberg Hamiltonian (Equation 105).

Typically, the QAA is designed by initializing all qubits in the |0 [symbol] state, where Δ(t=0)<0 and Ω(t=0)=0 (with U>0). QAA for MWIS is usually done in two or three stages. First, Ω(t) is ramped up to a non-zero value while Δ(t) is slowly tuned from negative to zero. Next, Ω(t) is ramped off while Δ(t) is slowly tuned from zero to positive. In this way, the initial state is adiabatically connected to the ground state of the final, classical Hamiltonian whose ground state encodes the MWIS solution of the UDG. For sufficiently slow ramps, the quantum state of the system follows the instantaneous ground state of the time-dependent Hamiltonian and thus the final state corresponds to the MWIS of the graph.

In order to focus on adiabatic behavior near the gap closing point and account for the weights in the MWIS problem, the state of the system starting at the end of the first stage is initialized in the ground state of the Hamiltonian Ω(t=0)=20 and Δ(t=0)=0. Then, Ω is linearly ramped to zero over a time T and each of the detunings are linearly ramped from zero to a final value. Note that because the weights Δᵥ on each vertex may be different, the rate of change of detuning may be different on each vertex. This protocol is shown in FIG. 34B.

The numerical simulation work is performed in the limit of Δ₀, Ω₀<<U, where the non-independent set space of the graph can be neglected (in experiments, this corresponds to the strong Rydberg blockade limit). In this limit, the simulation is restricted to the independent set subspace of the graph. Long-range Rydberg interactions are also ignored, since the original graph does not have a geometric description.

The performance of QAA is often discussed via an analysis of the minimum spectral gap along the parameter path. However, the minimum gap alone is not sufficient to understand the time scales for adiabaticity, as the structure of matrix elements between ground and excited states can cause larger or smaller diabatic effects. Furthermore, it can be ambiguous for instances where multiple degenerate ground states exist. The QAA performance on the original and mapped problems are compared by directly comparing their adiabatic time scales. Specifically, the adiabatic time scale is evaluated by extracting a Landau-Zener time scale, T_{LZ}, which is the characteristic time needed to evolve the system adiabatically. T_{LZ} is determined by fitting numerical results to the expected long-time behavior of the ground state probability P_{MIS}=1−e^{a-T/T}^{_{LZ}} at T where P_{MIS}>>0.99.

FIG. 34C presents results of this analysis, comparing the extracted Landau-Zener time scale for the original graphs in the ensemble with the Landau-Zener time scale of the corresponding mapped UDGs. The simulation results indicate that for the graphs considered here, the timescale for adiabaticity of a mapped MWIS problem is correlated with that of the original problem: the correlation appears to be linear, but the limited range of data precludes a reliable fitting. The spread of the data is likely due to the specific structure of the graph, but there is no clear dependence on the number of vertices in the mapped graph. Unfortunately, these instances are far from the large-problem size limit and the displayed time scales give us little intuition about the asymptotic performance of the quantum algorithm for larger graphs. To have more conclusive understandings of the performance of quantum algorithms, one has to study it in Rydberg atom array experiments on larger graphs.

While this discussion focuses on encodings into UDG-MWIS, similar strategies can also be designed for encoding computation problems into unweighted UDG-MIS problems. This is favorable for experimental implementation when local detuning capabilities are not available. These approaches may be generalized to encode computation problems that include interactions involving three or more variables, such as higher-order unconstrained binary optimization (HUBO) problems; the NOR gate shown in FIG. 28C, for example, is a constraint that involves three variables.

### Overhead Reduction

In the following discussion, additional strategies are introduced to the mapping scheme to further reduce the overhead required for encoding the computation problems into UDG-MWIS problems. Several simplification techniques are provided that can be easily automated to reduce the overhead of the final mapped graph, allowing one to map specific graphs with significantly less overhead.

### Pathwidth Reduction

Referring to FIGS. 35A-35C, simplification techniques to reduce the overhead are illustrated. Vertex reordering can be used to reduce the depth of the crossing lattice. FIG. 35D gives a final mapping of the K_{2,3} graph after bipartition and vertex reordering, reducing the overhead mapping from 92 nodes to 9 (see FIG. 31B). FIG. 35E is a graph of MWIS overhead scaling as a function of the number of vertices of original randomly generated graphs for chosen graph classes using a greedy pathwidth reduction algorithm.

As discussed above, to impose interaction constraints for arbitrary connectivity, a crossing lattice is constructed. The depth of the crossing lattice is reduced by reordering the vertices, thus allowing the final mapping to scale with the pathwidth of the original graph. A graph G=(V, E) has a pathwidth pw(G)≤k if and only if it has a vertex order v₁, v₂, . . . , vₙ such that for any 1≤i≤n, there are at most k vertices among {v₁, . . . , vᵢ} that have neighbors in {vᵢ₊₁, . . . , vₙ}. pw(G) can be obtained with a path decomposition. A path decomposition is a sequence of “bags” (X₁, X₂, . . . , X_{N}), where Xᵢ⊆V such that

$$v ∈ {X}_{i} , v ∈ {X}_{k} ⟹ ∀ j ∈ [ i , k ] , v ∈ {X}_{j} \qquad Equation 108$$

In other words, every vertex v∈V in G belongs to at least one bag and the set of bags containing v forms a connected interval of the sequence (X₁, X₂, . . . , X_{N}). Moreover, for each edge e∈E, there is a bag Xᵢ that contains both endpoints. The width w of a path decomposition is defined as the maximum size of the bags and pathwidth pw(G)=w−1.

This is advantageous because for a sparse graph, the pathwidth is usually much smaller than the number of vertices. For example, the pathwidth of a 3-regular graph is asymptotically bounded by n/6, and the pathwidth of a tree graph is logarithmic in n. By inspecting the appearance of the order of vertices in a bag in an optimal path decomposition, a good vertex reordering is obtained that reduces the size of the crossing lattice as described below.

### Vertex Reordering

One can reorder the vertices in the encoding mappings to reduce the depth of the final mapped graph to the pathwidth of the graph, i.e., the size of the crossing lattice is thus O(N*pw(G)). More concretely, the overhead in the mappings can be reduced by minimizing the length of the copy lines and reducing the number of crossing gadgets needed. Reordering the vertices allows one to cluster crossings in the crossing lattice where the two degrees of freedom interact (such as when two vertices share an edge in the MWIS problem), and thus reduce the number of unnecessary crossings in the crossing lattice.

Graphically, for the example of the MWIS problem on the K_{2,3} graph, FIG. 35A depicts the original crossing lattice discussed above. Reordering the vertices according to the path decomposition of the graph (FIG. 35B) reduces the number of empty squares (crossing gadgets) from 4 to 2, thus reducing the mapping overhead even when pw(G)+1=N; in general, pw(G)+1<N for most graphs. Because the crossing lattice is a 2D mapping, the same strategy can be applied to reorder vertices along both axes: one can find a bipartition of a graph to construct a crossing lattice that minimizes the number of unnecessary crossings (or empty squares), as shown in FIG. 35C. Using vertex reordering, for the K_{2,3} example graph, a simplified unit-disk mapping of 9 vertices (FIG. 35D) can be constructed, whereas the direct mapping has 92 nodes.

Thus, the standard mapping can be simplified and the overhead can be reduced by restructuring the crossing lattice to reduce the length of copy lines and minimize unnecessary crossings. The optimal vertex reordering requires computing the optimal path decomposition of a graph, which is itself an NP-hard problem. For small graphs, the optimal path decomposition can be effectively computed with the branching algorithm; for larger graphs, one can use heuristic algorithms to find good path decompositions. This strategy allows one to achieve the overhead scaling for a chosen set of graph classes shown in FIG. 35E.

### Simplification Gadgets

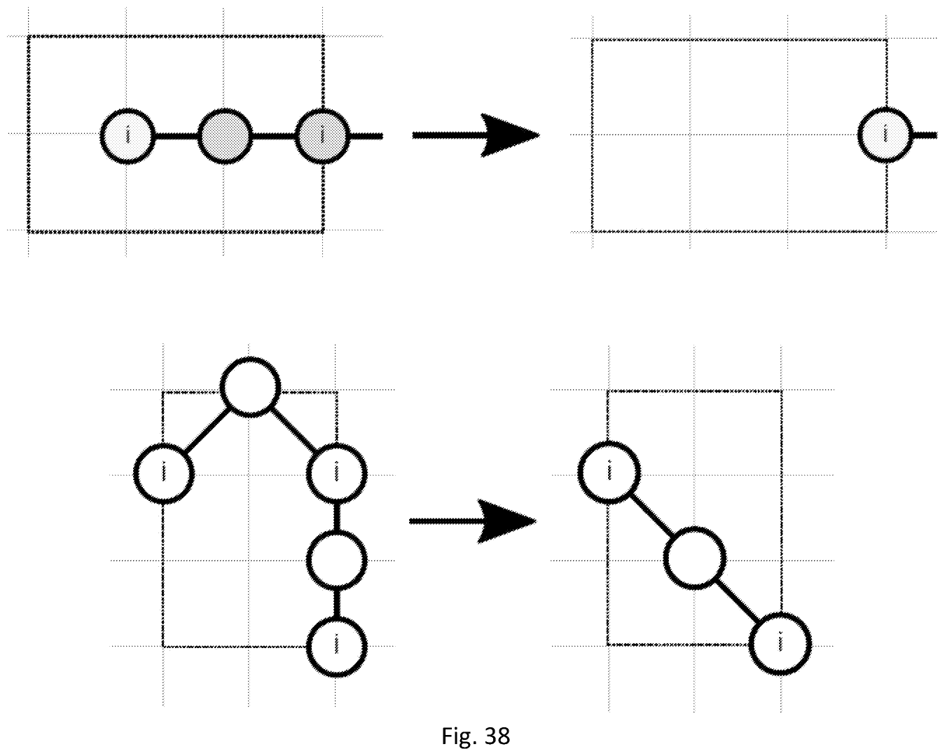

The mapping overhead can be further reduced from the standard encoding procedure, or any valid unit-disk mapping, by introducing rewriting rules, or gadgets that maintain the integrity of the mapping, while also reducing the overhead of the graph. Simplification gadgets are most useful for the MWIS problem, where node weights are more uniform, but simplification gadgets should preserve the weight constraints of the original problem. For example, some simplification rules are given in FIG. 38.

### Defects and MWIS Guarantees

As described above, one needs to be careful with the proper normalization of the vertex weights to ensure the ground state of the mapped problem correctly encodes the solution of original problem. In the following discussion, more details are provided on normalization for the MWIS and QUBO problem.

For the MWIS mapping shown in FIGS. 31A-31B, the UDG-MWIS problem is guaranteed to encode a valid solution of the original problem only if the additional weights (biases) are properly chosen. If a bias is too large, it may be energetically favorable to violate a constraint in the problem, causing the MWIS to be an invalid solution. These constraint violations, in the context of the copy gadget, are called “defects”. It is thus imperative to limit the size of the biases to guarantee that the MWIS is a valid solution.

For the constraint satisfaction problems constructed as reductions for MWIS and QUBO, there is a hierarchy of constraints. At one scale is δ, which corresponds to the energy scale of the unweighted problem and at another scale is the linear (wᵢ) and quadratic (wᵢⱼ) biases that prefer certain MWIS and QUBO solutions for the weighted problems.

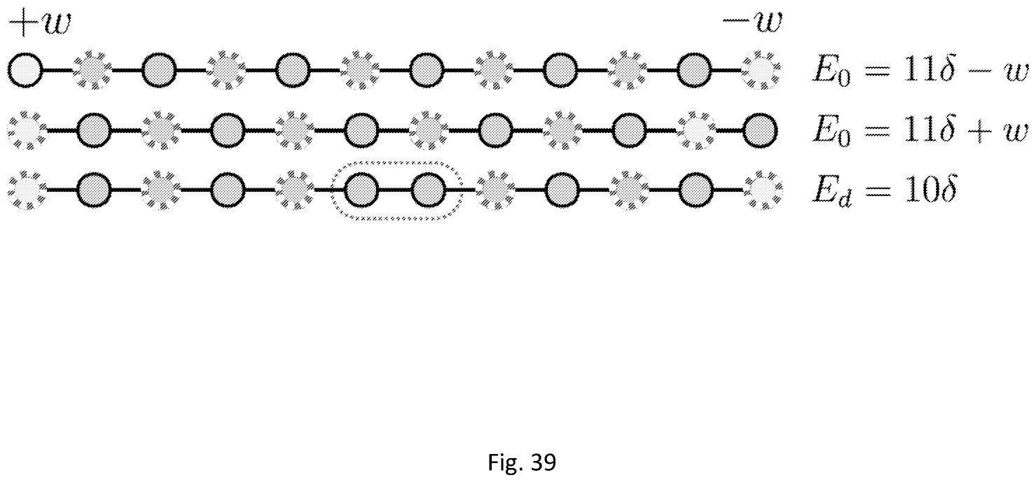

The safest normalization of biases is to constrain that the total weight is less than the cost of a single constraint violation. For the copy gadget, which encodes the constraint (n₁=n̅₂)Λ(n₂=n̅₃Λ . . . , the cost of violating one constraint and adding one defect is at least δ. For instance, consider a length-12 copy gadget with bias w as shown in FIG. 39.

For the configuration with a defect (the third line), the left side incorrectly represents a 1, while the right side represents a 0. Similarly, for the crossing gadget, removing the vertex from a clique costs an energy of at least 2δ, at the expense of adding two defects; one to the horizontal and one to the vertical copy gadget. Thus, the most conservative normalization of biases, which sums over all clauses, is

$$δ > {\sum }_{ij} \vert {w}_{ij} \vert + \vert {w}_{i} \vert . \qquad Equation 109$$

Unfortunately, such a normalization is too conservative. For the MWIS problem, the normalization goes as 1/N, while, for the QUBO problem, the normalization goes as 1/N². A larger bias that still guarantees a valid MWIS can be found by inspecting the structure of the copy gadget and crossing lattice.

For the MWIS problem, it is beneficial to only inspect a single copy gadget. Consider a copy gadget of length 2n and biases +w on one end and −w on the other. The valid solutions have energies (n−1)δ±w, and the single-defect invalid solution has an energy nδ. Thus, in order to guarantee a valid solution, it serves to have every bias δ>wᵢ. In this way, the normalization must obey the constraint

$$δ > {max}_{i} \vert {w}_{i} \vert \qquad Equation 110$$

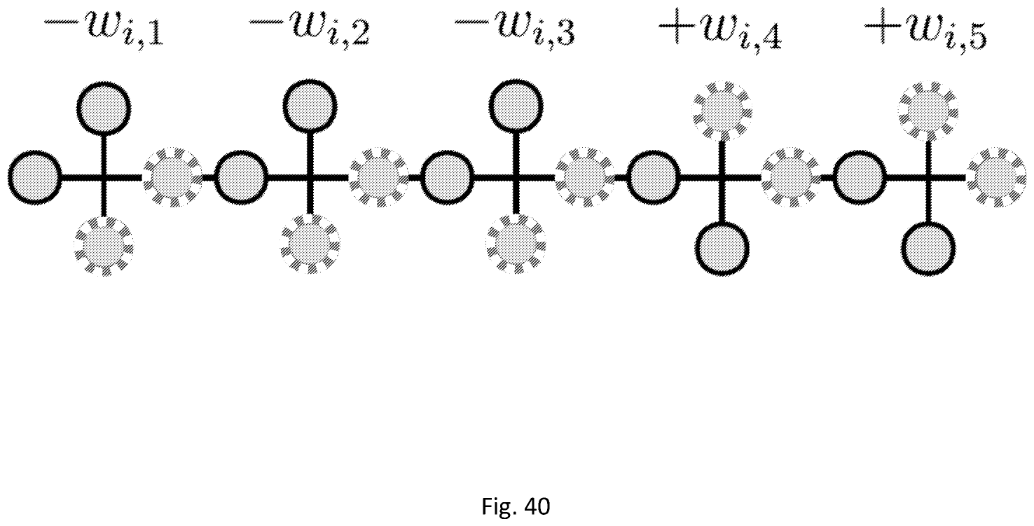

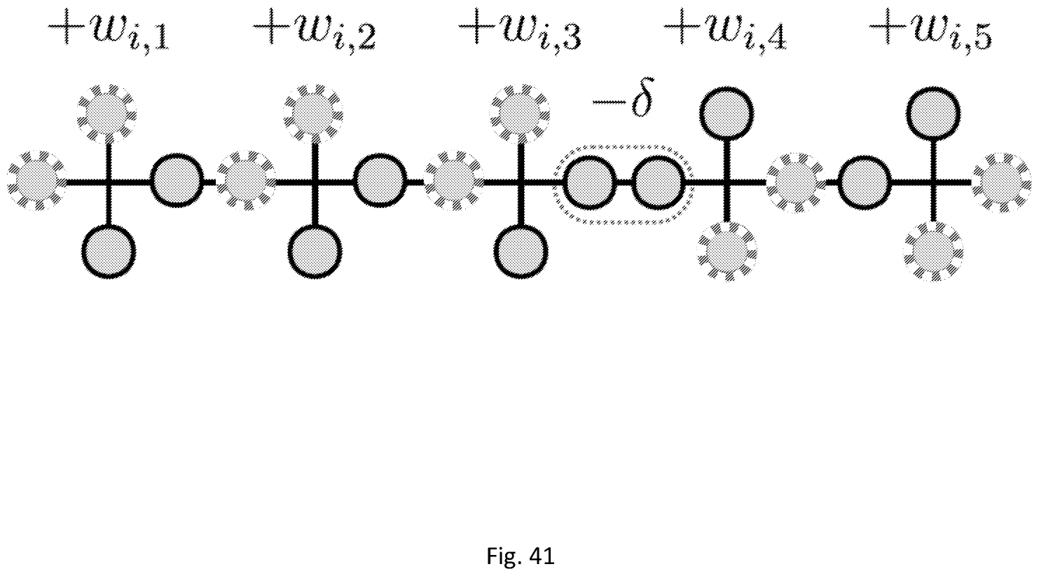

For the QUBO problem, it is similarly beneficial to only inspect a single copy gadget. Single-defect solutions to the copy gadget may potentially be energetically favorable if the cost of adding a defect is outweighed by satisfying more quadratic terms. As an extreme case, consider a bit i in a state −1, with a QUBO interaction wᵢⱼ>0 with every other qubit j. However, suppose the optimal state of every other qubit j is +1 for j<k, and −1 for j≥k due to a strong linear term pinning the vertical j bits. In this case, every QUBO quadratic contribution to the left of k is negative while all to the right are positive, and the total contribution to the QUBO energy is small, as shown in FIG. 40, with a weight of w=wᵢ−Σ_{j<k}|wᵢⱼ|+Σ_{j>k}|wᵢⱼ|. However, if one adds a single defect to bit i at k, it looks like a +1 state to the left and −1 to the right, satisfying every QUBO quadratic term at the cost of adding one defect worth of energy, as shown in FIG. 41, with a weight of w′=wᵢ+Σⱼ|wᵢⱼ|−δ. To guarantee the MWIS encodes a valid solution, the weight of the zero-defect solution must be larger, w≥w′. Given that a QUBO contribution will always contribute a positive weight (w>wᵢ), this guarantee is equivalent to enforcing that the defect cost is greater than the sum on all w for each bit

$$δ > {max}_{i} {\sum }_{j} \vert {w}_{ij} \vert \qquad Equation 111$$

If both the linear and quadratic constraints are satisfied by normalizing the weights correctly, the MWIS is guaranteed to be a zero-defect state and thus encode the QUBO solution.

### Restricted QUBO Connectivity

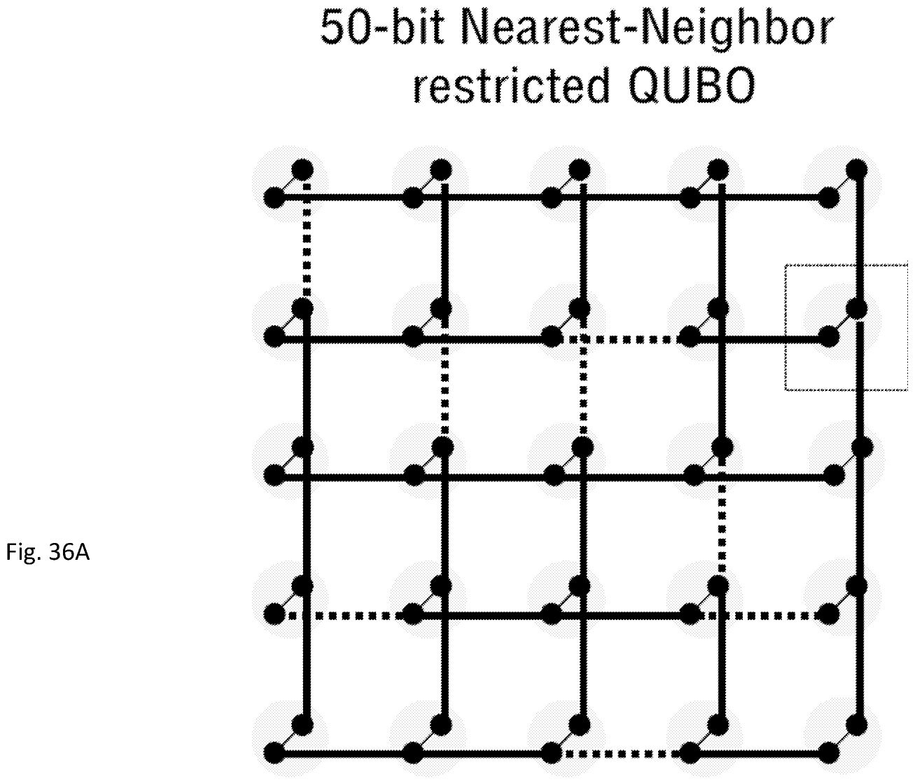

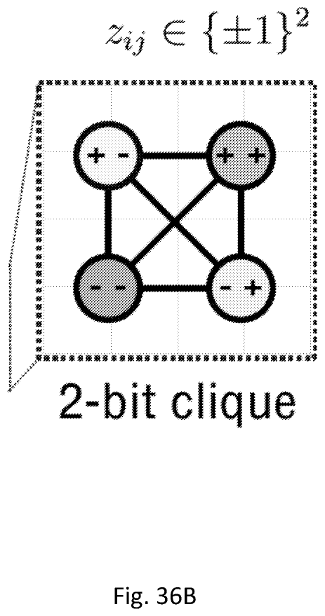

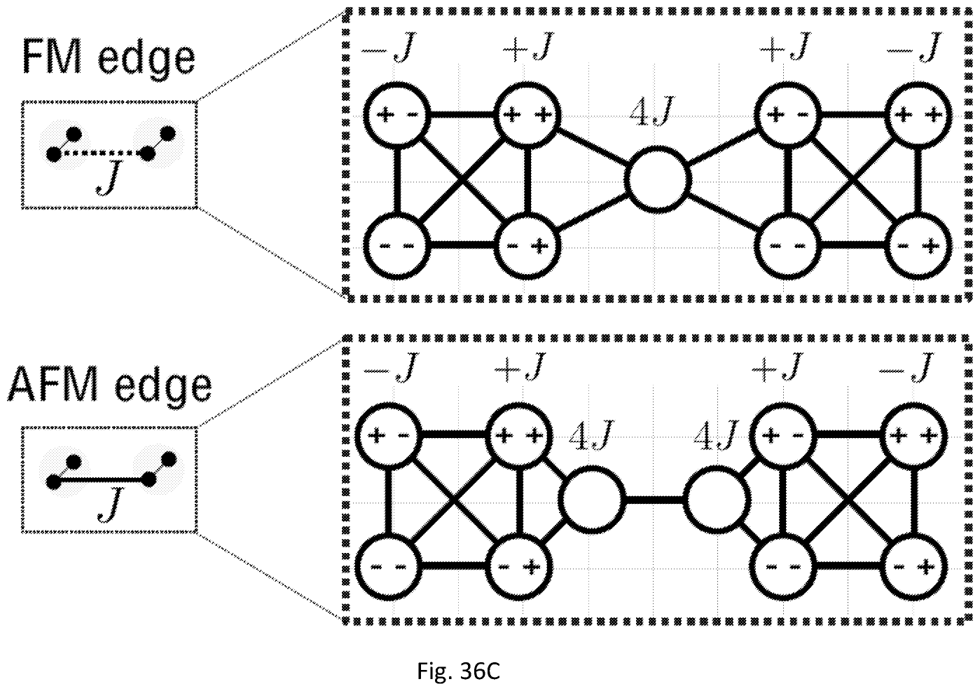

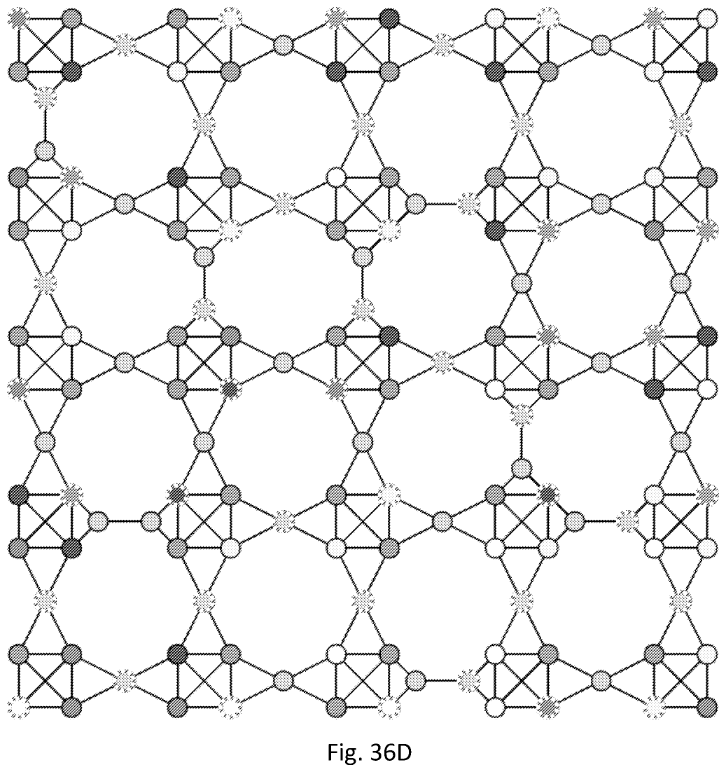

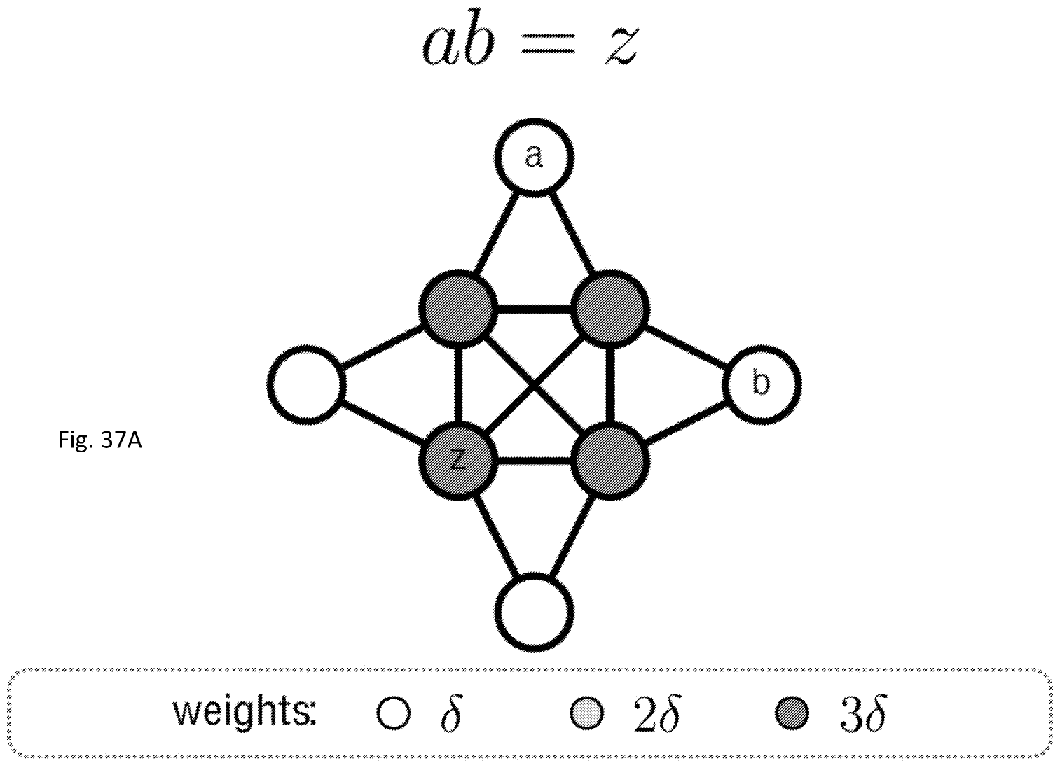

Referring to FIGS. 36A-36D, an example 2D restricted-connectivity graph and reduction to UDG-MWIS is illustrated. FIG. 36A shows a particular topology of bits (vertices) and quadratic terms (edges). The original graph can be mapped into a UDG-MWIS using some gadgets. FIG. 36B illustrates that two bits can be represented by a clique of four vertices, with each state (±±) represented by a single vertex of the clique. Linear and quadratic interactions are represented by biasing the weights of the clique. FIG. 36C illustrates that interactions between neighbors can be represented by adding ancilla vertices. FIG. 36D shows the original restricted-connectivity QUBO problem as mapped to a UDG-MWIS problem, where the ground state encodes the solution to the QUBO problem. Here, quadratic QUBO weights have been chosen to be ±J. This example graph has 50 bits in the original graph and an extent of 13×13 in the mapped UDG graph, which naturally fits onto today's Rydberg atom array hardware.

While it is useful to envision arbitrary-connectivity QUBO problems, the implementation comes at the practical cost of encoding overhead. For example, encoding a 5-bit problem takes around a 16×16 lattice, which is on the upper limit of today's Rydberg atom array systems. A more near-term solution is to specify graphs with a constrained connectivity that naturally fits more bits onto today's hardware. A natural restriction is a nearest neighbor 2D connectivity, such as the example graph shown in FIG. 36A. Just like any arbitrary QUBO problem can be mapped to a UDG-MWIS problem with a quadratic overhead, a restricted 2D QUBO problem can be mapped onto UDG-MWIS with only a constant overhead.

In order to construct particular restricted connectivity QUBO problems for the particular topology of FIGS. 36A-36D, it is instructive to introduce three new gadgets, which are extensions of the crossing gadget. The first gadget is a square clique of 4 vertices, which is similar to the 4-vertex clique of the QUBO gadget, shown in FIG. 36B. The four MWIS of the clique represent four possible states of two qubits; for this mapping, the top right vertex is chosen to be the ++ state, and the bottom right vertex to be the +− state, etc. In order to encode a QUBO interaction between the bits, the weights of each vertex are biased as shown in FIG. 36B.

An additional gadget can encode ferromagnetic (FM) (J>0) or antiferromagnetic (AFM) (J<0) interactions between adjacent bits, as shown in FIG. 36C. The independent set restriction naturally encodes nn-type interactions, while QUBO usually requires ZZ-type interactions, which can be converted back and forth using linear terms. In this way, the interaction between adjacent bits can be encoded by adding one (J<0) or two (J>0) ancilla vertices in between each clique within the unit-disk radius. Ultimately, the absolute value of the interaction is encoded into the weight of these interaction vertices.

For an example of how this interaction gadget works, consider the one vertex antiferromagnetic interaction and gadget of FIG. 36C. If the horizontal bit of the left clique is in the +1 state (e.g., on the right side of the clique), the ancilla vertex is blockaded from being part of the independent set, and likewise if the horizontal bit of the right clique is in the −1 state. Thus, the effective interaction encoded into the condition of the ancilla vertex of weight wᵢⱼ being included in the independent set is wᵢⱼ(1−zᵢ) (1+zⱼ)/4. Similarly, the two-vertex ferromagnetic interaction is encoded into the weight as

$${w}_{ij} ( 1 - \frac{( 1 - {z}_{i} ) ( 1 + {z}_{j} )}{4} ) ,$$

as the ancilla vertex is only blockaded for one configuration instead of three. Note that the antiferromagnetic gadget has a negative sign in front of the zz term, as required, and similar for the ferromagnetic gadget. After correcting the linear offsets, the biases for each vertex of the gadget are shown in FIG. 36C, with wᵢⱼ=J.

Finally, one must guarantee that the ground state does in fact map to the codespace of valid solutions, with proper normalization as described above. Here, a solution is valid if each 4-vertex clique has at least one vertex in the maximum independent set. This may be guaranteed by increasing the zero-bias weight of the four-vertex clique to be much larger than any other scale. One guaranteed offset is U=8J, where J is the largest coupling strength between adjacent bit cliques. This condition is set because, if the weight is smaller, an independent set vertex in the clique can be replaced with two adjacent vertices of the interaction gadget, which each have a weight of 4|J|. Thus, this bias guarantees the correct ground state. An example set of weights, which encodes a graph with random bonds ±J, is shown in FIG. 36D.

FIG. 36D is just one particular example of a local connectivity encoding for unit-disk graphs. In practice, there may be many different encodings of many different restricted-connectivity graphs. Due to the nature of Rydberg atom arrays, which reconstruct the graph for each shot, these neutral-atom platforms are much more flexible in the connectivities of the problems they solve, potentially even on a shot-by-shot basis. This is in contrast with other architectures such as superconducting qubits, which have a fixed qubit connectivity and require a lengthy fabrication process to modify their topology.

Additionally, these local-connectivity graphs can encode more nonlocal problems, by increasing the ferromagnetic weight of edges such that the ground state of adjacent vertices are always the same. In this way, choosing a large ferromagnetic weight recreates the copy gadget and, by extension, may recreate the crossing lattice of the all-to-all QUBO problem shown in FIGS. 32A-32C. Furthermore, such a local-connectivity graph may recreate another hardware's configuration. For instance, the DWAVE Chimera graph consists of sets of 8 bipartite connected bits in a unit cell, which are connected colinearly with adjacent unit cells. The same connectivity can be reproduced by choosing some large ferromagnetic J terms appropriately on the grid of FIG. 36A. It should be emphasized that due to the re-configurable nature of Rydberg atom arrays, it is trivial to modify the topology of the connectivity. For example, on one shot, a Rydberg atom array system could recreate the DWAVE Chimera topology, while, on the next shot, it may recreate the DWAVE Pegasus topology, and so forth.

### Factoring Gadget

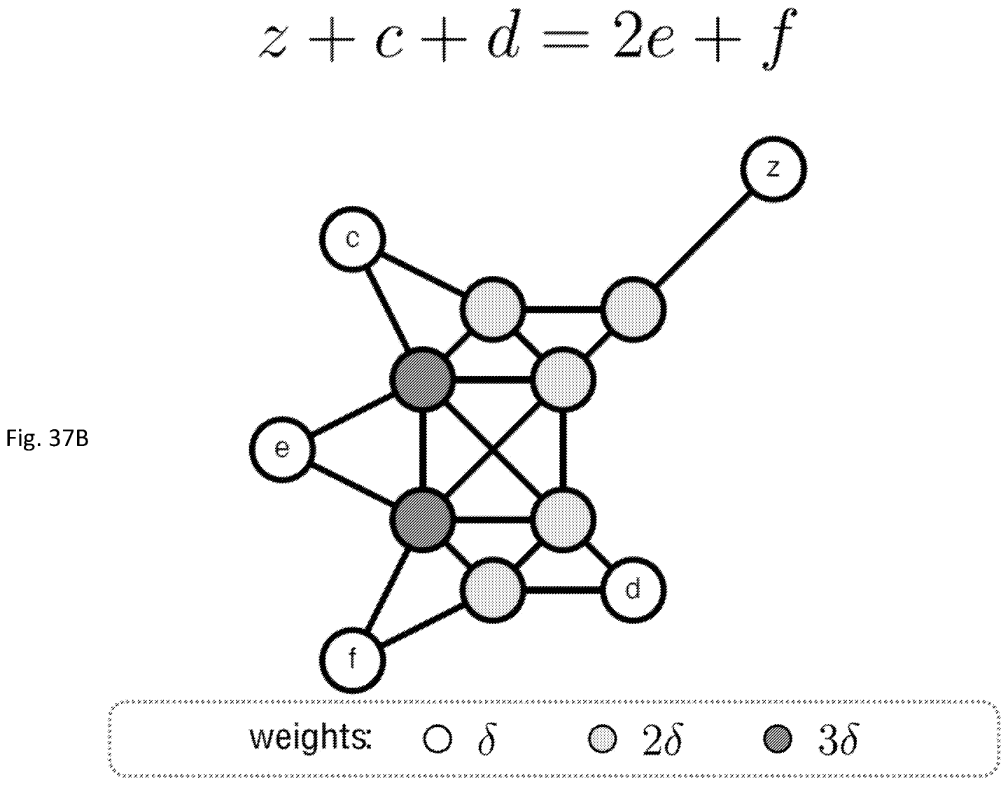

Referring to FIGS. 37A-37B, the two basic components of the factoring gadget are illustrated. The gadget in FIG. 37A is a crossing gadget. Besides its use in routing effective variables a and b, it also serves as a tool to access the value of the product of the variables, Z=ab, at the indicated interior vertex. The gadget in FIG. 37B is the MWIS representation of the constraint z+c+d=2e+f.

In the following discussion, further details are provided regarding the factoring gadget introduced in FIGS. 32A-32C. The factoring gadget is designed such that the MWIS space corresponds to the satisfying assignments

$${s}_{i , j} + 2 {c}_{i , j} = {p}_{i , j} {q}_{i , j} + {s}_{i + 1 , j - 1} + {c}_{i - 1 , j} \qquad Equation 112$$

$${q}_{i + 1 , j} = {q}_{i , j} \qquad Equation 113$$

$${p}_{i , j + 1} = {p}_{i , j} \qquad Equation 114$$

The constraint of Equation 112 is considered first, since the other two constraints are easy to satisfy with a combination of copy and crossing gadgets. To simplify notations, one rewrites the constraint of Equation 112 as ab+c+d=2e+f between binary variables a, b, c, d, e, f∈{0,1}. This constraint is further rewritten as a conjunction of two simple constraints, namely

$$z = ab \qquad Equation 115$$

$$z + c + d = 2 e + f \qquad Equation 116$$

A MWIS representation of the first constraint is obtained directly from the crossing gadget (see FIG. 37A). As already discussed above, the interior vertices of the crossing gadget encode the information about the variables on the boundary. Specifically, the lower left interior vertex (representing z) is in the MWIS if and only if both the top and the right outer vertices (representing a and b respectively) are also in the MWIS, thus exactly representing ab=z.

The MWIS representation of the second constraint is given in FIG. 37B. One can check by exhaustive search that the MWISs of this gadget indeed represent exactly all satisfying assignments of z+c+d=2e+f. To obtain the MWIS representation of ab+c+d=2e+f, the graphs in FIGS. 37A and 37B are joined at the common vertex z. Note that the total weight of the vertex z in this joint graph is the sum of its weights in each individual graph. One can easily identify this joint structure in the full factoring gadget given in FIG. 33B. The remaining parts of this gadget are simply formed by combining it with copy and crossing gadgets that satisfy Equation 113 and Equation 114 and to route the variables to positions where they can be accessed also by neighboring factoring gadgets.

### Tropical Tensor Network Framework to Reduce Combinanatorial Optimization to Maximum Independent Set on Unit Disk Graphs

The present disclosure provides a tropical tensor-based framework for gadget design, which can be used to reduce combinatorial optimization problems into a maximum independent set on unit disk graphs. This method is demonstrated by reducing the problem of maximum independent set of a general graph G=(V, E) to that of a diagonal-coupled unit-disk grid graph of size O(|V|pw(G)), where pw(G) is the pathwidth of G, a graph characteristic upper bounded by |V|. This reduction scheme is optimal if no algorithm can find maximum independent sets of a general graph in a time sub-exponential to its number of vertices, i.e., if the exponential time hypothesis is true.

Problem reductions play a central role in the field of computational complexity, many of the which require introducing gadgets for certain purposes. While gadget design often needs human insights and clever designs, a general algorithmic gadget searching framework may significantly reduce the human effort. This disclosure introduces such a framework of gadget finding to reduce general combinatorial and graph problems to finding the maximum independent set (MIS) problem on a diagonal-coupled unit-disk grid graph (DUGG), a grid graph wherein two vertices are connected if and only if they are nearest neighbors or second nearest neighbors. As a particular example, this gadget finding is used to reduce MIS on general graphs to MIS on DUGG. In physics, the MIS problem on a DUGG is also called the hard-core lattice gas model, and has a natural implementation on neutral atom quantum computers.

Although DUGGs have highly constrained topology, finding a maximum independent set of one is nevertheless NP-complete, as will be shown here via explicit reduction from MIS. This implies the existence of a polynomial-time reduction from this problem to other NP-complete problems. However, the exponent of the polynomial matters when targeting a real world application, as the encoding overhead may make it infeasible to solve useful problems on special-purpose hardware. The previously best-known algorithm to reduce a general maximum independent set problem to an independent set problem on DUGG has an overhead of n⁶.

If one wants to solve an MIS problem on a general graph with 100 vertices, which can be solved in a classical computer in milliseconds, the required number of qubits is ˜10¹², which not feasible in the near term. As a lower bound on encoding overhead, unless NP=P, it is not expected that there can be a reduction scheme that only introduces a constant overhead, because the MIS size of a unit disk graph can be constant-approximated in polynomial time. The method presented here encodes solutions in a DUGG of size [symbol] (|V|pw(G))≤O(|V|²), where pw(G) is the pathwidth of G.

### Tropical Tensor Network

Given a generic graph, the problem of finding its MIS size can be formulated as a contraction of a tropical tensor network.

A tensor network is a multi-linear map from a collection of labelled tensors [symbol] to an output tensor. It is formally defined as described below.

A tensor network is a multi-linear map specified by a triple of [symbol] =(Λ, [symbol] , s_{∂}), where Λ is a set of symbols (or labels),

$$𝒯 = \{ {T}_{{s}_{1}}^{( 1 )} , {T}_{{s}_{2}}^{( 2 )} , … , {T}_{{s}_{M}}^{( M )} \}$$

is a set of tensors as the inputs, and s_{∂} is a string of symbols labelling the output tensor. Each tensor

$${T}_{{s}_{k}}^{( k )}$$

∈ [symbol] is labelled by a string sₖ∈Λ^{r(T}^{^{(k)}}⁾, where r(T^{(k)}) is the rank of T^{(k)}. The multi-linear map or the contraction on this triple is

$${O}_{{s}_{\partial }} = {\sum }_{Λ \backslash {s}_{\partial }} {\prod }_{k = 1}^{M} {T}_{{s}_{k}}^{( k )} \qquad Equation 117$$

where the summation runs over all possible configurations over the set of symbols absent in the output tensor.

This notation is a minor generalization of the standard tensor network notation used in physics as the number of times a label can appear in the tensors is not restricted to two. A tensor network with a standard real element type is related to the solution space size of some combinatorial optimization problems. To generalize it for finding the MIS size, the element type in a tensor network must be adapted to tropical numbers.

A tropical tensor network is a tensor network (Λ, [symbol] , s_{∂}) such that each element of [symbol] is a tropical tensor. A tropical tensor is a tensor with its elements being tropical numbers. The algebra of tropical numbers is defined by mapping the regular addition and multiplication operators to max and addition operators, respectively, as follows:

$$x ⊕ y = max ( x , y ) , \qquad Equation 118$$

$$x ⊙ y = x + y ,$$

$$= - ∞ ,$$

$$= 0 ,$$

where the additive identity [symbol] and multiplicative identity [symbol] are also changed correspondingly. The contraction of a tropical tensor network is equivalent to evaluating the following expression on real numbers

$${O}_{{s}_{\partial }} = {max}_{Λ \backslash {s}_{\partial }} {\sum }_{k = 1}^{M} {T}_{{s}_{k}}^{( k )} \qquad Equation 119$$

Given a particular choice of [symbol] , the contraction result of the tensor network can be directly related to the maximum independent set of a graph, as will be shown below.

An open graph is defined as a triple of (V, E, ∂R), where V is the set of vertices, E is the set of edges and ∂R∈V^{|∂R|} is a vector of open vertices. Let R=(V, E, ∂R) be an open graph, its α-tensor, α(R), is a tensor of rank |∂R|, with its element α(R)_{∂s} being the maximum independent set size of graph G=(V, E) given a fixed open-vertex configuration ∂s∈{0,1}^{|∂R|}. Here, 0 is used to denote a vertex absent in the independent set and 1 to denote a vertex in the independent set.

An α-tensor is a compact representation of local maximum independent set sizes under different open-vertex configurations. It can be obtained by contracting a tropical tensor network.

The α-tensor for an open graph R=(V, E, ∂R=∂₁∂₂ . . . ∂_{|∂R|}) can be computed by contracting the following tropical tensor network.

$$Λ = \{ {s}_{v} \vert v ∈ V \} , \qquad Equation 120$$

$$𝒯 = \{ {W}_{{s}_{v}}^{( v )} \vert v ∈ V \} ⋃ \{ {B}_{{s}_{u} {s}_{v}}^{( u , v )} \vert ( u , v ) ∈ E \} ,$$

$${s}_{\partial } = {s}_{{\partial }_{1}} {s}_{{\partial }_{2}} … {s}_{{\partial }_{\vert {\partial }_{R} \vert}} ,$$

where each vertex v∈V_{G} is associated with a label sᵥ∈{0, 1} of dimension 2, and use 0 (1) to denote a vertex is absent (present) in the set. For each vertex v∈V, a tropical tensor indexed by sᵥ is defined as

$${W}^{( v )} = ( \begin{matrix}0 \\ 1\end{matrix} ) \qquad Equation 121$$

which encodes the vertex count in the independent set. For each edge (u, v)∈E_{G}, a tropical matrix B indexed by sᵤ and sᵥ is defined as

$${B}^{( u , v )} = ( \begin{matrix}0 & 0 \\ 0 & - ∞\end{matrix} ) \qquad Equation 122$$

which encodes independent set violations if both vertices sᵤ=1=sᵥ. The output tensor is labeled by a string of length |∂R|, meaning the output tensor has a rank |∂R|.

The contraction of this tropical tensor network can be evaluated on real algebra as follows:

$${α ( R )}_{{s}_{\partial }} = {max}_{\{ {s}_{v} \vert v ∈ V \backslash \partial R \}} {\sum }_{v ∈ V} {W}_{{s}_{v}}^{( v )} + {\sum }_{( u , v ) ∈ E} {B}_{{s}_{u} {s}_{v}}^{( u , v )} \qquad Equation 123$$

where the maximization runs over all 2^{|V\∂R|} internal-vertex (not open) configurations and take the maximum of the sum of tensor elements, which is equal to the MIS size with fixed boundary configuration specified by Sa. Here, a vertex tensor element

$${W}_{{s}_{v}}^{( v )}$$

contributes a weight 1 whenever v is in the set. The independence constraint is encoded in the edge tensors, where weight

$${B}_{11}^{( u , v )} = - ∞$$

is used to punish we configurations that have both vertices connected by an edge (u, v) in the set.

Consider: in Equation 123, if s_{∂}=ϵ is an empty string, then the max function iterates over all possible bit strings Λ, while the sum over tensors counts the number of independent set vertices and penalizes independent set violations. The contraction result of this tensor network is a scalar, which corresponds to the MIS size of a graph.

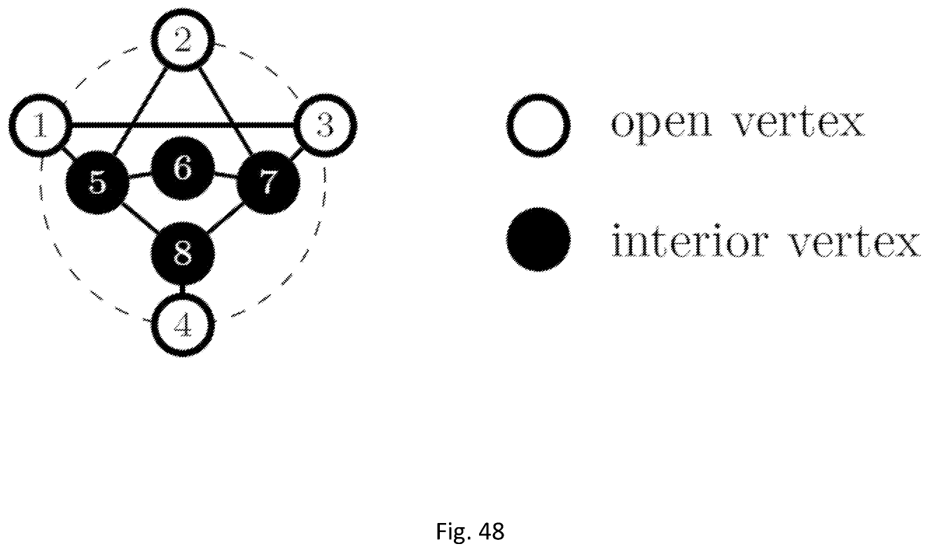

Consider the α-tensor of an open graph R with 6 vertices, and the open vertices are specified as 1234 in FIG. 48.

Its α-tensor A has rank 4 and is indexed by string s_{∂}=s₁s₂s₃s₄

$$A = ( \begin{matrix}( \begin{matrix}{A}_{0000} & {A}_{0100} \\ {A}_{1000} & {A}_{1100}\end{matrix} ) & ( \begin{matrix}{A}_{0001} & {A}_{0101} \\ {A}_{1001} & {A}_{1101}\end{matrix} ) \\ ( \begin{matrix}{A}_{0010} & {A}_{0110} \\ {A}_{1010} & {A}_{1110}\end{matrix} ) & ( \begin{matrix}{A}_{0011} & {A}_{0111} \\ {A}_{1011} & {A}_{1111}\end{matrix} )\end{matrix} ) = ( \begin{matrix}( \begin{matrix}2 & 3 \\ 3 & 4\end{matrix} ) & ( \begin{matrix}3 & 3 \\ 3 & 4\end{matrix} ) \\ ( \begin{matrix}3 & 4 \\ - ∞ & - ∞\end{matrix} ) & ( \begin{matrix}3 & 4 \\ - ∞ & - ∞\end{matrix} )\end{matrix} ) \qquad Equation 124$$

Entry A₀₀₀₀=2 is the MIS size given s₁=s₂=s₃=s₄=0, and the corresponding independent set is {5, 7} or {6, 8}. Entry A₀₁₀₀=3 is the MIS size given s₂=1 and s₁=s₃=s₄=0, and the corresponding independent set is {2, 6, 8}. Entry A₁₀₁₀=−∞ means the configuration s₁=s₃=1 and s₂=s₄=0 is forbidden, as it violates the independence constraint.

Consider gluing two open graphs into a larger one, while requiring the edges connecting two parts only to involve the open vertices. A configuration of one open graph having less 1 s at the open vertices is less likely to violate the independence constraint with a configuration from the other open graph. By generalizing this intuition, it will be shown that some entries in an α-tensor can be “worse” than others, removing those that can uniquely determine a reduced α-tensor.

Let α(R) be α-tensors for an open graph R. The reduced α-tensor for R, α′(R), is uniquely determined by the following statement.

$$∀ \partial {s}_{b} {\underbrace{( ¬ ∃ \partial {s}_{a} ( \partial {s}_{a} ≺ \partial {s}_{b} ) ∧ ( {α ( R )}_{\partial {s}_{a}} \geq {α ( R )}_{\partial {s}_{b}} ) )}}_{{s}_{b} is not “ worse ” than any other configuration} ∧ ( {{α}^{′} ( R )}_{\partial {s}_{b}} = {α ( R )}_{\partial {s}_{b}} ) ∨ {\underbrace{( ∃ \partial {s}_{a} ( \partial {s}_{a} ≺ \partial {s}_{b} ) ∧ ( {α ( R )}_{\partial {s}_{a}} \geq {α ( R )}_{\partial {s}_{b}} ) )}}_{{s}_{b} is “ worse ” than another configuration} ∧ {\underbrace{( {{α}^{′} ( R )}_{\partial {s}_{b}} = - ∞ )}}_{set the entry to tropical zero} ; \qquad Equation 125$$

where ∂s_{a/b}={0, 1}^{∂R|} is a open-vertex configuration for R. The relation [symbol] is defined by

$$( \partial s ≺ \partial {s}^{′} ) := ( \partial s \neq \partial {s}^{′} ) ∧ ( \partial s \leq \partial {s}^{′} ) \qquad Equation 126$$

in which ∂s≤∂s′ is true if and only if all bits in ∂s are smaller than or equal to their correspondence in ∂s′.

The operator [symbol] has the meaning of being less restrictive: If ∂sₐ [symbol] ∂s_{b}, then there are fewer boundary vertices in the independent set. If the open graph R participates in a larger graph G, these boundary vertices “block” adjacent vertices in the larger graph from being in the independent set, which is “bad” when finding MIS. In human language, a reduced α-tensor is a tensor obtained from an α-tensor by setting entries that correspond to “bad” open-vertex configurations to tropical zero. An open-vertex configuration is “bad” if it is “worse” than any other open-vertex configuration.

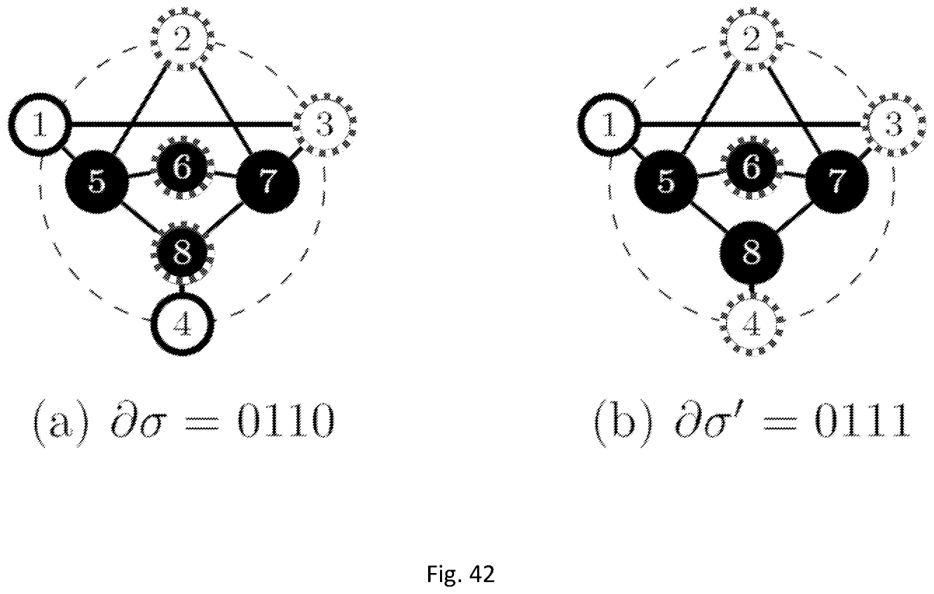

Referring to FIGS. 42A-42B, local maximum independent sets {2, 3, 6, 8} and {2, 3, 4, 6} are depicted given two different open-vertex configurations ∂s=0110 and ∂s′=0111 of an open graph R. Nodes with dashed edges are vertices in the independent sets. The two independent sets shown here have the same size, i.e. α(R)_{∂s}=α(R)_{∂s′}=4, while ∂s<∂s′

The reduced α-tensor for the graph in FIG. 48 is

$${α}^{′} ( R ) = ( \begin{matrix}( \begin{matrix}2 & 3 \\ 3 & 4\end{matrix} ) & ( \begin{matrix}3 & \\ & \end{matrix} ) \\ ( \begin{matrix}3 & 4 \\ - ∞ & - ∞\end{matrix} ) & ( \begin{matrix} & \\ - ∞ & - ∞\end{matrix} )\end{matrix} ) = ( \begin{matrix}( \begin{matrix}2 & 3 \\ 3 & 4\end{matrix} ) & ( \begin{matrix}3 & - ∞ \\ - ∞ & - ∞\end{matrix} ) \\ ( \begin{matrix}3 & 4 \\ - ∞ & - ∞\end{matrix} ) & ( \begin{matrix}- ∞ & - ∞ \\ - ∞ & - ∞\end{matrix} )\end{matrix} ) \qquad Equation 127$$

Here, / is used to denote an entry in α-tensor being removed to generate a reduced α-tensor. The open-vertex configuration in FIG. 42A corresponds to tensor entry α(R)₀₁₁₀, which is less restrictive than the one in FIG. 42B that corresponds to α(R)₀₁₁₁. In the MIS problem, the less restrictive open-vertex configuration in FIG. 42A imposes fewer constraints on the environment, thus allowing the environment to have a larger or equal MIS size. For any graph G being a parent graph of R, α(G, ∂s=0110)≥α(G, ∂s=0111) holds, where α(G, ∂s) is used to denote the MIS size after fixing the configuration on ∂R to ∂s. The key information is that some open-vertex configurations can be asserted as being “worse’” than others by only inspecting a local structure.

A graph G is a parent graph of an open graph R=(V, E, ∂R) if R is an induced subgraph of G, and the vertices in R having connections with the rest of G\R are all in ∂R.

Let G be an arbitrary parent graph of an open graph R. In the following description, it will be shown that not all entries in α(R) can contribute to the MIS size of G. By removing the “bad” entries from the α(R), a reduced α-tensor can be obtained.

Let G=(V_{G}, E_{G}) be a parent graph of an open graph R=(V, E, ∂R=∂₁∂₂ . . . ∂_{|∂R|}). Then α(G)=α(R)ε=α′(R)ε, where ε is the contraction output of the tropical tensors network for tensors not in R (or the environment of R)

$$\sum = \{ {s}_{v} \vert v ∈ ( {V}_{G} \backslash V ) ⋃ \partial R \} , \qquad Equation 128$$

$$𝒯 = \{ {W}_{{s}_{v}}^{( v )} \vert v ∈ {V}_{G} \backslash V \} ⋃ \{ {B}_{{s}_{u} {s}_{v}}^{( u , v )} \vert ( u , v ) ∈ {E}_{G} \backslash E \} ,$$

$${s}_{\partial } = {s}_{{\partial }_{1}} {s}_{{\partial }_{2}} … {s}_{{\partial }_{\vert \partial R \vert}} .$$

α(R)∈ is used as a shorthand for the inner product

$${max}_{{s}_{\partial }} ( {α ( R )}_{{s}_{\partial }} + {ℰ}_{{s}_{\partial }} ) ,$$

where the max operation runs over all 2^{|∂R|} open-vertex configurations.

The edge set E_{G}\E is composed of two parts, Eₑₑ={(u, v)|(u, v)∈E_{G}∂u, v∈V_{G}\V} that involves only vertices not in R and Eᵣₑ={(u, v)|(u, v)∈E_{G}Λu∈∂RΛv∈V_{G}\V} that bridges R and the rest part of G. Therefore, the maximum independent set of G can be represented as

$$α ( G ) = {max}_{\{ {s}_{v} \vert v ∈ ( {V}_{G} \backslash V ) ⋃ \partial R \}} {α ( R )}_{{s}_{\partial }} + {\sum }_{v ∈ {V}_{G} \backslash V} {W}_{{s}_{v}}^{( v )} + {\sum }_{( u , v ) ∈ {E}_{ee}} {B}_{{s}_{u} {s}_{v}}^{( u , v )} + {\sum }_{( u , v ) ∈ {E}_{re}} {B}_{{s}_{u} {s}_{v}}^{( u , v )} , \qquad Equation 129$$

which contains four terms, while only the first and last terms involve vertices in ∂R and are relevant to the proof of the lemma. Let ∂s_{b} be a open-vertex configuration of R and this configuration is consistent with some MIS of G, i.e. ∂(G)=∂(G, ∂s_{b}), where ∂(G, ∂s_{b}) is the maximum independent set after fixing the open-vertex configuration of R to ∂s_{b}. It is assumed that this configuration is absent in the reduced α-tensor of R, i.e. α′(R)_{∂s}_{_{b}}=−∞. By the definition of the reduced α-tensor in Equation 125, ∂s_{b} is a “bad” configuration. There must be a nonzero entry in α′(R) for open-vertex configuration ∂sₐ that makes ∂sₐ<∂s_{b}Λα(R)_{∂s}_{ₐ}≥α(R)_{∂s}_{_{b}} hold. By fixing the open-vertex configuration to ∂sₐ, both the first and last terms are guaranteed to have a larger or equal value, i.e. the MIS size is not decreased after removing ∂s_{b}. Proving the lemma. Here, that the last term associated with a “better” open-vertex configuration is not smaller can be seen from the fact that B₀ₛ_{ᵥ}≥B₁ₛ_{ᵥ} for any vertex v.

In the following, it will be shown that with zero knowledge about the environment, the nonzero entries in a reduced α-tensor can not the further reduced while keeping the MIS size of the parent graph unchanged.

Let α′(R) be a reduced α-tensor for an induced subgraph R=(V, E, ∂R) and ∂s={0, 1}^{|∂R|} be an open-vertex configurations such that α′(R)_{∂s}≠−∞. Then there exists a parent graph G of R such that ∂s is consistent with the only MIS of G.

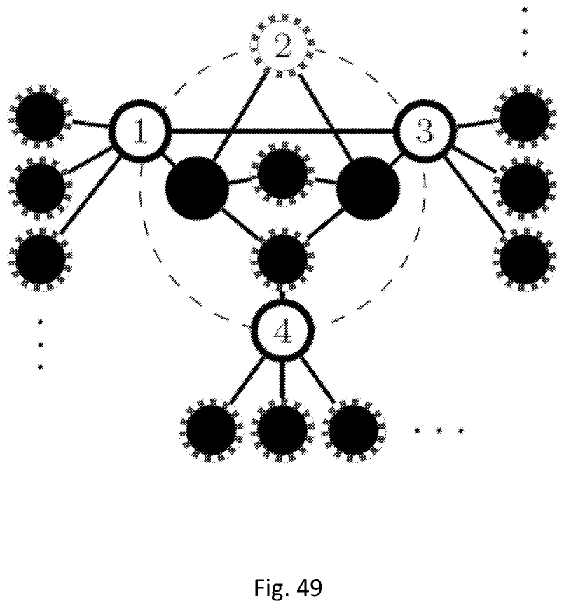

The lemma is proved by construction. Let ∂s∈{0, 1}^{|∂R|} be an open-vertex configuration and G be a parent graph of R constructed by adding an infinite number of mutually independent vertices to each v∈∂R that sᵥ=0 as shown in FIG. 49.

The maximum independent set size of G is

$$α ( G , \partial s ) = {{α}^{′} ( R )}_{\partial s} + ∞ ( \vert \partial R \vert - {\sum }_{v ∈ \partial R} - \partial {s}_{v} ) \qquad Equation 130$$

which is a summation of contributions from two parts, R and its environment G\R. If there exists another configuration with open-vertex configuration ∂τ that gives the same or better maximum independent set size α(G, ∂τ)≥α(G, ∂s), then ∂τ<∂s must be true, otherwise it will suffer from infinite punishment from the environment. For such a Ot, it also must be true that α′(R)_{∂τ}<α′(R)_{∂s}, otherwise α′(R)_{∂s}≤α′(R)_{∂r}Λ∂τ<∂s contradicts with α′(R) being a reduced α-tensor. Finally, α(G, ∂τ)=α′(R)_{∂τ}+∞(|R′|−Σ_{v∈∂R}∂τᵥ)<α(G, ∂s), which contradicts with the assumption. ∂s must be the only open-vertex configuration that gives one the only maximum independent set of G, proving the lemma.

### Subgraph Rewrite and MIS Gadgets

The reduction scheme is composed of replacing a local structure of a source graph by another one following some rule. This procedure is also called subgraph rewrite and the rule is called the MIS gadgets.

Let G=(V_{G}, E_{G}) be a parent graph of an open graph R=(V, E, ∂R=∂₁∂₂ . . . ∂_{|∂R|}), the subgraph rewriting G[R→R′] is defined by replacing R by R′=(V′, E′, ∂R′=∂′₁∂′₂ . . . ∂′_{|∂R′|=|∂R|}), while mapping an edge (u∈V_{G}\V, ∂ₖ) that connects R and the rest part of G to (u, ∂′ₖ). An MIS gadget is a subgraph rewrite rule specified by a pair of open graphs (R, R′), such that for any G being a parent graph of R, α(G[R→R′])=α(G)+c is true for some c.

One important goal is finding MIS gadgets that can help transform an MIS problem on a general graph to that MIS problem on a DUGG. In the following, it is shown that MIS gadgets can be discovered programmatically with the tropical tensor formalism.

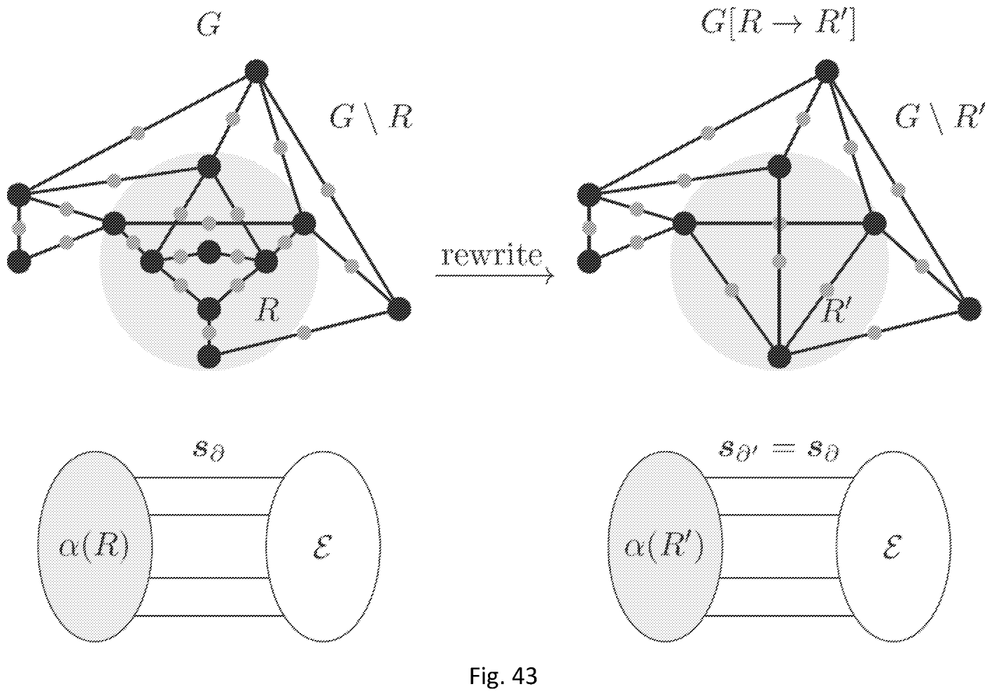

Referring to FIG. 43, the top panel is an example of graph rewrite G[R→R′], where a black circle is a vertex or a vertex tensor, and a gray circle is an edge tensor. The tensors in the shaded region belong to the open subgraph graph R or R′, while the rest are environmental tensors. The bottom panels show the last step of tropical tensor network contractions for the graphs on the top panel. Ellipses are tensors and lines are contracted labels, where ellipses annotated with α(R) and α(R′) are alpha tensors for open subgraphs R and R′, while those annotated with ε are the environmental tensors.

Let R and R′ be two open graphs and α(R′)=α(R)⊙c, then for any parent graph G, α(G[R→R′])=α(G)+c for some c, i.e. (R, R′) is an MIS gadget.

The proposition is proved by contracting this tensor network by parts. Let G=(V_{G}, E_{G}) be a parent graph of R=(V, E, ∂R={∂₁, ∂₂, . . . , ∂_{|∂R|}}). As illustrated in the left panel of FIG. 43, first, contract tensors in R (tensors inside the shaded region) and, second, obtain α(R) of rank |∂R|. Then, all the environmental tensor networks in Equation 128 are contracted and the output is denoted as E, which has the same rank as α(R). The MIS size or the contraction result of the whole tensor network can be represented as a tropical inner product

$$α ( G ) = {max}_{s \partial } ( {α ( R )}_{{s}_{\partial }} + {ℰ}_{{s}_{\partial }} ) ,$$

shorthanded as α(R)ε. Similarly, α(G[R→R′])=α(R′)ε, as ε is not changed during the subgraph rewrite. By the associativity and commutativity of tropical tensor multiplication, it is easy to show α(G[R→R′])=(α(R)⊙c)ε=α(G)+c.

This proposition is a sufficient but not necessary condition for an open graph being a MIS gadget of another one. To search for practically useful gadgets, a necessary and sufficient condition for gadget design based on the reduced α-tensor is introduced.

Let α′(R) and α′(R′) be reduced α-tensors for open graphs R and R′, if and only if α′(R′)=α′(R)+c for some c, (R, R′) is a MIS gadget.

The sufficiency can be proved as given above, where the MIS size can be computed by contracting the reduced α-tensor and its environment. Since their reduced α-tensors are different by a constant and their environments are the same, the reduced subgraph and the original graph are also different by the same constant. The necessity is from the above assertion, which states that removing any of the remaining nonzero elements in the reduced α-tensors may change the MIS size.

For any problem reduction, it is important to show the existence of an algorithm to map a solution for the reduced problem to one for the source problem in a time polynomial to the problem size. It is shown that such an algorithm exists for a reduction scheme composed of MIS gadgets.

For any MIS gadget (R, R′), there exists a local map on R that maps a MIS solution for G[R→R′] to one for G.

If for any parent graph G, α(G[R→R′])=α(G)+c is true, α′(R′)=α′(R)⊙c must hold. Let I′ be a MIS for the mapped graph G[R→R′], and its open-vertex configuration ∂s′ satisfies α′(R′)_{∂s′}≠−∞, then a MIS for G can be obtained by replacing the configuration associated with α′(R′)_{∂s′} by the one associated with α′(R)_{∂s′}. Otherwise if α′(R′)_{∂s′}=−∞Λα(R′)_{∂s′}≠−∞, then there must be a s<s′ such that α′(R′)_{∂s}≠−∞ and α(R′)_{∂s}=α(R′)_{∂s′}, then a MIS for G can be obtained by replacing a configuration associated with α′(R′)_{∂s′} by the one associated with α′(R)_{∂s}.

Given a reduction scheme composed of an n-step MIS gadgets application: G^{(k)}=G^{(k-1)}[Rₖ→R′ₖ] for k=1, 2, . . . , n, one can map any MIS for the reduced graph to one for the source graph, which can be done by applying the configuration back tracing rules derived above step by step in the inverse order of the gadgets application. The configuration back tracing rules are listed explicitly below for the gadgets that are introduced below.

A graph U=(V, E) is a D dimensional unit disk graph if there exists an Euclidean embedding p: v [symbol] [symbol] , such that E={(v, w)|v≠w∈V, ∥p(v)−p(w)∥₂≤r} for some r. A diagonal-coupled unit-disk grid graph (DUGG) is a special unit disk graph that can be embedded in a grid of unit length 1, i.e. there exists a grid embedding g: v [symbol] [symbol] , such that

$$E = \{ ( v , w ) \vert v \neq w ∈ V , {‖ g ( v ) - g ( w ) ‖}_{2} \leq \sqrt{2} \} .$$

The goal of the reduction scheme is to construct a DUGG such that an arbitrary MIS for this DUGG can be mapped back to an MIS of the source graph in polynomial time. This reduction procedure mainly consists of a sequence of subgraph rewriting, including rewriting a vertex to a path graph and rewriting a crossing to a DUGG. It can be represented as a sequence of graph rewrite {G, G₁, G₂, . . . , Gₘ}, m˜poly(|V|), where the reduced graph Gₘ is a DUGG. The transformation at step k can be expressed as G (k+1)=G^{(k)} [R→R′], meaning replacing an open subgraph R⊆G^{(k)} by R′ for (R, R′) being a MIS gadget.

Crossings is a typical structure that does not have a unit-disk embedding, while it can not be removed completely by relocating the vertices unless it is a planar graph. The way crossings are removed from the graph is by introducing some DUGGs that can be used to rewrite crossings.

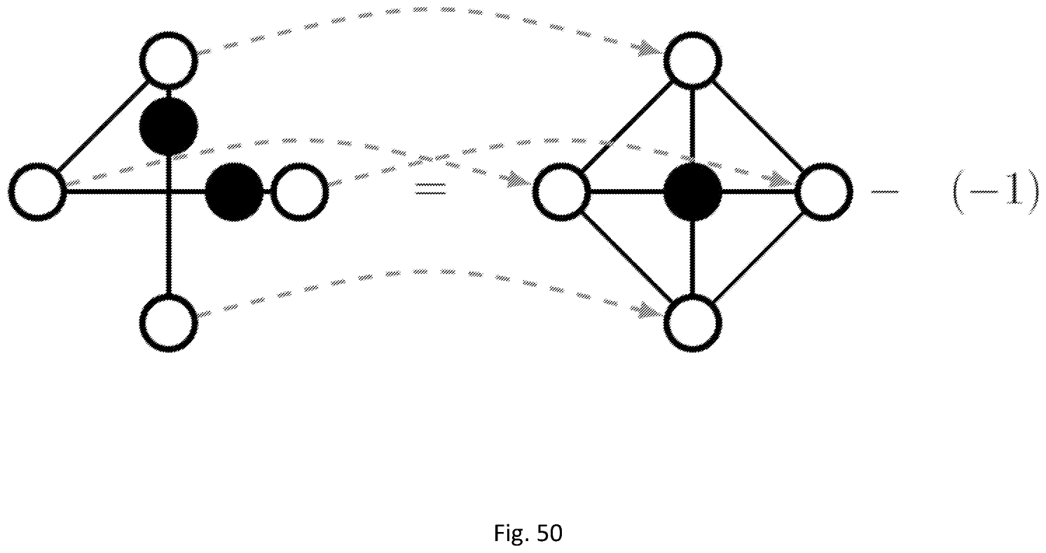

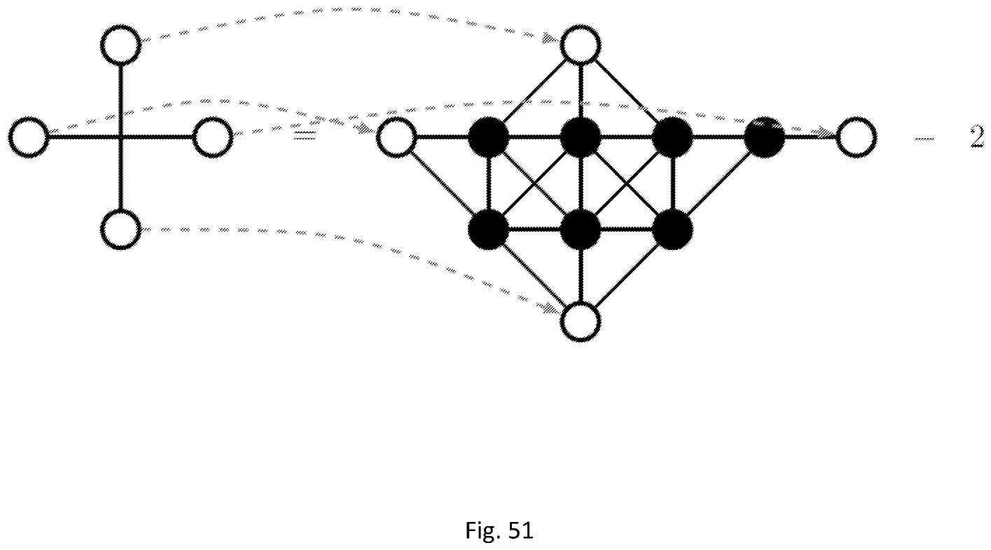

Let CROSS+EDGE be the open graph on the left-hand side of FIG. 50 and PIRAMID be the DUGG on the right-hand side. The map between their open vertices is indicated by the dashed arrows. (CROSS+EDGE, PIRAMID) is an MIS gadget, and it is optimal in terms of the number of the additional vertices (−1). The constant overhead in the MIS size is −1.

The reduced α-tensors for CROSS+EDGE and PIRAMID are related by

$$( \begin{matrix}( \begin{matrix}2 & \\ & - ∞\end{matrix} ) & ( \begin{matrix} & \\ 3 & - ∞\end{matrix} ) \\ ( \begin{matrix} & 3 \\ & - ∞\end{matrix} ) & ( \begin{matrix} & \\ & - ∞\end{matrix} )\end{matrix} ) = ( \begin{matrix}( \begin{matrix}1 & \\ & - ∞\end{matrix} ) & ( \begin{matrix} & - ∞ \\ 2 & - ∞\end{matrix} ) \\ ( \begin{matrix} & 2 \\ - ∞ & - ∞\end{matrix} ) & ( \begin{matrix}- ∞ & - ∞ \\ - ∞ & - ∞\end{matrix} )\end{matrix} ) ⊙ 1 \qquad Equation 131$$

These two reduced α-tensors are different by a constant 1. The optimality is proved by brute force search.

Let CROSS be the open graph on the left hand side of FIG. 51 and BATOIDEA be the DUGG on the right hand side. The map between their open vertices is indicated by the dashed arrows. (CROSS, BATOIDEA) is an MIS gadget, and it is optimal in terms of the number of the additional vertices (7). The constant overhead in the MIS size is 2.

The reduced α-tensors for CROSS and BATOIDEA are related by

$$( \begin{matrix}( \begin{matrix}0 & 1 \\ 1 & 2\end{matrix} ) & ( \begin{matrix}1 & 2 \\ - ∞ & - ∞\end{matrix} ) \\ ( \begin{matrix}1 & - ∞ \\ 2 & - ∞\end{matrix} ) & ( \begin{matrix}2 & - ∞ \\ - ∞ & - ∞\end{matrix} )\end{matrix} ) = ( \begin{matrix}( \begin{matrix}2 & 3 \\ 3 & 4\end{matrix} ) & ( \begin{matrix}3 & 4 \\ & \end{matrix} ) \\ ( \begin{matrix}3 & \\ 4 & \end{matrix} ) & ( \begin{matrix}4 & \\ & \end{matrix} )\end{matrix} ) ⊙ - 2 \qquad Equation 132$$

These two reduced α-tensors are different by a constant −2. The optimality is proved by brute force search.

$$Let {K}_{1}^{n} = ( \{ v \} , \{ \} , {\underbrace{vv … v}}_{n times} \}$$

be an open graph with a single vertex, COPYⁿ be a path graph with (2k+1) vertices for some integer k and n≤k+1 with odd indices being open.

$$( {K}_{1}^{n} , {COPY}^{n} )$$

is an MIS gadget. The constant overhead in the MIS size is n.

The reduced α-tensor for

$${K}_{1}^{n}$$

is

$${{α}^{′} ( {K}_{1}^{n} )}_{{s}_{1} {s}_{1} … {s}_{1}} = \{ \begin{matrix}0 , & {s}_{1} = 0 , \\ 1 , & {s}_{1} = 1 , \\ - ∞ , & otherwise\end{matrix} , \qquad Equation 133$$

where the tensor entries that do not have consistent assignment are tropical zero. The reduced α-tensor for COPYⁿ is

$${{α}^{′} ( {COPY}^{n} )}_{{s}_{1} {s}_{3} … {s}_{2 n + 1}} = \{ \begin{matrix}n , & {s}_{1} = {s}_{3} = … = {s}_{2 n + 1} = 0 , \\ n + 1 , & {s}_{1} = {s}_{3} = … = {s}_{2 n + 1} = 1 , \\ - ∞ , & otherwise\end{matrix} . \qquad Equation 134$$

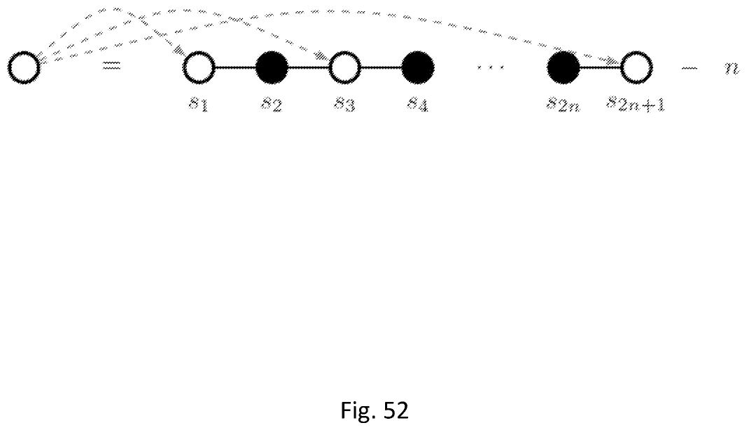

Then these two reduced α-tensors are different by a constant n, proving the correctness of FIG. 52.

In COPYⁿ, only open vertices (denoted as white circles in FIG. 52) are allowed to connect to the remaining part of a parent graph. Since there is no one-to-one correspondence between open vertices, edges connecting to the vertex v in

$${K}_{1}^{n}$$

can not be mapped to one in COPYⁿ deterministically. In practice, one can map an edge (v, u) to any (v′, u) that v′∈∂COPYⁿ, because all open vertices in a copy gadget are “equivalent” to the source vertex. A copy gadget does not have to be a path graph, it can also be a tree, which is equivalent to rewriting a vertex to a path graph multiple times. Copy gadgets can be used to decompose a high degree vertex into low degree ones or bridge two vertices that are far away from each other.

In this disclosure, several concrete examples of applying the copy gadget

$$G [ {K}_{1}^{3} \to {COPY}^{3} ]$$

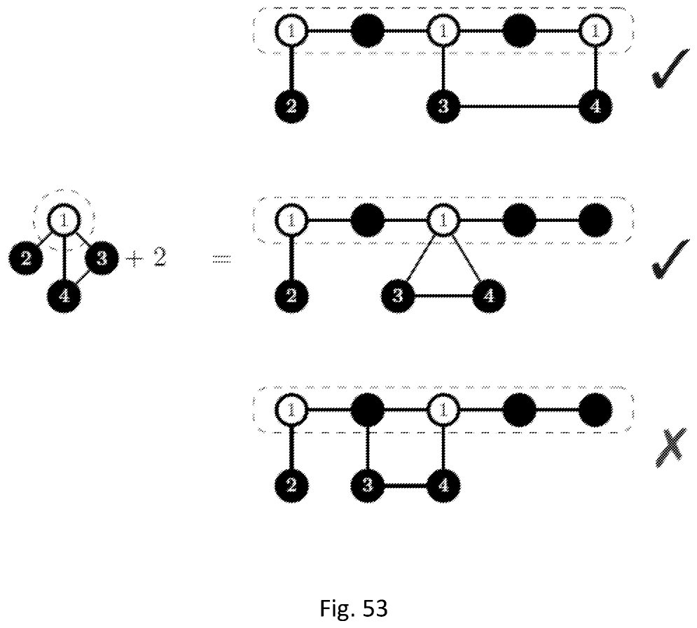

in graph rewriting are shown. Then it is shown how to map a solution for the reduced graph to one for the source graph. FIG. 53 shows several correct and incorrect subgraph rewrites with copy gadgets.

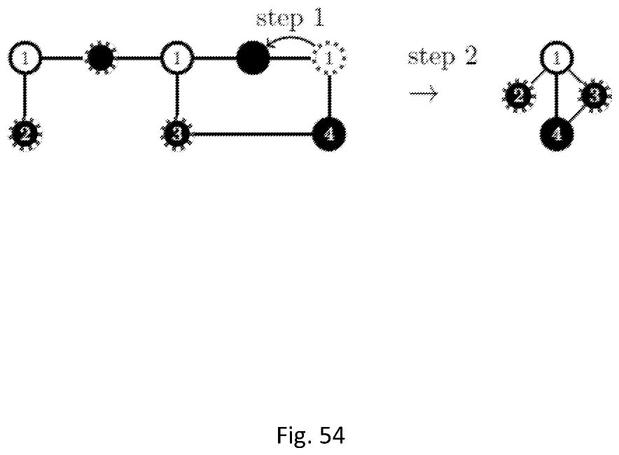

The numbers on the vertices of COPY3 are the source vertices mapped from the source graph. The third graph rewrite is incorrect because an interior vertex in black should not be connected to any of 2, 3 and 4. Given an MIS solution of the first mapped graph, an MIS of the source graph can be obtained with the two steps illustrated in FIG. 54.

Here, dashed (solid) node edge color is used to represent a vertex absent (present) in an independent set. In the first step, the program checks the copy gadget configuration and changes as many open vertices in the set to interior vertices as possible, which is equivalent to finding a open-vertex configuration that corresponds to a nonzero entry in the reduced α-tensor. Only two such configurations are available, which are subsequently mapped to source configurations in step 2.

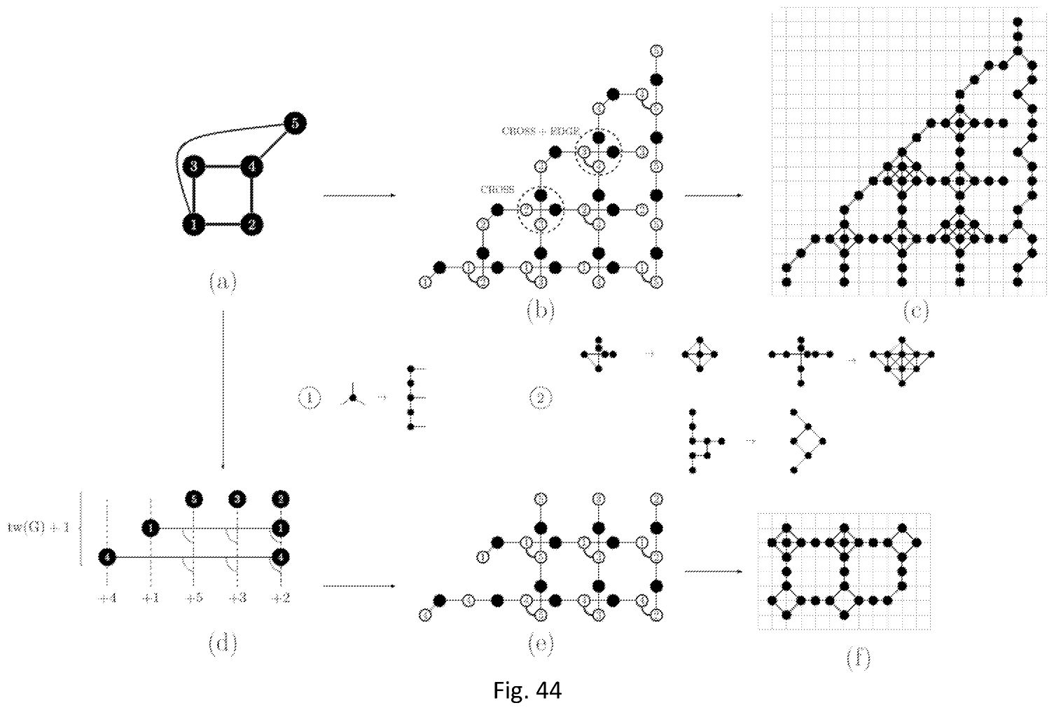

Referring to FIG. 44, the reduction schemes from the MIS problem on a general graph to that on a DUGG are illustrated. Subplots (a), (b) and (c) on the upper panel is the O(|V|²) direct approach as follows: (a) is the source graph. (b) is the crossing lattice (a kind of 2D geometric graph) obtained by applying the copy gadgets to the source graph. Black circles are interior vertices, white circles are open vertices and curved edges correspond to the edges in the source graph. The numbers on the boundary vertices correspond to the sources vertices they are mapped from. (c) is the DUGG after applying the two crossing gadgets (CROSS, BATOIDEA) and (CROSS+EDGE, PIRAMID). The lower panels (d), (e) and (f) are for the path-decomposition optimized approach. (d) is the optimal path decomposition of the source graph, where a column is a bag in the path decomposition, and a segment with horizontal span (sᵥ, fᵥ) is a vertex v that is added to the bag at step sᵥ and removed in a future step fᵥ+1. The curved lines are edges in the original graph. (e) is the crossing lattice for (d). (f) is the DUGG obtained by applying MIS gadgets on (e). The gadgets applied during the two-step reduction processes are illustrated in the middle panel.

The problem of finding maximum independent sets of a general graph G=(V, E) can be reduced to that of a DUGG with O(|V|²) vertices.

This is proved by constructing a two-step reduction scheme as illustrated in the top panel of FIG. 44: In step 1, the vertices in the source graph are aligned into a row, and then each of them is replaced with a “Γ” shaped COPY (FIG. 52) as shown in FIG. 44B. Black and white circles are interior and boundary vertices, respectively, while only boundary vertices are allowed to connect to the vertices in other COPYs, and all boundary vertices in a COPY are “equivalent” to the source vertex they mapped from. These path graphs form a crossing lattice, a two dimensional geometric graph that has a crossing at a certain lattice site for any u, v∈V. For each edge (u, v)∈E in the source graph, it is mapped to an edge at the crossing of the copy gadgets of u and v (the curved lines in FIG. 44B). In step 2, either (CROSS, BATOIDEA) is applied in FIG. 51 or (CROSS+EDGE, PIRAMID) is applied in FIG. 50 for each crossing, as enclosed by dashed circles in figure (b). To embed the graph into a grid, extra even number of vertices must be added to the copy gadgets so that these rewrite rules for the crossings can be adapted to grids as detailed below. In the last step, the generated graph is post-processed by, e.g. trimming the dangling legs, and obtain the resulting DUGG as shown in FIG. 44C. Given any MIS of the obtained DUGG, an MIS of the source graph is obtained in a time polynomial to the graph size with the configuration back-tracing rules listed herein.

By relating the layout of the crossing lattice with the path decomposition, the depth of the mapped DUGG can be further reduced to O(pw(G)) for a source graph G, where pw(G) is the pathwidth of G, a graph characteristic smaller than the number of vertices in G.

Given a graph G=(V, E), its path-decomposition is a sequence of bags Xᵢ⊆V, with the following two properties:
1. For each edge of G, there exists an i such that both endpoints of the edge belong to bag Xᵢ, and
2. For every three indices i≤j≤k, Xᵢ∩Xₖ⊆Xⱼ.

The path decomposition defines a mapping from a general graph to a path graph {X₁, X₂, . . . , Xₘ} and its width is defined as

$$\begin{matrix}m \\ {max}_{j = 1}\end{matrix} \vert {X}_{j} \vert - 1.$$

The smallest width among all path decompositions is the pathwidth which is denoted as pw(G).

For a sparse graph, the pathwidth is usually much smaller than the number of vertices. For example, the pathwidth of a 3-regular graph is asymptotically bounded by |V|/6, and the pathwidth of a tree graph is only logarithmic in |V|. A crossing lattice of depth pw(G)+1 can be obtained by inspecting the bags in an optimal path decomposition. For example, an optimal path decomposition for the graph in FIG. 44A is

$${⟶}^{+ 4} ( 4 ) {⟶}^{+ 1} ( 41 ) {⟶}^{+ 5} ( 415 ) {⟶}^{+ 3} ( 413 ) {⟶}^{+ 2} ( 412 ) \qquad Equation 135$$

The above decomposition can be diagrammatically represented as shown in FIG. 44D. Here, each column is a bag in the path decomposition, and the maximum bag size is equal to the number of rows. It is easy to verify that all edges are included, (1,5), (4,5)∈X₃, (1,2), (2,4)∈X₅ and (1,3), (3,4) € X₄, i.e. it is a valid path decomposition.

The problem of finding maximum independent sets on a general graph G=(V, E) can be reduced to that on a DUGG of width O(|V|) and depth pw(G)+1, where pw(G) is the pathwidth of G.

Given a path decomposition, a vertex ordering can be determined, e.g. (4,1,5,3,2) in the above example. Each column is assigned to a vertex and its copy gadget is wired into the “ [symbol] ” shape as shown in FIG. 44D (including both solid and dashed lines). For any (u, v)∈E, copy gadgets for u and v are guaranteed to cross at a certain bag. Crossing gadgets are applied for each crossing, and the resulting graph is a DUGG of depth pw(G)+1.

With an optimal path decomposition, the graph in FIG. 44A can be mapped to the DUGG in FIG. 44F with only 31-vertices. Here, the mapped graph has depth 2 rather than pw(G)+1=3 because the dangling vertices in the copy gadgets are trimmed. Note that removing a dangling line is effectively reducing the size of a copy gadget.

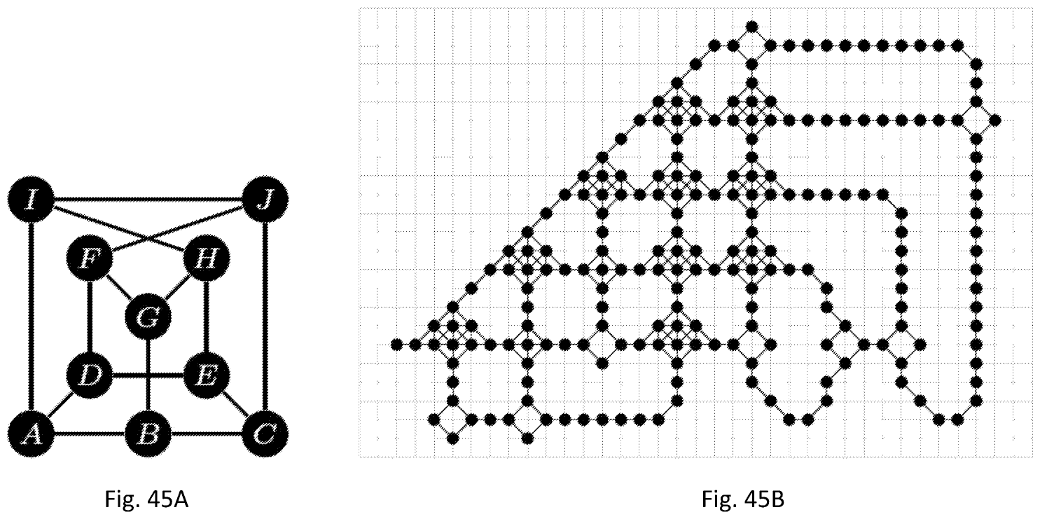

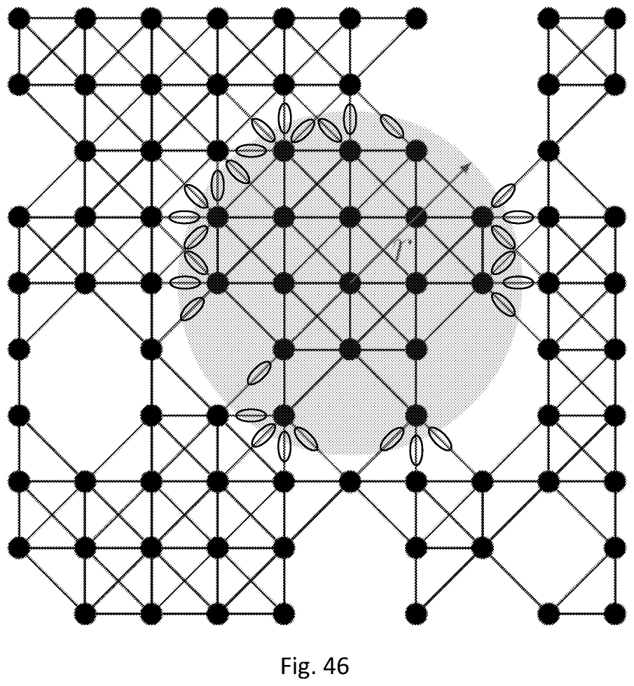

Referring to FIG. 45, the Petersen graph (FIG. 45A) and its diagonally coupled unit disk grid graph embedded with an optimal vertex ordering (FIG. 45B) are illustrated.

The Petersen graph is a 3 regular graph with 10 vertices as shown in FIG. 45A, One of its optimal path decompositions, which has pathwidth 5, is

$${⟶}^{+ A} ( A ) {⟶}^{+ B} ( AB ) {⟶}^{+ C} ( ABC ) {⟶}^{+ D} ( ABCD ) {⟶}^{+ E} ( ABCDE ) {⟶}^{+ G} ( ABCDEG ) {{⟶}_{- B}}^{+ F} ( ACDEGF ) {{⟶}_{- D}}^{+ H} ( ACEGFH ) {{⟶}_{- EG}}^{+ 1} ( ACFHI ) {{⟶}_{- AH}}^{+ J} ( CFIJ ) . \qquad Equation 136$$

The mapped DUGG shown in FIG. 45B has depth 6 and grid size 23×32. It has 218 vertices and its MIS size is larger than that of the Petersen graph by a constant 88.

In the following discussion, the proposed DUGG reduction scheme for the MIS problem is shown very likely to be optimal up to a constant or logarithmic factor, otherwise, there will be a sub-exponential time algorithm for finding the maximum independent sets of a general graph, i.e., it is better than any existing classical algorithms and contradicts with the exponential time hypothesis.

A D-dimensional area-law graph is a geometric graph that given a unit ball of radius r centered at a reasonable reference point, the number of vertices contained in the ball is upper bounded by its volume αr^{D} for some a and the number of edges cut by the sphere is upper bounded by the surface area βr^{D-1} for some β.

A DUGG is an area-law graph.

If the exponential time hypothesis is true, no algorithm can reduce the problem of finding maximum independent sets on a general graph G=(V, E) to that on an area-law graph in dimension D of at most

$$η {\vert V \vert}^{\frac{D}{D - 1} - ϵ}$$

vertices for some η and any ϵ>0.

The above assertion can be proven by contradiction. Suppose there exists a polynomial time algorithm [symbol] which reduces the problem of finding the MIS on any graph [symbol] =(V, E) onto finding the MIS on an area-law graph [symbol] ₐ in dimension D with at most

$$η {\vert V \vert}^{\frac{D}{D - 1} - ϵ}$$

vertices for some η and ϵ>0. There exists an algorithm [symbol] based on tropical tensor network which can solve the MIS on an area-law graph [symbol] ₐ=(V, E) in dimension D in a time of at most

$$O ( \vert E \vert ) {2}^{O ( {\vert V \vert}^{\frac{D - 1}{D}} )} .$$

An algorithm [symbol] may be used to solve the MIS on any graph [symbol] by using [symbol] and [symbol] as a subroutine as follows. First, algorithm [symbol] is given any graph of N vertices and computes an area-law graph

$${𝒢}_{a} of \vert V \vert = η {N}^{\frac{D}{D - 1} - ϵ}$$

vertices. Then, algorithm [symbol]
solves the MIS of [symbol] ₐ, which takes a time of at most poly(N)

$${2}^{O ( {N}^{1 - ϵ \frac{D - 1}{D}} )} .$$

Then, given a solution of [symbol] ₐ, algorithm A can compute a solution of the source graph G. The exponential time hypothesis (ETH) states that MIS cannot be solved in a time lower bounded by poly(|V|)2^{O(|V|)}, by a linear reduction of 3-SAT to MIS. Assuming that the ETH is true lies in contradiction with the existence of algorithm [symbol] . In a proof by contradiction, if ETH is true, the algorithm [symbol] may not exist, proving the above assertion.

There exists an algorithm [symbol] which can solve the MIS of any area-law graph [symbol] ₐ=(V, E) in spatial dimension D in a time of at most

$$O ( \vert E \vert ) {2}^{O ( {\vert V \vert}^{\frac{D - 1}{D}} )} .$$

It is proved by bounding the time of contracting the tropical tensor network for the maximum independent set problem on Ga, O(|E|) [symbol] . Here, tw( [symbol] ₐ) is the treewidth of [symbol] ₐ and it is upper bounded by the pathwidth since a path decomposition is also a tree decomposition. For an area-law graph, a path decomposition of width

$$O ( {\vert V \vert}^{\frac{D - 1}{D}} )$$

can be obtained with the process illustrated in FIG. 46. Starting from some reference point, a ball of radius r=0 is drawn. Then the radius is increased to include more edges into the ball. Whenever the surface of the ball cuts a new edge, a bag that consists of endpoints of edges at the boundary is added to the sequence. At certain point, all edges will be included, and the generated sequence of bags corresponds to a path decomposition of [symbol] ₐ. By the definition of area-law graph, the size of the bag is proportional to the surface area of the ball

$${r}^{\frac{D - 1}{D}} .$$

Since the number of vertices included in the ball scales as its volume r^{D}, the overall time and space complexity to contract this tensor network is

$$O ( \vert E \vert ) {2}^{O ( {\vert V \vert}^{\frac{D - 1}{D}} )} ,$$

proving the above assertion.

Referring to FIG. 46, a way to construct a path decomposition of an area-law graph, e.g. the DUGG in the graph, is illustrated. The vertices and edges in the ball are those already included in the existing bags. The interior vertices connected to the edges at the cut (circled) are the elements of the current bag.

The present disclosure introduces a tropical tensor network based framework for finding gadgets of the maximum independent set problem (MIS). With the gadgets discovered by the computer program, it is shown that the reduction from a MIS problem on a generic graph G to that on a diagonal-coupled unit-disk grid graph (DUGG) can be done with a vertex overhead of O(pw(G)), where pw(G) is the pathwidth of G. The proposed reduction scheme is optimal up to a constant or logarithmic factor if the exponential time hypothesis holds. This gadget searching scheme can be extended to study the reduction of multiple combinatorial optimization problems, as long as the target problem has a tropical tensor network representation.

These methods may be used to improve tensor network optimization algorithms. Usually, the contraction ordering is only aware of the problem structure, such as graph connectivity, and optimizes accordingly. However, this subgraph reduction is aware of local solution structure, and can potentially replace subgraphs with a large pathwidth with similar subgraphs with a smaller pathwidth. In this way, this subgraph reduction may construct an optimizer that is aware of solution structure as well as problem structure, by first doing subgraph replacement. It is an interesting future direction to evaluate the performance of such a combined algorithm.

The reduction scheme relates some facts about the computational complexity of the MIS problem on a general graph and that on a DUGG or hard core lattice gases. For example, Given NP≠P, there exists a polynomial-time algorithm for constant approximating the MIS size of a unit-disk graph but no polynomial algorithm can approximate the MIS of a general graph within n^{1-ϵ} for any ϵ>0. With the reduction scheme described herein, it is easy to see that there is no polynomial-time algorithm to approximate the MIS size of a n²-vertex DUGG M to a value better than α(M)−δn for any δ<½. It is interesting to check if there are more facts that can be related to this reduction scheme.

This tropical tensor method can be used for gadget finding of a variety of other combinatorial problems, such as the spin-glass problem, the matching problem, the k-coloring problem, the max-cut problem, the binary paintshop problem, the set packing problem, and the set covering problem.

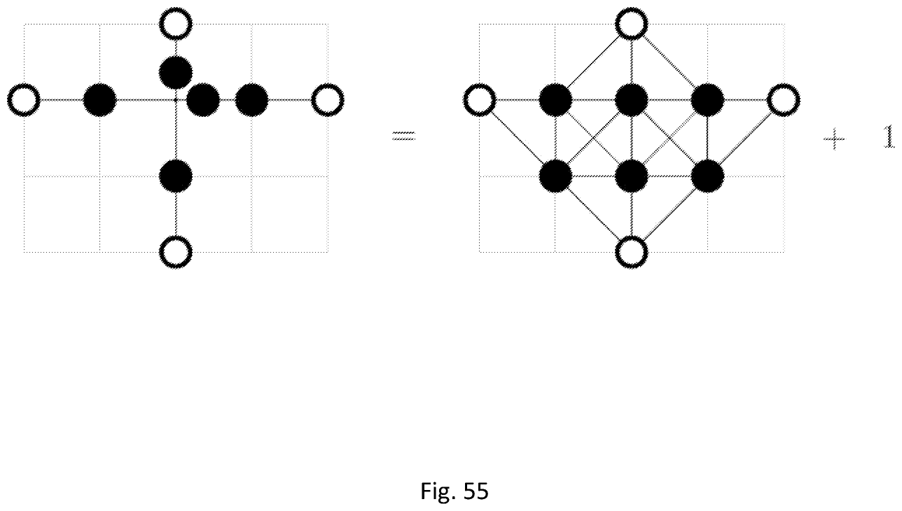

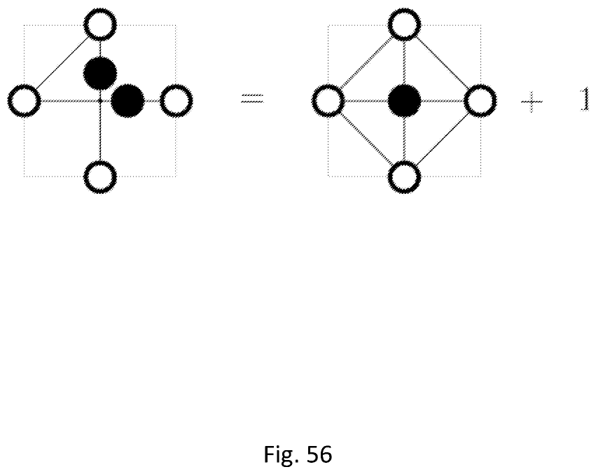

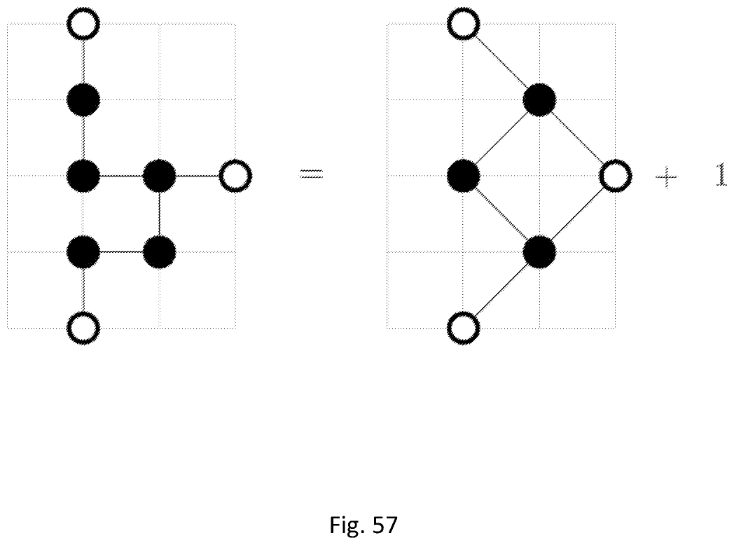

Referring to FIGS. 55-57, exemplary rewriting rules for MIS gadgets that are suitable for problem reduction are shown. FIG. 57 depicts the gadget used in the path-decomposition optimized reduction scheme. The structure on the left side is located at the connection point of the I-wiring when one uses path decomposition to optimize the depth of the DUGG.

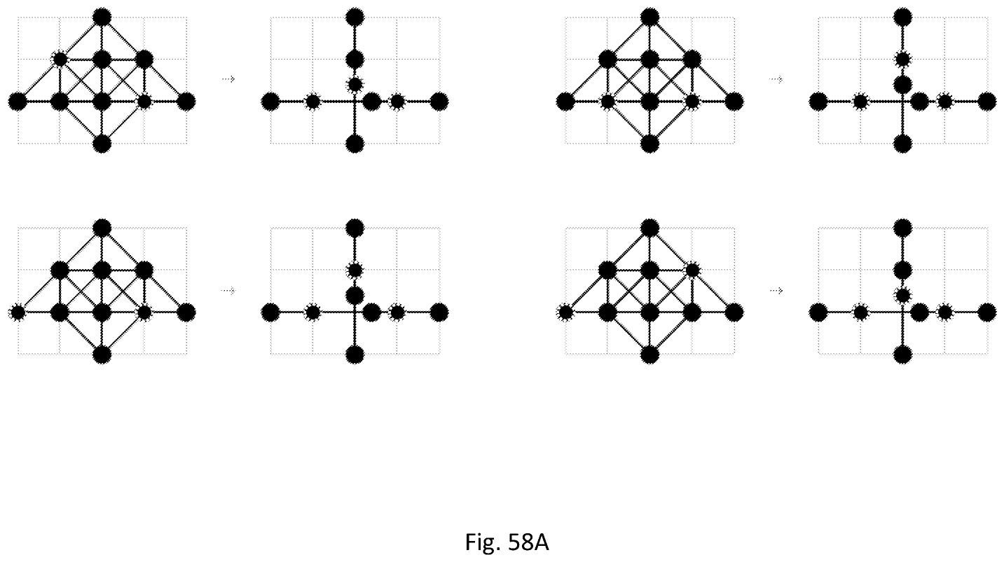

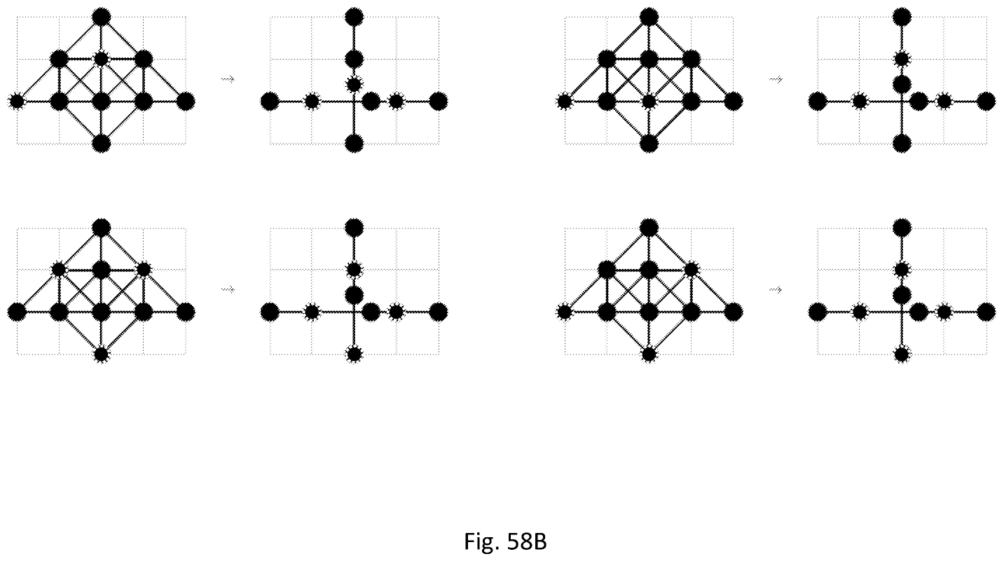

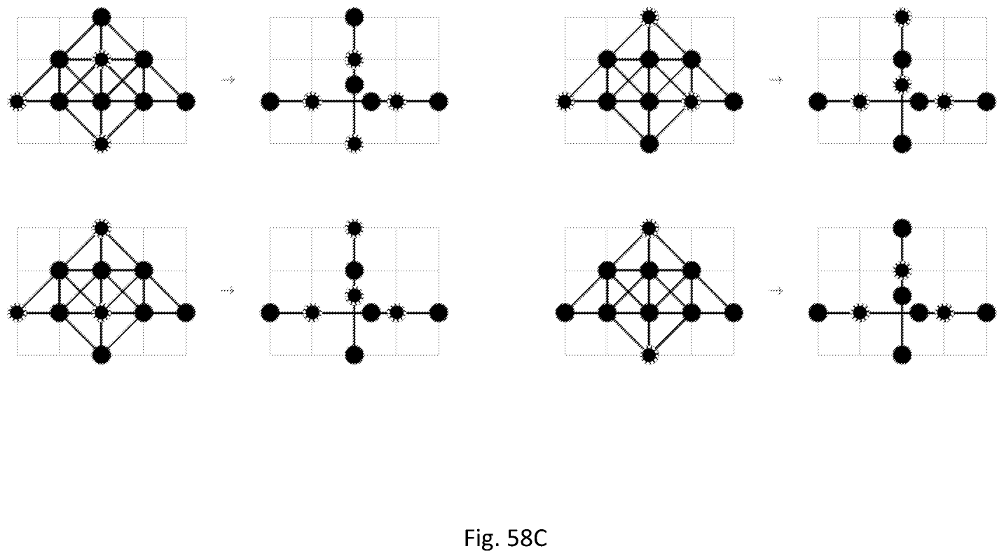

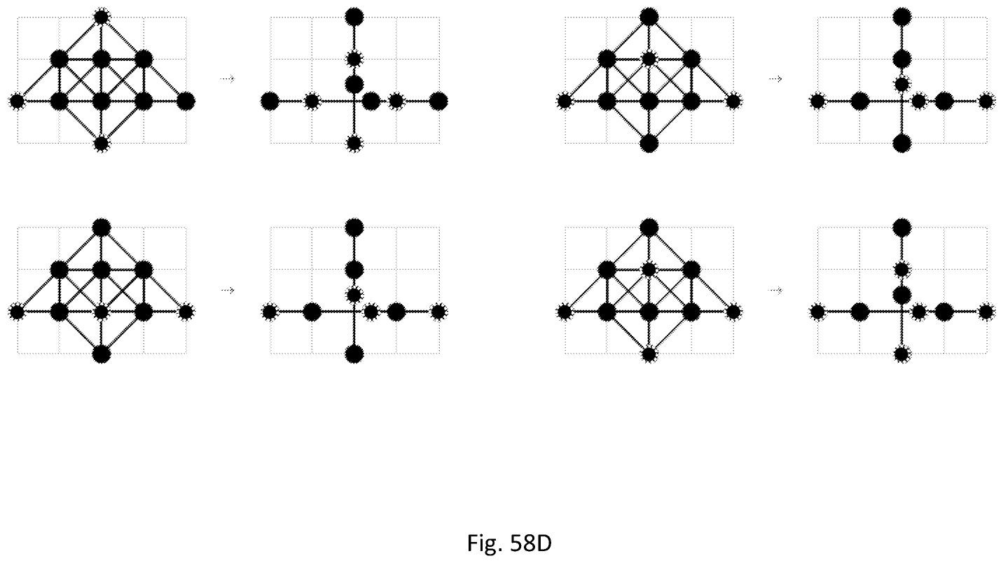

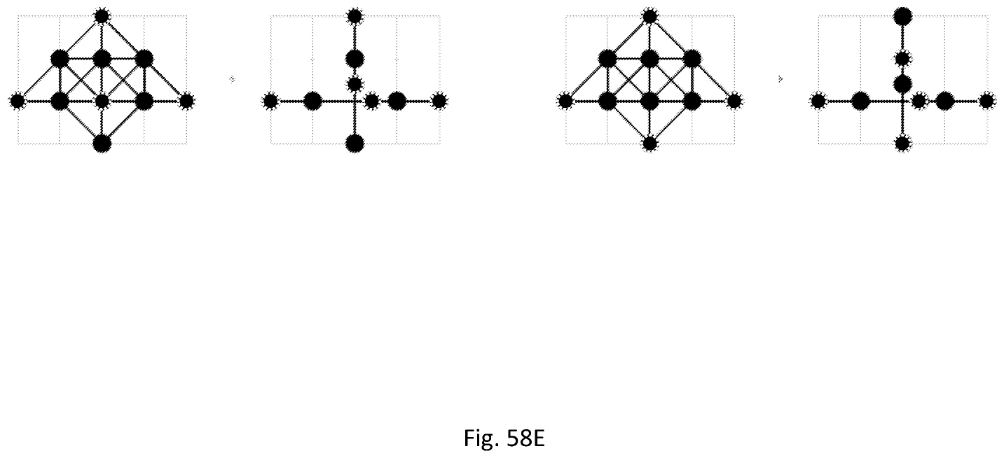

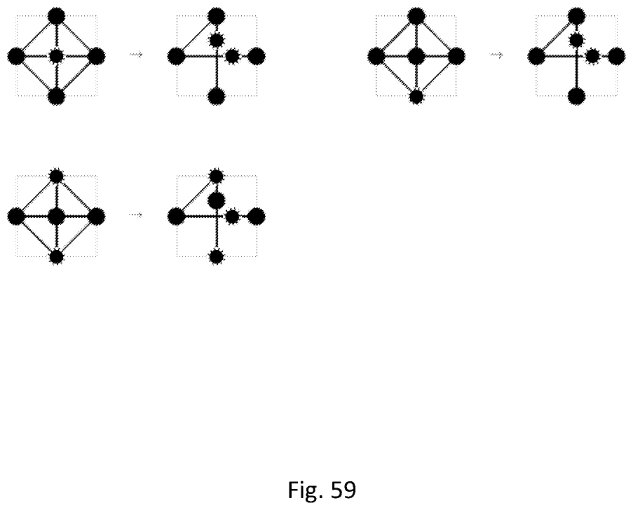

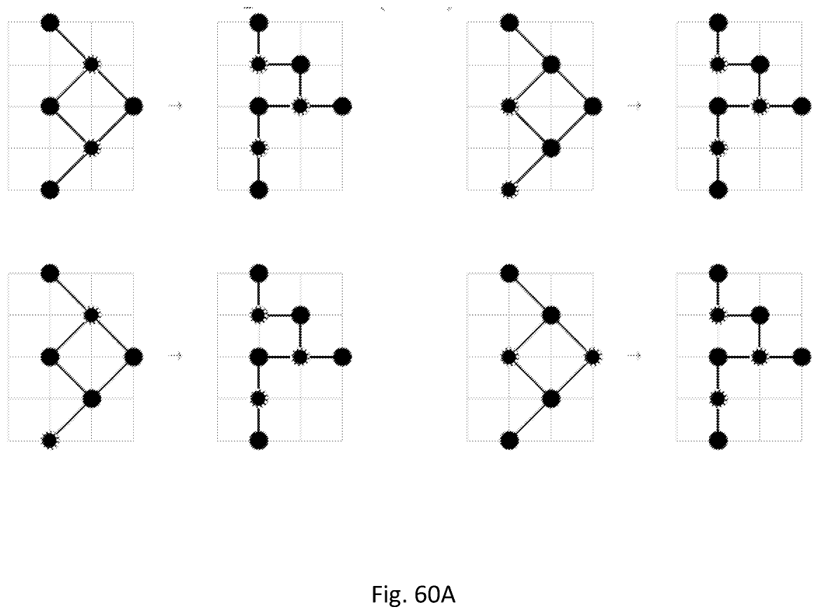

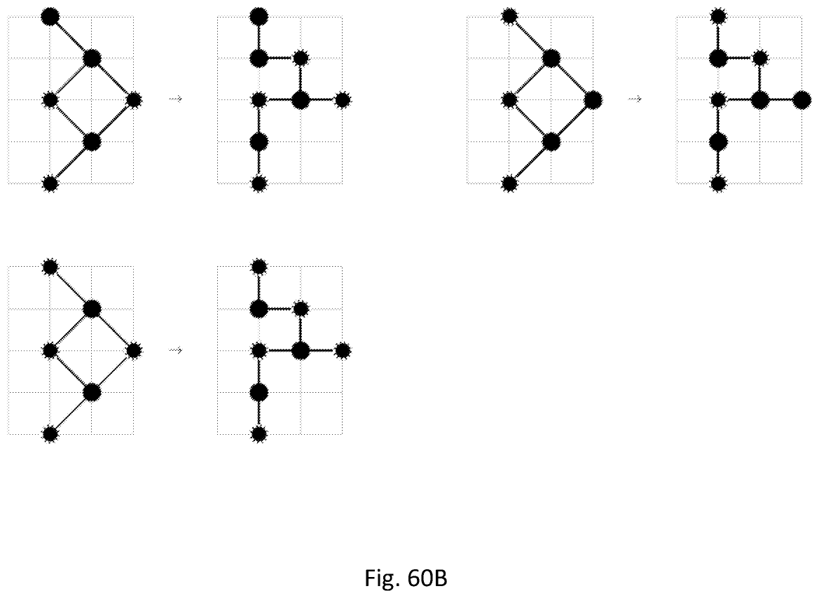

Referring to FIGS. 58-60, the rules to extract MIS for the source graph are presented. On the left side of the “→” symbol, a possible gadget configurations in the MIS of a mapped graph is specified, and on the right side, a possible replacement is specified. FIGS. 58A-58E relate to BATOIDEA. FIG. 59 relates to PIRAMID. FIGS. 60A-60B relate to BRANCHING.

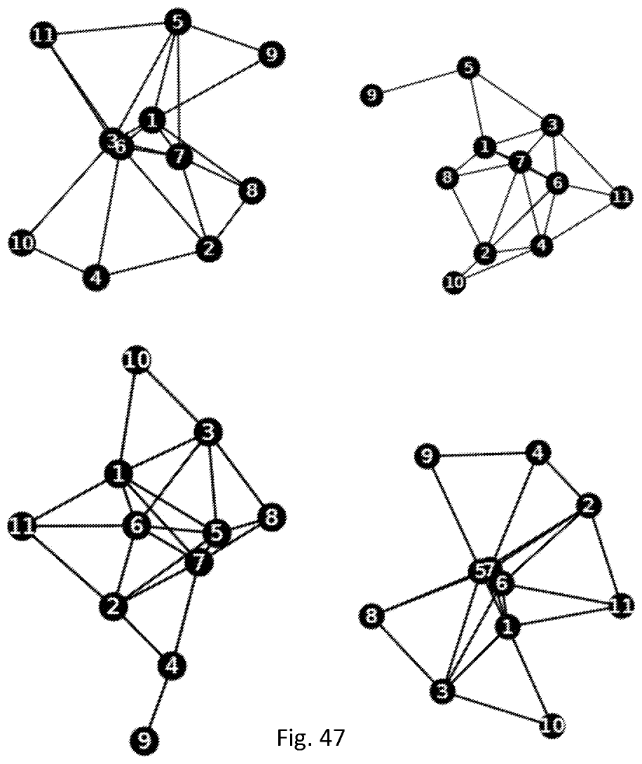

How to search unit disk MIS gadgets for crossings by efficiently enumerating graphs of a certain size is described below. A crossover gadget G=(V, E) is composed of |V|−4 ancilla vertices and 4 open vertices. The ancilla part is enumerated as non-isomorphic graphs. For the largest graph size |V|=11 searched, there are only 1044 non-isomorphic ancilla graph configurations. For each non-isomorphic graph, there are 4^{|V|-4} possible ways to connect open vertices and ancilla vertices, while some of them can be ignored since they are isomorphic to others. One should also consider the connections between open vertices, among 2⁶ possible connection patterns, wherein most are forbidden due to the restriction of the properties of α-tensors. It is tedious to use symmetry to filter out all non-isomorphic graphs, so all the details are not shown here. For each graph instance in the reduced searching space, the generic tensor network is used to find the α-tensor and turn it into a reduced α-tensor. If the reduced α-tensor of this graph is the same as the source crossing graph, then it is a gadget for crossing. The rest is to prove it has a correct spatial layout and is a unit disk graph. All non-isomorphic graphs of size |V|=5, 6, . . . , 11 were checked on an Amazon web service (AWS) host with 72 nodes in less than one day. The minimum size of a crossover gadget is |V|=11; all four solutions are listed in FIG. 47.

Crossing criteria are provided to reduce the graph searching space. Let the four open vertices of a crossover gadget G=(V, E) be A, B, C and D, where (A, D) and (B, C) are the two edges in the crossing. Since G is a crossover gadget, it is required that any path π_{AD}∈Paths(A, D) intersects any path π_{BC}∈Paths(B,C), where the intersection between two paths has a necessary condition specified as follows:
Let π_{AD} and π_{AD} be two paths in a unit disk graph G=(V, E). They intersect each other only if at least one of the following statements are true
1. there exists a vertex v such that v∈π_{AD} and v∈π_{BC},
2. there exists a vertex w∈π_{AD} and an edge (u, v)∈π_{BC}, such that both (w, u) and (w, v) are in E.
3. there exists a vertex w∈π_{BC} and an edge (u, v)∈π_{AD}, such that both (w, u) and (w, v) are in E.

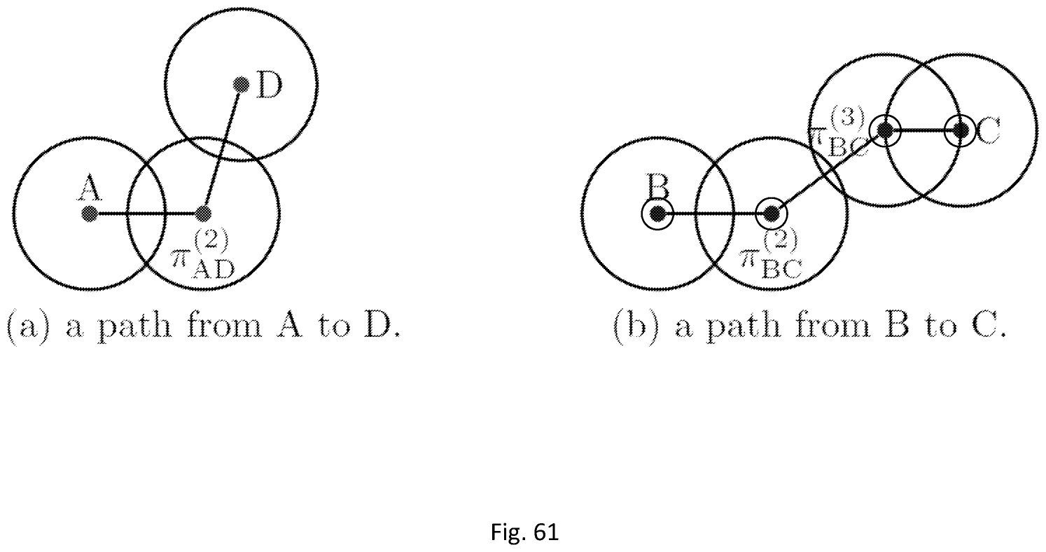

Referring to FIG. 61, this can be proved visually. Let there be a circle of radius 0.5 drawn around each vertex. By definition of a unit disk graph, two vertices are connected if and only if their circles overlap.

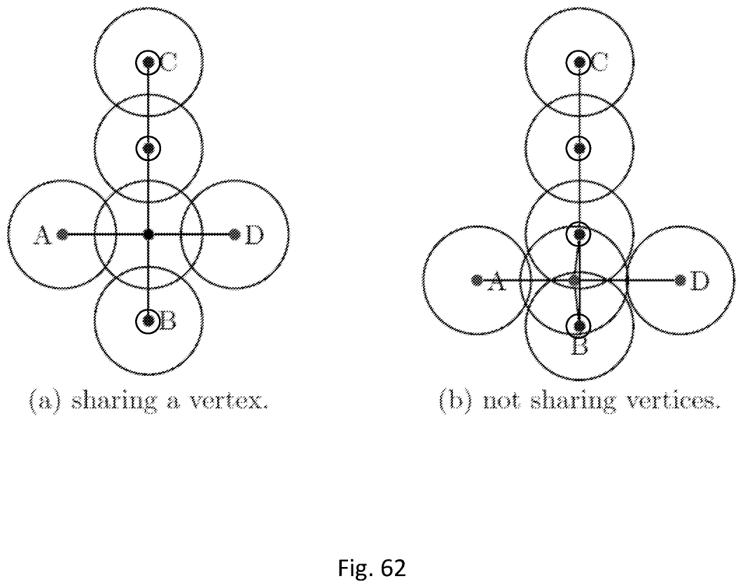

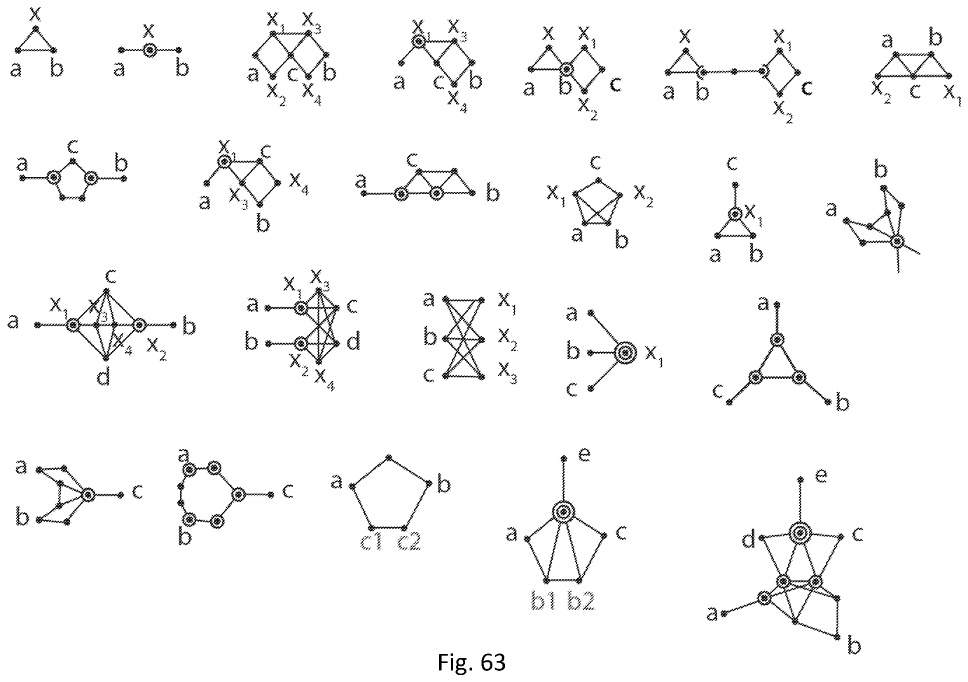

If π_{AD} and π_{BC} cross each other, they must have circles overlapping in the middle, because the circles in each path form a connected region in the two dimensional plane. As shown in FIG. 62, there are only two different ways to cross paths π_{AD} and π_{BC}, either they share a common vertex, as shown in FIG. 62A, or there is a node in one of the paths that connects to a segment in another path, as shown in FIG. 62B.

Equivalently, the crossing criteria in the monadic second order logic (MSO2) language is

$$\begin{matrix}{∀}_{{π}_{AD} ∈ Paths ( A , D )} {∀}_{{π}_{BC} ∈ Paths ( B , C )} ( ( {∃}_{u , v , w} ( u , v ) ∈ {π}_{AD} ∧ ( u , w ) ∈ {π}_{BC} ) \\ ∨ ( {∃}_{( w , {w}^{′} ) ∈ {π}_{AD}} {∃}_{( u , v ) ∈ {π}_{BC}} adj ( w , u ) ∧ adj ( w , v ) ) \\ ∨ ( {∃}_{( w , {w}^{′} ) ∈ {π}_{BC}} {∃}_{( u , v ) ∈ {π}_{AD}} adj ( w , u ) ∧ adj ( w , v ) ) )\end{matrix} \qquad Equation 137$$

where adj is the adjacency relation.

Recognizing a unit disk graph is NP-hard, however, for a small graph, it is not that hard to find a valid embedding. To find a unit disk embedding for a candidate graph G=(V, E), the following loss function is defined

$$ℒ ( x ) = {\sum }_{( i , j ) ∈ E ( G )} relu ( {‖ {x}_{i} - {x}_{j} ‖}^{2} - 0.99 ) │ + {\sum }_{( i , j ) ∉ E ( G )} relu ( 1.01 - {‖ {x}_{i} - {x}_{j} ‖}^{2} ) \qquad Equation 138$$

and one variationally optimizes this loss function using the automatic differentiation technique. Here, variational parameters x are vertex coordinates and relu is a widely used activation function in machine learning defined as

$$relu ( x ) = \{ \begin{matrix}x & x > 0 \\ 0 & x \leq 0\end{matrix} \qquad Equation 139$$

Whenever the unit disk constraint is violated, there will be a positive contribution from the relu function, otherwise, the loss is zero. Here, it is required that there be a minimum gap 0.01 when applying the unit disk constraints. The L-BFGS optimizer is used to optimize this loss function, and one of the vertex coordinates is fixed so that there are 2|V|−2 free variational parameters in total. If this loss can be optimized to its minimum (e.g., 0) then the optimized parameters specify a valid unit disk embedding of G. With randomly initialized parameters, it is possible that the gradient based optimization can be trapped in a local minimum. By repeatedly doing the above optimization, there is a very high probability to get a valid unit disk embedding if the graph is unit disk embedible. In the program, a high performance automatic differentiation tool, NiLang, is used so that a single optimization takes only a few milliseconds.

Referring to FIG. 47, the four unit disk crossover gadgets of size 11 (or 7 ancillas) are shown, where the top right one is isomorphic to the one in FIG. 50.

All publications and patents mentioned herein are hereby incorporated by reference in their entirety as if each individual publication or patent was specifically and individually indicated to be incorporated by reference. In case of conflict, the present application, including any definitions herein, will control.

### Formation of Array of Particles Using Optical Tweezers

Optical trapping of neutral atoms is a powerful technique for isolating atoms in vacuum. Atoms are polarizable, and the oscillating electric field of a light beam induces an oscillating electric dipole moment in the atom. The associated energy shift in an atom from the induced dipole, averaged over a light oscillation period, is called the AC Stark shift. Based on the AC Stark shift induced by light that is detuned (i.e., offset in wavelength) from atomic resonance transitions, atoms are trapped at local intensity maxima (for red detuned, that is, longer wavelength trap light), because the atoms are attracted to light below the resonance frequency. The AC Stark shift is proportional to the intensity of the light. Thus, the shape of the intensity field is the shape of an associated atom trap. Optical tweezers utilize this principle by focusing a laser to a micron-scale waist, where individual atoms are trapped at the focus. Two-dimensional (2D) arrays of optical tweezers are generated by, for example, illuminating a spatial light modulator (SLM), which imprints a computer-generated hologram on the wavefront of the laser field. The 2D array of optical tweezers is overlapped with a cloud of laser-cooled atoms in a magneto-optical trap (MOT). The tightly focused optical tweezers operate in a “collisional blockade” regime, in which single atoms are loaded from the MOT, while pairs of atoms are ejected due to light-assisted collisions, ensuring that the tweezers are loaded with at most single atoms, but the loading is probabilistic, such that the trap is loaded with a single atom with a probability of about 50-60%.

To prepare deterministic atom arrays, a real-time feedback procedure identifies the randomly loaded atoms and rearranges them into pre-programmed geometries. Atom rearrangement requires moving atoms in tweezers which can be smoothly steered to minimize heating, by using, for example, acousto-optic deflectors (AODs) to deflect a laser beam by a tunable angle which is controlled by the frequency of an acoustic waveform applied to the AOD crystal. Dynamic tuning of the acoustic frequency translates into smooth motion of an optical tweezer. A multi-frequency acoustic wave creates an array of laser deflections, which, after focusing through a microscope objective, forms an array of optical tweezers with tunable position and amplitude that are both controlled by the acoustic waveform. Atoms are rearranged by using an additional set of dynamically moving tweezers that are overlaid on to p of the SLM tweezer array.

### Exemplary Hardware

Optical tweezer arrays constitute a powerful and flexible way to construct large scale systems composed of individual particles. Each optical tweezer traps a single particle, including, but not limited to, individual neutral atoms and molecules for applications in quantum technology. Loading individual particles into such tweezer arrays is a stochastic process, where each tweezer in the system is filled with a single particle with a finite probability p<1, for example p˜0.5 in the case of many neutral atom tweezer implementations. To compensate for this random loading, real-time feedback may be obtained by measuring which tweezers are loaded and then sorting the loaded particles into a programmable geometry. This may be performed by moving one particle at a time, or in parallel.

Parallel sorting may be achieved by using two acousto-optic deflectors (AODs) to generate multiple tweezers that can pick up particles from an existing particle-trapping structure, move them simultaneously, and release them somewhere else. This can include moving particles around within a single trapping structure (e.g., tweezer array) or transporting and sorting particles from one trapping system to another (e.g., between one tweezer array and another type of optical/magnetic trap). This sorting is flexible and allows programmed positioning of each particle. Each movable trap is formed by the AODs and its position is dynamically controlled by the frequency components of the radiofrequency (RF) drive field for the AODs. Since the RF drive of the AODs can be controlled in real time and can include any combination of frequency components, it is possible to generate any grid of traps (such as a line of arbitrarily positioned traps), move the rows or columns of the grid, and add or remove rows and columns of the grid, by changing the number, magnitude, and distribution of the frequency components in the RF drive fields of the AODs.

In an exemplary embodiment, an optical tweezer array is created using a liquid crystal on silicon spatial light modulator (SLM), which can programmatically create flexible arrangements of tweezers. These tweezers are fixed in space for a given experimental sequence and loaded stochastically with individual atoms, such that each tweezer is loaded with probability p˜0.5. A fluorescence image of the loaded atoms is taken, to identify in real-time which tweezers are loaded and which are empty.

After detecting which tweezers are loaded, movable tweezers overlapping the optical tweezer array can dynamically reposition atoms from their starting locations to fill a target arrangement of traps with near-unity filling. The movable tweezers are created with a pair of crossed AODs. These AODs can be used to create a single moveable trap which moves one atom at a time to fill the target arrangement or to move many atoms in parallel.

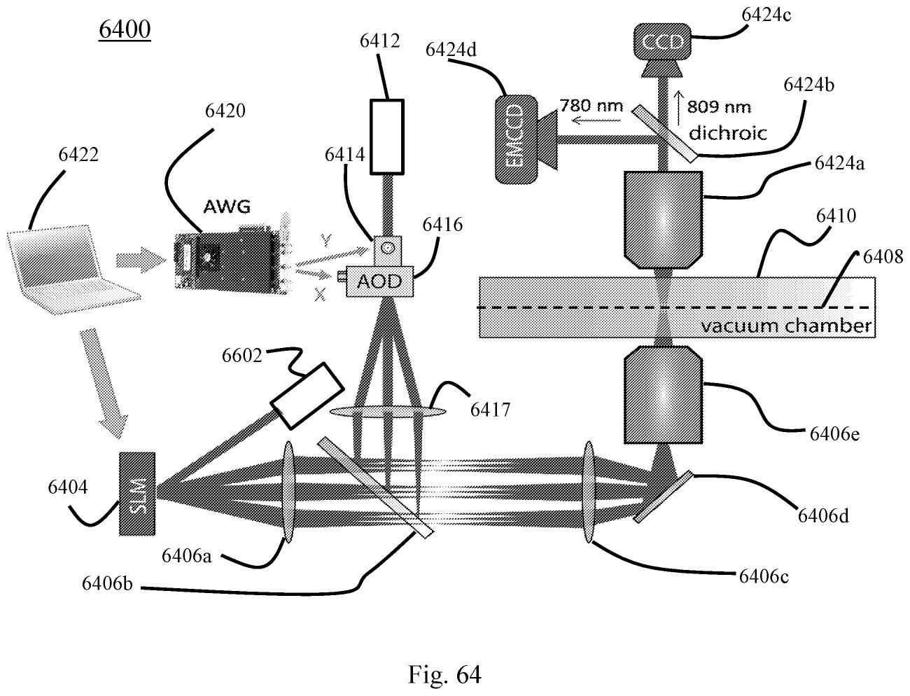

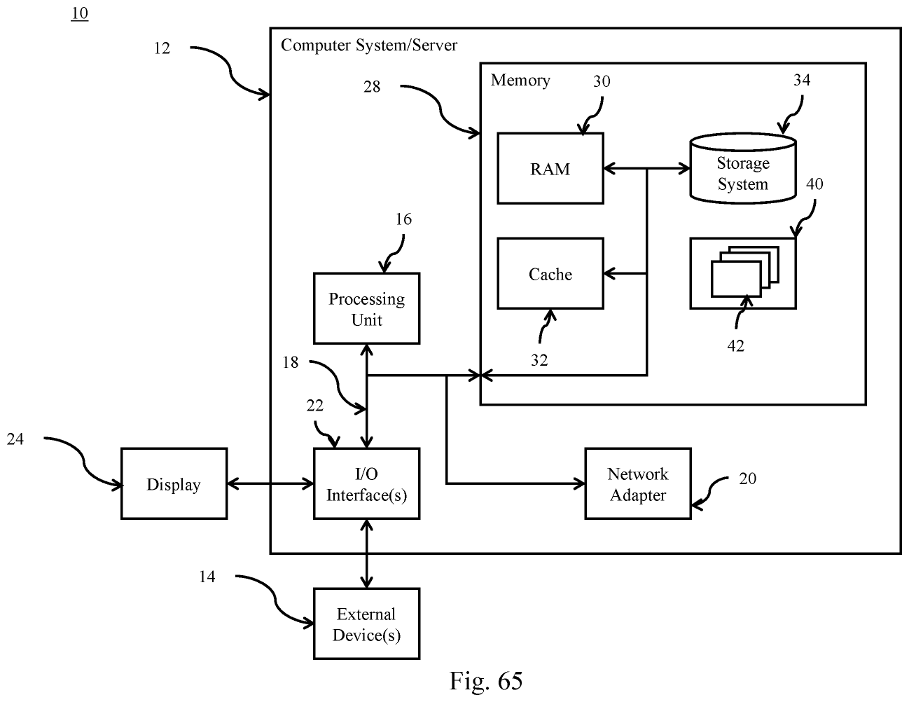

Referring to FIG. 64, a schematic view is provided of an apparatus 6400 for quantum computation according to embodiments of the present disclosure. As shown in FIG. 64, using a beam generated by a light source 6402 (for example, a coherent light source, in some example embodiments—a monochromatic light source), SLM 6404 forms an array of trapping beams (i.e., a tweezer array) which is imaged onto trapping plane 6408 in vacuum chamber 6410 by an optical train that, in the example embodiment shown in FIG. 64, comprises elements 6406a, 6406c, 6406d, and a high numerical aperture (NA) objective 6406e. Other suitable optical trains can be employed, as would be easily recognized by a person of ordinary skill in the art. Using a beam generated by light source 6412 (for example, a coherent light source; in some example embodiments-a monochromatic light source), a pair of AODs 6414 and 6416, having non-parallel directions of acoustic wave propagation (for example, orthogonal directions) creates dynamically movable sorting beams. By using the optical train, such as the one depicted in FIG. 64 (elements 6417, 6406b, 6406c, 6406d, and 6406e), the sorting beams are overlapped with the trapping beams. It is understood that other optical train can be used to achieve the same result. For example, source 6402 and 6412 can be a single source, and the trapping beam and the sorting beam are generated by a beam splitter.

The dynamic movement of the steering beams is accomplished by employing two non-parallel AODs 6414, 6416, arranged in series. In the example embodiment depicted in FIG. 64, one AOD defines the direction of “rows” (“horizontal”—the ‘X’ AOD) and the other AOD defines the direction of “columns” (“vertical”—the ‘Y’ AOD). Each AOD is driven with an arbitrary RF waveform from an arbitrary waveform generator 6420, which is generated in real-time by a computer 6422 which processes the feedback routine after analyzing the image of where atoms are loaded. If each AOD is driven with a single frequency component, then a single steering beam (“AOD trap”) is created in the same plane 6408 as the SLM trap array. The frequency of the X AOD drive determines the horizontal position of the AOD trap, and the frequency of the Y AOD drive determines the vertical position; in this way, a single AOD trap can be steered to overlap with any SLM trap.

In FIG. 64, laser 6402 projects a beam of light onto SLM 6404. SLM 6404 can be controlled by computer 6422 in order to generate a pattern of beams (“trapping beams” or “tweezer array”). The pattern of beams is focused by lens 6406a, passes through mirror 6406b, and is collimates by lens 6406c on mirror 6406d. The reflected light passes through objective 6406e to focus an optical tweezer array in vacuum chamber 6410 on trapping plane 6408. The laser light of the optical tweezer array continues through objective 6424a, and passes through dichroic mirror 6424b to be detected by charge-coupled device (CCD) camera 6424c.

Vacuum chamber 6410 may be illuminated by an additional light source (not pictured). Fluorescence from atoms trapped on the trapping plane also passes through objective 6424a, but is reflected by dichroic mirror 6424b to electron-multiplying CCD (EMCCD) camera 6424d.

In this example, laser 6412 directs a beam of light to AODs 6414, 6416. AODs 6414, 6416 are driven by arbitrary wave generator (AWG) 6420, which is in turn controlled by computer 6422. Crossed AODs 6414, 6416 emit one or more beams as set forth above, which are directed to focusing lens 6417. The beams then enter the same optical train 6406b . . . 6406e as described above with regard to the optical tweezer array, focusing on trapping plane 6408.

It will be appreciated that alternative optical trains may be employed to produce an optical tweezer array suitable for use as set out herein.

Referring now to FIG. 67, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 67, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### Definitions

Two chains of vertices are said to bypass each other if they are configured such that on a unit disk graph the chains cross without introducing any coupling between the two corresponding effective degrees of freedom. Two chains of vertices are said to connect if they cross without bypassing each other. As set out herein, a bypass may be achieved by the use of any of the disclosed “crossover gadgets” or their equivalents. A connection may be achieved by the use of any of the disclosed “crossover-with-edge gadgets” or their equivalents.

A graph is said to conform to a graph type when the vertices of that graph are a subset of the vertices of an exemplary graph of that graph type. Accordingly, a graph that conforms to a grid graph maps onto a grid, but does not necessarily fill all positions in that grid.

An algebraic primitive is an equation having one or more variables that may be combined in a system of equations to solve more complicated expressions.

A graph specification or graph definition is computer-readable description sufficient to specify the vertices and edges of graph. Various manners of specifying a graph are known in the art, including but not limited to a connectivity table, a linked list, a list of vertex coordinates and edges, or combinations thereof.

1. A method of compiling a combinatorial graph optimization problem and executing the compiled combinatorial graph optimization problem on a quantum computer, the method comprising:
reading a specification of an input graph, the input graph comprising a first plurality of vertices, each having a vertex weight, and a first plurality of edges, each having an edge weight and an associated interaction, the input graph corresponding to the combinatorial graph optimization problem; and
generating an output graph, the output graph being a unit disk graph and comprising a second plurality of vertices, each having a vertex weight, and a second plurality of edges, such that a maximum weight independent set on the output graph encodes the solution to the combinatorial graph optimization problem, wherein generating the output graph comprises:
generating a chain of vertices corresponding to each of the first plurality of vertices, each vertex in the chain being connected by an edge with its nearest neighbors in the chain;
arranging the chains into a crossing lattice such that for any two chains there is one intersection between edges thereof, corresponding to one of the first plurality of edges;
for each interaction associated with one of the first plurality of edges, determining a unit disk crossing gadget encoding that interaction; and
at each intersection, inserting the unit disk crossing gadget that encodes the interaction associated with the corresponding edge in the input graph,
the method further comprising:
arranging a plurality of qubits according to the output graph, wherein one of the plurality of qubits is associated with each of the second plurality of vertices, each qubit being excitable into a Rydberg state having a Rydberg blockade radius, and wherein the Rydberg blockade radius of each of the plurality of qubits corresponds to a unit disk of the unit disk graph;
evolving the plurality of qubits into a final state, the final state corresponding to a maximum weight independent set of the output graph;
measuring at least one of the plurality of qubits to determine a measurement outcome;
repeating said arranging, evolving, and measuring steps to determine a plurality of measurement outcomes; and
solving the combinatorial graph optimization problem based on the plurality of measurement outcomes, said solving comprising:
mapping measurement outcomes of each unit disk crossing gadget to a solution state of the crossing lattice according to the interaction encoded by that unit disk crossing gadget; and
mapping the solution state of the crossing lattice to the solution of the combinatorial graph optimization problem by determining a parity of each chain of vertices.

2. The method of claim 1, wherein the combinatorial graph optimization problem is a maximum weight independent set problem.

3. The method of claim 2, wherein each of the second plurality of vertices has an associated weight.

4. The method of claim 1, wherein the combinatorial graph optimization problem is a quadratic unconstrained binary optimization problem (QUBO).

5. The method of claim 1, wherein the vertex weights of the first plurality of vertices are equal.

6. The method of claim 1, wherein the edge weights of the first plurality of edges are equal.

7. The method of claim 1, the method further comprising at each intersection, connecting a subgraph to the intersecting chains, wherein each subgraph is configured to either connect or bypass the respective chains according to whether the corresponding input vertices are connected by one of the first plurality of edges.

8. The method of claim 7, wherein the subgraphs are independently selected from:

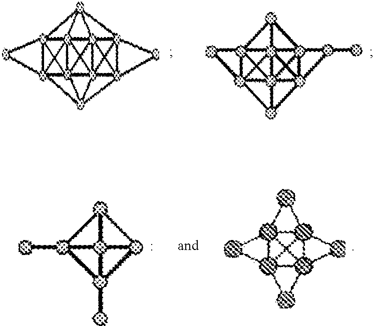

9. The method of claim 1, wherein generating the output graph further comprises relocating the second plurality of vertices within the output graph to conform with a unit disk constraint.

10. The method of claim 1, wherein generating the output graph further comprises adding pairs of vertices to one or more of the chains.

11. The method of claim 1, wherein generating the output graph further comprises pruning the output graph to remove a subset of vertices whose removal does not affect the maximum independent set of the remaining portion of the output graph.

12. The method of claim 1, wherein the chain of vertices contains an odd number of vertices.

13. The method of claim 12, wherein the odd number of vertices is equal to 2n−1, wherein n corresponds to a count of the first plurality of vertices.

14. The method of claim 1, wherein the output graph conforms to a grid graph.

15. The method of claim 1, wherein the output graph conforms to a diagonal-coupled unit-disk grid graph.

16. The method of claim 1, wherein generating the output graph further comprises reordering the first plurality of vertices in a two-dimensional space.

17. The method of claim 1, wherein determining the unit disk crossing gadget for each interaction comprises performing a search using a tropical tensor network.

18. (canceled)

19. The method of claim 1, wherein solving the combinatorial graph optimization problem further comprises applying a greedy algorithm to correct the plurality of measurement outcomes.

20. The method of claim 1, wherein solving the combinatorial graph optimization problem further comprises applying a simulated annealing algorithm to correct the plurality of measurement outcomes.

21-80. (canceled)
